(19) United States
(12) Patent Application Publication
(10) Pub. No.: US 2022/0118618 A1
(43) Pub. Date: Apr. 21, 2022

(54) ROBOTIC KITCHEN HUB SYSTEMS AND METHODS FOR MINIMANIPULATION LIBRARY ADJUSTMENTS AND CALIBRATIONS OF MULTI-FUNCTIONAL ROBOTIC PLATFORMS FOR COMMERCIAL AND RESIDENTIAL ENVIORNMENTS WITH ARTIFICIAL INTELLIGENCE AND MACHINE LEARNING

(71) Applicant: Mark Oleynik, Monaco (MC)

(72) Inventor: Mark Oleynik, Monaco (MC)

(21) Appl. No.: 17/399,045

(22) Filed: Aug. 10, 2021

Related U.S. Application Data
(63) Continuation-in-part of application No. 17/120,221, filed on Dec. 13, 2020.
(60) Provisional application No. 63/093,100, filed on Oct. 16, 2020.
(60) Provisional application No. 63/121,907, filed on Dec. 5, 2020.

(51) Int. Cl. B25J 9/16; B25J 9/02; B25J 11/00; B25J 13/08

(52) U.S. Cl. CPC B25J 9/1671; B25J 13/089; B25J 11/0045; B25J 9/026

(57) ABSTRACT

The present disclosure is directed to methods, computer program products, and computer systems of a robotic kitchen hub for calibrations of multi-functional robotic platforms for commercial and residential environments with artificial intelligence and machine learning. The multi-functional robotic platform includes a robotic kitchen for calibration with either a joint state trajectory or in a coordinate system like a cartesian coordinate for mass installation of robotic kitchens. Calibration verifications and minimanipulation library adaptation and adjustment of any serial model or different models provide scalability in the mass manufacturing of a robotic kitchen system. A robotic kitchen with multi-mode provides a robot mode, a collaboration mode and a user mode which a particular food dish can be prepared by the robot, a collaboration on sharing tasks between the robot and a user, or the robot serves as an aid for the user to prepare a food dish.

### CROSS REFERENCE TO RELATED APPLICATIONS

This application claims priority and is a continuation-in-part of co-pending U.S. patent application Ser. No. 17/120,221 entitled “Robotic Kitchen Hub Systems and Methods for Minimanipulation Library Adjustment and Calibrations of Multi-Functional Robotic Platforms for Commercial and Residential Environments with Artificial Intelligence and Machine Learning,” filed 13 Dec. 2020, which in turn is a continuation-in-part of co-pending U.S. patent application Ser. No. 16/900,18-3 entitled “Systems and Methods for Minimanipulation Library Adjustments and Calibrations of Multi-Functional Robotic Platforms with Supported Subsystem Interactions,” filed 12 Jun. 2020.

This application claims priority to U.S. Provisional Application Ser. No. 63/121,907 entitled “Systems and Methods for Minimanipulation Library Adjustments and Calibrations of Multi-Functional Robotic Platforms with Supported Subsystem Interactions,” filed 5 Dec. 2020, U.S. Provisional Application Ser. No. 63/093,100 entitled “Systems and Methods for Minimanipulation Library Adjustments and Calibrations of Multi-Functional Robotic Platforms with Supported Subsystem Interactions,” filed 16 Oct. 2020, U.S. Provisional Application Ser. No. 63/088,443 entitled “Systems and Methods for Minimanipulation Library Adjustments and Calibrations of Multi-Functional Robotic Platforms with Supported Subsystem Interactions,” filed 6 Oct. 2020, the disclosures of which are incorporated herein by reference in their entireties.

This application is also related to U.S. Non-Provisional Application Ser. No. 16/900,18-3 entitled “Systems and Methods for Minimanipulation Library Adjustments and Calibrations of Multi-Functional Robotic Platforms with Supported Subsystem Interactions,” filed on 12 Jun. 2020, U.S. Provisional Application Ser. No. 63/088,443 entitled “Systems and Methods for Minimanipulation Library Adjustments and Calibrations of Multi-Functional Robotic Platforms with Supported Subsystem Interactions,” filed 6 Jun. 2020, U.S. Provisional Application Ser. No. 63/026,328 entitled “Ingredient Storing Smart Container for Human and Robotic Operation Environment,” filed 18 May 2020, U.S. Provisional Application Ser. No. 62/984,321 entitled “Systems and Methods for Operation Automated and Robotic, Instrumental Environments Including Living and Warehouse Facilities,” filed 3 Mar. 2020, U.S. Provisional Application Ser. No. 62/970,725 entitled “Systems and Methods for Operation Automated and Robotic, Instrumental Environments Including Living and Warehouse Facilities,” filed 6 Feb. 2020, U.S. Provisional Application Ser. No. 62/929,973 entitled “Method and System of Robotic Kitchen and IOT Environments,” filed 4 Nov. 2019, and U.S. Provisional Application Ser. No. 62/860,293 entitled “Systems and Methods for Operation Automated and Robotic Environments in Living and Warehouse Facilities,” filed 12 Jun. 2019

### BACKGROUND

### Technical Field

The present disclosure relates generally to the interdisciplinary fields of robotics and artificial intelligence (AI), more particularly to computerized robotic systems employing electronic libraries of minimanipulations with transformed robotic instructions for replicating movements, processes, and techniques with real-time electronic adjustments.

### Background Art

Research and development in robotics have been undertaken for decades, but the progress has been mostly in the heavy industrial applications like automobile manufacturing automation or military applications. Simple robotics systems have been designed for the consumer markets, but they have not seen a wide application in the home-consumer robotics space, thus far. With advances in technology, combined with a population with higher incomes, the market may be ripe to create opportunities for technological advances to improve people's lives. Robotics has continued to improve automation technology with enhanced artificial intelligence and emulation of human skills and tasks in many forms in operating a robotic apparatus or a humanoid.

The notion of robots replacing humans in certain areas and executing tasks that humans would typically perform is an ideology in continuous evolution since robots were first developed in the 1970s. Manufacturing sectors have long used robots in teach-playback mode, where the robot is taught, via pendant or offline fixed-trajectory generation and download, which motions to copy continuously and without alteration or deviation. Companies have taken the pre-programmed trajectory-execution of computer-taught trajectories and robot motion-playback into such application domains as mixing drinks, welding or painting cars, and others. However, all of these conventional applications use a 1:1 computer-to-robot or tech-playback principle that is intended to have only the robot faithfully execute the motion-commands, which is usually following a taught/pre-computed trajectory without deviation.

As the research and development in the robotic industry has accelerated in recent years, both in consumer robotics, commercial robotics and industrial robotics, companies are working to design robotic products that can be scaled and widely deployed in their respective regions and worldwide. Due in part to the mechanical compositions of a robotic product, mass manufacturing and installation of robotic products present challenges to ensure that the finished robotic product operates to meet with the technical specification, which can arise from issues such as part variations, manufacturing errors, installation differences, and others.

Accordingly, it is desirable to have a robotic system with a fully or semi-automatic calibration operating framework and minimanipulation library adjustment for mass manufacturing kitchen modules, multiple modes of operations, and subsystems operating and interacting in a robotic kitchen.

### SUMMARY OF THE DISCLOSURE

Embodiments of the present disclosure are directed to methods, computer program products, and computer systems of a multi-functional robotic platform including a robotic kitchen for calibration with either a joint state trajectory or in a coordinate system like a cartesian coordinate for mass installation of robotic kitchens, multi-mode (also referred to as multiple modes, e.g., bimodal, trimodel, multimodal, etc.) operations of the robotic kitchen to provide different ways to prepare food dishes, and subsystems tailored to operate and interact with the various elements of a robotic kitchen, such as the robotic effectors, other subsystems, and containers, ingredients.

In a first aspect of the present disclosure, a system and a method comprises a reliable operation inside a robotic kitchen in an instrumented environment is the capability to rely on absolute positioning of the instrumented environment. As to resolve a common problem in robotics in which each robotic system manufactured undergoes calibration verifications and minimanipulation library adaptation and adjustment of any serial model or different models automatic adaptation. The disclosure is directed to the scalability in the mass manufacturing of a robotic kitchen system, as well as methods as to how each manufactured robotic kitchen system meets the operational requirements. Standardized procedures are adopted which are aimed to automate the calibration process. Accurate and repeatable assembly process is the first step in assuring that each manufactured robotic system is as close as possible to the assumed (or predetermined) geometry or geometric parameters. Lifetime product natural deformation could be also the reason to process time to time automatic calibration and minimanipulation library adaptation and adjustment. The different product models need to have also adapted and validated library of minimanipulation which support various functional operations. Automated calibration procedures assure that operations created inside a master (or model) kitchen environment works in each robotic kitchen system and the solution is easily scalable for mass production. The physical geometry is adapted for robotic operations, any displacement in the robotic system is being compensated using various techniques as described in the present disclosure. In another embodiment, the present disclosure is directed to a robotic system compatibility operable in a plurality of different modes. User mode, robot mode and collaborative mode. Document specifying the way of mitigation for the risk in collaborative mode, using different sensors to keep environment safe for human collaborative operation. For example, the present disclosure describes a robotic kitchen system and a method that operates with any functional robotic platform having minimanipulation operations libraries of a master robotic kitchen module with an automatic calibration system for initializing the initial state of another robotic kitchen during an installation.

In a second aspect of the present disclosure, a robotic system and a method that comprise a plurality of modes of operations of a robotic kitchen, including but not limited to, a robot operating mode, a collaborative operating mode between a robot apparatus and a user, and a user operating mode which the robotic kitchen facilitating to the requirements by the user.

In a third aspect of the present disclosure, a robotic kitchen includes subsystems that are designed to operate and interact with a robot (e.g., one or more robotic arms coupled to one or more end effectors), or interact with other subsystems, kitchen tools, kitchen devices, or containers.

In a fourth aspect of the present disclosure, a method for calibrating a robotic apparatus is disclosed. The method may be a computer-implemented method executed by a processor. The method moves at least one element of the robotic apparatus from a predetermined start configuration until the at least one element of the robotic apparatus is in contact with or touches a predetermined surface of an object. Then, the method records a location value and/or an orientation value of the surface of the object based on or when detecting the contact with the surface of the object. The method compares the recorded location value and/or the recorded orientation value with an expected location value and/or with an expected orientation value to determine a positional deviation and/or an orientational/rotational deviation. For example, the positional deviation and/or the orientational/rotational deviation may include linear and/or rotational shifts or spatial differences. The method stores the determined positional and/or orientational/rotational deviation in a transformation data set. The transformation data set may be stored in a memory of the robotic apparatus

Broadly stated, a computer-implemented method for a robotic kitchen, executed by a processor, comprises providing a minimanipulation library including a plurality of minimanipulations; comparing a virtual model of a first robotic kitchen with a physical model of a second robotic kitchen to determine one or more deviations; computing a mathematical transformation based on the one or more deviations in the virtual model of the first robotic kitchen with the physical model of a second robotic kitchen; and when executing a minimanipulation from the plurality of minimanipulations, applying the transformation matrix to the robotic kitchen by adjusting the location and orientation data value in the virtual model for compensating the one or more deviations in the virtual model of the first robotic kitchen, thereby the relative locations of the virtual model of the first robotic kitchen has been modified to be the same as the model of the second robotic kitchen.

A robotic calibration method, executed by a processor, comprises receiving a virtual three-dimensional model of a first robotic kitchen; sensing, by one or more sensors, a second robotic kitchen to produce a physical three-dimensional model in a second robotic kitchen; comparing the virtual three-dimensional model of the first robotic kitchen with the physical three-dimensional model in the second robotic kitchen to determine one or more deviations; computing a mathematical transformation based on the one or more deviations the virtual three-dimensional model of the first robotic kitchen with the physical three-dimensional model in the second robotic kitchen; and when executing a minimanipulation by a robot having one or more robotic arms, applying the transformation matrix to the robotic kitchen using a multi-axis gantry by adjusting one or more locations and one or more orientations to the one or more robotic arms, thereby the relative locations of the physical three-dimensional model in the second robotic kitchen have been modified to be the same as the virtual three-dimensional model of the first robotic kitchen.

A system for mass production of a robotic kitchen module comprises a kitchen module frame for housing a robotic apparatus in an instrumented environment, the robotic apparatus having one or more robotic arms and one or more effectors, the one or more robotic arms including a share joint, the kitchen module having a set of robotic operable parameters for calibration verifications to an initial state for operation by the robotic apparatus; and one or more calibration actuators coupled to a respective one of the one or more robotic arms, each calibration actuator corresponding to an axis on x-y-z axes, each actuator in the one or more calibration three-degree actuators having at least three degrees of freedom, the one or more actuators comprising a first actuator for compensation of a first deviation on the x-axis, a second actuator for compensation of a second deviation on the y-axis, a third actuator for compensation of a third deviation on the z-axis, and a fourth actuator for compensation of a fourth deviation on rotational on x-rail; and a detector for detecting one or more deviations of the positions and orientations in one or more reference points in the original instrumented environment and a target instrumented environment thereby generating a transformational matrix, applying the one or more deviations to one or more minimanipulations by adding or subtracting to the parameters in the one or more minimanipulations.

In one or more embodiments, the contact with the surface is detected by an increase in electrical current or an increase in resistance detected for an electrical motor of the robotic apparatus.

In one or more embodiments, a force sensor, a torque sensor, a force and torque sensor, a camera, a distance sensor, a sonar (sound navigation and ranging) sensor, a lidar (light detection and ranging or light imaging, detection and ranging) sensor or a combination thereof is use to detect the contact with the surface.

In one or more embodiments, the expected location and/or the expected orientation is a location and/or an orientation stored as part of or derivable from a model associates with the robotic apparatus.

In one or more embodiments, the method for calibrating the robotic apparatus is repeated multiple times for different predetermined surfaces, moving the at least one element of the robotic apparatus along different axes, moving the at least one element of the robotic apparatus towards different directions or any combination thereof to record multiple location values and/or multiple orientation values.

In one or more embodiments, the transformation data set is created by combining and/or processing the multiple recorded location values and/or the multiple recorded orientation values.

In one or more embodiments, the method processing or computes the recorded location value and/or the recorded orientation value to create the transformation data set based on the determined positional deviation and/or the determined orientational/rotational deviation.

In one or more embodiments, the method receives a minimanipulation to be executed by the robotic apparatus in a physical environment. The minimanipulation is pre-planned and/or pre-tested. The method then receives transformation information from the transformation data set. The received transformation information is associated with the received minimanipulation. The method applies the received transformation information to the received minimanipulation to generate an adjusted minimanipulation. The method executes the adjusted minimanipulation by the robotic apparatus.

In a fifth aspect of the present disclosure, a method for executing minimanipulations by a robotic apparatus. The method may be a computer-implemented method executed by a processor. The method receives a minimanipulation to be executed by the robotic apparatus in a physical environment. The minimanipulation is pre-planned and/or pre-tested. The method receives transformation information from a transformation data set. The transformation data set may be stored in a memory of the robotic apparatus. The received transformation information is associated with the received minimanipulation. The method applies the received transformation information to the received minimanipulation to generate an adjusted minimanipulation. The method executes the adjusted minimanipulation by the robotic apparatus. In one embodiment, during execution, a processor in a system may use an adjusted minimanipulation to achieve a predefined functional outcome at a predetermined performance level.

In one or more embodiments, the minimanipulation is received from a minimanipulation library associated with the robotic apparatus. The minimanipulation library may be a software library, e.g., a digital database or a data repository. The minimanipulation library stores a plurality of minimanipulations. The plurality of minimanipulations is pre-planned and/or pre-tested.

In one or more embodiments, the received minimanipulation and/or the plurality of minimanipulations has been pre-planned for and/or pre-tested with the robotic apparatus or another robotic apparatus one or more times during a testing or training phase to obtain a predetermined functional outcome when executing the received minimanipulation. For example, the robotic apparatus is defined in a predefined physical environment.

In one or more embodiments, the received minimanipulation and/or the plurality of minimanipulations has been pre-planned and/or pre-tested in the physical environment in which the adjusted minimanipulation is to be executed, in another physical environment of another robotic apparatus, in a virtual model of the physical environment, in a virtual model of another physical environment, or any combinations thereof.

In one or more embodiments, the method applies the received transformation information to the received minimanipulation to compensate positional and/or orientational/rotational deviations between the physical environment in which the robotic apparatus is to be executed and the physical environment or the virtual model based on which the received minimanipulation has been pre-planned and/or pre-tested during the testing or training phase.

In one or more embodiments, the physical environment in which the adjusted minimanipulation is to be executed is compared to the virtual model based on which the received minimanipulation has been pre-planned and/or pre-tested during the testing or training phase to determine positional and/or orientational/rotational deviations.

In one or more embodiments, the received minimanipulation has one or more parameters, and wherein applying the received transformation information to the received minimanipulation changes or adjusts at least one parameter value for at least one of the one or more parameters. For example, the at least one parameter value is adjusted by adding a first correction value or by multiplying the parameter values with a second correction value.

In one or more embodiments, the at least one parameter value to be changed or adjusted is originally received from the minimanipulation library or another data storage.

In one or more embodiments, the method applies the received transformation information to the received minimanipulation to adapt the received minimanipulation to the physical environment in which the minimanipulation is to be executed by the robotic apparatus.

In one or more embodiments, the method receives a sequence of minimanipulations for performing a certain task by the robotic apparatus. The the received minimanipulation is received as part of the sequence of minimanipulations. The method executes the sequence of minimanipulations including the minimanipulation by the robotic apparatus after applying transformation information to at least some minimanipulations in the sequence of minimanipulations. The task may be preparing a certain dish or parts thereof. The minimanipulations may correspond to cooking operations.

In one or more embodiments, the received minimanipulation is pre-planned and/or pre-tested. The method executes executing the received minimanipulation during the testing or training phase to obtain or achieve a certain functional outcome. The method then evaluates a level of performance of the execution of the minimanipulation based on predetermined evaluation criteria for the functional outcome by comparing the functional outcome to the predetermined evaluation criteria. The method assigns the level of performance to the minimanipulation. The method stores the level of performance with the minimanipulation in the minimanipulation library.

In one or more embodiments, the received minimanipulation is a joint state trajectory minimanipulation and/or one or more of the plurality of minimanipulations are joint state trajectory minimanipulations. The joint state trajectory minimanipulation is or the joint state trajectory minimanipulations are developed by simulating a desired action inside a virtual environment or by recording a desired action in the physical environment of the robotic apparatus or in another physical environment.

In one or more embodiments, the robotic apparatus comprises a multi-axis gantry system. The multi-axis gantry system comprises multiple axes secured on a frame. The multi-axis gantry system further comprises a robotic arm mount bracket or a robotic arm carriage attached to the multiple axes and carrying one or more robotic arms of the robotic apparatus.

In one or more embodiments, the multi-axis gantry system comprises at least two robotic arm mount brackets or at least two robotic arm carriages. Each of the at least two robotic arm mount brackets or carriages carries one or more robotic arms of the robotic apparatus. Each of the at least two robotic arm mount brackets or carriages is movable independently of the other of the at least two robotic arm mount brackets or carriages.

In one or more embodiments, adjusted minimanipulation comprises adjustment instructions in addition to the received minimanipulation. The adjustment instructions move the robotic arm mount bracket or carriage of the multi-axis gantry system to compensate for the positional and/or orientational/rotational deviations.

In one or more embodiments, the received minimanipulation is executed as pre-planned and/or pre-tested without additional adjustments or modifications after the adjustment instructions were executed.

In one or more embodiments, the at least one element of the robotic apparatus is moved by the multi-axis gantry system from the predetermined start configuration along a predetermined axis towards the predetermined surface of the object, while (the robotic arm of) the robotic apparatus remains in its original configuration.

In one or more embodiments, the multi-axis gantry system comprises a plurality of motors or actuators. The plurality of motors or actuators move the robotic arm mount bracket or carriage or the at least two robotic arm mount brackets or carriages independently in a x-axis, in a y-axis, in a z-axis, or any combination thereof. Alternatively or additionally, the plurality of motors or actuators rotate the robotic arm mount bracket or the at least two robotic arm mount brackets along or around the x-axis, along or around the y-axis, along or around the z-axis, or any combination thereof.

In one or more embodiments, instead of or in addition to executing the adjusted minimanipulation by the robotic apparatus the method stores the adjusted minimanipulation in the minimanipulation library.

In a sixth aspect of the present disclosure, a method for executing minimanipulations by a robotic apparatus is disclosed. The method may be a computer-implemented method executed by a processor. The method provides a virtual model. Then the method receives transformation information from a transformation data set. The transformation information includes information about one or more positional and/or orientational/rotational deviations between a physical environment in which the robotic apparatus is to be executed and the virtual model. The method applies the transformation information to the virtual model to generate an adjusted virtual model matching at least in part with the physical environment. The method plans a trajectory or a motion for the robotic apparatus in the adjusted virtual model using a minimanipulation. The method executes the minimanipulation by the robotic apparatus in the physical environment.

In one or more embodiments, the method applies the transformation information to the virtual model to adjust at least a part of the virtual model to the physical environment.

In one or more embodiments, the adjusted virtual model is used for live planning one or more trajectories for the robotic apparatus in the physical environment.

In one or more embodiments, the method senses or measures the physical environment by one or more sensors. The method compares the virtual model with the sensed physical environment to determine the one or more positional and/or orientational/rotational deviations between the physical environment in which the robotic apparatus is to be executed and the virtual model. The method computes the transformation data set based on the one or more positional and/or orientational/rotational deviations. The transformation information in the transformation data set allows compensating the one or more positional and/or orientational/rotational deviations.

In one or more embodiments, the transformation data set is generated by a contact based calibration or adaption process. The contact based calibration or adaption process moves at least one element of the robotic apparatus from a start configuration until the at least one element of the robotic apparatus is in contact with or touches a predetermined surface of an object. The method records a location value and/or an orientation value of the surface of the object based on or when detecting the contact with the surface of the object. The method compares the recorded location value and/or the recorded orientation value with an expected location value and/or with an expected orientation value to determine a positional and/or orientational/rotational deviation. The method stores the determined positional and/or orientational/rotational deviation in the transformation data set.

In one or more embodiments, the contact with the surface is detected by an increase in electrical current or an increase in resistance detected for an electrical motor of the robotic apparatus.

In one or more embodiments, a force sensor, a torque sensor, a force and torque sensor, a camera, a distance sensor, a sonar sensor, a lidar sensor or a combination thereof is use to detect the contact with the surface.

In one or more embodiments, the transformation data set is generated by a marker based calibration or adaption process. The process detects a marker in the physical environment in which the robotic apparatus is to be executed. The process determines a location and/or an orientation of the marker by the robotic apparatus. The process compares the determined location and/or the determined orientation of the marker with an expected location and/or an expected orientation of the marker to determine a positional and/or orientational/rotational deviation. The process stores the determined positional and/or the determined orientational/rotational deviation in the transformation data set.

In one or more embodiments, the marker is affixed to one or more objects and/or living beings (e.g., human beings such a patients in a hospital) within the physical environment, is affixed to an particular element of the robotic apparatus, or is a particular part or element of one or more objects or living beings located within the physical environment.

In one or more embodiments, the marker is detected by a camera capturing one or more images of the marker. The one or more images of the marker are analyzed to determine the location and/or the orientation of the marker.

In one or more embodiments, the expected location and/or the expected orientation is a location and/or an orientation stored as part of or derivable from a model associates with the robotic apparatus or the virtual model.

In one or more embodiments, the expected location and/or the expected orientation corresponds to or is associated with the location and/or the orientation stored as part of or derivable from the model associates with the robotic apparatus or the virtual model.

In one or more embodiments, the contact based calibration or adaption process and/or the marker based calibration or adaption process for generating the transformation data set is repeated multiple times for different predetermined surfaces, moving the at least one element of the robotic apparatus along different axes, moving the at least one element of the robotic apparatus towards different directions or any combination thereof to record multiple location values and/or multiple orientation values.

In one or more embodiments, the transformation data set is created by combining and/or processing the multiple recorded location values and/or the multiple recorded orientation values.

In one or more embodiments, the transformation data set is one or more transformation matrices and/or the transformation information is stored and/or organized in the one or more transformation matrices.

In one or more alternative embodiments, the transformation data set is one or more one-dimensional or multi-dimensional arrays (e.g., a two-dimensional array) and/or the transformation information is stored or organized in the one or more one-dimensional or multi-dimensional arrays.

In one or more alternative embodiments, the transformation data set comprises one or more rules for compensating positional and/or orientational/rotational deviations between the physical environment in which the robotic apparatus is to be executed and the physical environment or the virtual model based on which the received minimanipulation has been pre-planned and/or pre-tested during the testing or training phase.

In one or more embodiments, the transformation data set is individually created for the robotic apparatus and the physical environment in which the robotic apparatus is to be executed. Additionally or alternatively, the transformation data set is unique.

In one or more embodiments, the received minimanipulation comprises one or more action primitives. Additionally or alternatively, one or more of the plurality of minimanipulations comprise one or more action primitives.

In one or more embodiments, the robotic apparatus comprises one or more robotic arms and one or more robotic end effectors. One end of one of the one or more robotic arms is coupled to one end of one of the one or more robotic end effectors.

In one or more embodiments, the robotic apparatus is or is part of a robotic kitchen, is a telerobot in a hospital environment, or is a robotic apparatus in a laboratory environment.

In a seventh aspect of the present disclosure, a data processing system is disclosed. The data processing system comprises a processor configured to perform any of the above-described methods.

In an eight aspect of the present disclosure, a computer program product is disclosed. The computer program product comprises instructions which, when the program is executed by a computer, cause the computer to carry out any of the above-described methods.

In a ninth aspect of the present disclosure, a computer-readable storage medium is disclosed. The computer-readable storage medium comprises instructions which, when executed by a computer, cause the computer to carry out any of the above-described methods.

In a tenth aspect of the present disclosure, a ventilation system for an operating environment of a robotic apparatus is disclosed. The ventilation system comprises a first ventilation subsystem adapted to extract air from the operating environment and a second ventilation subsystem adapted to push air to the operating environment and to extract air from the operating environment. The first ventilation subsystem is distinct from the second ventilation subsystem.

In one or more embodiments, the first ventilation subsystem is spatially distant from the second ventilation subsystem. Additionally or alternatively, the first ventilation subsystem is arranged at a first end of the operating environment and the second ventilation system is arranged at a second end of the operating environment. The first end is opposite to the second end.

In one or more embodiments, the first ventilation subsystem is a downdraft extraction ventilation subsystem. In one or more embodiments the second ventilation subsystem is an overhead fan.

In one or more embodiments, the second ventilation subsystem comprises at least one fan. Blades of the at least one fan are movable in two opposite directions.

In one or more embodiments, in a first operation mode of the second ventilation subsystem, the at least one fan is operable to push air into the operating environment of the robotic apparatus by moving the blades of the at least one fan in a first direction to create a positive pressure inside the operating environment. Additionally or alternatively, in a second operation mode of the second ventilation system, the fan is operable to extract air from the operating environment of the robotic apparatus by moving the blades of the at least one fan in a second direction to create an negative pressure inside the operating environment. The first direction is opposite to the second direction.

In one or more embodiments, air extracted from the operating environment is directed into a recirculation system or into an outside environment.

In one or more embodiments, the system also comprises one or more high-efficiency particulate air (HEPA) filters adapted to remove contaminates and/or unwanted particles from air extracted from the operating environment and/or from air pushed to the operating environment.

In one or more embodiments, the system comprises an air quality sensor.

In one or more embodiments, the system comprises a protective screen encompassing at least a part of the operating environment and adapted to isolate the operating environment from an outside environment.

In one or more embodiments, the system comprises a heating element adapted to control and/or adjust temperature inside the operating environment.

In one or more embodiments, the system comprises a humidifier device adapted to control and/or adjust humidity inside the operating environment.

In one or more embodiments, the first ventilation subsystem is operable independently of the second ventilation subsystem. Alternatively or additionally, the second ventilation subsystem is operable independently of the first ventilation subsystem.

In one or more embodiments, the first ventilation subsystem is operable in conjunction with the second ventilation subsystem. Alternatively or additionally, the second ventilation subsystem is operable in conjunction with the first ventilation subsystem.

In an eighth aspect of the present disclosure, a robotic system is disclosed. The robotic system comprises a robotic apparatus and the above-described ventilation system.

In one or more embodiments, robotic apparatus comprises at least one robotic arm and at least one robotic end effector. The at least one robotic end effector is coupled to the at least one robotic arm.

In one or more embodiments, the robotic system is a robotic kitchen and the operating environment is a cooking environment.

In one or more embodiments, the robotic system is a laboratory robot and the operating environment is a robotic laboratory cabinet.

Advantageously, the robotic systems and methods of the present disclosure provide greater functions and capabilities that work on multi-functional robotic platforms with calibration techniques with a joint state embodiment or a cartesian embodiment with multiple modes of operating the robotic kitchen.

The structures and methods of the present disclosure are disclosed in detail in the description below. This summary does not purport to define the disclosure. The disclosure is defined by the claims. These and other embodiments, features, aspects, and advantages of the disclosure will become better understood with regard to the following description, appended claims, and accompanying drawings.

### BRIEF DESCRIPTION OF THE DRAWINGS

The disclosure will be described with respect to specific embodiments thereof, and reference will be made to the drawings, in which

FIG. 1 is a block diagram illustrating a first embodiment of a robotic kitchen artificial intelligence (“AI”) engine (“AI Engine”, “AI Brain”, or “Moley Brain) in accordance with the present disclosure.

FIG. 2 is a block diagram illustrating the robotic artificial intelligence engine module with one or more processors, one or more graphics processing units (GPU), a network, and an optional field-programmable gate arrays (FPGA) in accordance with the present disclosure.

FIG. 3 is a block diagram illustrating an example of a parameterized minimanipulation in accordance with the present disclosure.

FIG. 4 is a block diagram illustrating an example of a cloud inventory central database structure in executing a sequential operation of minimanipulations with a plurality of data fields (or parameters) on the horizontal rows, and a plurality of dates and times on the vertical columns in accordance with the present disclosure.

FIG. 5 is a block diagram depicting the process of calibration whereby deviations of the position and orientation of the physical world system are compared to the reference positions and orientations from the virtual world etalon model, allowing a set of parameter deviations to be computed in accordance with the present disclosure.

FIG. 6 is a block diagram depicting a situational decision-tree to be used to determine when to apply one of three parameter adaptation and compensation techniques in the calibration process in accordance with the present disclosure.

FIG. 7 is a block diagram depicting a schematic fashion a plurality of reference points and associated state configuration vector locations, not limited to two dimensions, but rather in multi-dimensional space, where the robotic kitchen could be commanded to carry out a (re-)calibration procedure to ensure proper performance within the entire workspace as well as within specific portions of the workspace in accordance with the present disclosure.

FIG. 8 is a block diagram depicting the process of a flowchart by which one or more of the calibration processes can be carried out in accordance with the present disclosure. The process utilizes a set of calibration-point and -vector datasets from the etalon model, which are compared to real-world positions, allowing for the computation of parameter adaptation datasets to compensate for the misalignment between the robot system in the physical world and that in the ideal virtual world, and how such compensation data can ne used to modify one or more databases in accordance with the present disclosure.

FIG. 9 is a block diagram depicting a flowchart by which one or more of the pre-command sequence step execution deviation compensation processes can be carried out in accordance with the present disclosure.

FIG. 10 is a block diagram depicting the structure and execution flow of Action-Primitive (AP) Mini-manipulation Library (MML) commands in accordance with the present disclosure.

FIG. 11 is a block diagram depicting how the starting- and ending configurations for any given macro- or micro-AP can be defined not only for each specific subsystem within a robotic kitchen but also contain state variables not limited solely to physical position/orientation, but also other more generic system descriptors in accordance with the present disclosure.

FIG. 12 is a block diagram illustrating a flowchart of how a specific cooking step made up of multiple sequential macro-Aps, themselves each described by a multitude of micro-Aps would be executed by a cooking sequence controller executing a particular cooking step within a particular recipe in accordance with the present disclosure.

FIG. 13 is a block diagram depicting a decision-tree flow for a given AP adaptation. The notion revolves around the potential need to adapt a given AP based on deviations in the sensed configuration of the robotic system in accordance with the present disclosure.

FIG. 14 is a block diagram depicting a comparison of a standard robotic control process, to that of a MML-driven process with minimal adaptation in accordance with the present disclosure.

FIG. 15 is a block diagram depicting the MML Parameter Adaptation elements, which have parameters that can be developed through a variety of methods, including through simulation, teach/playback, manual encoding or even by watching and codifying the process of a master in the field (chef in the case of a kitchen) in accordance with the present disclosure.

FIG. 16 is a block diagram depicting the actual process steps that form part of an MML Adaptation and AP-execution.

FIG. 17 is a block diagram illustrating a multi-stage parameterized process file with the notion of using pre-defined execution steps at the micro- and macro-levels within separate mini-manipulations, by transitioning through pre-defined robot-configurations for each of these steps, thereby avoiding any robot reconfiguration and replanning during the entire process-step execution, as all mini-manipulations consist of pre-computed and -verified starting- and ending robot configurations as part of a their pre-validated execution sequence in accordance with the present disclosure.

FIG. 18 is a pictorial diagram illustrating a perspective view of a robotic arm platform with a robotic arm with one or more actuators and a rotary module in accordance with the present disclosure.

FIG. 19 is a pictorial diagram illustrating a robotic arm platform with a robotic arm with one or more actuators and a rotary module in accordance with the present disclosure.

FIG. 20 is a pictorial diagram illustrating a perspective view of a robotic arm platform with a robotic arm with one or more actuators and a rotary module in accordance with the present disclosure.

FIG. 21 is a pictorial diagram illustrating a first embodiment of a robotic arm magnetic gripper platform with the robotic arm, a magnetic gripper, the one or more actuators and the rotary module in accordance with the present disclosure.

FIG. 22 is a pictorial diagram illustrating a perspective view of the first embodiment of robotic arm magnetic gripper platform with the robotic arm, the magnetic gripper, the one or more actuators and the rotary module in accordance with the present disclosure.

FIG. 23 is a pictorial diagram illustrating a second embodiment of the robotic arm magnetic gripper platform with the robotic arm, the magnetic gripper, the one or more actuators and the rotary module in accordance with the present disclosure.

FIG. 24 is a pictorial diagram illustrating a perspective view of the second embodiment of the robotic arm magnetic gripper platform with the robotic arm, the magnetic gripper, the one or more actuators and the rotary module in accordance with the present disclosure.

FIG. 25 is a pictorial diagram illustrating a perspective view of a dual robotic arm platform with a pair (or a plurality) of the robotic arms and a pair (or a plurality) of the magnetic grippers, and a plurality of actuators and the rotary modules in accordance with the present disclosure.

FIG. 26 is a pictorial diagram illustrating a perspective view of the third embodiment of a robotic arm magnetic gripper platform with the robotic arm, the magnetic gripper, the one or more actuators and the rotary module, force and torque sensor for robotic arm, and an integrated camera for the robot in accordance with the present disclosure.

FIG. 27 is a perspective view of a frying basket for use with the round, spheric, rectangular, square or other robotic module assembly in accordance with the present disclosure.

FIG. 28 is a perspective view of a wok body for use with the round, spheric, rectangular, square or other robotic module assembly in accordance with the present disclosure.

FIG. 29 is a pictorial diagram illustrating an isometric view of a round (or a spheric) robotic module assembly with a single robotic arm and a single end effector in accordance with the present disclosure.

FIG. 30 is a pictorial diagram illustrating a top view of a round robotic module assembly with a single robotic arm and a single end effector in accordance with the present disclosure.

FIG. 31 is a pictorial diagram illustrating an isometric view of a round robotic module assembly with two robotic arms and two end effectors in accordance with the present disclosure.

FIG. 32 is a pictorial diagram illustrating a top view of a round robotic module assembly with two robotic arms and two end effectors in accordance with the present disclosure.

FIG. 33 is a pictorial diagram illustrating an isometric front view of a round (or a spheric) robotic module assembly with two robotic arms and two end effectors which the robot is a moveable portion in accordance with the present disclosure.

FIG. 34 is a pictorial diagram illustrating an isometric back view of a round robotic module assembly with two robotic arms and two end effectors which the robot is a moveable portion in accordance with the present disclosure.

FIG. 35 is a pictorial diagram illustrating an isometric front view of a rectangular robotic module assembly with two robotic arms and two end effectors which the robot is a moveable portion in accordance with the present disclosure.

FIG. 36 is a pictorial diagram illustrating an isometric back view of a rectangular robotic module assembly with two robotic arms and two end effectors which the robot is a moveable portion in accordance with the present disclosure.

FIG. 37 is a pictorial diagram illustrating an isometric front right view of a rectangular (or a square) robotic module assembly with one or more robotic arms and one or more end effectors with a conveyor belt located in the back side of the rectangular robotic module assembly in accordance with the present disclosure.

FIG. 38 is a pictorial diagram illustrating an isometric front left view of a rectangular (or a square) robotic module assembly with one or more robotic arms and one or more end effectors with a conveyor belt located in the back side of the rectangular robotic module assembly in accordance with the present disclosure.

FIG. 39 is a pictorial diagram illustrating an isometric back right view of a rectangular (or a square) robotic module assembly with one or more robotic arms and one or more end effectors with the conveyor belt located in the back side of the rectangular robotic module assembly in accordance with the present disclosure.

FIG. 40 is a pictorial diagram illustrating an isometric back left view of a rectangular (or a square) robotic module assembly with one or more robotic arms and one or more end effectors with the conveyor belt located in the back side of the rectangular robotic module assembly in accordance with the present disclosure.

FIG. 41 is a block diagram illustrating a first embodiment of a front view of commercial robotic kitchen with a plurality of robotic module assemblies in accordance with the present disclosure.

FIG. 42 is a block diagram illustrating the first embodiment of an isometric front right view of a commercial robotic kitchen with a plurality of robotic module assemblies with respect to FIG. 41 in accordance with the present disclosure.

FIG. 43 is a block diagram illustrating the first embodiment of an isometric front left view of a commercial robotic kitchen with a plurality of robotic module assemblies with respect to FIG. 41 in accordance with the present disclosure.

FIG. 44 is a block diagram illustrating the first embodiment of an isometric back right view of a commercial robotic kitchen with a plurality of robotic module assemblies with respect to FIG. 41 in accordance with the present disclosure.

FIG. 45 is a block diagram illustrating a second embodiment of a front view of commercial robotic kitchen with a plurality of robotic module assemblies with an end robotic module assembly with a front side conveyor belt and a back side conveyor belt in accordance with the present disclosure.

FIG. 46 is a block diagram illustrating the second embodiment of an isometric front right view of commercial robotic kitchen with a plurality of robotic module assemblies with an end robotic module assembly with a front side conveyor belt and a back side conveyor belt with respect to FIG. 45 in accordance with the present disclosure.

FIG. 47 is a block diagram illustrating the second embodiment of an isometric front left view of commercial robotic kitchen with a plurality of robotic module assemblies with an end robotic module assembly with a front side conveyor belt and a back side conveyor belt with respect to FIG. 45 in accordance with the present disclosure.

FIG. 48 is a block diagram illustrating the second embodiment of an isometric back view of commercial robotic kitchen with a plurality of robotic module assemblies with an end robotic module assembly with a front side conveyor belt and a back side conveyor belt with respect to FIG. 45 in accordance with the present disclosure.

FIGS. 49A, 49B, 49C, 49D are block diagrams illustrating the various layouts of a commercial robotic kitchen including a front view, a top view, and a sectional view in accordance with the present disclosure.

FIG. 50 is a flow chart illustrating a first embodiment of the process of steps in operating a commercial robotic kitchen with a plurality of robotic module assemblies in accordance with the present disclosure.

FIG. 51 is a flow chart illustrating a second embodiment of the process of steps in operating a commercial robotic kitchen with a plurality of robotic module assemblies with a master robotic module assembly or a slave robotic module assembly preparing a plurality of orders for the same dish in a larger portion at the same time in accordance with the present disclosure.

FIG. 52 is a block diagram illustrating one embodiment of a commercial robotic kitchen with a plurality of cooking stations line suitable for restaurants, hotels, hospitals, offices, academic institutions and work places in accordance with the present disclosure.

FIG. 53 is a block diagram illustrating one embodiment of a commercial robotic kitchen with an open kitchen suitable for restaurants, hotels, hospitals, offices, academic institutions and work places in accordance with the present disclosure.

FIG. 54 is a block diagram illustrating a robo cuisines hub with a plurality of robot module assemblies (or robot chefs), a plurality of transport robots that transport the food dishes prepared by the robo chefs and move the food dishes to the autonomous vehicles (or robotaxi) for deliveries of the food dishes to the customers in accordance with the present disclosure.

FIG. 55 is a block diagram illustrating an isometric view of the robo cuisines hub with a plurality of robot chefs and a plurality of transport robots with respect to FIG. 54 in accordance with the present disclosure.

FIG. 56 is a block diagram illustrating a top view of the robo cuisines hub with a plurality of robot chefs and a plurality of transport robots with respect to FIG. 54 in accordance with the present disclosure.

FIG. 57 is a block diagram illustrating a back view of the robo cuisines hub with a plurality of robot chefs and a plurality of transport robots with respect to FIG. 54 in accordance with the present disclosure.

FIG. 58 is a block diagram illustrating an isometric front view of a robotic kitchen module assembly with a scrapping tool component in accordance with the present disclosure.

FIG. 59 is a block diagram illustrating an isometric back view of a robotic kitchen module assembly with a scrapping tool component with respect to FIG. 58 in accordance with the present disclosure.

FIG. 60 is a block diagram illustrating the side view of a robotic kitchen module assembly with the scrapping tool component with respect to FIG. 58 in accordance with the present disclosure.

FIGS. 61, 62, 63, 64 are pictorial diagrams illustrating a touch screen operation finger including a conductive material (metal: aluminum) fingertip, finger rubber part, finger metal part, a screen, and capacitive buttons in accordance with the present disclosure.

FIG. 65 is a block diagram illustrating a first embodiment of a mobile robotic kitchen on a food truck in accordance with the present disclosure.

FIG. 66 is a block diagram illustrating a second embodiment of a pop-up restaurant or a food catering service in accordance with the present disclosure.

FIG. 67 is a block diagram illustrating one example of a robotic kitchen module assembly with a motorized (or automatic) dosing device and a manual dosing device that can be tailored for the robotic kitchen which the one or more robotic hands coupled to one of more robotic end effectors can operate a dosing device manually, or the computer processor in the robotic kitchen can send an instruction signal to a dosing device to dispense the amount of dosing automatically in accordance with the present disclosure.

FIG. 68 depicts the functionalities and process-steps of pre-filled ingredient containers with one or more program ingredient dispenser controls for use in the standardized robotic kitchen.

FIG. 69 is a block diagram illustrating a robotic nursing care module with a three-dimensional vision system in accordance with the present disclosure.

FIG. 70 is a block diagram illustrating a robotic nursing care module with standardized cabinets in accordance with the present disclosure.

FIG. 71 is a block diagram illustrating a robotic nursing care module with one or more standardized storages, a standardized screen, and a standardized wardrobe in accordance with the present disclosure.

FIG. 72 is a block diagram illustrating a robotic nursing care module with a telescopic body with a pair of robotic arms and a pair of robotic hands in accordance with the present disclosure.

FIG. 73 is a block diagram illustrating a first example of executing a robotic nursing care module with various movements to aid an elderly person in accordance with the present disclosure.

FIG. 74 is a block diagram illustrating a second example of executing a robotic nursing care module with loading and unloading a wheel chair in accordance with the present disclosure.

FIG. 75 is a block diagram illustrating one embodiment of an isometric view in calibrating and operating a chemical embodiment with the robot with one or more robot arms coupled to one or more robotic end effectors in accordance with the present disclosure.

FIG. 76 is a block diagram illustrating one embodiment of a front view in calibrating and operating a chemical embodiment with the robot with one or more robot arms coupled to one or more robotic end effectors in accordance with the present disclosure.

FIG. 77 is a block diagram illustrating one embodiment of a bottom angled view in calibrating and operating a chemical embodiment with the robot with one or more robot arms coupled to one or more robotic end effectors in accordance with the present disclosure.

FIG. 78 is a block diagram illustrating one embodiment of a top angled view in calibrating and operating a chemical embodiment with the robot with one or more robot arms coupled to one or more robotic end effectors in accordance with the present disclosure.

FIG. 79 is a block diagram illustrating a telerobotic for a hospital environment with operating one or more robot arms coupled to one or more robotic end effectors for distance (or remote) automation in accordance with the present disclosure.

FIG. 80 is a block diagram illustrating a telerobotic for a manufacturing environment with operating one or more robot arms coupled to one or more robotic end effectors for distance (or remote) automation in accordance with the present disclosure.

FIG. 81 illustrates one embodiment of object interactions in an unstructured environment in accordance with the present disclosure.

FIG. 82 illustrates a graph for indicating linear dependency of the total waiting time on the number of constraints in accordance with the present disclosure.

FIG. 83 illustrates information flow and generation of incomplete APAs, according to an exemplary environment in accordance with the present disclosure.

FIG. 84 is a block diagram illustrating write-in and read-out scheme for a database of pre-planned solutions in accordance with the present disclosure.

FIG. 85 is a flow chart illustrating one embodiment of a process for executing an interaction in accordance with the present disclosure.

FIG. 86 is an architecture diagram illustrating one embodiment on one or more portions of a robot in accordance with the present disclosure.

FIG. 87 illustrates an architecture of a general-purpose vision subsystem in accordance with the present disclosure.

FIG. 88 illustrates an architecture for identifying objects using the general-purpose vision subsystem in accordance with the present disclosure.

FIG. 89 illustrates a sequence diagram of a process for identifying objects in an environment or workspace in accordance with the present disclosure.

FIGS. 90A, 90-B, 90C, 90D, 90E illustrate an example of a wall locking mechanism in accordance with the present disclosure.

FIG. 91 is a block diagram illustrating one example of a robot kitchen prepare multiple recipes at the same time with the execution of the minimanipulations with a first robot (robot 1), a smart appliance, and an operator graphical user interface (GUI) in accordance with the present disclosure.

FIG. 92 is a block diagram illustrating an isometric front view of a robotic café (or café barista) for a robot to serve a variety of drinks to customers in accordance with the present disclosure.

FIG. 93 is a block diagram illustrating an isometric back view of a robotic café for a robot to serve a variety of drinks to customers in accordance with the present disclosure.

FIG. 94 is a block diagram illustrating an isometric front view of a robotic bar (barista alcohol) for a robot to serve a variety of drinks to customers in accordance with the present disclosure.

FIG. 95 is a block diagram illustrating an isometric back view of a robotic café for a robot to serve a variety of drinks to customers in accordance with the present disclosure.

FIG. 96 is a block diagram illustrating a mobile, multi-use robot module for fitting with a cooking station, a coffee station, or a drink station in accordance with the present disclosure.

FIG. 97 is a block diagram depicting the control software architecture of the robotic apparatus that comprises a high-level software control module and a low-level software control module in accordance with the present disclosure.

FIG. 98 is a block diagram depicting the process of transformation matrix application. In this embodiment, the model of the robotic apparatus comprises of a number of target placements inside the operational environment of a robotic kitchen in accordance with the present disclosure.

FIG. 99 depicts a front view of a multiple axis gantry system in accordance with the present disclosure.

FIG. 100 depicts a side view of the multiple axis gantry system in accordance with the present disclosure.

FIG. 101 depicts a top view of the multiple axis gantry system in accordance with the present disclosure.

FIG. 102 depicts an isometric view of the multiple axis gantry system in accordance with the present disclosure.

FIG. 103 depicts an isometric view of the multiple axis gantry system which includes arrows that indicate the possible directions of motion in accordance with the present disclosure.

FIG. 104 is a block diagram depicting the process of adjusting the positional and orientational location of the robotic arm (or equivalent) using the multiple axis gantry systems, in accordance with the transformation matrix in accordance with the present disclosure.

FIGS. 105 to 108 depict another embodiment of a robotic apparatus with the multiple axis gantry system in accordance with the present disclosure.

FIGS. 109 to 112 depict the calibration procedure to determine the x-axis shift of a specific point on a placement using a six-axis force and torque sensor in accordance with the present disclosure.

FIGS. 113 to 116 show the same calibration procedure performed for the y-axis of the oven on the robotic kitchen, obtaining the y-axis gantry location, recorded as the first y-axis placement location data, y₁ in accordance with the present disclosure.

FIGS. 117 to 120 show the same calibration procedure may be performed for the z-axis gantry location, recorded as the first z-axis placement location data, z₁, in accordance with the present disclosure.

FIG. 121 is a block diagram depicting the calibration procedure with a 6-axis force/torque sensor in accordance with the present disclosure.

FIG. 122 is a block diagram depicting the marker calibration procedure. In this embodiment, the robotic apparatus is that of a robotic kitchen, with a single robotic arm mounted on the multiple-axis gantry system outlined in the present disclosure.

FIGS. 123 to 149 are pictorial diagrams illustrating the a system for marker calibration procedure when two markers are different to adjust a robotic arm's relative location with the target placement as a mechanism to match the imaged marker with the selected specified calibration point marker on the etalon model target placement in accordance with the present disclosure.

FIG. 150 depicts a robotic laboratory cabinet apparatus in accordance with the present disclosure.

FIGS. 151 and 152 depict a robotic apparatus inside a hospital environment in accordance with the present disclosure.

The FIGS. 153 to 155 above depict a tray loading robotic system platform in accordance with the present disclosure.

FIG. 156 depicts an embodiment of the robotic system that comprises of a robotics arm with a five-finger anthropomorphic robotic hand mounted as its end-effector in accordance with the present disclosure.

FIGS. 157 and 158 are visual diagrams depicting a ventilation system integrated onto a robotic apparatus in accordance with the present disclosure.

FIG. 159 depicts a two-finger parallel gripper in accordance with the present disclosure.

FIG. 160 depicts the fingers of the parallel gripper in accordance with the present disclosure.

FIG. 161 is a section view of the gripper tool interface in accordance with the present disclosure.

FIG. 162 is a transparent view of the gripper tool interface in accordance with the present disclosure.

FIG. 163 depicts the gripper holding a set of tongs in the open position in accordance with the present disclosure.

FIG. 164 depicts the gripper holding a set of tongs in the closed position in accordance with the present disclosure.

FIG. 165 depicts the gripper holding a set of tongs in the open position while immersed in a box containing an ingredient, depicted as spheres, in accordance with the present disclosure.

FIG. 166 depicts the gripper holding a set of tongs in the closed position while immersed in a box containing an ingredient, depicted as spheres, in accordance with the present disclosure.

FIGS. 167-181 are graphical diagrams illustrating additional examples of other types of tongs, including flat tongs for picking up ingredients, flat tongs for flipping in accordance with the present disclosure.

FIG. 182 is a block diagram illustrating an example of a computer device on which computer-executable instructions to perform the robotic methodologies discussed herein may be installed and executed in accordance with the present disclosure.

### DETAILED DESCRIPTION

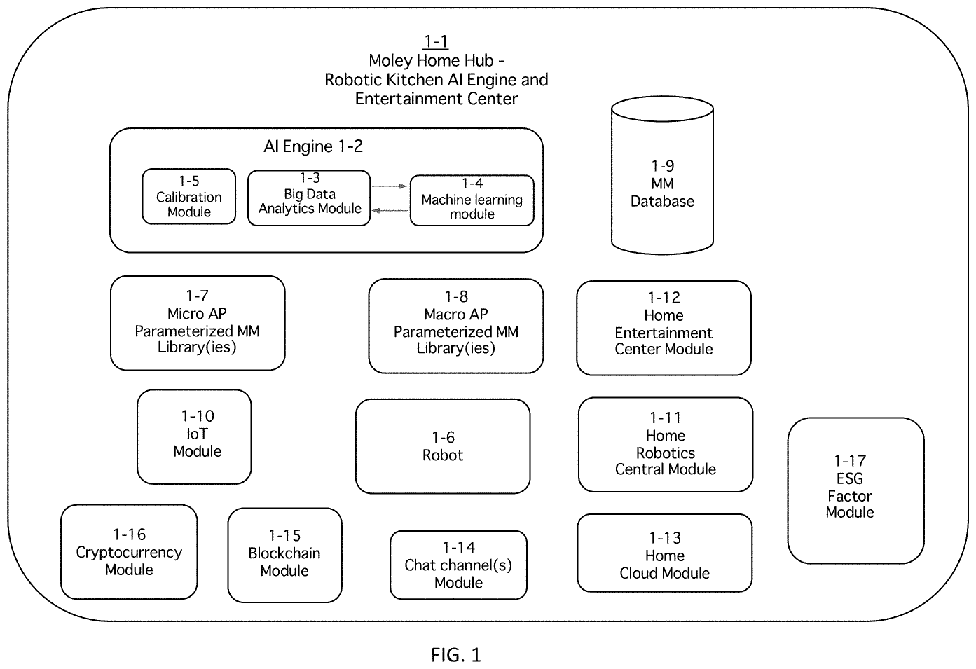

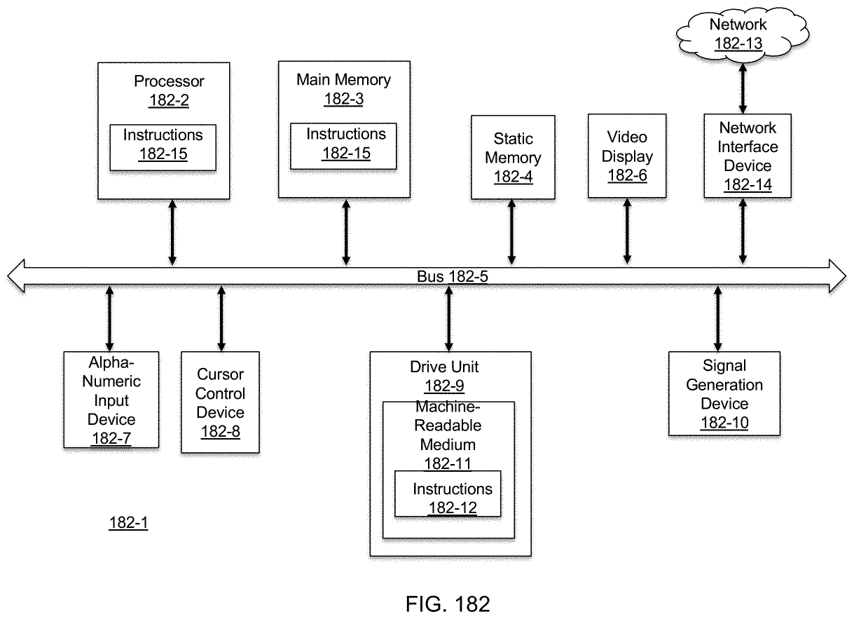

A description of structural embodiments and methods of the present disclosure is provided with reference to FIGS. 1-182. It is to be understood that there is no intention to limit the invention to the specifically disclosed embodiments but that the invention may be practiced using other features, elements, methods, and embodiments. Like elements in various embodiments are commonly referred to with like reference numerals.

The following definitions apply to the elements and steps described herein. These terms may likewise be expanded upon.

Accuracy—refers to how closely a robot can reach a commanded position. Accuracy is determined by the difference between the absolute positions of the robot compared to the commanded position. Accuracy can be improved, adjusted, or calibrated with external sensing, such as sensors on a robotic hand or a real-time three-dimensional model using multiple (multi-mode) sensors.

Action Primitive (AP)—refers to the smallest functional operation executable by the robot. An action primitive starts and ends with a Default Posture. In one embodiment, action primative refers to an indivisible robotic action, such as moving the robotic apparatus from location X1 to location X2, or sensing the distance from an object (for food preparation) without necessarily obtaining a functional outcome. In another embodiment, the term refers to an indivisible robotic action in a sequence of one or more such units for accomplishing a minimanipulation. These are two aspects of the same definition. (smallest functional subblock—lower level minimanipulation.

Adaptation—a process referred to reconfiguring a robotic system through a transformation process from a given starting configuration or pose into a modified or different configuration or pose.

Alignment—the process of reconfiguring a robotic system by way of a transformation process from a current configuration to a more desirable configuration or pose for the purpose of a streamlined command execution of a macro manipulation or micro minimanipulation AP, command step or sequence.

Best-Match—closest configuration between an as-sensed and possible ideal or simulated or experimentally-defined possible configuration candidates for a robotic system in free-space or while handling/grasping an object or interacting with the environment, by way of one or more methods for establishing deviation metrics based on a variety of linear or multi-dimensional deviation-computation metrics applied to one or more types of sensory data types.

Boundary Configuration—a joint or cartesian robot configuration at the start (first) or end (last) step of one or more commanded motion sequences.

Calibration—a process by which a real-world system undergoes one or more measurement steps to determine the deviation of the real-world system configuration in cartesian and/or joint-space from that of an etalon model. The deviation can then be used in one of multiple ways to ensure the system will perform as intended and predicted in the ideal world through transformations to ensure alignment between the real and ideal worlds as part of an adaptation process. Calibration can be performed at any time during the life-cycle of the system and at one or more points within the workspace of the system.

Cartesian plan—refers to a process which calculates a joint trajectory from an existing cartesian trajectory.

Cartesian trajectory—refers to a sequence of timed samples (each sample comprises of an xyz position and an 3-axis orientation expressed as a quaternion or euler angles) in the kitchen space, defined for a specific frame (object or hand frame) and related to another reference frame (kitchen or object frame).

Collaborative mode—refers to one of the multiple modes of the robotic kitchen (other modes include a robot mode and a user mode) where the robot executes a food preparation recipe in conjunction with a human user, where the execution of a food preparation recipe may divide up the tasks between the robot and the human user.

Compensation—a process by which an adaptation of a system results in a more suitable configuration of a physical entity or parameter values describing the same, in order to enact commanded changes to a parameter or system, based on sensed robot-configuration values or changes to the environment which the robot operates within and interacts with, for the purposes of a more effective execution of one or more command sequences that make up a particular process.

Configuration—synonymous with posture, which refers to a specific set of cartesian endpoint positions achievable through one or more joint space linear or angular values for one or more robot joints.

Dedicated—refers to hardware elements such as processors, sensors, actuators and buses, that are solely used by a particular element or subsystem. In particular, each subsystem within the macro- and micro-manipulation systems, contain elements that utilize their own processors and sensor and actuators that re solely responsible for the movements of the hardware element (shoulder, arm-joint, wrist, finger, etc.) they are associated with.

Default Posture—refers to a predefined robot posture, associated with a specific held object or empty hand for each arm.

Deviation—Displacement as defined by a multi-dimensional space between an as-measured actual and desired robot configuration in cartesian and/or joint-space.

Emulation Abstraction—description of a set of steps or actions in a fashion that allows for repeatable execution of these steps or actions by another entity, including but not limited to, a computer-controlled robotic system.

Encoding—a process by which a human or an automated process creates a sequence of machine-readable, interpretable and executable command steps as part of a computer-controlled execution process to be carried out at a later time.

Etalon Model—standard or reference Model.

Executor—a module within a given controller system responsible for the successful execution of one or more commands within one or more stand-alone or interconnected execution sequences.

Joint State—refers to a configuration for a set of robot joints, expressed as a set of values, one for each joint.

Joint Trajectory (aka Joint Space Trajectory or JST)—refers to a timed sequence of joint states.

Kitchen Module (or Kitchen Volume)—a standardized full-kitchen module with standardized sets of kitchen equipment, standardized sets of kitchen tools, standardized sets of kitchen handles, and standardized sets of kitchen containers, with predefined space and dimensions for storing, accessing, and operating each kitchen element in the standardized full-kitchen module. One objective of a kitchen module is to predefine as much of the kitchen equipment, tools, handles, containers, etc. as possible, so as to provide a relatively fixed kitchen platform for the movements of robotic arms and hands. Both a chef in the chef kitchen studio and a person at home with a robotic kitchen (or a person at a restaurant) uses the standardized kitchen module, so as to maximize the predictability of the kitchen hardware, while minimizing the risks of differentiations, variations, and deviations between the chef kitchen studio and a home robotic kitchen. Different embodiments of the kitchen module are possible, including a standalone kitchen module and an integrated kitchen module. The integrated kitchen module is fitted into a conventional kitchen area of a typical house. The kitchen module operates in at least two modes, a robotic mode and a normal (manual) mode.

Library—synonymous with computer-accessible digital-data database or repository, located on a local computer, a network computer, a mobile device, or a cloud computer.

Machine Learning—refers to the technology wherein a software component or program improves its performance based on experience and feedback. One kind of machine learning often used in robotics is reinforcement learning, where desirable actions are rewarded and undesirable ones are penalized. Another kind is case-based learning, where previous solutions, e.g. sequences of actions by a human teacher or by the robot itself are remembered, together with any constraints or reasons for the solutions, and then are applied or reused in new settings. There are also additional kinds of machine learning, such as inductive and transductive methods.

Minimanipulation (MM)—generally, MM refers to one or more behaviors or task-executions in any number or combinations and at various levels of descriptive abstraction, by a robotic apparatus that executes commanded motion-sequences under sensor-driven computer-control, acting through one or more hardware-based elements and guided by one or more software-controllers at multiple levels, to achieve a required task-execution performance level to arrive at an outcome approaching an optimal level within an acceptable execution fidelity threshold. The acceptable fidelity threshold is task-dependent and therefore defined for each task (also referred to as “domain-specific application”). In the absence of a task-specific threshold, a typical threshold would be 0.001 (0.1%) of optimal performance.
In one embodiment from a robotic technology perspective, the term MM refers to a well-defined pre-programmed sequence of actuator actions and collection of sensory feedback in a robot's task-execution behavior, as defined by performance and execution parameters (variables, constants, controller-type and -behaviors, etc.), used in one or more low-to-high level control-loops to achieve desired motion/interaction behavior for one or more actuators ranging from individual actuations to a sequence of serial and/or parallel multi-actuator coordinated motions (position and velocity)/interactions (force and torque) to achieve a specific task with desirable performance metrics. MMs can be combined in various ways by combining lower-level MM behaviors in serial and/or parallel to achieve ever-higher and higher-level more-and-more complex application-specific task behaviors with an ever higher level of (task-descriptive) abstraction.
In another embodiment from a software/mathematical perspective, the term MM refers to a combination (or a sequence) of one or more steps that accomplish a basic functional outcome within a threshold value of the optimal outcome (examples of threshold value as within 0.1, 0.01, 0.001, or 0.0001 of the optimal value with 0.001 as the preferred default). Each step can be an action primitive, corresponding to a sensing operation or an actuator movement, or another (smaller) MM, similar to a computer program comprised of basic coding steps and other computer programs that may stand alone or serve as sub-routines. For instance, a MM can be grasping an egg, comprised of the motor actions required to sense the location and orientation of the egg, then reaching out a robotic arm, moving the robotic fingers into the right configuration, and applying the correct delicate amount of force for grasping: all primitive actions. Another MM can be breaking-an-egg-with-a-knife, including the grasping MM with one robotic hand, followed by grasping-a-knife MM with the other hand, followed by the primitive action of striking the egg with the knife using a predetermined force at a predetermined location.
In a further embodiment, manipulation refers to a high level robotic operation in which the robot manipulates an object using the bare hands or some utensil. A Manipulation comprises of (is composed by) Action Primitives.
High-Level Application-specific Task Behaviors—refers to behaviors that can be described in natural human-understandable language and are readily recognizable by a human as clear and necessary steps in accomplishing or achieving a high-level goal. It is understood that many other lower-level behaviors and actions/movements need to take place by a multitude of individually actuated and controlled degrees of freedom, some in serial and parallel or even cyclical fashion, in order to successfully achieve a higher-level task-specific goal. Higher-level behaviors are thus made up of multiple levels of low-level MMs in order to achieve more complex, task-specific behaviors. As an example, the command of playing on a harp the first note of the 1^{st} bar of a particular sheet of music, presumes the note is known (i.e., g-flat), but now lower-level MMs have to take place involving actions by a multitude of joints to curl a particular finger, move the whole hand or shape the palm so as to bring the finger into contact with the correct string, and then proceed with the proper speed and movement to achieve the correct sound by plucking/strumming the cord. All these individual MMs of the finger and/or hand/palm in isolation can all be considered MMs at various low levels, as they are unaware of the overall goal (extracting a particular note from a specific instrument). While the task-specific action of playing a particular note on a given instrument so as to achieve the necessary sound, is clearly a higher-level application-specific task, as it is aware of the overall goal and need to interplay between behaviors/motions and is in control of all the lower-level MMs required for a successful completion. One could even go as far as defining playing a particular musical note as a lower-level MM to the overall higher-level applications-specific task behavior or command, spelling out the playing of an entire piano-concerto, where playing individual notes could each be deemed as low-level MM behaviors structured by the sheet music as the composer intended.
Low-Level Minimanipulation Behaviors—refers to movements that are elementary and required as basic building blocks for achieving a higher-level task-specific motion/movement or behavior. The low-level behavioral blocks or elements can be combined in one or more serial or parallel fashion to achieve a more complex medium or a higher-level behavior. As an example, curling a single finger at each finger joint is a low-level behavior, as it can be combined with curling each of the other fingers on the same hand in a certain sequence and triggered to start/stop based on contact/force-thresholds to achieve the higher-level behavior of grasping, whether this be a tool or a utensil. Hence, the higher-level task-specific behavior of grasping is made up of a serial/parallel combination of sensory-data driven low-level behaviors by each of the five fingers on a hand. All behaviors can thus be broken down into rudimentary lower levels of motions/movements, which when combined in certain fashion achieve a higher-level task behavior. The breakdown or boundary between low-level and high-level behaviors can be somewhat arbitrary, but one way to think of it is that movements or actions or behaviors that humans tend to carry out without much conscious thinking (such as curling ones fingers around a tool/utensil until contact is made and enough contact-force is achieved) as part of a more human-language task-action (such as “grab the tool”), can and should be considered low-level. In terms of a machine-language execution language, all actuator-specific commands, which are devoid of higher-level task awareness, are certainly considered low-level behaviors.

Minimanipulation library adaptation—refers to a particular minimanipulation library is adapted (or modified) to custom fit a specific kitchen module due to the differences (or deviations from the reference parameters of a master kitchen) identified between a master kitchen module and the particular kitchen module.

Minimanipulation library transformation—refers to transforming a cartesian coordinate environment to a different operating environment tailored to a specific type of robot. Repositioning the actuators to compensate for a greater flexibility for the robotic arms and effectors to reach a particular location

Macro/Micro minimanipulations—refers to a combination of macro minimanipulations and micro minimanipulations for executing a complete or a portion of the food preparation recipe. The term macro minimanipulations and micro minimanipulations can have a different types of relationship between macro minimanipulations and micro minimanipulations. For example, in one embodiment, macro/micro minimanipulations refers to one macro minimanipulation comprises one or more micro minimanipulations. To phrase it another way, each micro minimanipulation serves as a subset of a macro minimanipulation. In another embodiment, a macro-micro minimanipulation subsystem refers to a separation at the logical and physical level that is to bound the computational load on planners and controllers, particularly for the required inverse kinematic computation, to a level that allows the system to operate in real-time. The term “macro minimanipulation” is also referred to as macro manipulation, or macro-manipulation. The term “micro minimanipulation” is also referred to as micro manipulation, or micro-minimanipulation.

Motion Plan—refers to a process which calculates a joint trajectory from a start joint state and an end joint state.

Motion Primitives—refers to motion actions that define different levels/domains of detailed action steps, e.g. a high-level motion primitive would be to grab a cup, and a low-level motion primitive would be to rotate a wrist by five degrees.

Open-Loop—to be understood as used in the system control literature, where a computer-controlled system is acted upon by a set of actuators that are commanded along a time-stamped pre-computed/-defined trajectory described by position-/velocity-/torque-/force-parameters that are not subjected to any modification based on any system feedback from sensors, whether internal or external, during the time-period the system operates in the open-loop fashion. It is to be understood that all actuators are nevertheless operating in a localized closed-loop fashion in that each actuator will be caused to follow the pre-computed time-stamped trajectory described by position-/velocity-/torque-/force-parameters for each actuation unit, without the parameters being modified from their pre-computed values by any external sensory data not local to the respective actuator, required to measure and track the respective parameter (such as joint-position, -velocity, -torque, -force, etc.).

Parameter Adjustment—refers to the process of changing the values of parameters based on inputs. For instance changes in the parameters of instructions to the robotic device can be based on the properties (e.g. size, shape, orientation) of, but not limited to, the ingredients, position/orientation of kitchen tools, equipment, appliances, speed, and time duration of a minimanipulation.

Pose—synonymous or similar with Configuration.

Pose Configuration—a set of parameters that describe a set of specific configurations for a particular command execution step that can be used to compare the real world configurations to, in order to perform a best-match process to define which such set of parameters comes closest to describing the as-sensed real-world robot system configuration.

Pre planned JST (aka Cached JST)—refers to a pre-planned JST, saved inside a cache and retrieved when required for execution.

Ready-Pose/-Configuration—configuration of a robotic system in which it is disengaged and not interacting with the environment, capable of being commanded to reposition itself without requiring any collision-free interference checking by any trajectory planning or execution module.

Recipe—refers to a sequence of manipulations.

Reconfiguration—refers to an operation which can move the robot from the current joint state to a unique pre-defined joint state, used typically when the object to manipulate was moved from it's expected pre-defined placement.

Resequencer—a process by which a sequence of events or commands can be reordered or replaced by way of adding or moving events or commands in an execution queue, so as to adapt to perceived changes in the environment.

Robotic Apparatus—refers one or more robotic arms and one or more robotic end effectors. The robotic apparatus may include a set of robotic sensors, such as cameras, range sensors, and force sensors (haptic sensors) that transmit their information to the processor or set of processors that control the effectors.

Robot mode—refers to one of the multiple modes of the robotic kitchen where the robot completely or primarily executes a food preparation recipe.

Sense-Interpret-Replan-Act-Resense Loop—standard computer-controlled loop carried out at each time-step defined by a high-frequency controller involving the use of all system sensors to measure the state of the entire system, which data is then used to interpret (identify, model, map) the world state, leading to a replanning of the next commanded execution step, before the controller is allowed to enact the command step. At the next time-step the system again re-enters the same loop by re-sensing the entire system and surrounding world and environment. The loop has been the standard for robotic systems operating (moving, grasping, handling objects and interacting with the world) in a dynamic and non-deterministic environment.

Sense-ID/Model/Map Sequence—Basic starting sequence needed to understand the state of the physical world, involving the collection of all available sensory data (robot and surrounding world and workspace), and the interpretation of the data, involving the identification of known (and unknown) elements within the workspace/world, modeling them and identifying (model-/pattern matching to known elements) them as best possible, and final step of mapping them as to their location and orientation in multi-dimensional space.

Stack-up Time—time defined as an ever-increasing additive time delay due to unforeseen events within a robot controller execution sequence, increasing the deterministic execution time-window from a known and fixed number to that of a larger undesirable non-zero number larger than zero.

Transformation Parameter/Vector/Matrix—Numerical value or multiple values arranged in a multi-dimensional vector or matrix, used to effect a change in an alternate set of numbers, such as positions, velocities, trajectories or configurations of a robotic system.

User mode—refers to one of the multiple modes of the robotic kitchen where the robot may serve to aid or facilitate a human in food preparation recipe.

Vertex—a point or configuration in cartesian or joint space uniquely described by one or more numerical values in stand-alone or vector-format as defined within one or more standard coordinate frames.

For additional information on replication by a robotic apparatus and or a robotic assistant executing one or more minimanipulations from one or more minimanipulation libraries, see U.S. non-provisional patent application Ser. No. 14/627,900, now U.S. Pat. No. 9,815,191, entitled “Methods and Systems for Food Preparation in Robotic Cooking Kitchen,” and U.S. nonprovisional patent application Ser. No. 14/829,579, now U.S. Pat. No. 10,518,409, entitled “Robotic Manipulation Methods and Systems for Executing a Domain-Specific Application in an Instrumented Environment with Electronic Manipulation Libraries,” filed on 18 Aug. 2015, the disclosures of which are incorporated herein by reference in their entireties.

For additional information on containers in a domain-specific application in an instrumented environment, see pending U.S. non-provisional patent application Ser. No. 15/382,369, entitled, “Robotic Manipulation Methods and Systems for Executing a Domain-Specific Application in an Instrumented Environment with Containers and Electronic Manipulation Libraries,” filed on 16 Dec. 2016, the disclosure of which is incorporated herein by reference in its entirety.

For additional information for operating a robotic system and executing robotic interactions, see the pending U.S. non-provisional patent application Ser. No. 16/045,613, entitled “Systems and Methods for Operating a Robotic System and Executing Robotic Interactions,” filed on 25 Jul. 2018, the disclosure of which is incorporated herein by reference in its entirety.

For additional information on a deep learning based objection detection system of images, see the pending U.S. non-provisional patent application Ser. No. 16/870,899, entitled “Systems and Methods for Automated Training of Deep-Learning-Based Object Detection,” filed on 9 May 2020, the disclosure of which is incorporated herein by reference in its entirety.

FIG. 1 is a block diagram illustrating a first embodiment of a home hub 500 with a robotic kitchen artificial intelligence (“AI”) engine (“AI Engine”, “AI Brain”, or “Moley Brain) and an home entertainment center. The home hub 1-1 includes an artificial intelligence engine (“AI Engine”, “AI Brain”, or “Moley Brain) 1-2 for computing big data analytics from a big data analytics module 1-3 and a machine learning module 1-4. The artificial intelligence engine 1-2 includes a calibration module 1-5 for calibration the robotic kitchen and other electronic devices in a home or in the vicinity of the home. The robotic kitchen artificial engine 1-1 and the entertainment center 1-1 includes a robot 1-6 that executes one or more micro AP parameterized minminmanipulation (MM) libraries 1-7, and/or one or more micro AP parameterized minminmanipulation libraries 1-8 to perform a particular task or a set of tasks by accessing a minminmanipulation database 1-9. The kitchen artificial engine and the entertainment center 1-1 includes also includes an IoT module (Internet of things) 1-10 for connected devices to the Internet to collect and share data with the AI Engine 1-2. The robot includes one or more robotic arms and one or more robotic end effectors.

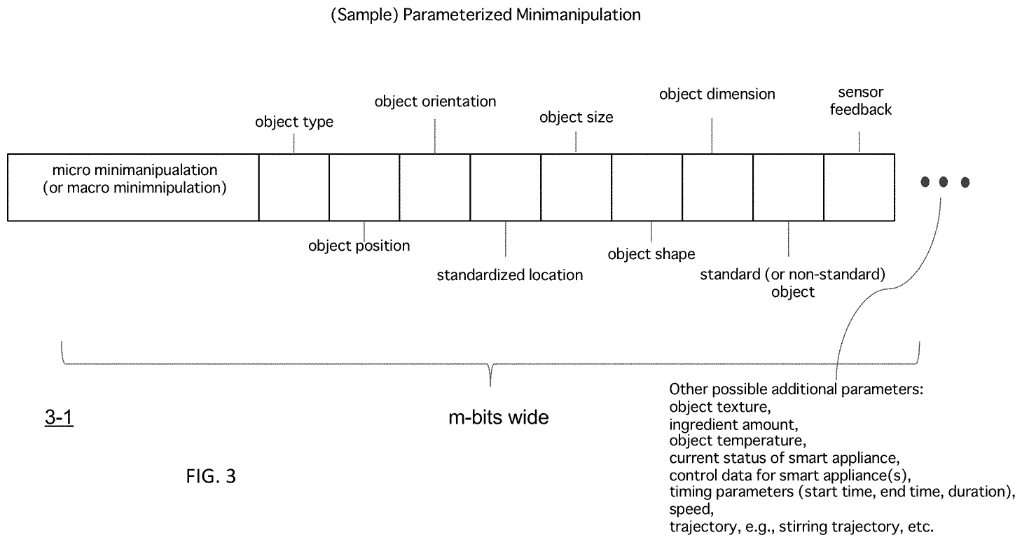

The AI engine 1-2 may be a hardware, a software, or a combination of hardware and software units, that use machine learning and artificial intelligence to learn their functions properly. As such, the AI engine 1-2 can use multiple training data sets from the micro minimanimanipulation libraries and macro minimanimanipulation libraries to train the execution units to route, classify, and format the various incoming data sets received from sensors, a computer network, or other sources. The data sets came be sourced from parameterized, pretested minimanipulations, and the parameters in a minimanipulation, as described further in FIG. 3 and configured to be m-bits wide that includes (1) a micro minimanipulation or a macro manimanipulation, and (2) a plurality of bits that are used related to that particular micro minimanipulation or a macro manimanipulation. The plurality of bits in the parameterized and pretested minimanipulation 3-1 includes an object type, an object position, an object orientation, a standardized location, an object size, an object shape, an object dimension, a standard (or non-standard) object, one or more sensor feedback signals, an object object, an object texture, an ingredient amount, an object temperature, a current status of smart appliance, a control data for smart appliance(s), one or more timing parameters (start time, end time, duration), a speed, and a trajectory, e.g., stirring trajectory. Some select parameters in a parameterized, pretested minimanipulation may have more impact to the taste of the food dish than other parameters, depending on the particularly minimanipulation to be executed, the object to be cooked, and the taste preference by a user.

The AI engine 1-2 may use machine learning to continuously train neural network-based analysis units. Training data sets may be used with the analysis units to ensure that the outputs of the analysis units are suitable for use by the system. Additionally, outputs from the analysis units that are suitable may be used for further training data sets to reinforce the suitable/acceptable results from the analysis units. Other types and/or forms of artificial intelligence may be used for the analysis units as necessary. AI engine 1-2 may be configured such that a single configurable analysis unit is used with the configuration of the analysis unit being changed every time a different analysis/different inputs are used/desired. Conversely, instead of having a single analysis unit per type of analysis to be performed on the data, an analysis unit may have different analysis types that it can perform. Then, depending on the data being sent to that analysis unit and the type of analysis to be performed, the configuration of the analysis unit may be adjusted/changed.

The home hub 1-1 further includes a home robotic central module 1-11, a home entertainment module 1-12, a home cloud 1-13, a chat channel module 1-14, a blockchain module 1-15, and a cryptocurrency module 1-16, and an ESG (Environmental, Social, and Governance) factors module 1-17. The home robotic central module 1-11 is configured to operate with one or more robotics within a home (or a house, or an office), such as a robot carpet cleaner, a robot humanoid, and other robots, as well as other robots within the vicinity of the home, such as a robo autonomous vehicle, an robo lawn mower, and other robots. The home entertainment center 1-11 serves as the entertainment center control of the home by controlling, interacting and monitoring a plurality of electronic entertainment devices in the home, as a home stereo, a home television, a home electronic security system, and others. The home cloud module 1-13 serves as a central cloud repository for the home to have the data and control setting at the cloud computing to control the various operations and devices at the home. The chat channel module 1-14 provides a plurality of electronic chat channels within the members of the household, the neighbors in a community, and service providers generally or in a community. The blockchain module 1-15 facilitates any blockchain transactions between the home hub and any applicable transactions available on blockchain technology. The cryptocurrency module 1-16 provides the capability for the home hub 1-1 to execute any financial transactions that another entity by exchanging cryptocurrency. The ESG factors module 1-17 is configured to monitor, assess, and report if a robotic kitchen as an entire unit, or if the one or more appliances are operating with the compliance variables in ESG factors.

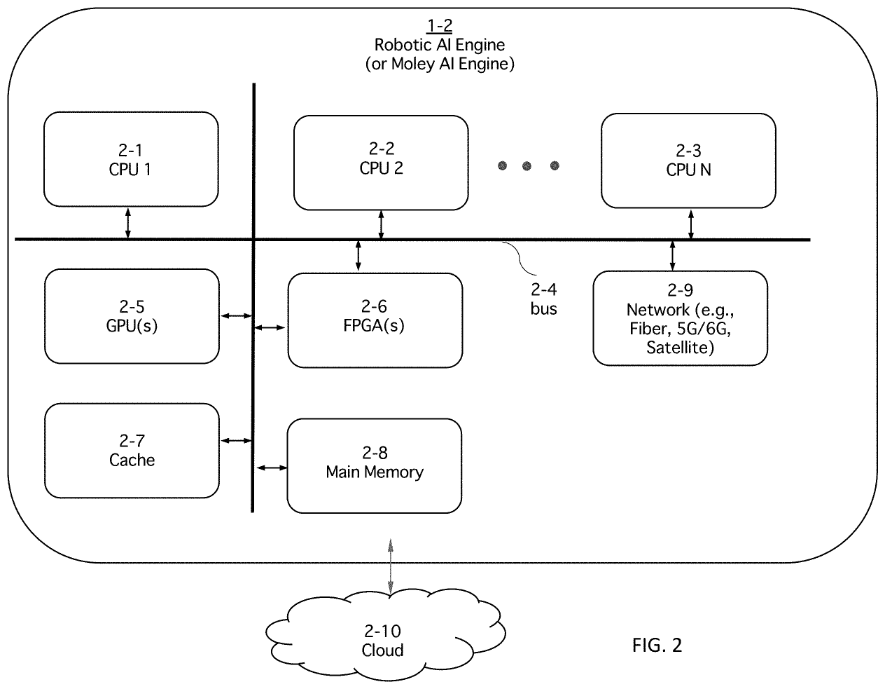

FIG. 2 is a block diagram illustrating the robotic artificial intelligence engine 1-2 that includes one or more processors (CPUs) 2-1, 2-2, 2-3, one or more graphics processing units (GPUs) 2-5, and one or more optional field-programmable gate arrays (FPGAs) 2-6 with one or more caches 2-7, a main memory 2-8, for communicating via a network 2-9 (e.g., 5G or 6G network, a fiber network, WiFi, Bluetooth, etc.), as well as with a cloud computing 2-10. The electronic components, CPUs 2-1, 2-2, 2-3, GPUs 2-5, FPGAs 2-6 with one or more caches 2-7, a main memory 2-8, are interconnected on a birdirectional bus 2-4.

FIG. 3 is a block diagram illustrating an example of a parameterized minimanipulation 3-1. The parameterized minimanipulation 3-1 is also referred to as parameterized and pretested minimanipulation 3-1. The robot executes one or more parameterized minimanipulation 3-1 to carry out a cooking operation, preparing food, or preparing a food dish. In this example, the parameterized and pretested minimanipulation 3-1 is configured to be m-bits wide that includes (1) a micro minimanipulation or a macro manimanipulation, and (2) a plurality of bits that are used related to that particular micro minimanipulation or a macro manimanipulation. The plurality of bits in the parameterized and pretested minimanipulation 3-1 includes an object type, an object position, an object orientation, a standardized location, an object size, an object shape, an object dimension, a standard (or non-standard) object, one or more sensor feedback signals, an object object, an object texture, an ingredient amount, an object temperature, a current status of smart appliance, a control data for smart appliance(s), one or more timing parameters (start time, end time, duration), a speed, and a trajectory, e.g., stirring trajectory.

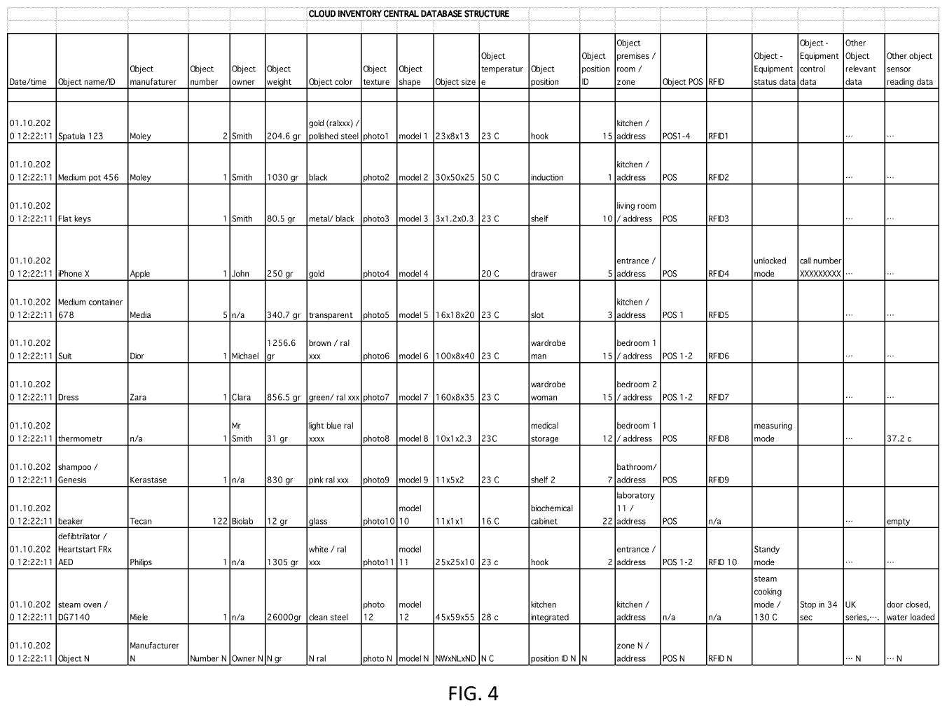

FIG. 4 is a block diagram illustrating an example of a cloud inventory central database structure in executing a sequential operation of minimanipulations with a plurality of data fields (or parameters) on the horizontal rows, and a plurality of dates and times on the vertical columns. The central database provides a central location in a cloud computer (or a local computer) to keep track and store the a list of inventor items for the robotic kitchen. That way, the central processor of the robotic kitchen knows the status and locations of a wide variety of objects in the robotic kitchen, as to facilitate the one or more robotic arms and the one or more robotic end effectors, as well as one or more smart appliances, in navigating within in the instrumented environment of the robotic kitchen. For example, a hook in the robotic kitchen has different positions to place an object on the hook. The central database would maintain the current status and position of the object placed on a particular hook, the one or more robotic arms and the one or more robotic end effectors would know how to properly retrieve the object from the hook. Without such central database structure, the one or more robots and one or more smart appliances may encounter difficulty not only in retrieving an inventory object, but the one or more the one or more robotic arms and the one or more robotic end effectors may clash against an object that has not bee properly identified and tracked.

The object name/ID column lists the various objects, with the respective (or corresponding) object weight, object color, object texture, object shape, object size, object temperature, object position, object position ID, object premises/room/zone, and an associated RFID. Initially, the robotic kitchen through the sensors reads the list of inventory objects. One or more sensors in the robotic kitchen then provides feedback to the cloud inventory database structure to track the plurality of objects as to the different states, different status, current mode, as well keeping track of the inventory items for replacement, and update the timeline of the plurality of objects.

### Calibration

Calibration of any robotic system during multiple points in its life-cycle should be self-evident, regardless of the application. The need for calibration becomes even more pressing for systems that represent substantial system installations based on size and weight due to such issues as material properties as well as shipping and setup and even wear-and-tear over time as a function of loading and usage.

Calibration is essential during and at the conclusion of the manufacture of main subsystems and certainly the finished assembly, particularly for a complicated mechanical machine like a robotic kitchen. This allows the manufacturer to certify and accept the system as performing to the required specifications, thereby also being able to verify to the buyer the system performs to its as-sold performance envelope. Sizeable robot systems, whether due to size and weight and even setup complexity at the customer facility, will require some form of disassembly for the ease and cost-effectiveness of shipping and thus require a setup at the client's facility. Such a setup has to conclude with yet another calibration step to allow the manufacturer to certify, and the client to verify, the systems operation to its advertised performance specifications. Calibration is even a required setup after any maintenance or repair was performed on any one or the overall system assembly. Some systems where utilization is high or even accuracy is critical over the lifetime of the system, or where a large number of components have to work flawlessly together ensuring critical availability, such as in the sizeable robotic kitchen system disclosed herein, it may become significant to perform system-calibration at regular intervals. These calibrations can be triggered automatically or be completely automated and self-directed without any human interventions. Such a system self-calibration can even be performed during offline or non-critical times during the utilization-profile of a robotic system, thereby not having any negative impact on the availability of the system to the user/owner/operator.

The significance in calibration to the overall accurate performance of the robotic system, is to be seen in the generation and usage of the calibration data generated thereby. In the case of the robotic kitchen, it may be significant to carry out measurements of the six-dimensional (mainly cartesian) linear XYZ- and angular agd-offsets between actual and commanded positions of any robotic system. In one of the embodiments in this disclosure, the robot uses an end effector-held probe capable of making position/angular offset measurements through a variety of built-in internal and external sensor modalities. Such offsets are determined between where the virtual robot representation commands the robot to go to and what the physical world position (linear and angular) is determined to be. Such data is collected at various points, and then used as a locational (and temporal) offset that is fed into the various subsystems, such as the modeling and planning modules, in order to ensure the system can continue to accurately execute all the commands fed to it.

The use of this calibration data may be significant as it reduces the number and accuracy of required environment sensors that might be needed to continuously measure positional/orientational errors in real time to continuously be used to recompute any trajectories or points along pre-computed trajectories—such an approach would not only be overly complex but also excessively costly in terms of hardware and prohibitive in terms of computational power, software module number and complexity and software (re-)planning and control real-time execution requirements. In effect it represents a critical approach to ensure the robotic kitchen is financially and technically viable, without requiring excessively costly and complex sensing hardware while also simplifying control and planning software, resulting in critically viable approaches and processes to ensure a commercially viable product.

For the specific robotic kitchen being considered here, there are three types of calibration errors that may be significant to consider: (1) Linear Errors due to deviations in manufacturing and assembly, (2) Non-linear errors due to wear and deformation, and (3) Deviation Errors due to mis-matched virtual and physical kitchen systems—all these three are elaborated on below.

First Embodiment—Deviations in Manufacturing (Linear Differences). In a first embodiment, a manufacturer in production builds many kitchen frames. Due to possible manufacturing imprecisions, physical deviations, or part variations between each kitchen frame, the resulting manufactured kitchen frames may not be exactly identical, which would require calibration to ensure and adjust any deviations of a particular kitchen frame in order to meet the specification requirements. These parameter deviations from the kitchen specification could be, first in a range that is sufficiently small and acceptable, or in a range that exceeds a threshold of a specific parameter deviation range and would require processing through a software algorithm to calculate these differences and add the parameter differences to compensate for the differences between the different kitchen frames to the ideal kitchen frame (etalon). The deviations between a kitchen frame and the kitchen frame specification reflect the linear differences, which then may require linear compensations, e.g., 5 mm or 10 mm. In one embodiment, the robotic kitchen would use simple compensation values for each deviation for all affected parameters, while in a second embodiment it would use one or more actuators accessing the same mini-manipulation libraries (MMLs) to compensate for the linear differences by adjusting x-axis, y-axis, z-axis, and rotary/angular axis. For the first and second embodiments, all MMLs are pre-tested and pre-programmed. The robot will operate in identical joint state spaces, which does not require live/real-time (re-) planning. The MML is a joint state library, with joint state values only in one example.

Second Embodiment—Kitchen Deformation (Non-Linear Differences)/Joint State MML. In a second embodiment, over the course of time in the usage of the robotic kitchen, the kitchen frame may wear and/or deform in some aspects within the kitchen frame relative to an etalon kitchen, resulting in differences manifested as non-linear deformations. In some embodiments, the term “etalon frame” refers to an ideal kitchen without any deformation (or in other embodiments, significant deformation). In an etalon frame, the robot (robotic arms or robotic end effectors) can touch the different points with different orientations in the kitchen frame. The deformation could be linear or non-linear. There are two ways to compensate for these errors. The first way to compensate for these errors is by repositioning the actuators though x-axis, y-axis, z-axis, x-rotation, y-rotation, z-rotation, and any combination thereof, thereby obviating the need to re-calculate the MMLs. A second way is to apply the displacement errors to the transformation matrices and re-calculate the joint state libraries. Since the robotic kitchen utilizes a plurality of reference points to identify and determine specific shifts/displacements, it is straightforward to identify the applicable calibration compensating-parameters/shift-parameters. Calibration compensation variables are thus re-calculated and applied to the mini-manipulation libraries and used to recalculate the joint state table, in order to compensate for the displacements from the reference points.

Third Embodiment—Virtual Kitchen Model and the Physical Kitchen. In a third case embodiment, usually all of the planning is done in a virtual kitchen model. The planning is done inside of a virtual kitchen platform in a software environment. In the third case scenario, mini-manipulation libraries use a cartesian planning approach to execute robot motions. Since the virtual and physical world will differ there will be deviations between the virtual environment and the physical environment. The robot may be executing an operating step in the virtual environment but unable to touch an object in the physical environment it is expecting to touch in the virtual world. If there are some differences between the virtual model of the kitchen and the physical model of the robotic kitchen, there is thus a need to reconcile the two models (between the virtual model and the physical world). Modifications to the virtual model may be necessary to match the physical model, such as adjusting the positions (linear and angular) of the objects in the virtual world to match the objects in the physical world. If the robot is able to touch an object in the physical world, but the robot is unable to touch the same object in the virtual model, the virtual model requires adjustment to match the physical model so that the robot is also able to touch the object in the virtual model. These adjustments are carried out purely in cartesian space through a set of required translations and angular orientations applied to the kinematic robot joint-chain, since the MMLs are structured in cartesian space, which includes the cartesian planner and motion planner to execute any operation.

In one embodiment, calibration may be significant to create the same virtual operating theater for calculation and execution. If the virtual model is incorrect, and is used for planning and execution in the physical world, the operating procedures that merge the two will not be identical, resulting in serious real-world errors. We avoid this situation by calculating the deviation for each reference point between the physical world and virtual model, and then adjust the geometric dimensions in the virtual model to match a plurality of reference points in the virtual to those reference points in the physical world.

The calibration step that is carried out as an example unfolds as described below. The robot is commanded to touch each reference point with a specific position and a specific orientation, and saves the robot current motor position values and joint values. This data is sent to the joint values in the virtual model, theoretically resulting in the robot in the virtual model to also touch the same reference points. If the robot in the virtual model is unable to touch the required reference points, the system will automatically make adjustments to the applicable reference points in the virtual model so that the robot in the virtual model touches the reference points with the same position and the same orientation (saving all joint values, transferring the joint values to the virtual world, and modifying/changing the virtual model). Thus, the modified set of reference points in the virtual model will match the reference points in the physical world. The modified set of reference points will result in moving and orienting the robot closer to the reference points, or make the robot's end effector longer or arm longer or the position of a gantry system described by a different height. The system will then combine multiple reference points to determine which adjustment to choose, either moving the robot closer to the reference points, or making the robot's end effector or arm longer. Different robot configurations would thus have different ways to touch a single reference point. Iterative and/or repetitive process can determine the best required virtual model modification or adjustment in order to compensate differences and minimize all reference points deviations.

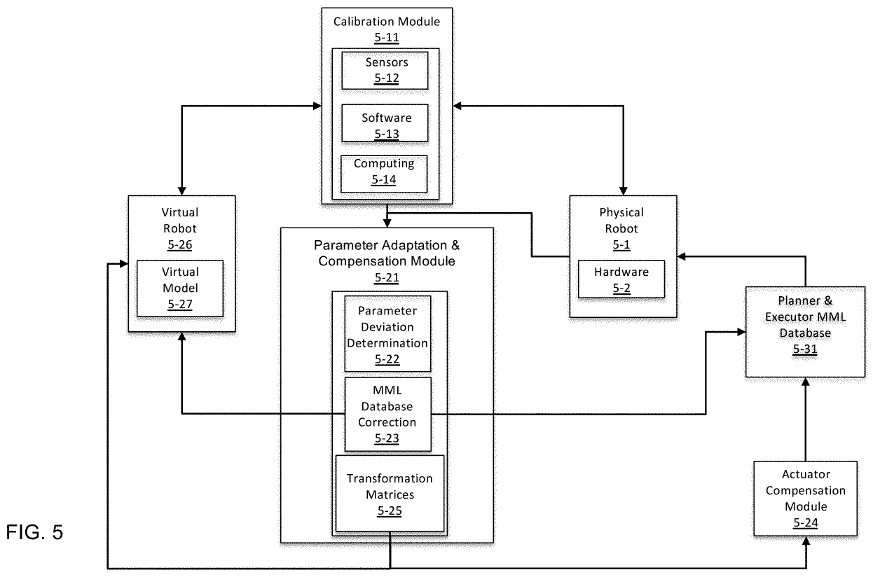

FIG. 5 is a block diagram depicting the process of calibration whereby deviations of the position and orientation of the physical world system are compared to the reference positions and orientations from the virtual world etalon model, allowing a set of parameter deviations to be computed in accordance with the present disclosure. The deviations serve as the basis from which to allow for adaptation in one of three ways: Utilization of the parameter adaptation dataset to (i) modify the virtual world etalon model to match the physical world, or (2) generation of an asset of transformation matrices that are used in real time to modify planned trajectories and velocities to ensure the real-world physical system tracks the desired model-based trajectories, or (3) re-computation of all commanded trajectory-points and -velocities as well as all mini-manipulation libraries (MMLs) using the parameter adaptation transformation matrices. The process of system calibration and adaptation undertaken to update an as-built system database to compensate between the as-sensed configuration of the real-world robotic system and the idealized representation of its configuration in a virtual world model representation. The process is critical to allow for the proper operation of the system and align the virtual representation of the system to the real-world configuration. The process by which an as-built robotic system 5-1 with all its associated hardware 5-2, including but not limited to actuators, sensors, structural members, etc., undergoes a calibration in order to ensure the system will perform as expected. Towards that end a calibration software module 5-11, with software modules 5-13 responsible to acquire sensory data 5-12 and process it via multiple computational steps 5-14. The acquired and processed data is fed by calibration module 5-11 to the parameter adaptation and compensation module 5-21. Within the module 5-21, parameter deviations between an ideal virtual-world representation of the robotic system and the as-measured robot configuration as determined by the sensors 5-12 is determined in 5-22, and used to compute transformation matrices 5-25 and corrective steps made to the MML database 5-23. The database 5-23 corrections are then fed to the virtual robot 5-26 to update its virtual model 5-27, as well as the real-world planner and executor MML database 5-31 so as to ensure all MMLs are updated for proper execution with the as-built robotic system. The transformation matrices 5-25 are furthermore used as potential offset drivers for both the virtual robot 5-26 for future simulation and planning steps, as well as the physical robot 5-1 by way of the actuator compensation module 5-24 that feeds its data to the planner and executor MML database 5-31.

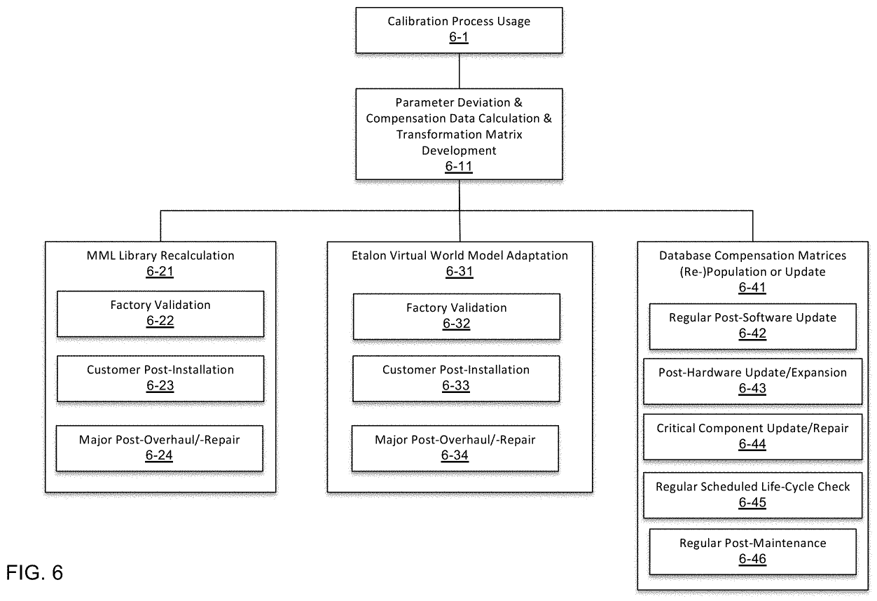

FIG. 6 is a block diagram depicting a situational decision-tree to be used to determine when to apply one of three parameter adaptation and compensation techniques in the calibration process in accordance with the present disclosure. The process of calibration and adaptation, whether virtual or databases, provides examples of when the calibration process might be warranted during the lifetime of the robotic system. The calibration data 6-1 is used to generate compensation data filtered into a transformation matrix development process 6-11, which in turn can be used for multiple purposes. The compensation data and parameters developed in 6-11 can be used in the MML Library Recalculation Process 6-21; the process could be undertaken as part of the factory validation step 6-22, as part of a customer post-installation step 6-23, or even after a major post-overhaul or -repair 6-24. Alternatively, the compensation data and parameters developed in 6-11 can be used in the adaptation of the Etalon Virtual World Model 6-31; the process could be undertaken again as part of factory validation 6-32, customer post-installation 6-33 or again as part of a major post-overhaul or post-repair step 6-34. Lastly, the compensation data and parameters developed in 6-11 can be used to modify or update matrices within one or more databases 6-41; the step can be undertaken as part of a regular post-software revision or update 6-42, post-hardware update or expansion/modification 6-43, a critical component update or repair 6-44, as part of a regularly scheduled lifecycle check 6-45, or even as a regular post maintenance step 6-46.

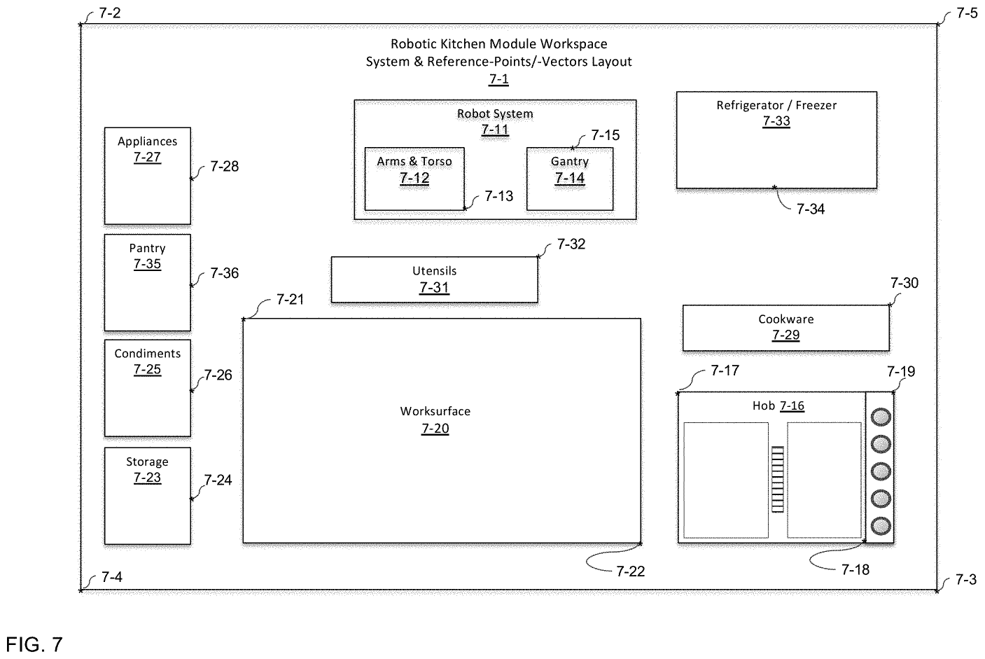

FIG. 7 is a block diagram depicting a schematic fashion a plurality of reference points and associated state configuration vector locations, not limited to two dimensions, but rather in multi-dimensional space, where the robotic kitchen could be commanded to carry out a calibration (or recalibration) procedure to ensure proper performance within the entire workspace as well as within specific portions of the workspace in accordance with the present disclosure. In this embodiment, one possible layout of physical world calibration points or collection of points is shown and described that a robotic cooking system operating in a robotic kitchen module workspace 7-1 utilized for robotically preparing dishes based on computerized recipe execution instructions. The layout is not intended to be all-encompassing, but illustrates the variety of types and locations for calibration points that a system might use to verify and adapt the system execution and transformation parameters captured in scalar, vector or matrix form within software libraries, to ensure the real-world system operates according to the execution plan captured and represented in the idealized representation of a model within a virtual world.

The robotic kitchen workspace 7-1 may include, but is not necessarily limited to, a robot system 7-11 comprising an arm and torso assembly 7-12 possibly mounted to a multi-dimensional (XYZ-coordinate typically) Gantry 7-14, each with respective one or more reference points 7-15 and 7-13, respectively. The reference points can be positions or coordinates that the system is commanded to move to in order to use internal and external sensors to verify the actual position and compared it to the commanded position, in order to determine any offsets resulting in potentially needed compensation and adaptation parameters for future operation in a more accurate model-prescribed fashion.

Additional items within the robotic kitchen module workspace 7-1 include such items as one or more refrigerator/freezer units 7-33, dedicated areas for appliances 7-27, cookware 7-29, holding-areas for utensils 77-31, as well as storage areas for cooking ingredients in a pantry 7-35, condiments 7-25, and general storage place 7-23. Each of these units and discrete elements within the kitchen will at least have one reference point or sets of reference points (labelled as 7-34, 7-28, 7-30, 7-32, 7-36, 7-26, and 7-24 respectively) that the robot system 7-11 can use in order to calibrate its position and location with respect to the locations and units.

The more dynamic and typically two-dimensional area used for cooking/grilling, shown as hob 7-16 have at least a set of two diametrically opposed reference points or sets of points 7-17, 7-18, 7-19 in order to allow the calibration system operating the robot system 7-11 to properly define the boundaries of the respective areas such as the cooking surface using reference points 7-17 and 7-18 or the control-knob areas for the cooking surface using reference points 7-18 and 7-19. The robot work surface 7-20 where many of the ingredient and preparation steps are carried out will as in the case of the hob 7-16 also use at minimum a set of two reference points or sets of points, which in the case of a tow-dimensional surface would be sufficiently defined by reference points 7-21 and 7-22, but could employ more reference points or sets of points if the worksurface is multi-dimensional rather than just two-dimensional as is the case of a counter surface.

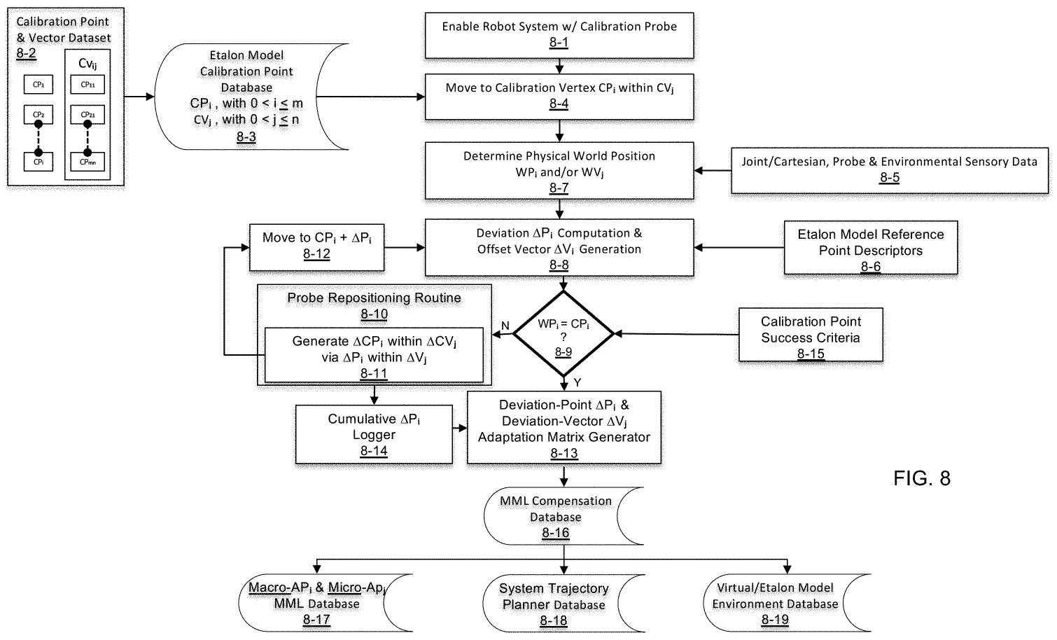

FIG. 8 is a block diagram depicting the process of a flowchart by which one or more of the calibration processes can be carried out in accordance with the present disclosure. The process utilizes a set of calibration-point and -vector datasets from the etalon model, which are compared to real-world positions, allowing for the computation of parameter adaptation datasets to compensate for the misalignment between the robot system in the physical world and that in the ideal virtual world, and how such compensation data cab ne used to modify one or more databases in accordance with the present disclosure. In this embodiment, a calibration routine outlines the main process steps that lead to the generation, processing and storage of any required calibration data to be applied to the real-world robotic system to ensure its operation tracks the commanded motions as referenced to a simulated model-based robotic system in a virtual computer-representation of the world or workspace.

The process begins with the robotic system and calibration probe 8-1 being enabled and commanded in 8-4 to a vertex point CPᵢ, or a set of points described by points within a vertex vector CVⱼ. The calibration vertex points CPᵢ within vertex vectors CVⱼ are contained within the etalon model database 8-3, which itself is fed by the pre-defined calibration-point and -vector dataset 8-2. The next step is for the calibration routine determine the physical world position WPᵢ and position-vector WVⱼ of the robot and its calibration probe in step 8-7, as-measured by all internal and external joint-/cartesian-, probe- and environmental sensory data 8-5. A deviation computation 8-8 results in the generation of offset scalar and vector representations of the deviation DPᵢ and DVⱼ between the real-world position and orientation and that of the same within the idealized virtual world representation of the etalon model points and vectors 8-6 of the robotic system 8-1. Should the comparison 8-9 of the actual world-position and the cartesian position not coincide, the system enters a robot (and thus also a probe-) repositioning routine 8-10, whereby step 8-11 is undertaken to move the commanded calibration point within the calibration vector by the measured error amount DPᵢ and in a direction defined by the error vector DVⱼ, thereby generating a motion-offset DCPᵢ and a motion offset vector DCVⱼ which is fed into a new commanded position offset value 8-12. The process is repeated until the real-world position WPᵢ coincides with the calibration point CPᵢ, at which point the loop exits and the cumulative offsets DPᵢ and vectors DVⱼ logged in 8-14 are used in adaptation matrix generator process 8-13, which collects all values in a mathematically usable computer representation. The adaptation matrices are then logged within the mini-manipulation library (MML) compensation database 8-16, which in turn can be accessed by other databases, such as the Macro-APᵢ and Micro-APⱼ MML database 8-17, the database 8-18 used for all robotic system trajectory planning, as well as the virtual-world etalon model environment database 8-19 (which includes the robotic system, its workspace and the entire environment within which it operates).

### AP-Transition

The use of pre-defined entry and exit transition states/points/configurations in the execution of any AP (Action-Primitive), regardless of whether it be a MACRO or MICRO manipulation action may be a significant factor in developing a commercially viable robotic system prototype, in particular a robotic kitchen as detailed herein. Such pre-defined transition configuration(s), allow for the use of pre-computed actions represented by clearly defined cartesian locations and trajectories in 6-dimensional space (XYZ position and ABC angular orientations), requiring each sequence of Micro-AP mini-manipulations that describe a Macro-AP mini-manipulation to be executed in open-loop fashion without the need for real-time 3D environmental sensing, which avoids excessive number and complexity of sensory systems (hardware and data-processing) and complex and computationally expensive (in terms of hardware and execution time) software routines for real-time re-planning and controller-adjustment.

The transition configurations are defined for all macro-AP and micro-AP mini-manipulations as part of the manipulation-library development process, whether done automatically, via teach-playback or in real time by a master chef monitored during a recipe creation process. Such transition states for any individual macro-AP and micro-AP mini-manipulation step need not be of a singular type, but could be comprised of various transition-configurations, which can be a function of other variables. These multiple transition configuration, in the case of a robotic kitchen, could be based on the presence or use of a particular tool (spoon or spatula during stirring or frying as an example), or even the type of succeeding macro-AP or micro-AP mini-manipulation; an example might be the conclusion of a spoon stirring action, which upon having been concluded, might require the transitional state to involve a re-orientation and alignment of the spoon with the container edge to allow it to be tapped against the edge to remove any attached cooking-substance form the spoon prior to returning the tool to a pre-determined location (sink or holder), instead of a halted stirring position to decide if more stirring cycles are needed.

In terms of a process execution it should be clear that such an approach requires at most only a single internal- and external-sensor environmental sensory data-acquisition and -processing step to ensure the environment and all required elements (robot, utensils, pots, ingredients, etc.) are in their proper expected locations and orientations as expected by the pre-computed planner, before engaging one or more macro-AP mini-manipulations, which themselves each consist of many micro-AP mini-manipulations executed in series or in parallel, with each macro-/micro-AP manipulation transitioning through its start/end states by way of a pre-defined transition state. All transition states are based on a pre-recorded set of state variables consisting of all measurable positional and angular robot actuator sensors, as well as other state-variables related to any and all physically measured variables of all other robotic kitchen subsystems contained within the state variable vector defining the subsystems critical to the execution of the respective macro-AP and micro-AP mini-manipulations, respectively. Each start/end configuration is defined by these set of transition state variables, and is based on the set of variables measured by those sensors responsible for returning state information for those systems defined in the critical systems vector, to any and all supervisory and planning/control modules active during the macro-AP and micro-AP mini-manipulation(s). The robotic kitchen elements involved in a particular step of a recipe creation process, created by a sequence of serial/parallel macro-AP mini-manipulations, which themselves each are made up of many more micro-AP mini-manipulation entities, are monitored by the control system to ensure the start and end configurations of any such macro-/micro mini-manipulation are properly achieved and communicated to the planning and control systems, before any transition to the next macro-/micro mini-manipulation AP is authorized.

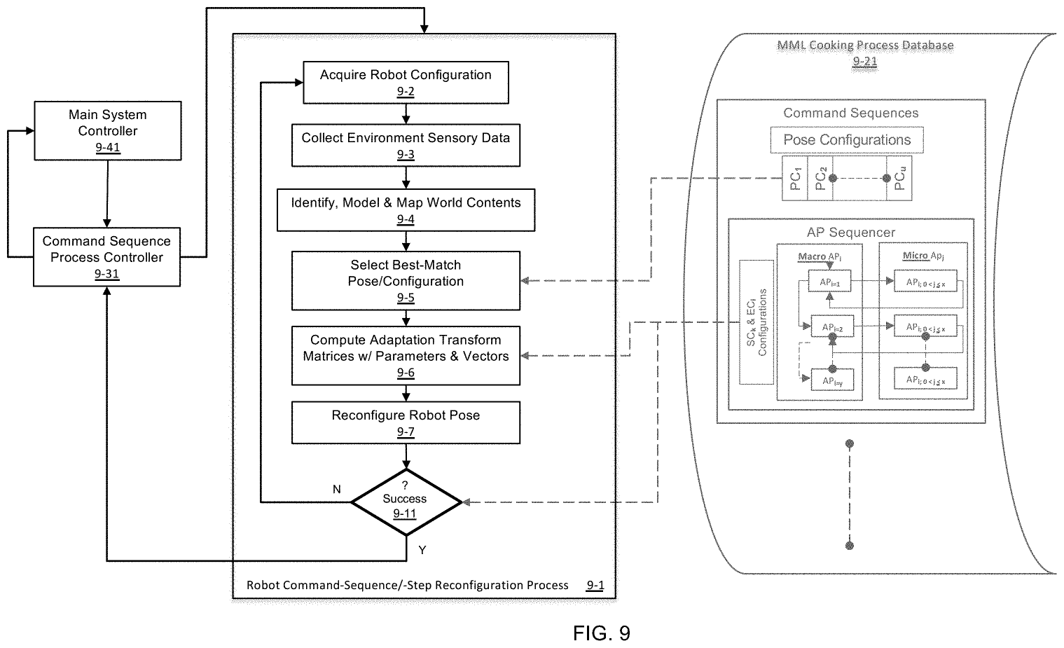

FIG. 9 is a block diagram depicting a flowchart by which one or more of the pre-command sequence step execution deviation compensation processes can be carried out in accordance with the present disclosure. The process utilizes a suite of robot-internal sensors (position, velocity, force/torque, contact, etc.), as well as environment world sensing systems (cameras, lasers, etc.) to image the position and configuration of the robot and its intended working space volume, and any and all tools/appliances/interfaces contained therein. The system then carries out a deviation measurement between the physical world and the pre-computed starting configuration for the start of the execution of a particular command sequence. The system uses a best-match process to determine the closest pose/configuration for the robot system to best start the execution of the command sequence. The deviation parameters are then assembled into vectors and combined into transformation matrices used to modify the robot configuration into the best-match pose for the start of the command sequence. Once reconfigured the robot system can then start the execution of the pre-determined command sequence through a series of macro-APs, with embedded serial sequences of micro-APs, without the need for re-sensing/re-imaging and re-interpreting the environment for any detected deviations requiring adaptation/compensation at every time step of the execution sequence.

The robot adaptation and reconfiguration 9-1 executes or carries out a particular cooking-sequence macro-AP mini-manipulation sequence. Theoretically this step need only be carried out at the beginning of each major recipe execution sequence, at the start of the first macro-AP step within a mini-manipulation sequence, or even at the start of each macro-AP mini-manipulation within a given recipe execution sequence. This same process 9-1 can also be invoked by the command sequence controller 9-31 whenever the system begins to detect excessive deviation in measured success criteria from the ideal/required values between successive macro-AP execution steps, allowing for continual open-loop execution without the need for continual Sense-Interpret-Replan-Act-Response steps at every time-step of a the high-frequency process controller.

The main system controller 9-41 issues a command to the recipe execution process controller 9-31 to execute the recipe-specific sequence. The system executes a robot command-sequence/-step reconfiguration process 9-1 prior to executing the first recipe execution sequence. The process 9-1 involves measuring the robot configuration 9-2, as well as collecting environmental sensory data 9-3, which are all used to identify, model and map 9-4 all the elements within the workspace of the robotic system. At this point the MML Cooking Process Database 9-21 provides possible starting configuration pose data to the best-match configuration selection process 9-5, which then selects the configuration pose PC_{l thru u} that best matches the sensed real-world configuration. Each PC has associated with it a set of ideal and precomputed macro- and micro-AP mini-manipulation sequences. Each macro- and micro-AP have associated with them a pre-defined (and pre-validated and -tested) Start- and Exit-configuration SCₖ and ECₗ, respectively, which are then used in a set of adaptation parameters/vectors/matrices in the computation of the appropriate transformation step 9-6. The robot system is then commanded to reconfigure itself in 9-7 based on this set of parameters, allowing for a one-time alignment of the robotic system prior to the execution of the first step within the selected recipe execution sequence with the best-match configuration and its associated configurations that allow open-loop execution of each macro-AP, gated to succeeding macro-APs in the sequence using a set of micro- and macro-AP success criteria.

Upon successful completion at step 9-11 of the robot command-sequence/command-step reconfiguration process 9-1, control is returned back to the process controller 9-31 to continue stepping through the cooking sequence through until it is completed, before returning control back to the main system controller 9-41, awaiting further instructions.

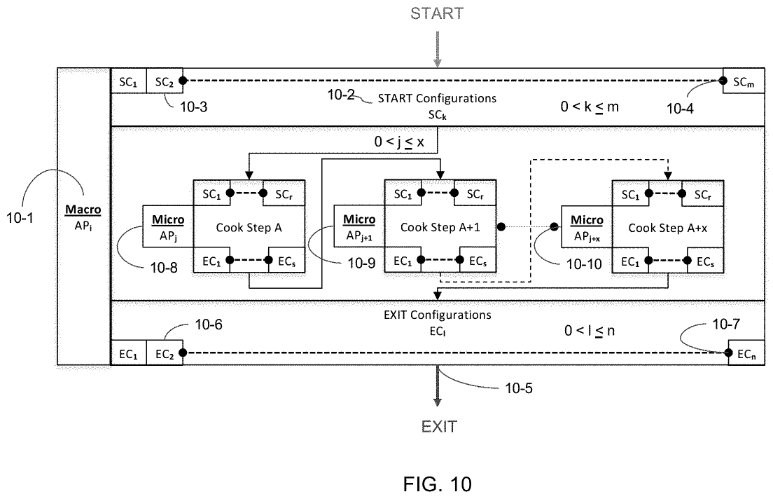

FIG. 10 is a block diagram depicting the structure and execution flow of Action-Primitive (AP) Mini-manipulation Library (MML) commands in accordance with the present disclosure. The process illustrates as to how a given cooking command is structured into a sequence of macro-AP, where each macro-AP itself contains a sequence of finer-movement micro-APⱼs, with each micro-APⱼ as well as each macro-APᵢ has one or more pre-defined user-generated and planner/controller system-selectable starting- (SCₖ) and ending-configurations (ECₗ), requiring each micro-AP to be completed by way of the defined/selected exit-configuration, before the next micro-AP can be executed through its own defined starting configuration (where the exit configuration of a prior macro- or micro-AP need not necessarily be identical). The overall structure of a particular Macro-AP includes one or more pre-defined starting configurations SC as well as corresponding one or more exiting configurations EC, where the macro-AP itself is composed of one or more sequentially executed micro-APs, who themselves have their own set of respective starting and exit configurations, each defined by a pre-determined set of specification parameters/variables.

The particular macro-APᵢ labelled 10-1 has one or more starting configurations SC_{K} labelled 10-2, numbered with the suffix ‘k’ ranging from 0 to a number ‘m’, labelled as 10-3 through 10-4. The first micro-APⱼ labelled 10-8 that constitutes the starting execution sequence for the macro-APᵢ, will have an identical starting configuration SCₖ to that of the starting configuration for the particular macro-APᵢ 10-8. Upon completion of this first micro-APⱼ 10-8 constituting cooking step A, the selected exiting configuration EC_{l->s}, will be identical to the starting configuration SC_{l->t} of the next micro-APⱼ₊₁ 10-9, which constitutes cooking step A+1. Upon completion of all sequential micro-AP_{j->x} cooking steps, the macro-APᵢ 10-1 concludes with the final micro-APⱼ₊ₓ, whereby the exiting configuration ECₛ of the micro-APⱼ₊ₓ 10-10, is identical to the exiting configuration 10-5 defined by EC_{l; 0≤1≤n} 10-6, 10-7 for the macro-APᵢ 10-1. Upon successfully completing this specific macro-AP, the process will continue and sequence into the next process step as defined by the MML libraries for a particular cooking process, which could entail the execution of the next macro-APᵢ₊₁ in a sequential manner, whereby the exiting configuration 10-5 of the macro-APᵢ; is identical to the starting configuration SCₖ for the next macro-APᵢ₊₁.

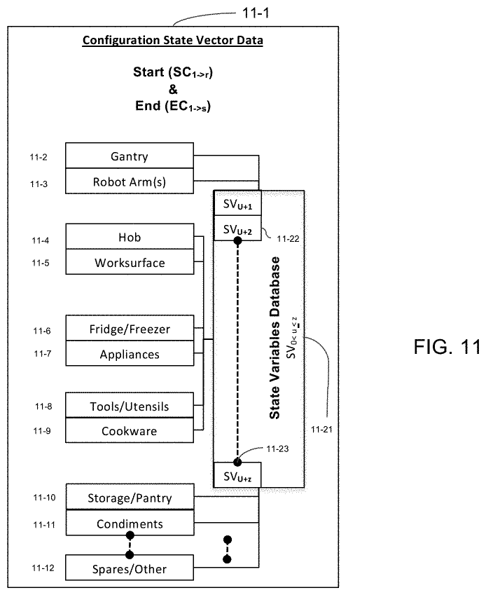

FIG. 11 is a block diagram depicting how the starting- and ending configurations for any given macro- or micro-AP can be defined not only for each specific subsystem within a robotic kitchen but also contain state variables not limited solely to physical position/orientation, but also other more generic system descriptors in accordance with the present disclosure. Each configuration is associated with the structure of the configuration state vector dataset of any and all starting and ending configurations and any parameter variable value, as applies to all the elements within the robotic kitchen and its workspace. The data is critical to not only describe physical configurations for any one of the respective systems, but to also describe other measurable quantities related to the status of each system, as measured by key process variables deemed critical to the performance of the overall system as part of a recipe cooking operation.

The configuration state vector data set 11-1, which includes all starting configurations SC_{l->r} and exiting configurations EC_{l->s}, has associated to each also a set of state variables SV_{u->z}, labelled 11-22 to 11-23 herein, within a database 11-21, which describe any necessary variable required for fully describing the state of the respective system beyond just its starting and exiting configuration. Note that the suffixes for each of these data points start at 1 and are denoted having a range denoted by an arrow ‘->’ and ending at some value, denoted by placeholder values labelled as ‘r’, ‘s’ and ‘z’. Individual systems within the robotic kitchen can include, but are not limited to such elements as, any robot arms 11-3 mounted to or with a multi-dimensional gantry system 11-2, relying on the presence of workspace elements such as a hob 11-4 and a worksurface 11-5, within reach of necessary appliances 11-7, tools and utensils 11-8 as well as cookware 11-9, supported by the presence of freezer and fridge 11-6 and any peripheral appliances 11-7. Additional elements holding potentially necessary ingredients include a storage and pantry unit 11-10 as well as a condiment module 11-11 and any other necessary spare areas 11-12 containing further elements needed in a robotic recipe cooking execution sequence.

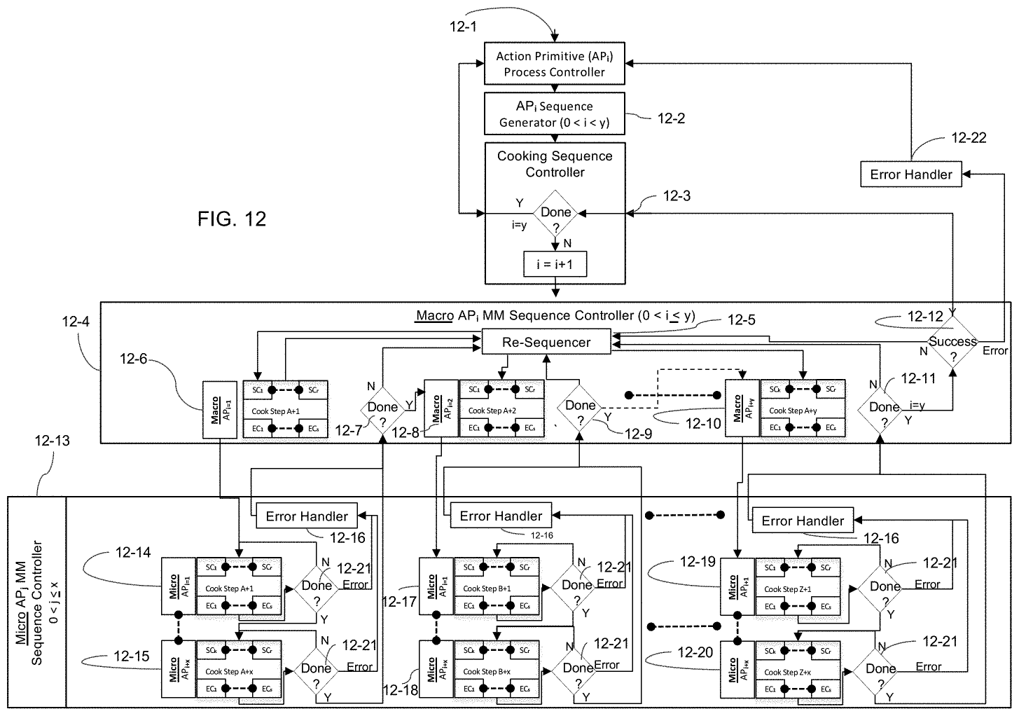

FIG. 12 is a block diagram depicting illustrating a flowchart of how a specific cooking step made up of multiple sequential macro-Aps, themselves each described by a multitude of micro-Aps would be executed by a cooking sequence controller executing a particular cooking step within a particular recipe in accordance with the present disclosure. The recipe execution sequence shows where a particular recipe selected by a user results in the selection of a cooking sequence stored within a database, which is fed to a process controller, which in turns executes a cooking sequence, where the sequence comprises of a sequence of one or more macro-APs, with each macro-AP consisting in turn of a sequence of one or more micro-APs, which are in turn also executed in a sequential manner. Errors are handled internal to each process step, resulting in turn in one of many steps, including re-execution or re-sequencing of one or more particular cooking steps or sequences, until all prescribed macro- and associated micro-APs are fully and successfully executed.

Given a particular recipe, a database provides the sequence of APs described within one or mini-manipulation libraries and/or databases, to the Action Primitive (AP) controller 12-1. The APi sequence generator 12-2, which creates the proper sequence for macro-AP_{i; 0<i≤y}, feeds the proper sequence to the cooking sequence controller 12-3, which steps through the steps i=i+1 until the counter reaches i=y, which indicates the conclusion of the cooking sequence. The sequential execution of the macro-AP_{i; 0<i≤y} is handled by a dedicated controller 12-4. The sequence begins with the first macro-APᵢ₌₁ labelled 12-6, which is defined by one of many pre-determined starting configurations SC. The macro-APᵢ₋₁ 12-6 is made up by a its own sequence of one or more sequentially executed micro-AP_{j; j<0≤x}, each with its own pre-determined and well-defined starting and exiting configuration, where the starting configuration for each micro-APⱼ is identical to the exit configuration of the preceding micro-APⱼ₋₁. The macro-APᵢ₌₁ 12-6 leads to the sequential execution of micro-APs labelled 12-14 through 12-15 in a sequential manner, with checks for completion 12-21 at the conclusion of each micro-AP. An internal error handler 12-16 routes the process to a resequencer 12-5 which can shuffle the macro-AP sequence as needed to ensure successful completion of a particular cooking step within the entire sequence. Upon completion of the entire micro-APⱼ sequence associated with macro-APᵢ₌₁, the last micro-APⱼ₊ₓ completes with an exit configuration that is identical to the exit configuration of its macro-APᵢ₌₁, which in turn is identical to the starting configuration of the next macro-APᵢ₌₂. The micro-APᵢ₌₂ will again step through a sequence of micro-APs labelled 12-17 through 12-18, with commensurate completion-checks 12-21 and error-handling 12-16, before proceeding to the next macro-AP in the sequence. This identical set of steps in 12-7, 12-8, 12-9 continues until the end of the sequence denoted by i=y is reached in macro-AP_{i+y} 12-2 for cooking step A+y, which concludes with the last micro-APⱼ₊ₓ 12-20 being checked for completion in step 12-11, with a check for successful completion in 12-12. Any remaining errors are again handled by the error handler 12-22, and regardless of status control is returned to the beginning of the Action Primitive APᵢ process controller 12-1.

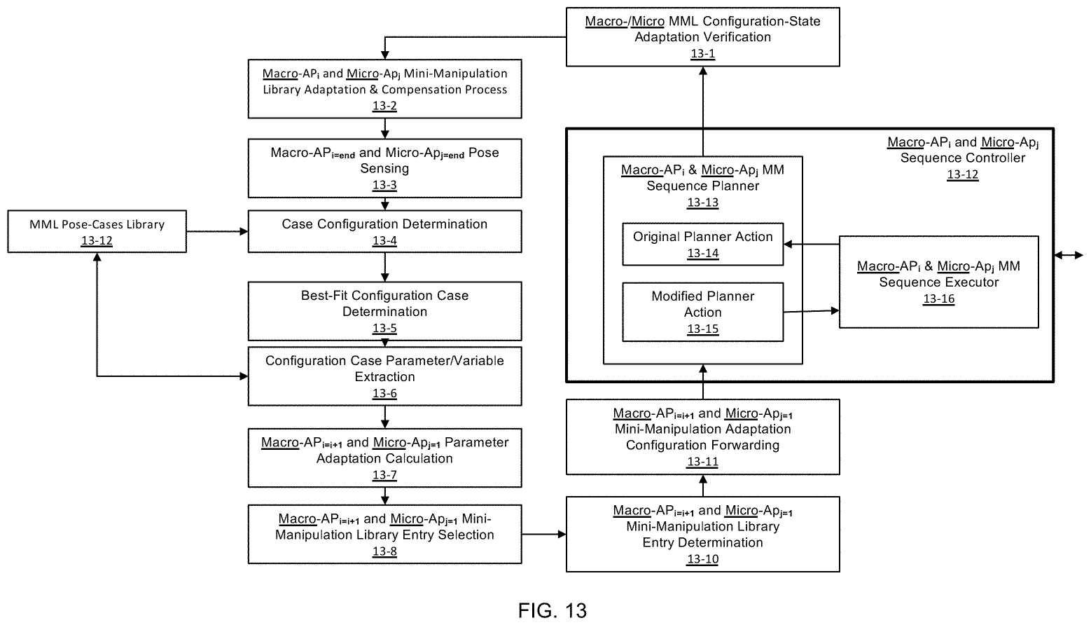

FIG. 13 is a block diagram depicting a decision-tree flow for a given AP adaptation. The notion revolves around the potential need to adapt a given AP based on deviations in the sensed configuration of the robotic system in accordance with the present disclosure. Based on a set of pre-determined configuration case options, the etalon-model based pre-computed AP steps can be modified by matching the closest configuration case from the pre-computed MML pose-case library to adapt and compensate execution of the cooking step so that the AP is adapted to ensure a successful outcome in the physical world, by picking the adaptation to the closest match based on a comparison of the physical world configuration to that of the closest pose-/configuration-case within the pre-computed MML library. The process flow by which a given macro- or micro-AP to be executed by a robotic system is compared to a number of similar APs contained within a MML library based on sensory data input, in order to determine the macro- or micro-AP with the closest fit in terms of starting and ending configuration respectively, before selecting the closest-fit macro-/micro-AP for execution. In one embodiment, the purpose of this process is to try to use just those macro-/micro-APs that have already been pre-determined and pre-validated in terms of performance that most closely match the required next-step macro-/micro-AP, in order to obviate the need for time- and computationally-costly and cumulative-error prone re-computation of the entire motion- and execution plan of the robotic system for a given commanded action. Should however the deviation between the currently-sensed configuration at the conclusion of a current macro-/micro-AP be too large from that of any pre-computed next-step macro-/micro-AP within the ML library, yielding too high a best-fit matching-error metric, it will become necessary to perform the recalculation of the entire motion- and execution plan, albeit based on existing pre-determined and pre-validated MML sequences of library-stored macro- and micro-APs.

The process 13-1 for determining the adaptation to a particular macro-micro-AP entails the MML library adaptation and compensation process 13-2, which as a first step requires collection of all relevant sensory data to determine the current pose in step 13-3 for a currently executed macro-APᵢ and micro-APⱼ. The determined configuration entails determining the exit-configuration of a current macro-AP_{i=end} or micro-AP_{j=end}, in order to determine the configuration case in step 13-4. The configuration will be compared to all relevant poses-cases from the MML library in step 13-12, so as to determine a best-match configuration case in step 13-5, where the exiting configuration for a current macro-AP_{i=end} or micro-AP_{j=end}, has a best-match in terms of minimal configuration-error to that of the next-step macro-APᵢ₌ᵢ₊₁ or micro-APⱼ₌₁ and their associated starting configuration or pose within the next step in the execution sequence, as determined by the sequence executor 13-16. The parameters and variables associated with the best-fit next-step macro-APᵢ₌ᵢ₋₁ or micro-APⱼ₌₁ are identified in step 13-6, allowing for a calculation of the adapted parameters of the macro-/micro-APs in step 13-7, allowing the identification and determination of the specific macro-APᵢ₌ᵢ₊₁ or micro-APⱼ₌₁ MML library entry in steps 13-8 and 13-10, respectively. The appropriate library entries are forwarded from the library 13-12 to the macro-AP/micro-APⱼ sequence controller 13-12 in step 13-11.

The macro-APᵢ/micro-APⱼ sequence executor 13-16 now uses the newly identified next-step macro-AP/micro-AP in the MM sequence planner 13-13 to shuffle the execution sequence determined in the previous time-step by planner 13-14, to generate a modified sequence as provided by planner 13-15. It may be significant to note that this adaptation process may occur at any time-interval within a given execution sequence, ranging from every time-step, at the beginning or end of any micro-APⱼ or macro-APᵢ or even the beginning or end of a complete execution sequence entailing one or more macro-APᵢ or micro-APⱼ steps. Furthermore, all adaptations are based and rely solely on the selection of pre-determined, pre-computed and -validated macro-APs and micro-APs, thereby obviating the need for any re-calculation of sequence- or motion-planning affecting the entire robot systems and their associated configurations or poses. This again saves valuable execution-time, reduces hardware complexity and -cost as well as limits execution mishaps due to error-accumulation, which will ultimately impact overall performance which can put a guarantee of successful task-execution at risk.

### MML Adaptation & AP-Execution

In order for a robotic system to be able to timely, accurately, and effectively execute commanded steps in a highly interactive dynamic and non-deterministic environment, execution typically requires continuous sensing and re-planning execution steps for the robot at every (control) time-step. Such a process is costly in terms of execution time, computational load, sensory hardware and data-accuracy, sensory and computational error-accumulation and does not necessarily yield a guaranteed solution at every time-step nor necessarily an eventual successful outcome. These detrimental attributes can however be mitigated and even removed, through the use of a simple yet effective adaptation process.

By splitting all the main robotic activities into basic manipulation steps, comprised of execution steps with multiple APs at the macro- and micro-levels, and forcing each AP to begin and end at known and pre-determined and -tested/-verified start and exit configurations, allows the system to theoretically perform only a single sensing/modelling step at the beginning of each controlled execution sequence. The required transformation to the robot configuration is performed only once, to adapt the robotic system to match the starting configuration by way of use of a compiled transformation process involving transformation-parameters/-vectors/-matrices applied to the robot system configuration (again, only once) defined for the first AP in the execution sequence. Thereafter the robot can theoretically carry out all pre-determined and pre-verified motions and task-steps along well-defined sequences with attached success-criteria at each AP conclusion in a virtually open-loop fashion, to eventually complete the entire process (like frying an egg, or making hot oatmeal), with a minimal number of (theoretical just a single) sensing and robotic system adaptation steps.

The above-described process varies dramatically from the standard Sense-Readjust-Execute-(Re)Sense infinite loop typical in complex robotic systems operating in complex and dynamic non-deterministic environments, where the above step is carried out at every time-step to maximize accuracy and ensure performance fidelity. The newly described process accomplishes the same goal at minimal computational and execution-delays with a guaranteed performance success by carrying out the adaptation process a minimal number of times (theoretically only at the beginning of the process-sequence, but it can be executed any number of additional times during the execution sequence, but is not required at every time-step), and forcing the execution to be carried out through a predefined set of pre-tested and pre-verified AP sequences with associated start/exit configurations and completion-success criteria with guaranteed performance and outcomes, all contained within a MML database or repository used to define each respective robotic sequence; in the case of the robotic kitchen, these would be defined as recipes, each of them containing multiple preparation steps and cooking sequences to result in a finished dish. For high-frequency controllers needed for robotic systems in highly environment-interaction and dynamic environments, controller sampling times are on the order of 100s of Hz, implying computational steps be completed in less than fractions of 1/10-ths of a second, placing daunting demands on computational power and sensory data processing, not to speak of issues related to sensory-errors and their propagation which will ultimately impact system performance and elicit concerns regarding guarantees related to successful step- or sequence-completion.

While the above description has been focused on the application in a robotic kitchen, the same logic and elements and processes can be applied to other applications, such as (i) an automated/robotic laboratory processing cell, (ii) component sub-assembly cell in a manufacturing setting, or (iii) order-assembly and packing in an automated order-fulfillment setting, but to name a few possible alternate candidate application scenarios.

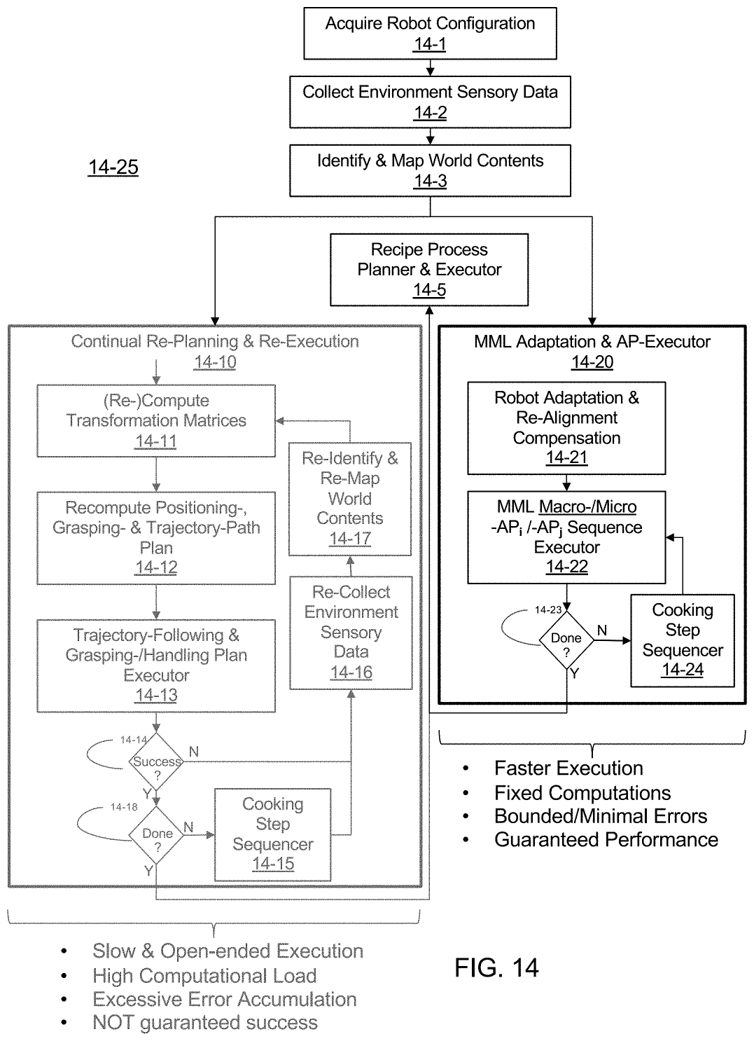

FIG. 14 is a block diagram depicting a comparison of a standard robotic control process, to that of a MML-driven process with minimal adaptation 14-25 in accordance with the present disclosure. The point taken is that a standard robot operating in an uncertain and dynamic world requires continuous environmental (re-)sensing and identification and modelling to determine all process variables, prior to re-calculating all position-/velocity-, grasping and handling trajectories and strategies, with continuous re-computation at nearly every time-step, resulting in a slow and computationally-expensive and non-deterministic loop-time, capable of accumulating execution and computational errors, with a high likelihood of a non-successful outcome. The use of pre-determined and -verified MML libraries with defined AP-sequences, both at the macro- and micro-levels, with guaranteed successful outcomes, as long as simple adaptation and compensation via a one-time transformation based on the sensed environment, is made at the beginning of each process-step, requires a highly reduced and deterministic computational load, resulting in faster execution with minimal and bounded (known) errors, yet more significantly, a guaranteed successful and known outcome. In the case of an MML-Adaptation driven AP-execution, sensing complexity and cycle-time and error-presence and -accumulation are highly reduced, while a successful outcome is guaranteed if the execution structure of the MML APs is observed.

This embodiment illustrates a visual comparison of the standard approach vs. the present disclosure to achieve a reliable and robust robotic system performance in a dynamic non-deterministic environment characterized by high degrees of grasping and object handling with non-trivial high-contact interactions between a robotic system within its workspace. All such systems involve the measurement of the robotic system configuration 14-1, the collection of environmental workspace sensory data 14-2, coupled with a subsequent step 14-3 to identify and map the world contents/objects, and a recipe process planner and executor 14-5.

The standard approach 14-10 of continual sensing, re-planning and re-execution requires the use of continually collecting sensory data 14-16 at every time-step, in order to generate a set of transformation parameters 14-11, many captured within matrices, allowing for the re-computation 14-12 of a-priori determined ideal-world position-/velocity-trajectories as well as grasping and handling strategies, which are then executed by a dedicated controller/executor 14-13. A continual series of commanded steps are thereby executed and the need for collecting new sensory data 14-16 and re-identifying and re-mapping the robot and its surrounding world contents 14-17 is needed at every time-step of the execution loop. Successful completion of each step is verified in 14-14, and continual sequence operation is also verified in 14-18, as part of the cooking step sequence controller 14-15. Upon completion of the cooking sequence, the system returns control back to the recipe process planning and executor 14-5 awaiting instructions for the next step in the recipe preparation/execution.

The present disclosure illustrates the MML Adaptation and AP-executor 14-20. In this implementation the system only performs a single measurement and mapping step 14-1 through 14-3, prior to determining the best-match configuration stored within the database upon which it will base its robot-adaptation and compensation 14-21 for a one-time re-alignment of the robotic system to begin the sequence execution 14-22. The execution relies on a set of macro-AP and micro-AP MML steps, which are executed by the executor 14-22, allowing progress and transitions between pre-validated and -verified macro- and micro-APs based on a set of clearly defined success criteria. In one embodiment, the process requires no validation and checking of system performance at every time-stamp of the high-frequency controller, but just at the start and end of each cooking sequence, as each of the macro- and micro-AP sequences have already been pre-tested and can thus be executed open-loop as any possible error accumulation is so small to be imperceptible and thus not impacting the outcome of the process. The cooking step sequencer 14-24 is responsible for the successful execution of the entire sequence within a specific recipe completion sequence.

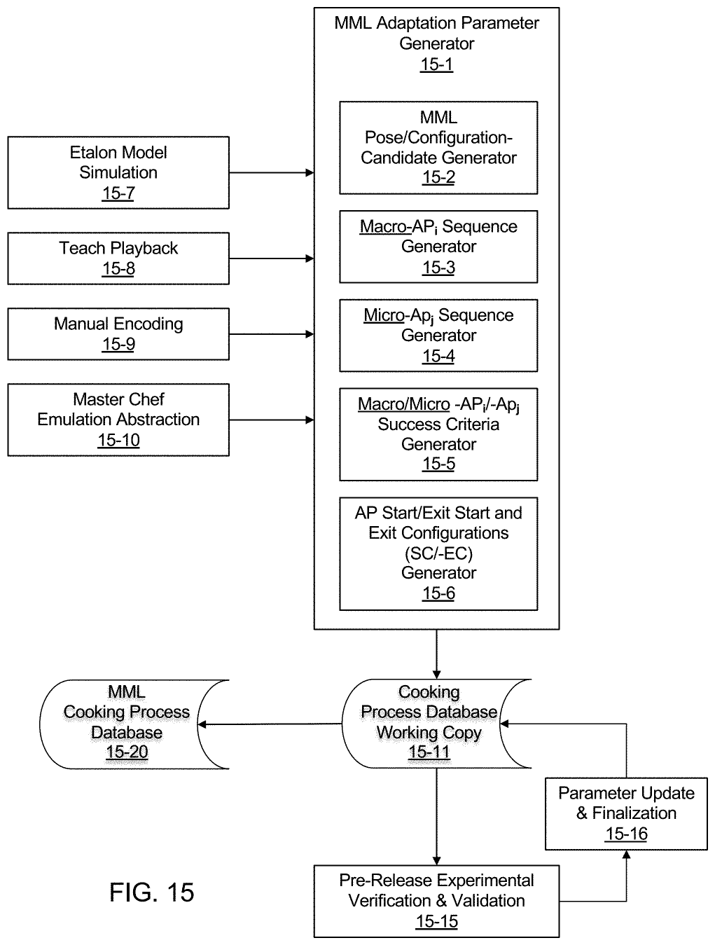

FIG. 15 is a block diagram depicting the MML Parameter Adaptation elements, which have parameters that can be developed through a variety of methods, including through simulation, teach/playback, manual encoding or even by watching and codifying the process of a master in the field (chef in the case of a kitchen) in accordance with the present disclosure. The parameters can be grouped into critical groupings required for rapid MML AP execution, such as allowable poses/configurations, AP-sequences (both macro- and mini-MMLs), success criteria for AP completion, as well as start and exit configurations of the stored AP MML sequences. The parameter data is verified via experimentation, and optimized/updated if needed, prior to validation and release into the MML Cooking Process Database.

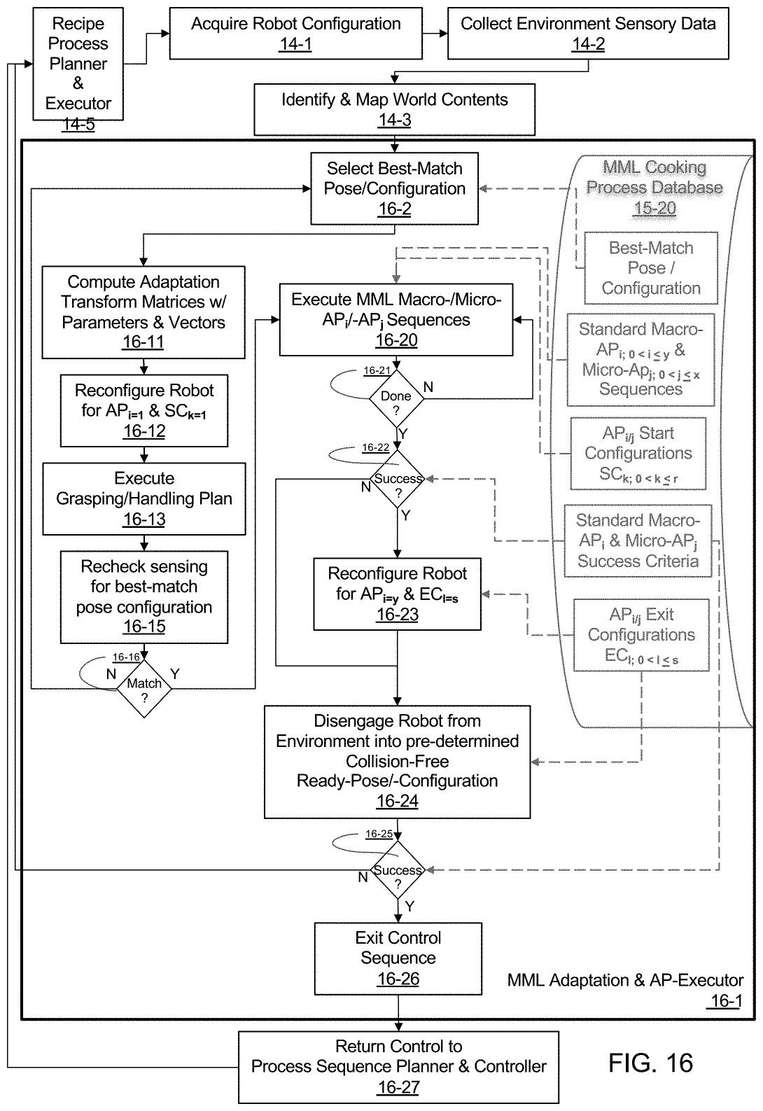

The structure and inputs in FIG. 15 illustrate the influence to the MML Adaptation Parameter Generator 15-1. In order for the robot process sequence planner and controller 16-27 (see FIG. 16) to function properly. A set of key parameters for each cooking sequence need to have been developed. Such parameters can be developed for example through an Etalon model 15-7 that allows a user to generate ideal configuration data to be processed for extractable parameters. A similar process can be used by way of a teach playback 15-8 method, allowing for the generation and extraction of the same parameters. It is further possible to have humans manually encode 15-9 these parameters based on a series of pre-computed parameters carried out offline and manually. Lastly it is possible to have a master chef carry out a set of cooking and recipe generation steps that a computer system 15-10 can monitor and abstract into key sequences with same such parameters being generated. Such parameters will be used to define a set of pose configuration candidates 15-2 that serve as templates to match a real-world configuration in order to minimize the search-space for allowable robot configurations. A sequence generator 15-3 is used to generate a set of macro-AP recipe preparation sequences, with each macro-AP having a more detailed set of mini-manipulations defined by a micro-AP generator 15-4. All success criteria 15-5 associated with each macro- and micro-AP step or sequence will also be generated and captured and associated with each of its respective mini-manipulations. Significantly, each macro- and micro-AP will also have a set of start (SC) and exit (EC) configurations associated with it by a dedicated process 15-6, allowing the robotic system to readily transition in and out of each macro- and micro-manipulation step or sequence without requiring a continuous Sense-Interpret-Replan-Act-Resense cycle at each time-step. This is may be a significant distinction, as it implies that mini-manipulations can be carried out almost open-loop, subject of course to their associated success criteria being (measured and) met, thereby dramatically reducing system complexity and cost as well as guaranteeing performance and a successful outcome. The parameters are stored in a temporary database 15-11, allowing for a verification and validation process 15-15 to experimentally verify and validate the accuracy and adequacy of each parameter set, with any needed updates applied prior to finalization 15-16, and being stored in the final MML Cooking Process Database 15-20.

FIG. 16 is a block diagram depicting the actual process steps that form part of an MML Adaptation and AP-execution. The robot configuration in the world is coupled with the sensed environmental data allowing the system to identify, model and map all entities therein. The MML (in this case) Cooking Process Database provides all the needed pre-defined AP-criteria and variables/constants. In the case of a process-step to be performed by the robot, the best-match pose/configuration for the robot configuration and its grasping and -handling steps is selected from the MML Cooking Process Database, proper positioning and process-start configurations are confirmed for all macro- and micro AP-sequences, before the AP process-steps are executed along their pre-defined sequence(s) via standard start and exit configurations for each, without the need for continuous re-imaging (the robot and the environment) and re-computation of process steps (positions/velocities, trajectories, grasping- and handling steps, etc.) via continuously modified transformations based on sensory data at each sampling time-step. Successful MML-defined macro-AP sequences are clear and pre-defined and are responsible for allowing the process sequence to progress until the cooking-sequence is completed, and the robotic system is returned to a pre-determined pose in a collision-free pose, ready for the next process-step. While re-sensing at the conclusion of each macro-AP is possible, the pre-defined macro-/micro structure for all AP-processes allows for execution of each with simple success- and termination-criteria checking, without the need for any massive sensing- and computationally-costly steps at every execution time-step.

The operations within the MML Adaptation and AP-Executor 14-25 are illustrated in FIG. 14. The executor 14-25 relies on a first step carried out by the recipe process planner and executor 14-5 that requests that a set of standard measurement steps be carried out, involving determining the robot configuration 14-1, the state of the workspace and the environment surrounding the robot system 14-2, In order to create a complete world model 14-3 by identifying all objects, modeling them and mapping them within the world. All succeeding steps are thereafter supported by parameter data provided by the MML cooking process database 14-20.

All this data is passed to the configuration matching process 16-2, which performs a best-match between the real-world pose of the system, compared to the possible and acceptable pre-computed and defined process-start configurations. The process 16-2 determines the best-match pose/configuration, allowing it to compute the proper transformation matrices populated by parameters in vectors and matrices provided by MML database 17-3. The controller then reconfigures the robot system in 16-12, by selecting the starting configuration SCₖ₌₁ for the first macro-manipulation step macro-APᵢ₌₁. The system then executes the associated grasping and handling step 16-13, and re-checks its configuration matches the best-match configuration identified in 16-2 in step 16-15. The system then checks for pose-fidelity in step 1616. If the configuration is not within acceptable deviation bounds from the selected pose, the system returns to re-select a different configuration in the best-match configuration selection step 16-2. If however the measured configuration parameters are sufficiently close to the selected pose configuration parameters provided, the system proceeds to execute all succeeding macro-APᵢ and micro-APⱼ steps within the pre-determined sequence(s) provided by the MML cooking process database 17-3. The sequence executor 16-20 is provided by all the parameters for each of the sequential macro-APᵢ sequences and therein contained micro-APⱼ steps, which in turn also have associated with them clearly defined start-configuration parameters SC_{k; 0<k≤r}, and exit-configuration parameters EC_{l; 0<l≤s}.

The execution loop 16-20 is carried out in an open-loop fashion without any need to perform any of the usually-required sense-plan-act loop at every time-step of the high frequency controller, as each of the macro-APᵢ and micro-APⱼ steps have been pre-tested and -verified for successful execution in an open-loop fashion, guaranteeing successful completion with little to no detrimental execution-error accumulations. It is this feature that allows the system to operate with minimal and pre-determined computational load and high execution speeds, with little to no (bounded and acceptable) error accumulation and guaranteed successful completion and outcomes.

In one embodiment, the system calls for a renewed Sense-ID/Model/Map sequence at any time it deems necessary. Such a situation might arise if the recipe execution process is fairly sensitive to particular steps in the recipe requiring the system to check for successful completion of one or more macro-AP steps within the cooking sequence; or it might detect appreciable deviations between measurements of macro-AP completion-states and the required/associated success-criteria that need to be met before proceeding to the next macro-AP step within a particular cooking sequence. The executor could thus be triggered to request another such a Sense-ID/Model/Map sequence through to decide on restarting or reorganizing the cooking sequence by selecting a different macro-AP sequence or re-ordering the original macro-AP sequence it was working with. All this paragraph describes is a potential use of the same process and databases described in our novel approach, and while not explicitly represented in this or any figure, its implementation could readily be envisioned.

The sequence executor 16-20 carries out each macro-APᵢ and micro-APⱼ step and checks for completion 16-21 with a successful outcome 16-22 of the same using the success criteria parameters clearly defined for each macro-AP_{i; 0<i≤y} and micro-AP_{j; 0<j≤x} step. Upon completion of all the required macro- and micro APs, the controller then uses the exit configuration parameters for the last macro-AP_{i=y} and its associated exit configuration ECₗ₌ₛ, to reconfigure the robot in step 16-23 to its completion pose. The controller then proceeds to disengage from any tool/appliance or world-surface into a ready-pose in step 16-24, verifying that the outcome of the cooking sequence meets the defined success criteria in step 16-25. If the outcome is negative, the system returns control to the executor 14-5 with an error to be handled. If successful, the cooking sequence is tagged as complete and the system exits the control sequence and resets any system variables to a completion-status in step 16-27, before again returning control to the overall recipe planner and executor 14-5.

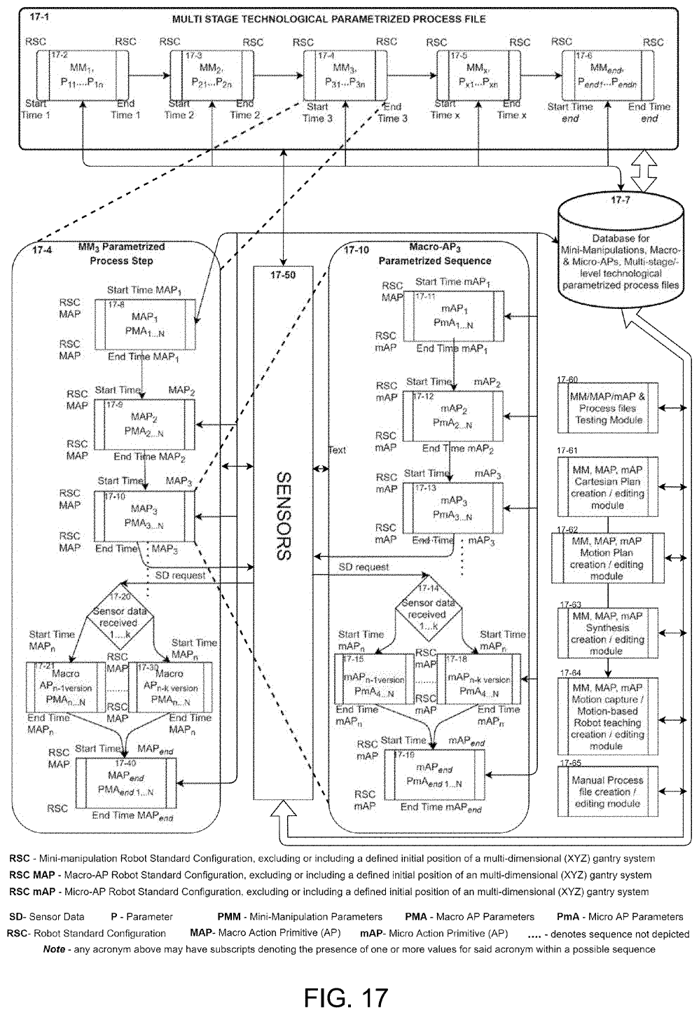

FIG. 17 is a block diagram illustrating a multi-stage parameterized process file 17-1 with the notion of using pre-defined execution steps at the micro- and macro-levels within separate mini-manipulations, by transitioning through pre-defined robot-configurations for each of these steps, thereby avoiding any robot reconfiguration and replanning during the entire process-step execution, as all mini-manipulations consist of pre-computed and -verified starting- and ending robot configurations as part of a their pre-validated execution sequence in accordance with the present disclosure. Specifically, it depicts the process by which a robotically executed task described by a sequence of parameterized process steps described as separate mini-manipulations, is executed in a layered and sequential fashion. It clarifies how an interactive task is described as a set of sequentially executed parameter-defined mini-manipulations with pre-defined starting and ending robot configurations and associated time-stamps, transitioning sequentially into each other through the pre-defined robot configurations. Each of the individual mini-manipulations is in turn partitioned into one or more sequentially-executed Macro-APs with their own respective starting- and ending robot configurations and associated time-stamps. Each of these Macro-APs furthermore may consist of one or more sequentially executed Micro-APs, again each having a set of pre-defined starting- and ending configurations and associated time-stamps. All Macro- and Micro-APs executions are based on real-time sensory data, where the sensory data is used to adaptively search for the next best-match pre-defined Macro- or Micro-AP with its associated started- and ending configurations in its execution sequence, to continue the execution sequence in the overall execution process.

The configuration and execution of a robotic task-command is illustrated in FIG. 17. A central database 17-7 containing all parameters for all mini-manipulations (MM) and associated macro-APs (MAPS) and micro-APs (mAPs) within process files, can be populated and verified through a variety of ways, including but not limited to, a (i) synthetic creation and editing execution module 17-63 operating with a virtual robot and world representation, or (ii) a software module 17-64 capable of creating and editing/modifying abstracted representations as part of a motion-capture or teach-playback process, and (iii) a manual process-file creation module 17-65 where a user or developer can directly shape and input a particular process step or sequence thereto. Separate software modules to perform cartesian motion planning 17-61 and joint-based motion-planning 17-62 generate the path and time-stamp parameters needed to define the starting and ending-configurations and their associated time-stamps. All MM/MAP/mAP steps and sequences within a process file are then also passed through a Testing module 17-60, which validates all the MMs/MAPs/mAPs and their associated parameters, whether through simulation in a virtual world or pre-delivery physical system walk-through. All data describing these MMs/MAPs/mAPS are then stored and made available in the central execution database 17-7 for retrieval in a process-step execution.

The database 17-7 containing the parameterized processes in a variety of digital formats within one or more files, is relied upon to compile and configure a parametrized process file 2000, where the process itself is comprised of one or more mini-manipulations (MM₁ through MM_{end}, numbered 17-2 through 17-6) that are sequentially executed to achieve the desired end-result specified for the specific process or execution sequence. Each MM transitions into the next by way of a pre-defined robot configuration at the end of the preceding MMᵢ, and a pre-defined starting-configuration in the next MMᵢ₊₁, each with a respective time-stamp associated therewith. Real-time sensor data 17-50 is continually used to guide and verify the execution process during the entire process.

In order to highlight the use of task-execution steps by way of mini-manipulations with pre-configured robot-configurations transitions to avoid the need for computationally-slow and -expensive re-planning and reconfiguration, can be seen in a detailed view of a particular mini-manipulation 17-4 within a sequence of a particular process execution file 2000. The mini-manipulation 17-4 is comprised by a sequence of macro-APs (MAPs), each with a particular and pre-defined starting- and ending configuration that is met before the particular MAPⱼ (like MAP2) can either start execution or transition to the next MAPⱼ₊₁ (like MAP3), where the ending-configuration of MAPⱼ (MAP2) will be identical to the starting-configuration of MAPⱼ₊₁(MAP3). Furthermore the sequence of MAPs, shown here as MAP1 through MAP3 labelled as 17-8/17-9/17-10 need not be rigidly pre-defined in database 17-7, but can also be modified within each MM, by using an array of sensory data 17-50 that can be used to optimize the sequence of MAPs at each step of the execution by collecting and using sensory data 17-20 by selecting the next-best MAP option labelled 17-21 through 17-30 to suit the current robot configuration and the next prescribed MAP. This adaptive MAP selection-process is taken in order to minimize and even obviate the need for any robot reconfiguration and replanning despite the presence of errors and uncertainty when executing a robotic task in a real-world environment (as compared to in a simulated or virtual world where all sensory data is without noise or measurement errors, and all executed motions are deprived of any errors due to real-world phenomena, such as friction, slop, wear-and-tear, etc.). It is thus possible to dynamically adapt the sequence of MAPs selected for sequential execution at every time-step between MAPs to best fit a maxim of minimal-to-no reconfiguration at the time-steps in order to improve execution-speed and maximize successful and guaranteed performance execution by using optimal pre-tested and -verified MAPs that best suit the situation at hand.

In order to further highlight that the drive to use pre-verified and -validated execution steps within each sequence, it may be significant to note that each macro-AP, is itself broken down into a sequence of smaller and finer micro-APs (mAPs). As an example, take Macro-AP labelled MAP3 as a parameterized sequence 17-10, shown in this figure again as a sequence of micro-APs APₖ, labelled as 17-11 through 17-13, each again transitioning with pre-defined ending- and starting robot configurations and their associated time-stamps. Again, each micro-AP is executed driven by sensory data 17-50 allowing the system to monitor progress and verify that one mAPₖ transitions with e pre-defined ending configuration which is identical to the succeeding mAPₖ₊₁ starting configuration at a mutual time-stamp instance. As before, the sequence of mAPs need not be rigidly defined by database 17-7, but rather be driven by collection of a suite of sensory data 17-50 at every time-step where transition from one mAPₖ to the next mAPₖ₊₁ occurs, where all received sensory data 17-14 is in turn used to select from an array of pre-defined mAPs labelled 17-15 through 17-18 that best suit the current real-world configuration of the robot system in order to continue the execution of the required mAPs to yield a guaranteed outcome within a deterministic timeframe without the need for reconfiguration and robot motion replanning.

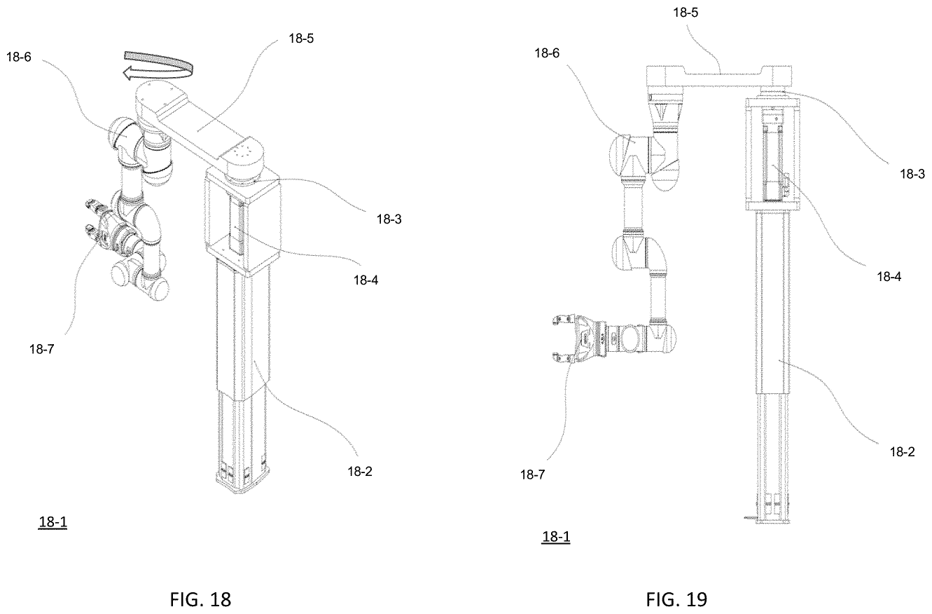

FIG. 18 is a pictorial diagram illustrating a perspective view of a robotic arm platform 18-1 with a robotic arm with one or more actuators and a rotary module, while FIG. 19 is a pictorial diagram illustrating a robotic arm platform with a robotic arm with one or more actuators and a rotary module. The robotic arm platform 18-1 includes a linear actuator 18-2 that can move vertically up and down (e.g., along the z-axis), if positioned upright (or move horizontally if positioned sideway to move from left to right). The linear actuator 18-2 in the robotic arm platform 18-1 extends the reachability of the robotic arm 18-6 (and therefore also extends the reachability of the corresponding robotic end effector). The robotic arm platform 18-1 further includes a rotary module 18-3, coupled to a robotic arm and rotary module interface bracket 18-5, that functions like an actuator to extend the reachability of the robotic arm platform 18-1 around the rotary axis (e.g., along the y-axis).

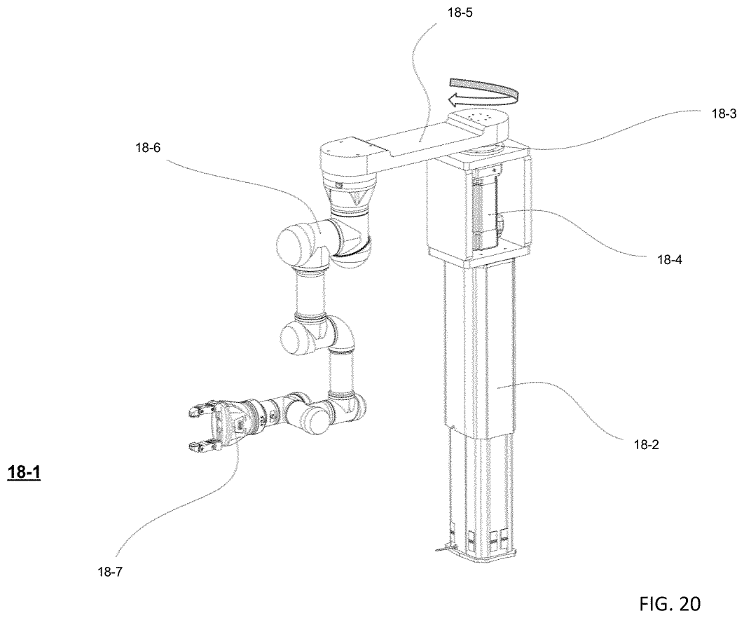

FIG. 20 is a pictorial diagram illustrating another perspective view of the robotic arm platform 18-1 with the robotic arm 18-6, a robotic gripper 18-7, the one or more actuators 1 (such as a linear actuator) and the rotary module 18-3. The robotic arm platform 18-1 includes the linear actuator 18-2 that can move vertically up and down (e.g., along the z-axis), if positioned upright (or move horizontally if positioned sideway to move from left to right). The linear actuator 1 in the robotic arm platform 18-1 extends the reachability of the robotic arm 18-6 (and therefore also extends the reachability of the corresponding robotic end effector). The robotic arm platform 18-1 further includes a rotary module 18-3, coupled to the robotic arm and rotary module interface bracket 18-5, that functions like an actuator to extend the reachability of the robotic arm platform 18-1 around the rotary axis (e.g., along the y-axis).

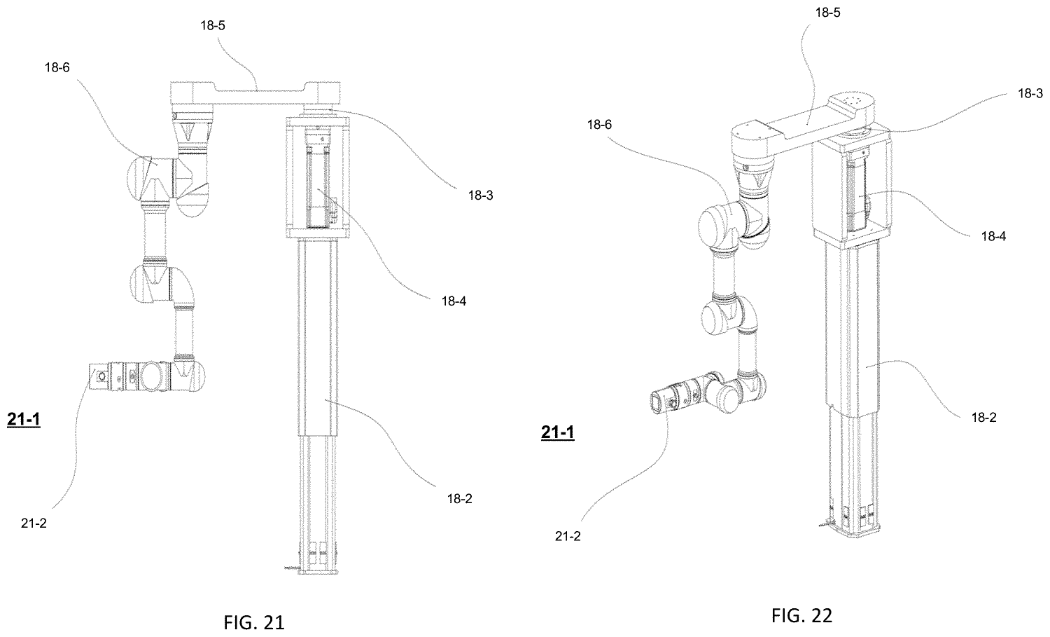

FIG. 21 is a pictorial diagram illustrating a first embodiment of a robotic arm magnetic gripper platform 21-1 including the robotic arm 18-6, a magnetic gripper 21-2, the one or more actuators 18-2 and the rotary module 18-3. The robotic arm magnetic gripper platform 21-1 includes a magnetic gripper 21-2 for attaching to a device, such as an utensil handle, for moving the utensil handle based on the execution of a particular minimanipulation. The linear actuator 18-2 in the robotic arm platform 21-1 extends the reachability of the robotic arm 18-6 and the magnetic gripper 21-2. The rotary module 18-3, coupled to the robotic arm and rotary module interface bracket 18-5, that functions like an actuator to extend the reachability of the robotic arm 18-6 and the magnetic gripper 21-2 (e.g., along the y-axis). FIG. 22 is a pictorial diagram illustrating a perspective view of the first embodiment of robotic arm magnetic gripper platform 21-1 including a robotic arm with the one or more actuators 18-2 and the rotary module 18-3.

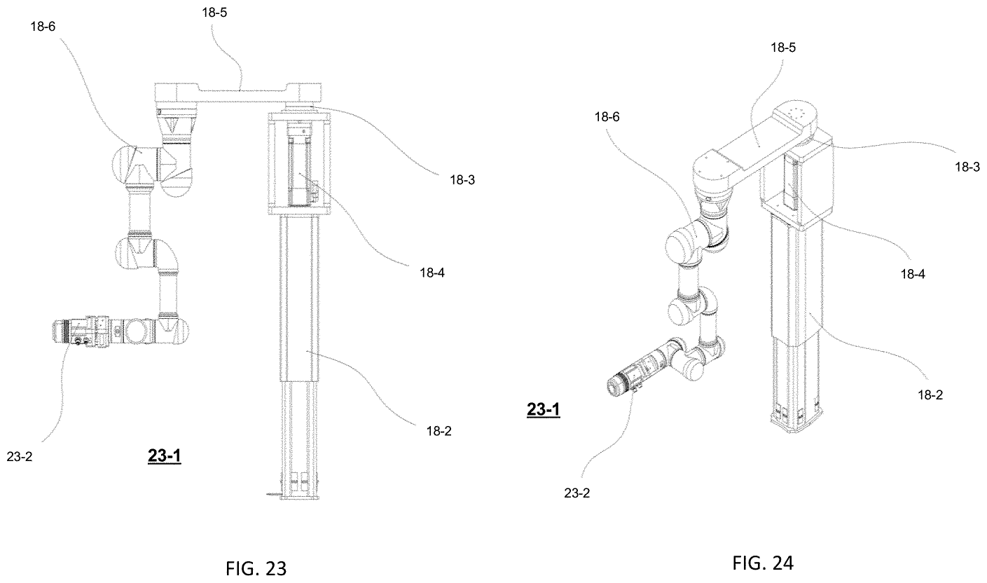

FIG. 23 is a pictorial diagram illustrating a second embodiment of the robotic arm magnetic gripper platform 23-1 including the robotic arm 18-6, the magnetic gripper 23-2, the one or more actuators 18-2 and the rotary module 18-3. FIG. 24 is a pictorial diagram illustrating a perspective view of the second embodiment of the robotic arm magnetic gripper platform 23-1 including the robotic arm 18-6, the magnetic gripper 23-2, the one or more actuators 18-2 and the rotary module 18-3.

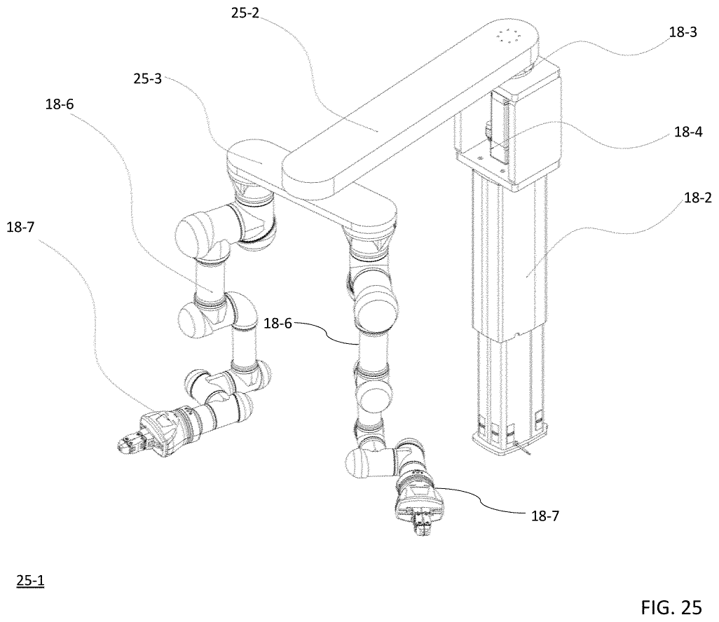

FIG. 25 is a pictorial diagram illustrating a perspective view of a dual robotic arm platform 25-1 with a pair (or a plurality) of the robotic arms 18-6, 18-6 and a pair (or a plurality) of the magnetic grippers 18-7, 18-7, and a rotary module 25-3 for moving the plurality of robotic arms 18-6, 18-6 and the plurality of the magnetic grippers 18-7, 18-7. The linear actuator 18-2 in the robotic arm platform 25-1 extends the reachability of the robotic arms 18-6, 18-6 and the magnetic grippers 18-7, 18-7. The rotary module 25-3, coupled to the robotic arm and rotary module interface bracket 25-2, that functions like an actuator to extend the reachability of the robotic arms 18-6, 18-6 and the magnetic grippers 18-7, 18-7 (e.g., along the y-axis), which can be used to compensate for any physical shift in the robotic kitchen over time.

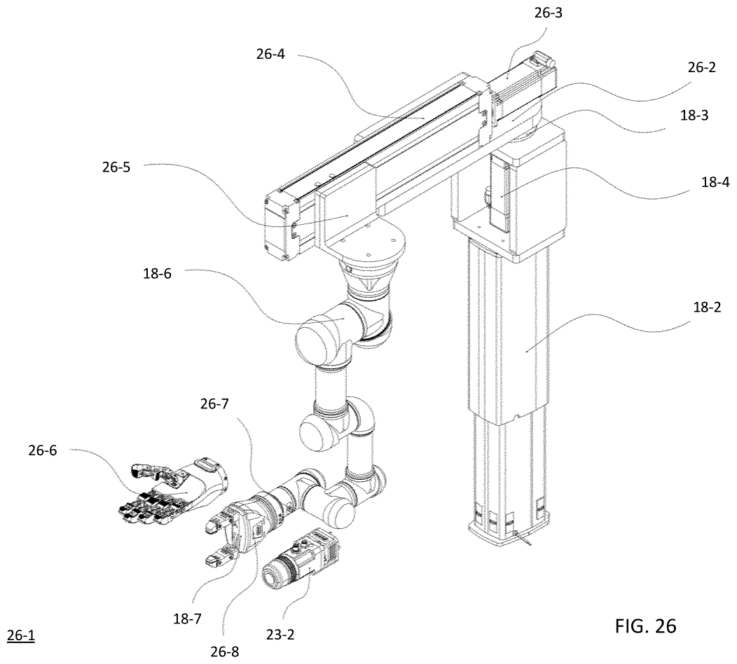

FIG. 26 is a pictorial diagram illustrating a perspective view of the third embodiment of a robotic arm magnetic gripper platform 26-1 with the robotic arm, the magnetic gripper, the one or more actuators and the rotary module, force and torque sensor for robotic arm, and an integrated camera for the robot. The robotic arm magnetic gripper platform 26-1 includes a linear actuary 18-2 for vertical motion (up and down), a rotary module motor 18-4, a rotary module 18-3, a rotary module and horizontal motion drive interface 26-2, a horizontal motion drive motion 26-3, a horizontal motion drive 26-4, a horizontal motion drive and robot arm interface bracket 26-5, a robot arm 26-4, a parallel gripper 18-7, a magnetic gripper 23-2, a robotic end effector (or a robotic hand) 26-6, a force & torque sensor for the robotic arm 26-7, and an integrated camera 26-7 for the robot 26-1. The force and torque sensor for the robotic arm 18-6 for measuring reaction, dynamic or rotary from the robot arm 18-6 or the robotic end effector 26-6 into another physical variable, such as into an electrical signal that can be measured, converted and standardized.

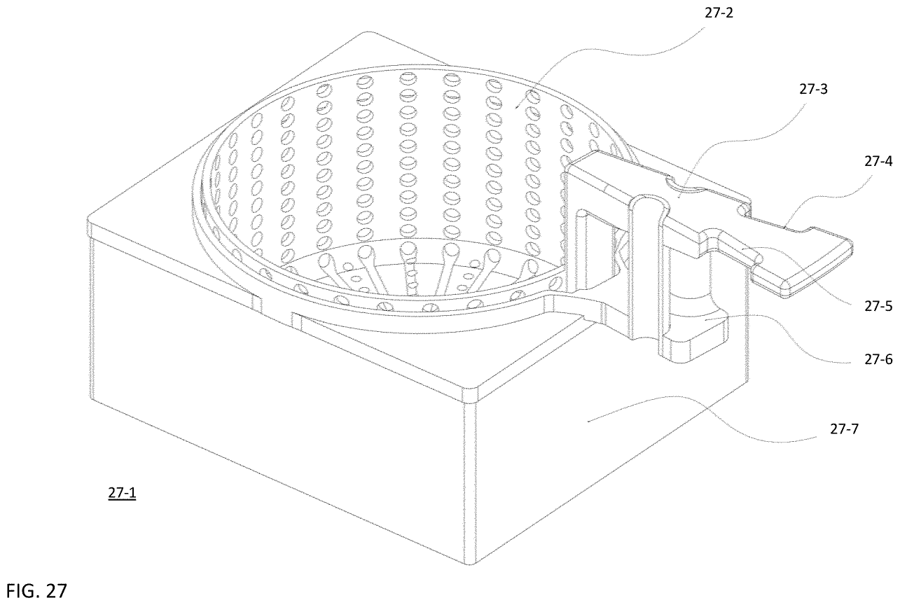

FIG. 27 is a perspective view of a frying basket module 27-1 for use with a round frying module 4. The frying basket module 27-1 includes a frying basket 27-2 that has a frying basket handle 27-3 which has a contour with a right indent 27-4 and a left indent 27-5 with gripping one a robotic end effector. The robotic end effector places the frying basket 27-2 and the frying basket handle 27-3 into a frying basket fixture 27-6 in one fixed position as to fix the bowl in one standard orientation and one particular position, as to ensure that a robotic end effector places and retrieves the frying basket 27-2 and the frying basket handle 27-3 into a frying basket fixture 27-6 from the same fixed position. Although the shape of the frying basket 27-2 (and the corresponding frying module 27-7) is round as illustrated in this embodiment, one of skilled in the art would recognize that other shapes, such as rectangular, square, oval, may be practiced without departing from the spirits of the present disclosure.

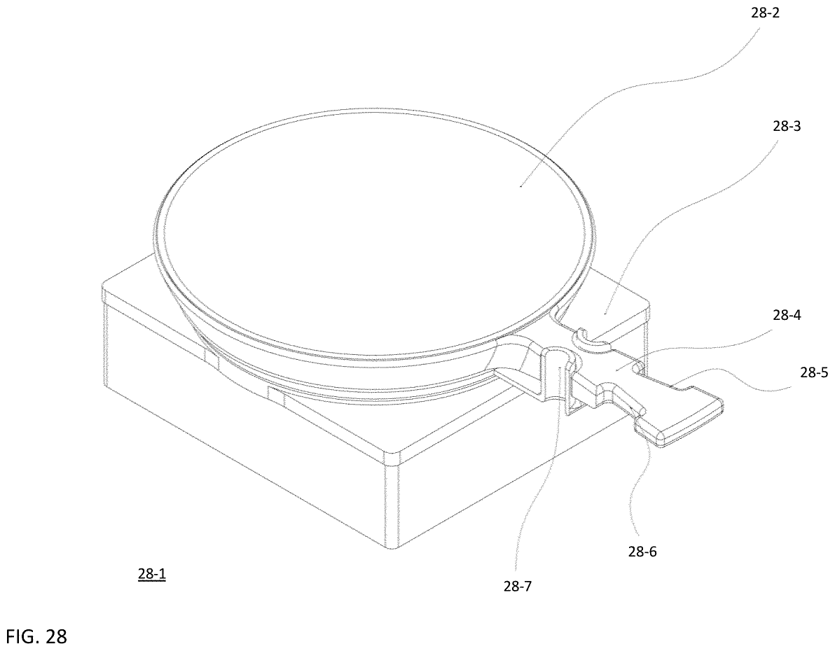

FIG. 28 is a perspective view of a wok 28-1 for use with the round, rectangular, or other robotic module assembly. The wok 28-1 has a wok body 28-2, an induction wok module 28-3, a wok fixture 28-7, and a wok handle 28-4. The induction wok module 28-3 which has a contour with a right indent 28-5 and a left indent 28-6 with gripping one a robotic end effector. The robotic end effector places the wok body 1 and the induction wok module 28-3 into a wok fixture 28-7 in one fixed position as to fix the bowl in one standard orientation and one particular position, as to ensure that the robotic end effector places and retrieves the wok body 28-2 and the induction wok module 28-3 into a wok fixture 28-7 from the same fixed position. The wok body 88 is structured to compensate for a slight movement or a slight displacement of the wok body 28-2 during stirring by a utensil as to remain within a deviation of a single fixed position for a robotic end effector to successfully grip the right indent 28-5 and the left indent 28-6 of the wok handle 28-4. Although the shape of the wok body 28-2 (and the corresponding induction work module 28-3) is round as illustrated in this embodiment, one of skilled in the art would recognize that other shapes, such as rectangular, square, oval, may be practiced without departing from the spirits of the present disclosure.

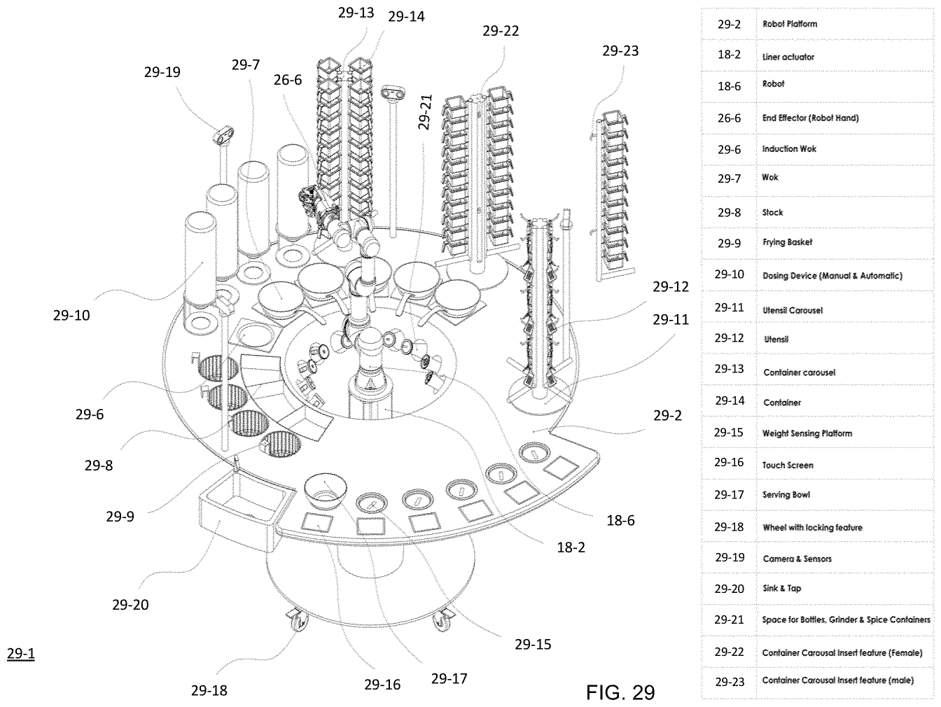

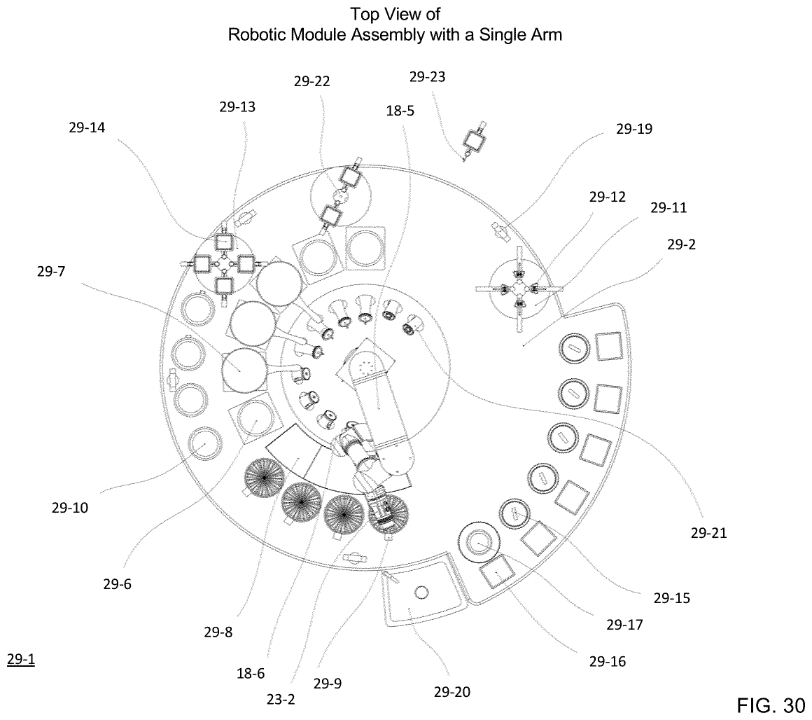

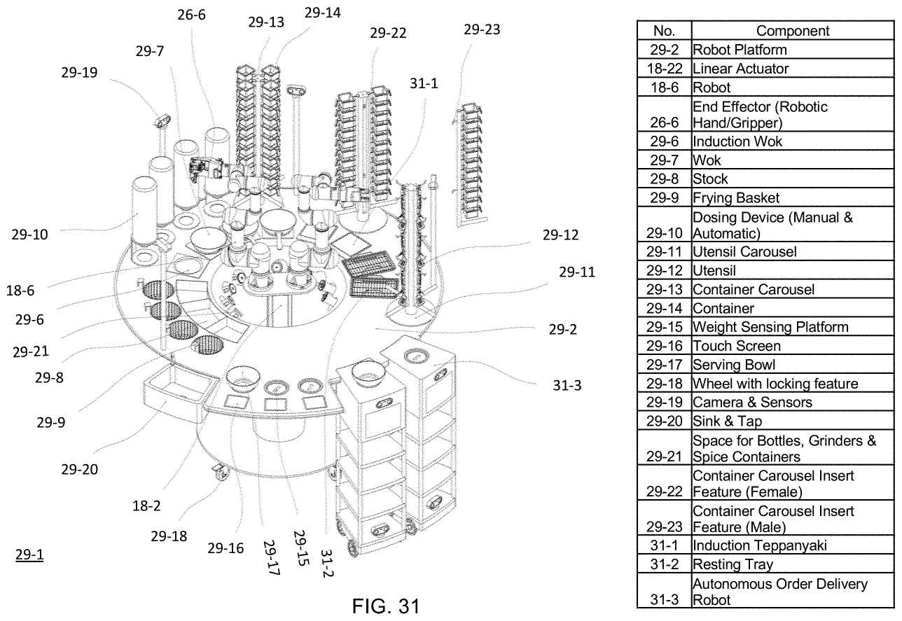

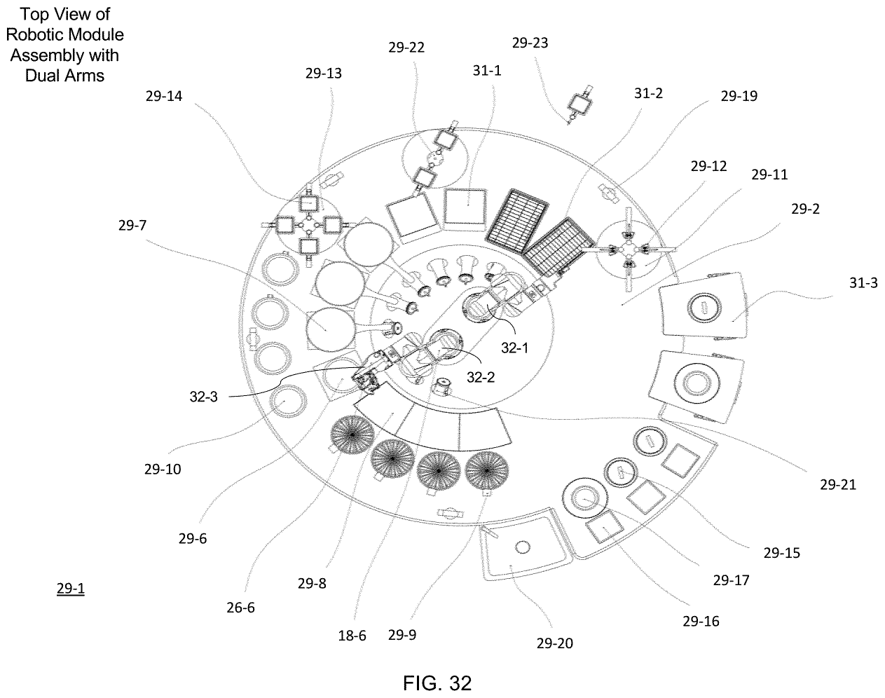

FIG. 29 is a pictorial diagram illustrating an isometric view of a round (or a spheric) robotic module assembly 1700 with a single robotic arm and a single end effector, while FIG. 30 is a pictorial diagram illustrating a top view of a round (or a spheric) robotic module assembly with a single robotic arm and a single end effector. FIG. 31 is a pictorial diagram illustrating an isometric view of a round (or a spheric) robotic module assembly two robotic arms and two end. FIG. 32 is a pictorial diagram illustrating a top view of a round (or a spheric) robotic module assembly with a plurality of robotic arms 29-3a, 29-3b and a plurality end effectors 3c. Reference numbers 29-1 to 29-25 used in FIGS. 29, 30, 31 and 32 are specific to these figures. The robotic module assembly 29-1 comprises a commercial kitchen suitable for restaurant, hotel, shopping malls, other commercial locations, as well as residential usage. The robotic module assembly includes one or more robotic arms and one or more robotic end effector 29-4 for preparing food dishes to customers who are dining at the commercial kitchen. When a customer sits or stand at one location near a touch screen, the customer can select a food dish from among a menu offering a variety of food dishes from a plurality of cooking stations from the commercial kitchen. After the customer has made a food dish selection, the one or more robotic arms and the one or more robotic end effectors moves the ingredients associated with selected food dish from one or more container carousel 29-12, one or more containers 29-13, one or more container carousal insert feature (female) 29-21, and one or more container carousal insert feature (male) 29-22, into a bowl 29-16. A weight sensor 29-14 detects whether a proper weight has been reached that is associated with the selected food dish. If the weight sensor 29-14 detects that a proper weight has been reached that is associated with the selected food dish, the one or more robotic arms and one or more robotic end effector 29-4 moves the bowl 29-16 to one of the cooking stations 06 for cooking the food dish from the received ingredients. The one or more robotic arms and one or more robotic end effector 29-4 retrieves one of the spice containers 29-20, or using an automated dousing devices 29-9, such as an electrical dousing wheel, to add spice flavors, either when the bowl 16 is receiving the ingredients, or when one of the cooking stations 29-6 is cooking the food dish. One of more frying baskets 29-8 can be used to boil food, such as Udon, Ramen, or pasta. A sink 29-19 in the commercial kitchen is for the one or more robotic arms and one or more robotic end effector 29-4 to move the dirty dishes to the sink 19. The robotic module assembly has a plurality of wheels 29-17 for conveniently move the robotic module assembly around, with a locking feature of the plurality of wheels to hold in a steady position. The one or more robotic arms and one or more robotic end effector 4 includes one or more camera or sensor for detecting any ID/bar code on the one more containers 29-13, and inside the one or more containers 29-12. The robotic module assembly also includes an utensil carousel 29-10 for holding a plurality of utensils. One or more stocks 29-7 for placement of flavorful liquids used in the preparation of soups, sauces, stews and others. One or more linear actuators 29-2 in the robotic module assembly is coupled to the one or more robotic arms and one or more robotic end effector 29-4 to extend the x-y-z axis and rotary angles the one or more robotic arms and one or more robotic end effector 29-4. One or more sensors 29-18 in the robotic module assembly comprises a camera sensor, a stereo camera, an infrared camera, a depth camera, a laser sensor, a weight sensor, a motion capture sensor, a pressure sensor, a humidity sensor, a temperature sensor, a magnetic sensor, a haptic sensor, a sound sensor, a light sensor, a force torque sensor, a smell sensor, or a multimodal sensing device, or any combination thereof, for identifying a current kitchen environment in the commercial kitchen on a processor request basis, wherein the current kitchen environment comprises one or more object identifications, positions, orientations, or associated properties including temperature, texture, color, shape, smell or weight. One or more teppanyaki inductions 29-23 is placed in the robotic module assembly for the robot 29-3 to grill the food. One or more rest trays 29-24 is for used to place food in the rest trays. One or more autonomous order delivery robots is stationed in the robotic module assembly for take a food dish from the robotic module assembly and deliver to a specified location, such as an identified customer table. In one embodiment, for safety measures, the one or more robotic arms and one or more robotic end effector 29-4 operates within the dimensions within the robotic module assembly as not to extend to the customer space to cause potential harm.

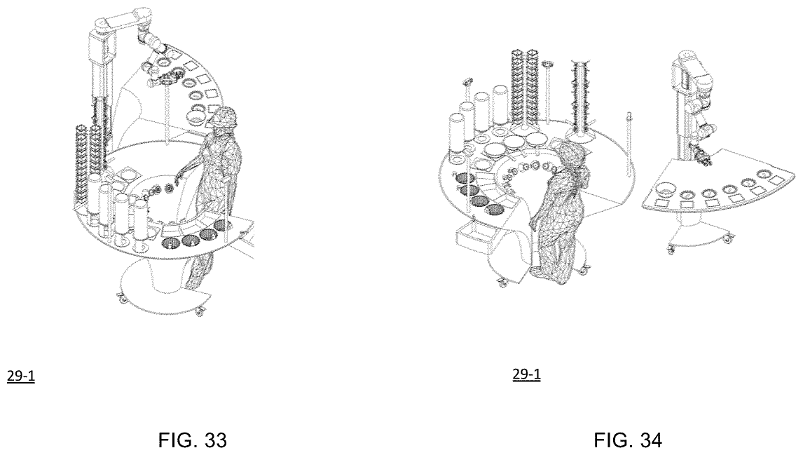

Optionally, the robotic module assembly 29-1 with either the single robotic arm assembly or the dual robotic arms assembly is a movable part, which can be disconnected from the robotic module assembly 29-1, which a human can step in at the place vacated by the single robotic arm or the dual robotic arms. FIG. 33 is a pictorial diagram illustrating an isometric front view of a round (or a spheric) robotic module assembly with two robotic arms and two end effectors which the robot is a moveable portion, while FIG. 34 is a pictorial diagram illustrating an isometric back view of a round robotic module assembly with two robotic arms and two end effectors which the robot is a moveable portion. The moveable robot portion can be moved way from round robotic module assembly which then a human can step in to cook in the round robotic module assembly.

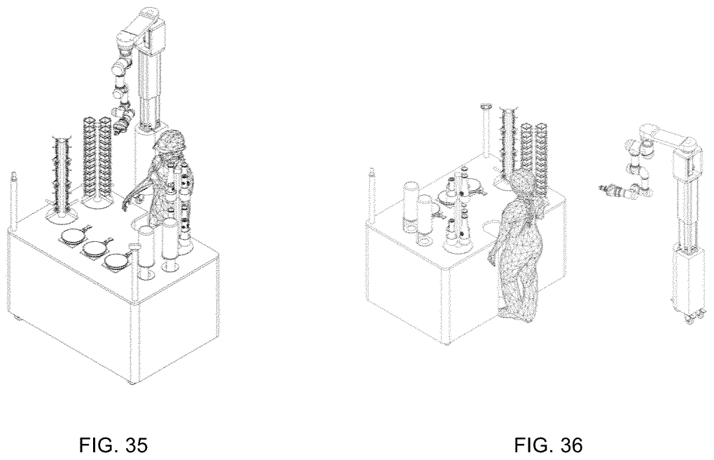

FIG. 35 is a pictorial diagram illustrating an isometric front view of a rectangular robotic module assembly with two robotic arms and two end effectors which the robot is a moveable portion. FIG. 36 is a pictorial diagram illustrating an isometric back view of a rectangular robotic module assembly with two robotic arms and two end effectors which the robot is a moveable portion.

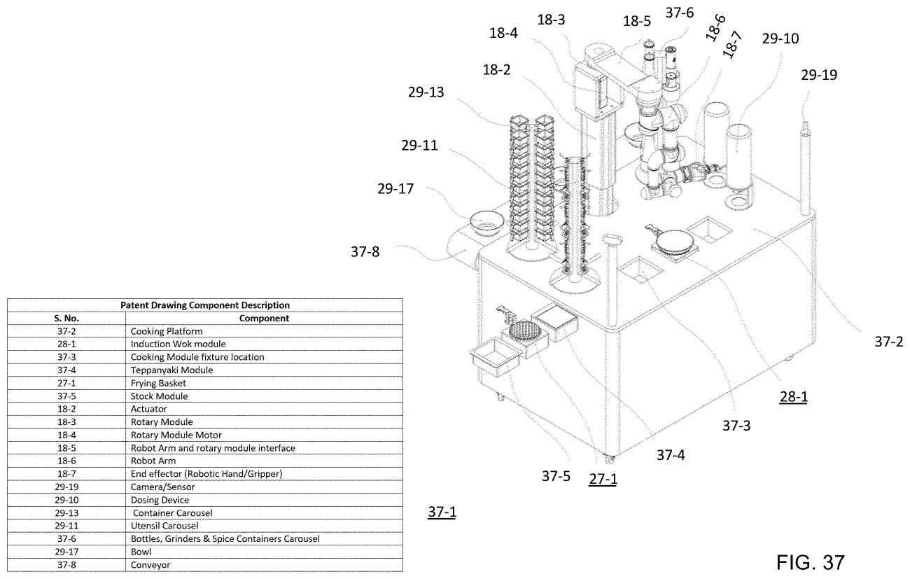

FIG. 37 is a pictorial diagram illustrating an isometric back view of a rectangular robotic module assembly 37-1 with one or more robotic arms and one or more end effectors with the conveyor belt located in the back side of the rectangular robotic module assembly. The rectangular robotic module assembly 37-1 comprise one or more robotic arms, one or more end effectors, a cooking platform 37-2, an induction wok module 28-1, a teppanyaki module 37-4, a frying basket 27-1, a stock module 37-5, a cooking module fixture location 37-3, an actuator 18-2, a rotary module motor 18-4, a rotary module 18-3, a robot arm and rotary module interface 18-5, a robot arm 18-6, an end effector (or a robotic gripper, or a robotic hand) 18-7, a camera or sensor 29-19, a dosing device 29-10, a container carousel 29-13, a utensil carousel 29-11, a bottles, grinders, spice containers carousel 37-6, a bowl 29-17, and a conveyor 37-8. The conveyor 37-8 is used to move a food dish along the robotic module assembly 20. The robotic module assembly (or commercial kitchen) comprises a commercial kitchen suitable for restaurant, hotel, shopping malls, other commercial locations, as well as residential usage. The robotic module assembly includes one or more robotic arms and one or more robotic end effector 18-7 for preparing food dishes to customers who are dining at the commercial kitchen. When a customer sits or stand at one location near a touch screen, the customer can select a food dish from among a menu offering a variety of food dishes from a plurality of cooking stations from the commercial kitchen. After the customer has made a food dish selection, the one or more robotic arms and the one or more robotic end effectors moves the ingredients associated with selected food dish from one or more container carousel 29-13, one or more containers, one or more container carousal insert feature (female), and one or more container carousal insert feature (male), into a bowl 29-17. A weight sensor 29-19 detects whether a proper weight has been reached that is associated with the selected food dish. If the weight sensor 29-19 detects that a proper weight has been reached that is associated with the selected food dish, the one or more robotic arms and one or more robotic end effector 18-7 moves the bowl 16 to one of the cooking stations 37-3 for cooking the food dish from the received ingredients. The one or more robotic arms and one or more robotic end effector 18-7 retrieves one of the spice containers 37-6, or using an automated dousing devices 29-10, such as an electrical dousing wheel, to add spice flavors, either when the bowl 29-17 is receiving the ingredients, or when one of the cooking stations 37-3 is cooking the food dish. One of more frying baskets 27-1 can be used to boil food, such as Udon, Ramen, or pasta. A sink (now shown) in the commercial kitchen is for the one or more robotic arms and one or more robotic end effector 18-7 to move the dirty dishes to the sink 19. The robotic module assembly has a plurality of wheels for conveniently move the robotic module assembly around, with a locking feature of the plurality of wheels to hold in a steady position. The one or more robotic arms and one or more robotic end effector 18-7 includes one or more camera or sensor for detecting any ID/bar code on the one more containers and inside the one or more containers in the containers carousel 37-6. The robotic module assembly also includes an utensil carousel 29-11 for holding a plurality of utensils. One or more stocks 37-5 for placement of flavorful liquids used in the preparation of soups, sauces, stews, and others. One or more linear actuators in the robotic module assembly is coupled to the one or more robotic arms 18-6 and one or more robotic end effector 18-7 to extend the x-y-z axis and rotary angles the one or more robotic arms and one or more robotic end effector 18-7. One or more sensors 29-19 in the robotic module assembly comprises a camera sensor, a stereo camera, an infrared camera, a depth camera, a laser sensor, a weight sensor, a motion capture sensor, a pressure sensor, a humidity sensor, a temperature sensor, a magnetic sensor, a haptic sensor, a sound sensor, a light sensor, a force torque sensor, a smell sensor, or a multimodal sensing device, or any combination thereof, for identifying a current kitchen environment in the commercial kitchen on a processor request basis, wherein the current kitchen environment comprises one or more object identifications, positions, orientations, or associated properties including temperature, texture, color, shape, smell or weight. One or more teppanyaki inductions 37-4 is placed in the robotic module assembly for the robot arm 18-6 and the robot end effector 18-7 to grill the food. One or more rest trays is for used to place food in the rest trays. One or more autonomous order delivery robots is stationed in the robotic module assembly for take a food dish from the robotic module assembly and deliver to a specified location, such as an identified customer table. In one embodiment, for safety measures, the one or more robotic arms and one or more robotic end effector 18-7 operates within the dimensions within the robotic module assembly as not to extend to the customer space to cause potential harm.

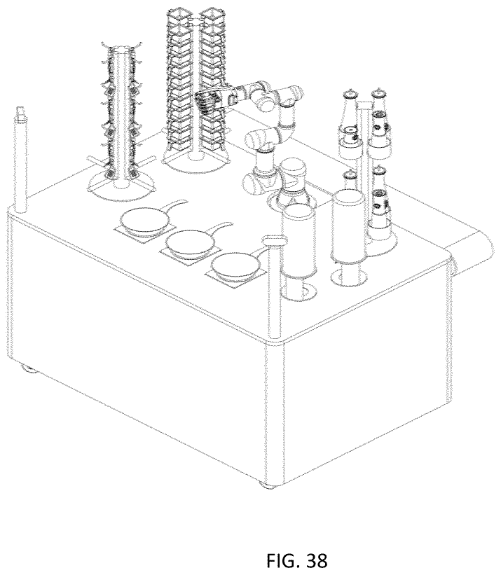

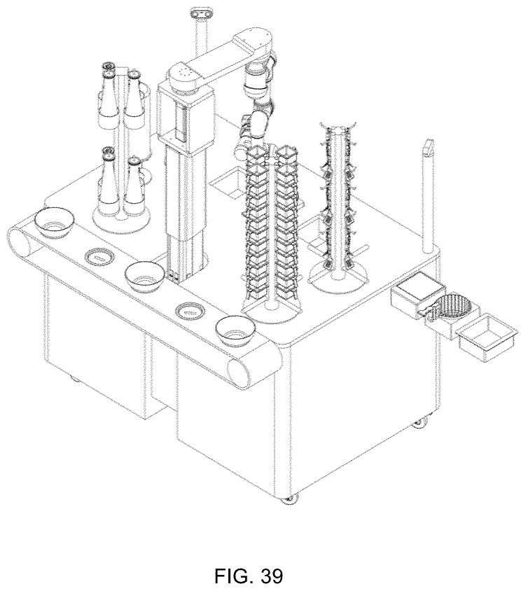

FIG. 38 is a pictorial diagram illustrating an isometric front view of a rectangular robotic module assembly with two robotic arms and two end effectors which the robot is a moveable portion. FIG. 39 is a pictorial diagram illustrating an isometric back view of a rectangular robotic module assembly with two robotic arms and two end effectors which the robot is a moveable portion.

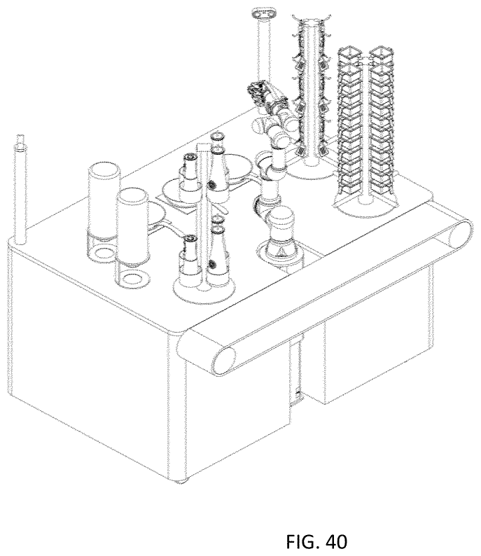

FIG. 40 is a pictorial diagram illustrating an isometric back left view of a rectangular (or a square) robotic module assembly with one or more robotic arms and one or more end effectors with the conveyor belt located in the back side of the rectangular robotic module assembly.

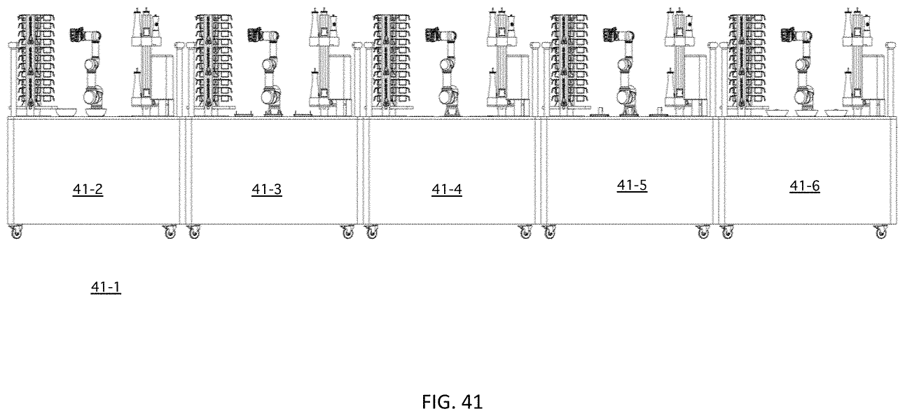

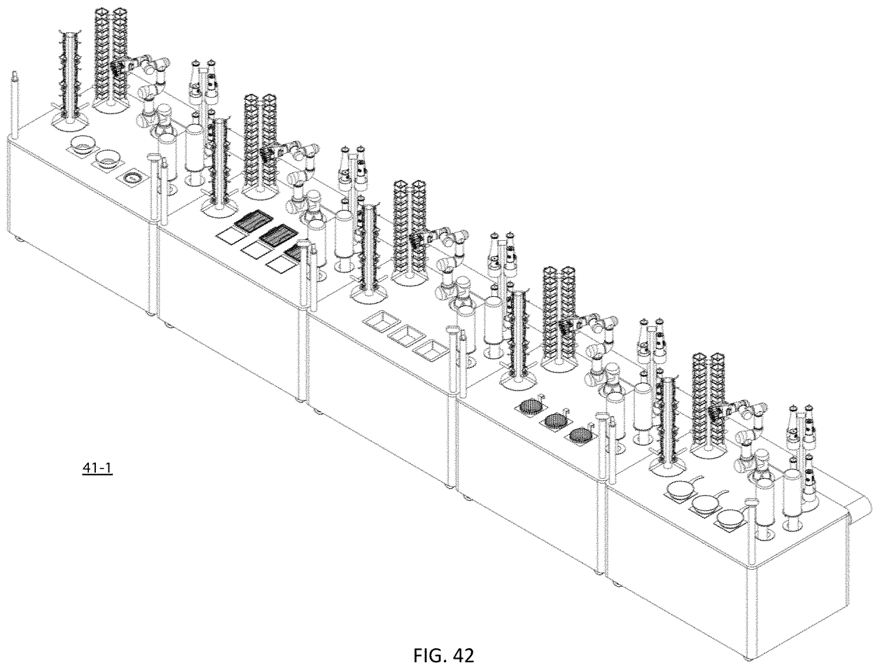

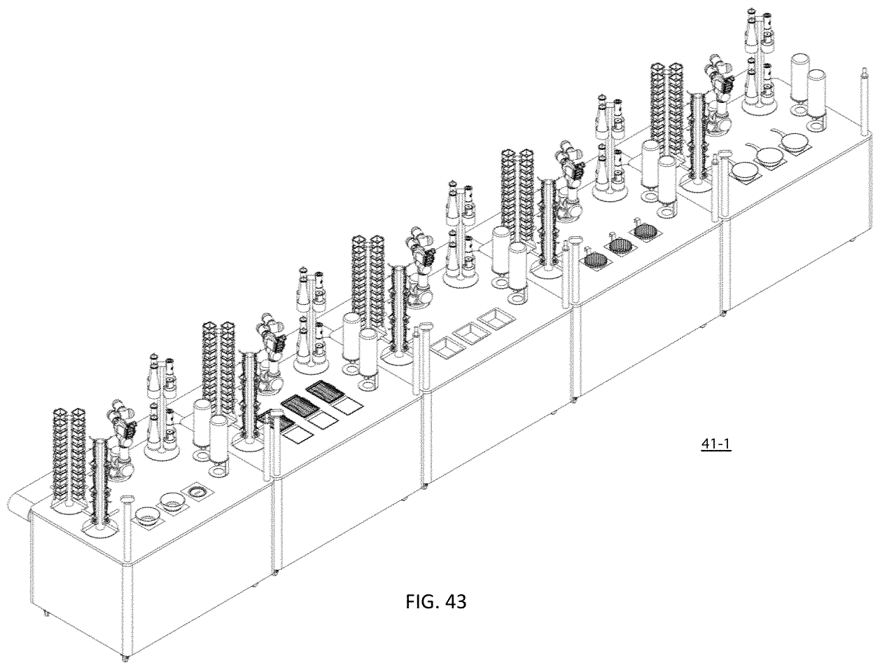

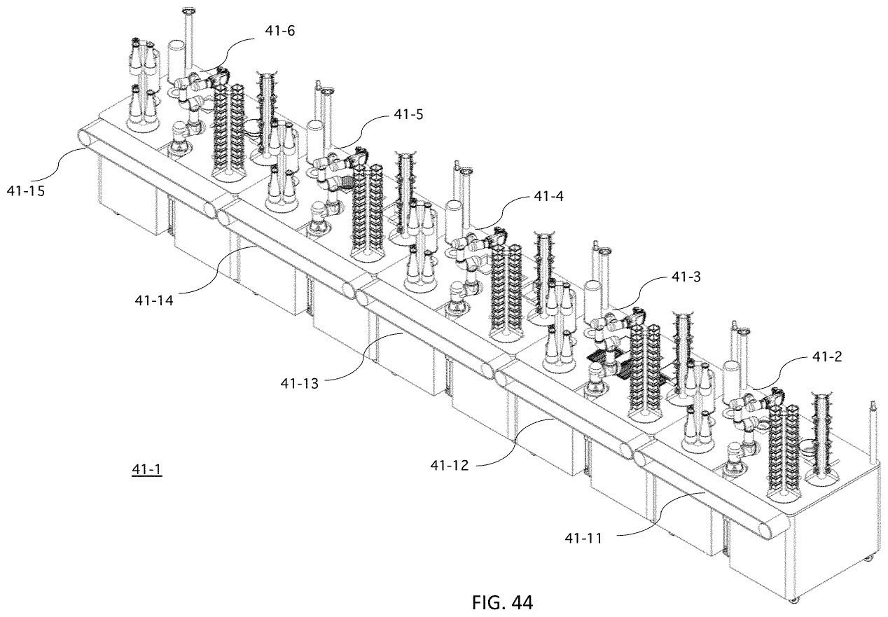

FIG. 41 is a block diagram illustrating a first embodiment of a front view of commercial robotic kitchen with a plurality of robotic module assemblies 41-2, 41-3, 41-4, 41-5, 41-6 that are coupled to operate together collectively, partially or individually. FIG. 42 is a block diagram illustrating the first embodiment of an isometric front right view of a commercial robotic kitchen with a plurality of robotic module assemblies with respect to FIG. 41. FIG. 43 is a block diagram illustrating the first embodiment of an isometric front left view of a commercial robotic kitchen with a plurality of robotic module assemblies with respect to FIG. 41. FIG. 44 is a block diagram illustrating the first embodiment of an isometric back right view of a commercial robotic kitchen with a plurality of robotic module assemblies with respect to FIG. 41. In this embodiment, commercial robotic kitchen 41-1 comprises five multiunit robot module assemblies 41-2, 41-3, 41-4, 41-5, 41-6, which are coupled together in this embodiment, but can also be separated apart. Each of the five multiunit robot module assemblies 41-2, 41-3, 41-4, 41-5, 41-6 has a respective transport system for food, such as conveyor belts 41-15, 41-14, 41-13, 41-12, 41-11, respectively. The overall cooking operations of the plurality of robot module assemblies 41-2, 41-3, 41-4, 41-5, 41-6 can vary depending on the applications. For example, in one operation mode, a restaurant with commercial robotic kitchen may like to set up the commercial robotic kitchen 41-1 to operate collectively (or somewhat collectively) in preparing a food dish at the restaurant. In this instance, each of the robot module assemblies 41-2, 41-3, 41-4, 41-5, 41-6 operates to serve different functions to prepare a dish. For example, the robot module assembly 41-2 prepares a first side dish (e.g., some vegetables), the robot module assembly 41-3 prepares a second side dish (e.g., rice), the robot module assembly 41-4 prepares a third side dish (e.g., mushrooms), the robot module assembly 41-5 prepares to fry an entrée (e.g., Chilean sea bass), and the robot module assembly 41-6 adds sauce on top of the fish. The preparation of the main entrée dish would pass through sequentially on the conveyor belts 41-15, 41-14, 41-13, 41-12, 41-11. At the robot module assembly 41-2, the robot module assembly 41-2 prepares a first side dish and places the first side dish on the conveyor belt 41-15, which moves the dish to the conveyor belt 41-14. The robot module assembly 41-3 prepares the second side dish and places the second side dish on the conveyor belt 41-14, which moves the dish to the conveyor belt 41-13. The robot module assembly 41-4 prepares the third side dish and places the third side dish on the conveyor belt 41-13, which moves the dish to the conveyor belt 41-12. The robot module assembly 41-5 prepares the main dish and places the main dish on the conveyor belt 41-12, which moves the dish to the conveyor belt 41-11. The robot module assembly 41-6 prepares the sauce and add the sauce over the entrée on the dish on the conveyor belt 41-6, which moves the completed dish to a station.

In one embodiment, each of the plurality of robotic module assemblies 41-2, 41-3, 41-4, 41-5, 41-6 has a conveyor belt on the back side of the robot (or the robotic arm). In another embodiment, the plurality of robotic module assemblies 41-2, 41-3, 41-4, 41-5, 41-6 have one or more ordering stations, wherein the one or more ordering stations have conveyor belts on the front as well as on the back side. In some embodiment, the conveyor belts have slots which a user can place his or her bowl while ordering the food.

The commercial robotic kitchen 41-1 comprising the plurality of robotic module assemblies 41-2, 41-3, 41-4, 41-5, 41-6 that are coupled to operate together can be programmed and operate in different modes. In a first mode, the five robotic module assemblies 41-2, 41-3, 41-4, 41-5, 41-6 operate collectively together to prepare one food dish. Each of the robotic module assemblies 41-2, 41-3, 41-4, 41-5, 41-6 can be loaded with software containing a set of minimanipulations that serves as a respective set of standard functions, such as the robotic module assembly 41-2 containing a first set of standard functions and a corresponding first set of minimanipulations, the robotic module assembly 41-3 containing a second set of standard functions and a corresponding second set of minimanipulations, the robotic module assembly 41-4 containing a third set of standard functions and a corresponding third set of minimanipulations, the robotic module assembly 41-5 containing a fourth set of standard functions and a corresponding fourth set of minimanipulations, and the robotic module assembly 41-6 containing a fifth set of standard functions and a corresponding fifth set of minimanipulations. In a second mode, the five robotic module assemblies 41-2, 41-3, 41-4, 41-5, 41-6 can divide up the cooking operations which some of the robotic module assemblies 41-2, 41-3, 41-4, 41-5, 41-6 collaborate together on a food dish, while some other robotic module assemblies 41-2, 41-3, 41-4, 41-5, 41-6 operate independently on a food dish.

The robotic module assemblies 41-2, 41-3, 41-4, 41-5, 41-6 can be customized to tailored to a specific operating food environment, while may maintain the multi-stage cooking process by putting a plurality of robotic module assemblies to operate in a particular food provider environment, such as a restaurant, a restaurant in a hotel, a restaurant in a hospital, a restaurant at an airport, and other environments.

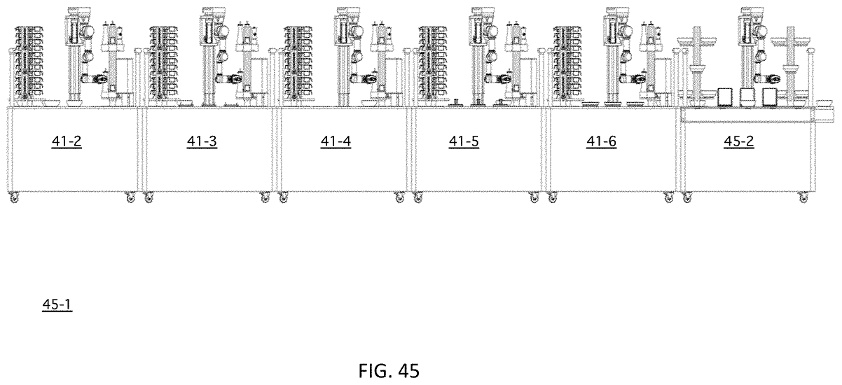

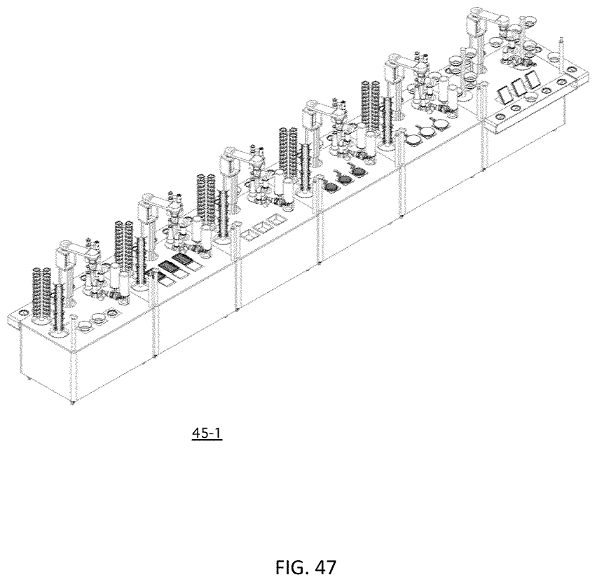

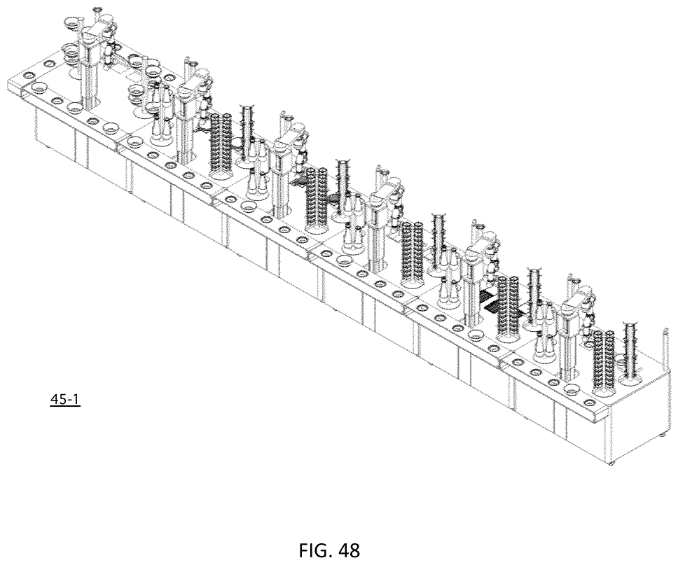

FIG. 45 is a block diagram illustrating a second embodiment of a front view of commercial robotic kitchen 45-1 with a plurality of robotic module assemblies 41-2, 41-3, 41-4, 41-5, 41-6 with an end robotic module assembly 954 with a front side conveyor belt and a back side conveyor belt. FIG. 45-1 is a block diagram illustrating the second embodiment of an isometric front right view of commercial robotic kitchen 45-1 assembly 954 with a front side conveyor belt and a back side conveyor belt with respect to FIG. 45. FIG. 47 is a block diagram illustrating the second embodiment of an isometric front left view of commercial robotic kitchen 45-1 with the plurality of robotic module assemblies 41-2, 41-3, 41-4, 41-5, 41-6 with an end robotic module assembly 954 with a front side conveyor belt and a back side conveyor belt with respect to FIG. 45. FIG. 48 is a block diagram illustrating the second embodiment of an isometric back view of commercial robotic kitchen 45-1 with the plurality of robotic module assemblies 41-2, 41-3, 41-4, 41-5, 41-6 with an end robotic module assembly 45-2 with a front side conveyor belt and a back side conveyor belt with respect to FIG. 41. Reference numbers 1-28 used in FIGS. 45, 46, 47, 48 are specific to these figures.

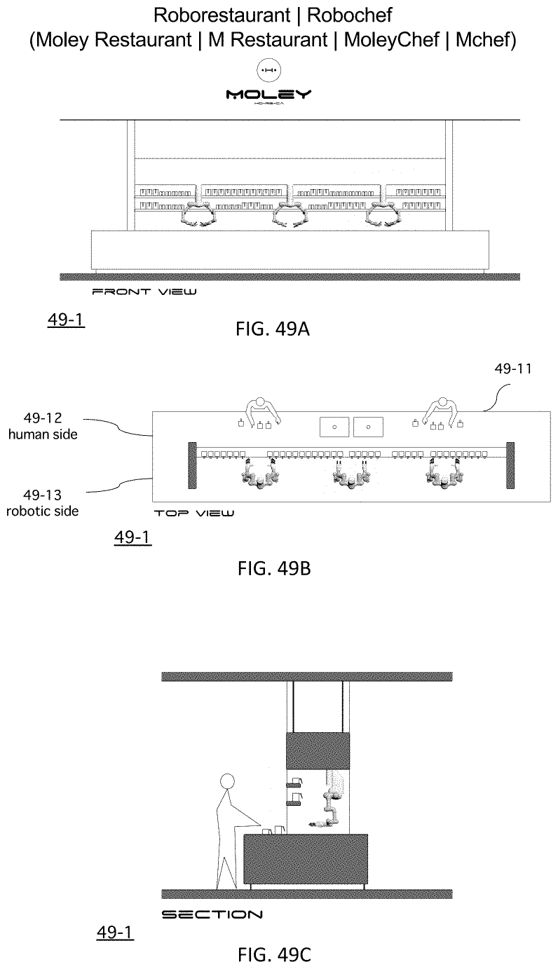

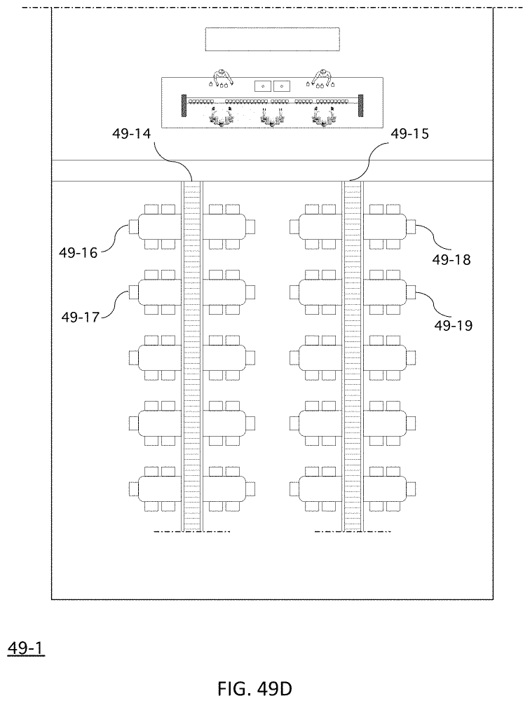

FIGS. 49A-D are block diagrams illustrating the various layouts of a commercial robotic kitchen 49-1 including a front view in FIG. 49A, a top view in FIG. 49B, and a sectional view in FIG. 49C. For additional information in illustrating one embodiment of the process steps applicable to FIGS. 49A-D, see FIG. 2B and the corresponding description in U.S. non-provisional patent application Ser. No. 17/120,221 entitled “Robotic Kitchen Hub Systems and Methods for Minimanipulation Library Adjustment and Calibrations of Multi-Functional Robotic Platforms for Commercial and Residential Environments with Artificial Intelligence and Machine Learning,” filed 13 Dec. 2020, which is incorporated herein by reference in its entirety. FIG. 49D shows the commercial robotic kitchen 49-1 and a plurality of tables 49-16, 49-17, 49-18, 2110d and so on. The commercial robotic kitchen 49-1 has a cooking area 49-11 which is arranged with humans working on a first side 2014 of the cooking area 49-11 and the robots working on a second side 986 of the cooking area 49-11. The humans and the robots are working together to prepare food dishes in a restaurant. For example, the human side 49-12 can cut some customized ingredients and pass the customized ingredients to the robotic side 49-13 to prepare food or cook. In one embodiment, the commercial robotic kitchen 49-1 has a conveyor 49-14 for the robotic to distribute the prepared dishes to customers 49-16, 49-17, and a conveyor 49-15 for the robotic to distribute the prepared dishes to customers 49-18, 49-19. In the commercial robotic kitchen 49-1, either the robot or a human can serve as a host of the recipe in preparing a food dish. If the human serves as a host, the robot executes a minimanipulation based on a human command. If the robot serves as a host, the human executes based on one or more commands from the robot. For example, when a recipe may require a hand dexterity (or fingers dexterity) that is more complicated than a robotic end effector is able to perform, the robot serves as a host and delegates one or more specific complex tasks to the human and when (as to the timing in a recipe) to delegate to the human, such as making sushi, making ravioli, or cutting vegetables, which could be as part of a prep stage of a recipe. After the human finishes cutting the vegetables, the human places into a container and passes the container for the robot. The robot then continues with cooking the recipe, as the robot is able to precise on the execution timing of the recipe, the sequence of the operations or minimanipulations, and/or the precise duration of the cooking. The robot would then serve as the host and responsible for managing the recipe, with a possible support from the human. With the human serves to support the robot, the robot can then cook a complex or a very complex recipe, with assistance from the human. Also, for a human that is not great at cooking, the human can simply do some prep food work or handle some simple tasks, such as cutting vegetable, which the robot then be able to execute and prepare a complex dish. The robot can also conduct cooking in parallel on multiple dishes at the same time, which the robot can simultaneous manages the timing, adding ingredients, cooking actions, for the multiple dishes simultaneously, to ensure perfect execution and perfect timing in preparing the multiple dishes without errors.

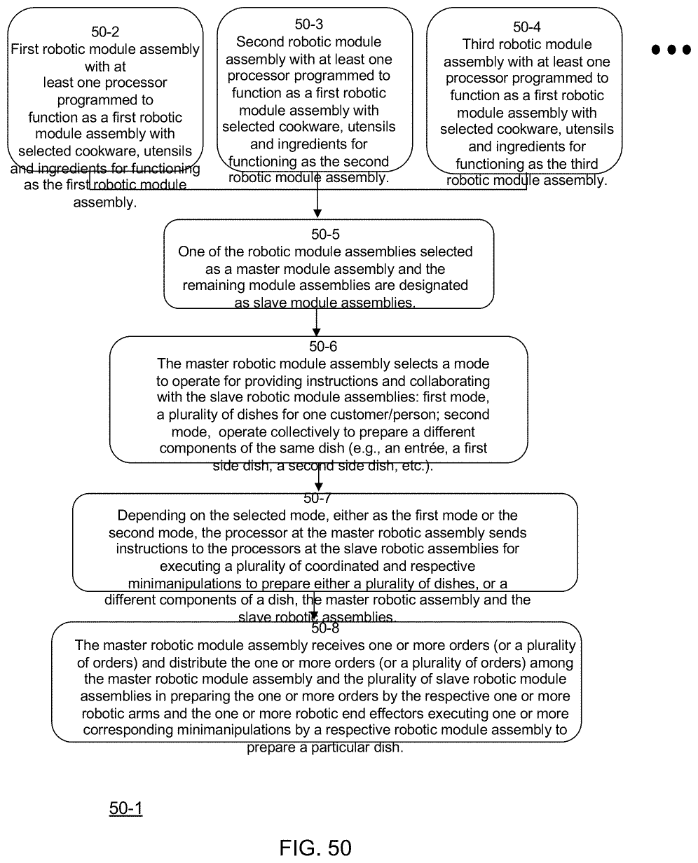

FIG. 50 is a flow chart 50-1 illustrating the process of steps in operating a commercial robotic kitchen with the plurality of robotic module assemblies 41-2, 41-3, 41-4, 41-5, 41-6 and the end robotic module assembly 954. At step 50-2, a processor 182-2 programs the first robotic module assembly to function as a first robotic module assembly with selected cookware, utensils and ingredients for functioning as the first robotic module assembly. At step 50-3, the processor 182-2 programs the second robotic module assembly to function as a first robotic module assembly with selected cookware, utensils and ingredients for functioning as the second robotic module assembly. At step 50-4, the processor 182-2 programs third robotic module assembly to function as a first robotic module assembly with selected cookware, utensils and ingredients for functioning as the third robotic module assembly. At step 50-5, the processor 182-2 selects one of the robotic module assemblies as a master module assembly and the remaining module assemblies are designated as slave module assemblies. At step 50-6, the processor 182-2 selects a mode for the master robotic module assembly to operate for providing instructions and collaborating with the slave robotic module assemblies: first mode, a plurality of dishes for one customer/person; second mode, operate collectively to prepare a different components of the same dish (e.g., an entrée, a first side dish, a second side dish, etc.). At step 50-7, depending on the selected mode, either as the first mode or the second mode, the processor 182-2 at the master robotic assembly sends instructions to the processors at the slave robotic assemblies for executing respective minimanipulations to prepare either a plurality of dishes, or a different components of a dish, the master robotic assembly and the slave robotic assemblies. At step 50-8, the processor 182-2 at the master robotic module assembly receives one or more orders (or a plurality of orders) and distribute the one or more orders among the master robotic module assembly and the plurality of slave robotic module assemblies in preparing the one or more orders by the respective one or more robotic arms and the one or more robotic end effectors executing one or more corresponding minimanipulations by a respective robotic module assembly to prepare a particular dish.

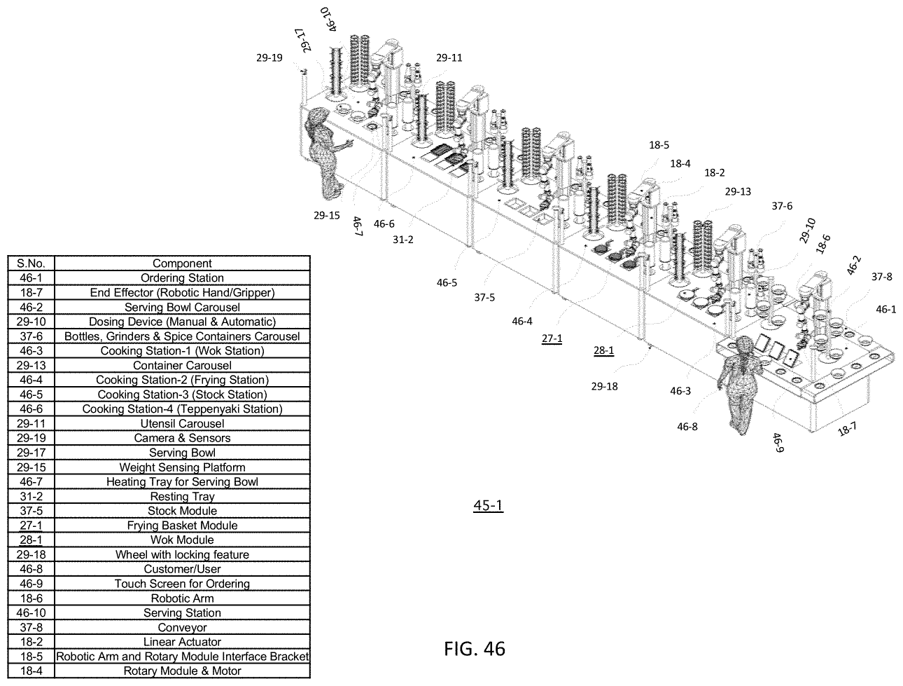

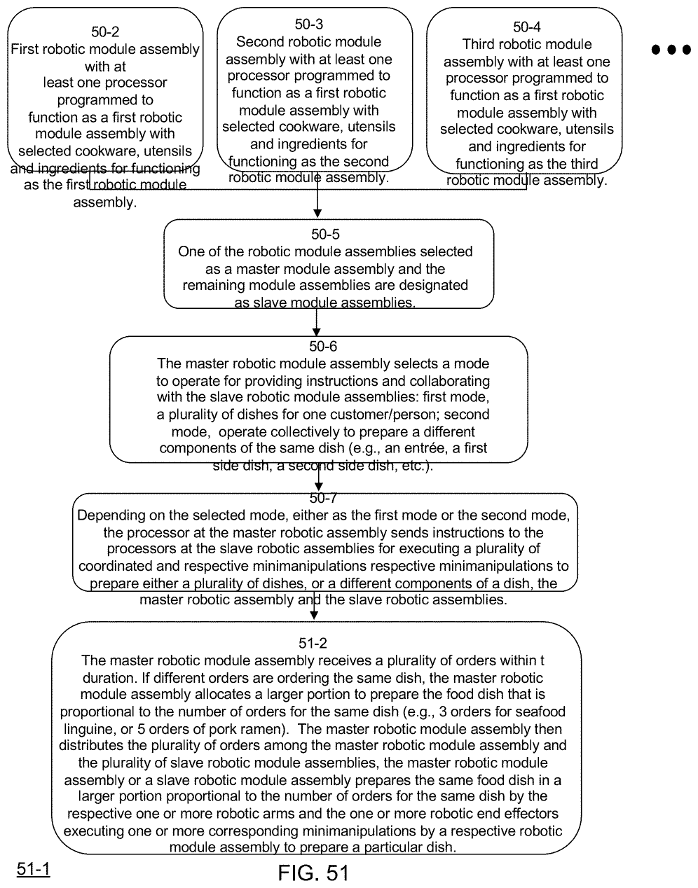

FIG. 51 is a flow chart 51-1 illustrating a second embodiment of the process of steps in operating a commercial robotic kitchen with the plurality of robotic module assemblies 41-2, 41-3, 41-4, 41-5, 41-6 with a master robotic module assembly or a slave robotic module assembly preparing a plurality of orders for the same dish in a larger portion at the same time. The process steps 50-2, 50-3, 50-4, 50-5, 50-6. 50-7 are similar to FIG. 46. At step 50-8, the processor 182-2 The master robotic module assembly receives a plurality of orders within t duration. If different orders are ordering the same dish, the master robotic module assembly allocates a larger portion to prepare the food dish that is proportional to the number of orders for the same dish (e.g., 3 orders for seafood linguine, or 5 orders of pork ramen). The master robotic module assembly then distributes the plurality of orders among the master robotic module assembly and the plurality of slave robotic module assemblies, the master robotic module assembly or a slave robotic module assembly prepares the same food dish in a larger portion proportional to the number of orders for the same dish by the respective one or more robotic arms and the one or more robotic end effectors executing one or more corresponding minimanipulations by a respective robotic module assembly to prepare a particular dish.

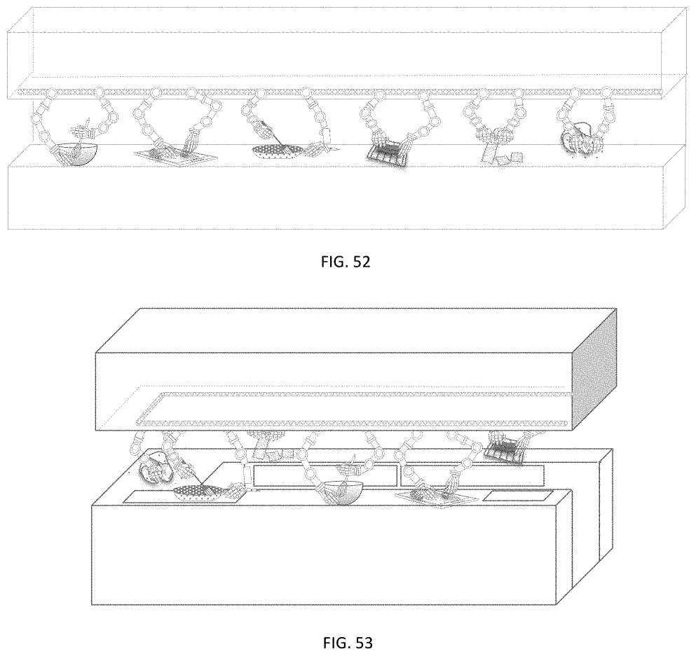

FIG. 52 is a block diagram illustrating one embodiment of a commercial robotic kitchen with a plurality of cooking stations line suitable for restaurants, hotels, hospitals, offices, academic institutions and work places. Multiple sets of a dual-arm (or a pair of robotic arms) and corresponding end effectors are arranged in a linear cooking line, which each pair of robotic arms serve as a station. FIG. 53 is a block diagram illustrating one embodiment of a commercial robotic kitchen with an open kitchen suitable for restaurants, hotels, hospitals, offices, academic institutions and work places in accordance with the present disclosure. Each station with a pair of robotic arms can be programmed to perform a different set of minimanipulations, or some pair of the robotic arms can operate collectively to perform a set of minimanipulations to carry out a food dish or a plurality of food dishes jointly.

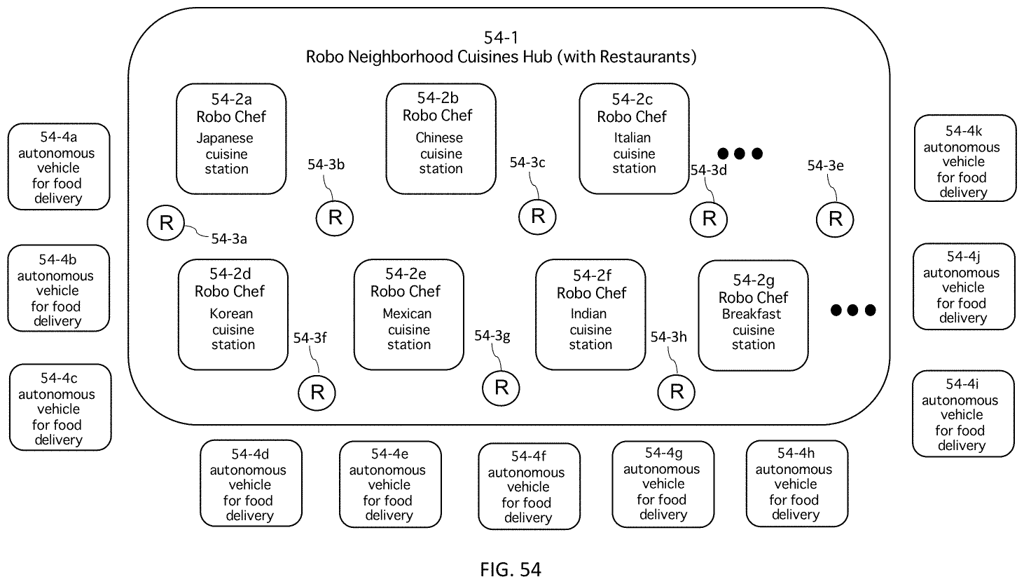

FIG. 54 is a block diagram illustrating a robo neighborhood cuisines hub 54-1 with a plurality of robot module assemblies (or robot chefs) 54-2a, 54-2b, 54-2c, 54-2d, 54-2e, 54-2f, 54-2g, a plurality of transport robots 54-3a, 54-3b, 54-3c, 54-3d, 54-3e, 1804f, 1804g, 1804h, that transport the food dishes prepared by the robo chefs and move the food dishes to the autonomous vehicles (or robotaxi) for deliveries of the food dishes to the customers in accordance with the present disclosure. The robo neighborhood cuisines hub 54-1 provides different types of cuisines restaurant at a particular neighborhood which (1) a plurality of robo chefs, where each robo chef prepares a particular type of cuisine, such as the robo chef Japanese cuisine station (or Japanese cuisine restaurant) 54-2a, the robo chef Chinese cuisine station 54-2b, the Italian cuisine station 54-2c, the robo chef Korean cuisine station 54-2d, the robo chef Mexican cuisine station 54-2e, the robo chef Indian cuisine station 54-2f, the robo chef breakfast cuisine station 54-2g, etc., (2) the plurality of robotic transports 54-3a, 54-3b, 54-3c, 54-3d, 54-3e, 1804f, 1804g, 1804h that transport the food dishes prepared by the robo chefs and move the food dishes to a plurality of autonomous vehicles 54-4a, 54-4b, 54-4c, 54-4d, 54-4e, 54-4f, 54-4g, 54-4h, 54-4i, 54-4j, 54-4k for deliveries of the food dishes to the customers in the neighborhood or a defined geography or an identified cities or counties. Each transport (from the plurality of robotic transports 54-3a, 54-3b, 54-3c, 54-3d, 54-3e, 1804f, 1804g, 1804h) would move one or more dishes from a particular robo chef cuisine station (from the robot module assemblies 54-2a, 54-2b, 54-2c, 54-2d, 54-2e, 54-2f, 54-2g) to a particular autonomous vehicle for delivery to a particular customer based on the food order that has been placed with the robo neighborhood cuisines hub 54-1.

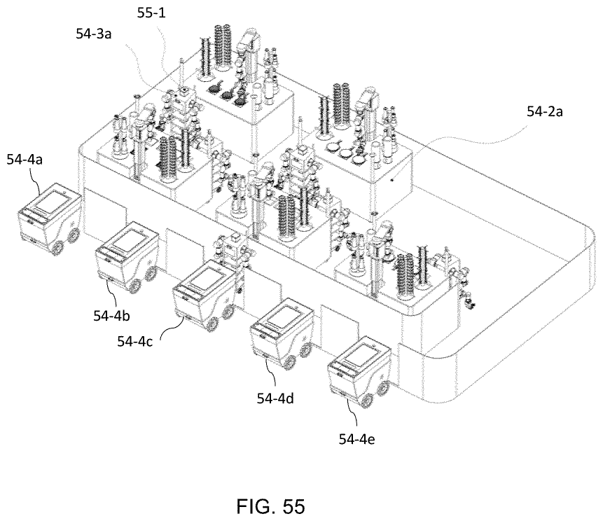

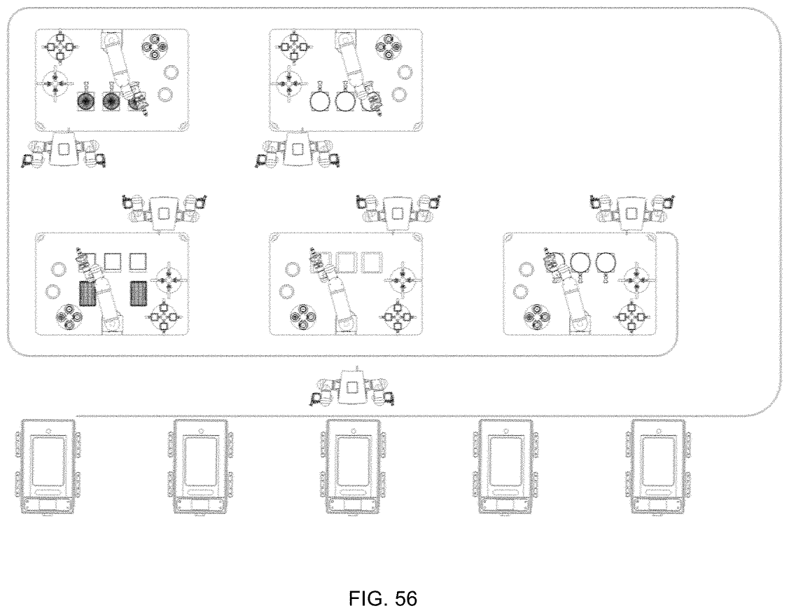

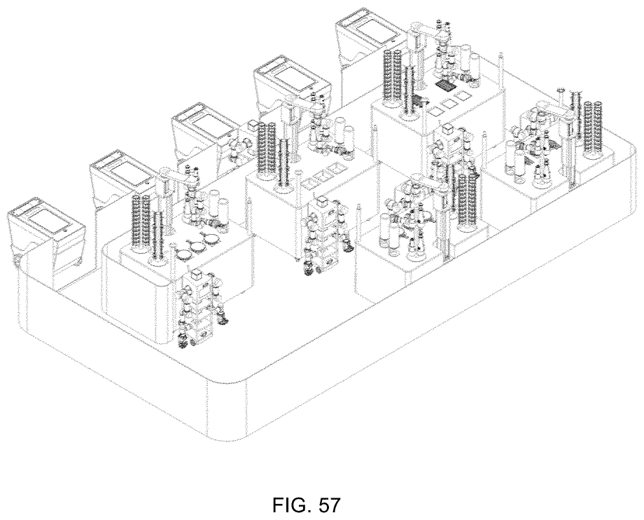

FIG. 55 is a block diagram illustrating an isometric view of the robo neighborhood cuisines hub 54-1 with a plurality of robot chefs and a plurality of transport robots with respect to FIG. 54. FIG. 56 is a block diagram illustrating a top view of the robo cuisines hub with a plurality of robot chefs and a plurality of transport robots with respect to FIG. 54. FIG. 57 is a block diagram illustrating a back view of the robo cuisines hub with a plurality of robot chefs and a plurality of transport robots with respect to FIG. 54. The robo chef cooking station 54-2a prepared one or more food dishes and place the prepared food in a packaged food container 55-1, which the food transport robot 54-3a then move the packaged food container 55-1 to the autonomous vehicle 1806 to delivery the packaged food container 55-1 to a particular customer. The autonomous vehicle 1806 as illustrated here is just one example of a simple autonomous vehicle. The use of autonomous vehicle can be expanded to an automobile or a truck which drives on the road or highway to delivery the prepared food to the customer.

In another embodiment, the robo neighborhood cuisines hub 54-1 can be applied a food court at a shopping mall, at an office restaurant, at a hospital, etc.

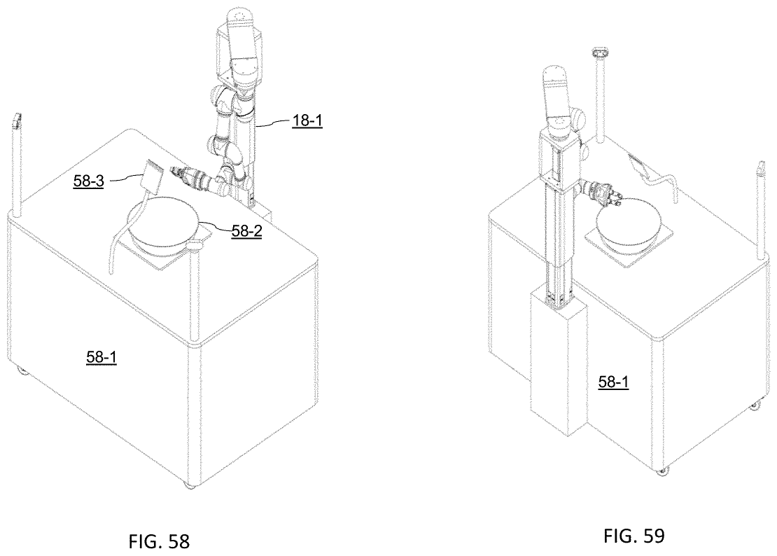

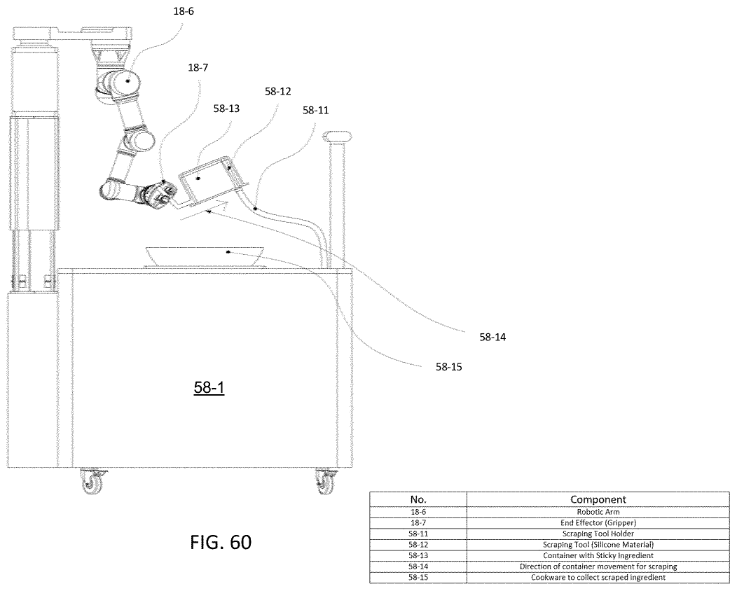

FIG. 58 is a block diagram illustrating an isometric front view of a robotic kitchen module assembly 58-1 with a scrapping tool component 58-12. FIG. 59 is a block diagram illustrating an isometric back view of a robotic kitchen module assembly 58-1 with a scrapping tool component 58-12 with respect to FIG. 58. FIG. 60 is a block diagram illustrating a side view of a robotic kitchen module assembly 58-1 with a scrapping tool component 58-12 with respect to FIG. 58. The robotic kitchen module assembly 58-1 includes the robotic arm 18-6, a robotic end effector 18-7, a container with sticky ingredient 58-13, a cookware 58-15, a scrapping tool holder 58-11, and a scraping tool 58-12. The scrapping tool 58-12 can be made of silicon material, plastic material, stainless metal material, aluminum material, nylon material, some mixed compositions, or other types of suitable materials for scrapping food out of a container. The robotic arm 18-6 and the robotic effector (or gripper) 18-7 holds a handle of the container 58-13 with sticky ingredient that flips the container 58-13 over and positioned at an angle, which the scrapping tool holder 58-11 positions the scrapping tool inside the container 58-13. The robotic arm 18-6 and the robotic effector (or gripper) 18-7 then moves the handle on the container 58-13 in a tilted upward motion as to enable the scrapping tool 58-12 to scrap out completely or substantially completely of the sticky ingredient out of the container 58-13. The tilting upward motion can vary in the number of degrees or angles, e.g., 15 degrees, 20 degrees, 30 degrees, 45 degrees, which in part is dependent on the type, form and amount of ingredient, and any pre-testing information about the ingredient, and the exact robotic arm motion process, as well as the amount of pressure in the robot placing the container 58-13 against the scrapping tool 58-12.

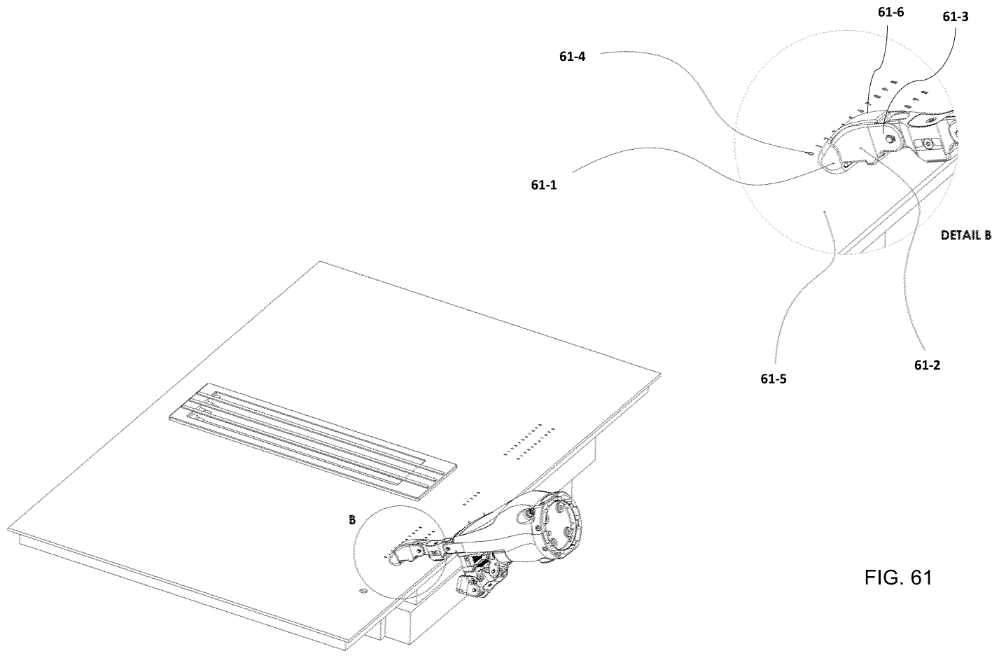

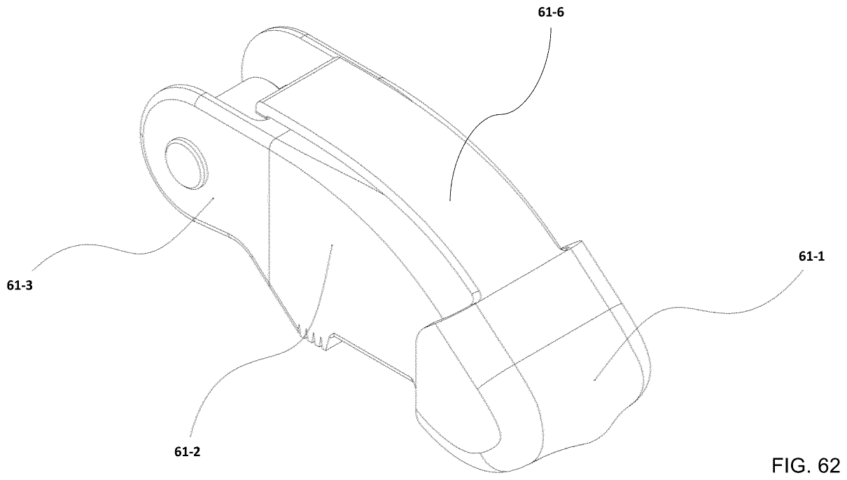

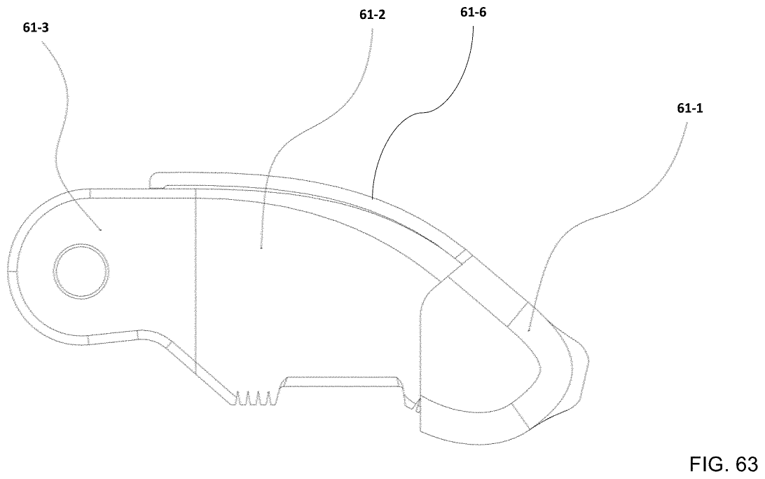

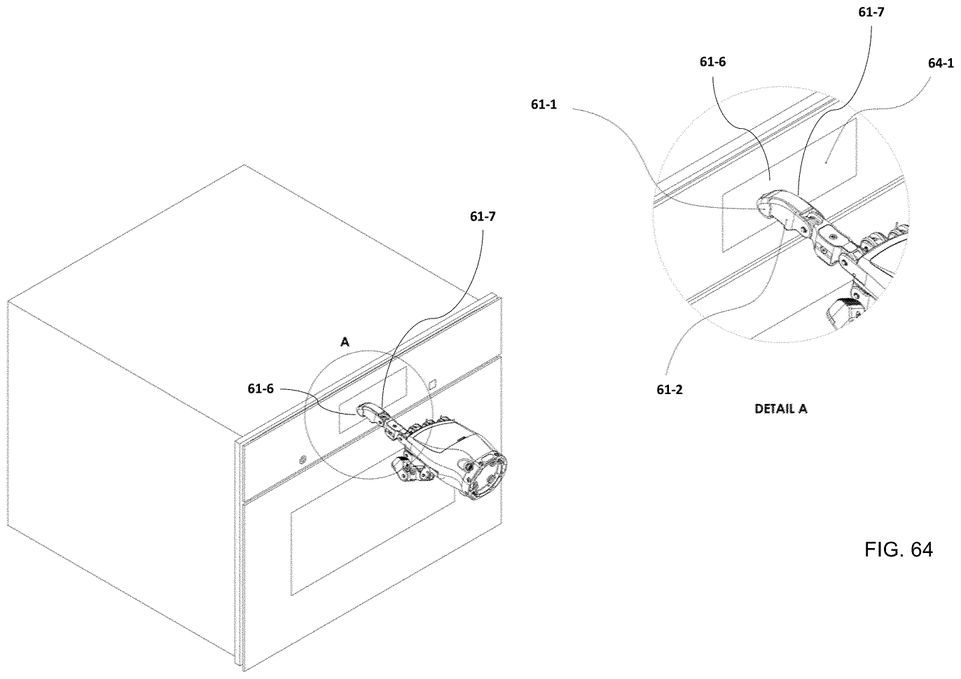

FIGS. 61, 62, 63, 64 are pictorial diagrams illustrating a touch screen operation finger 1709 including a conductive material (metal or aluminum) fingertip 61-1, a finger rubber part 61-2, a finger metal part 61-3, a screen 61-4, and one or more capacitive buttons 61-5. In one embodiment, the finger cap 61-1, the connecting piece 61-7 and the finger body 61-3 are all made of aluminum. Other types of materials can also be used with various components, including rubber, metal, aluminum, conductive materials, semi-conductive materials, etc. In this illustration, the fingertip 61-1 (in a robotic effector coupled to a robotic arm) is shown in touching the one or more capacitive buttons 61-5, a touchscreen surface 61-6, and a connecting piece 61-7. FIG. 64 illustrates one finger on a robotic effector, where the rubber portion is attached between the finger tip (or finger cap) 61-1 and the finger body 61-3, and the connecting piece 61-7 is connected between the finger tip 61-1 and the finger body 61-3. In this embodiment, the connection piece 61-7 is a conductive material that provides a conductive connection between the finger tip 61-1 and the finger body 61-3, as to facilitate the finger tip 61-1 to operate an optical screen (or optical keyboard), or a capacitive screen (or capacitive keyboard), or a resistive touchscreen. The touchscreen surface 6 could be a touchscreen in FIG. 61, or a touchscreen surface on an oven in FIG. 64. In one embodiment, an optical touchscreen (or optical keyboards) comprises two or more image sensors, such as CMOS sensors, are placed around the edges (e.g., the corners) of the screen. A capacitive touch screen is a device display screen that relies on finger pressure for interaction. A resistive touchscreen is a touch-sensitive computer display comprises of two flexible sheets coated with a resistive material and separated by an air gap or microdots.

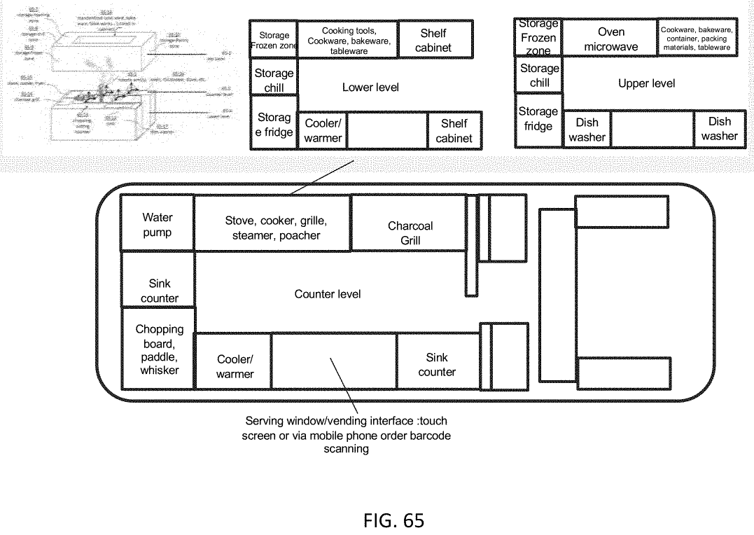

FIG. 65 is a block diagram illustrating a first embodiment of a mobile robotic kitchen on a food truck in accordance with the present disclosure.

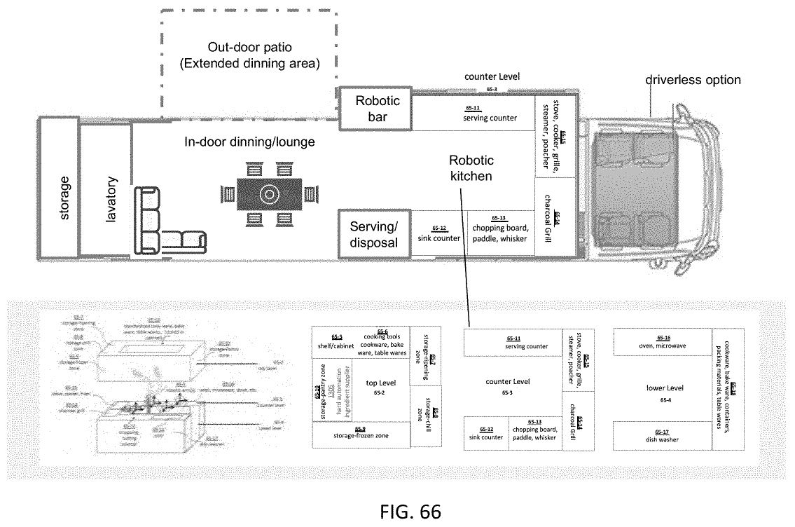

FIG. 66 is a block diagram illustrating a second embodiment of a pop-up restaurant or a food catering service in accordance with the present disclosure.

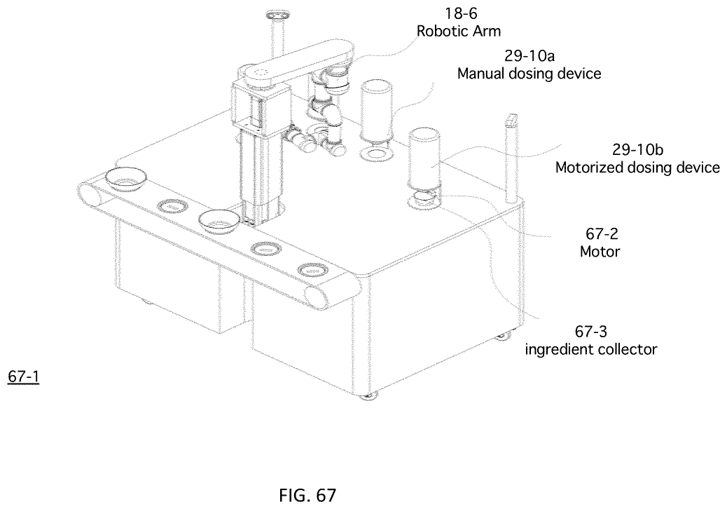

FIG. 67 is a block diagram illustrating one example of a robotic kitchen module assembly 67-1, including a motor 67-2 and an ingredient collection 67-3 with a motorized (or automatic) dosing device 29-10b and a manual dosing device 29-10a that can be tailored for the robotic kitchen which the one or more robotic arms 18-6 coupled to one of more robotic end effectors can operate a dosing device manually, or the computer processor in the robotic kitchen can send an instruction signal to a dosing device to dispense the amount of dosing automatically.

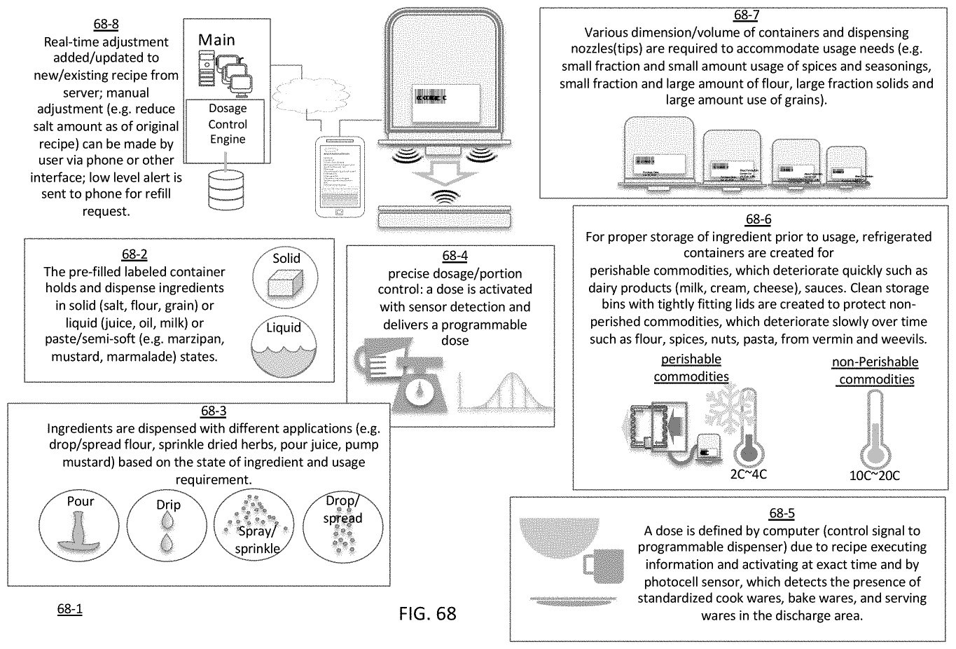

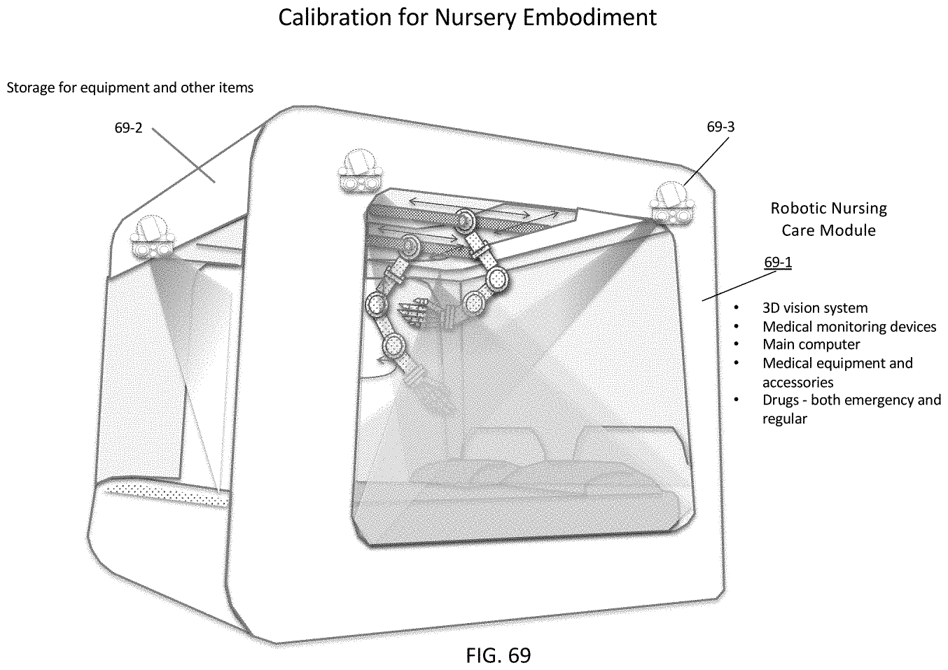

FIG. 68 depicts the functionalities and process-steps of pre-filled ingredient containers 68-1 with one or more program ingredient dispenser controls for use in a standardized robotic kitchen, whether it be the standardized robotic kitchen or the chef studio. Ingredient containers 68-1 are designed in different sizes 68-7 and varied usages are suitable for proper storage environments 68-6 to accommodate perishable items by way of refrigeration, freezing, chilling, etc. to achieve specific storage temperature ranges. For additional information on a robotic kitchen or a standardized robotic kitchen, see U.S. non-provisional patent application Ser. No. 14/627,900, now U.S. Pat. No. 9,815,191, entitled “Methods and Systems for Food Preparation in Robotic Cooking Kitchen,” and U.S. nonprovisional patent application Ser. No. 14/829,579, now U.S. Pat. No. 10,518,409, entitled “Robotic Manipulation Methods and Systems for Executing a Domain-Specific Application in an Instrumented Environment with Electronic Manipulation Libraries,” filed on 18 Aug. 2015, the disclosures of which are incorporated herein by reference in their entireties. Additionally, the pre-filled ingredient storage containers 68-1 are also designed to suit different types of ingredients 68-2, with containers already pre-labeled and pre-filled with solid (salt, flour, rice, etc.), viscous/pasty (mustard, mayonnaise, marzipan, jams, etc.) or liquid (water, oil, milk, juice, etc.) ingredients, where dispensing processes 68-3 utilize a variety of different application devices (dropper, chute, peristaltic dosing pump, etc.) depending on the ingredient type, with exact computer-controllable dispensing by way of a dosage control engine 68-8 miming a dosage control process 68-4 ensuring that the proper amount of ingredient is dispensed at the right time. It should be noted that the recipe-specified dosage is adjustable to suit personal tastes or diets (low sodium, etc.), by way of a menu-interface or even through a remote phone application. The dosage determination process 68-5 is carried out by the dosage control engine 68-8, based on the amount specified in the recipe, with dispensing occurring either through manual release command or remote computer control based on the detection of a particular dispensing container at the exit point of the dispenser.

The calibration concepts, the action primitive micro minimanipulations, the action primitive macro minimanipulations, and other robotic hardware and software concepts applicable to the robotic kitchen, including commercial robotic kitchens and residential robotic kitchens, are also applicable to telerobotics, chemical environments, hospital environments, nursery environments, and other commercial applications. One of ordinary skill in the art would also recognize the robotic description in this application can be practiced in a variety of applications without departing from the spirits of the present disclosure.

FIG. 69 is a block diagram illustrating a robotic nursing care module 69-1 with a three-dimensional vision system in accordance with the present disclosure. Robotic nursing care module 69-1 may be any dimension and size and may be designed for a single patient, multiple patients, patients needing critical care, or patients needing simple assistance. Nursing care module 69-1 may be integrated into a nursing facility or may be installed in an assisted living, or home environment. Nursing care module 69-1 may comprise a three-dimensional (3D) vision system, medical monitoring devices, computers, medical accessories, drug dispensaries or any other medical or monitoring equipment. Nursing care module 69-1 may comprise other equipment and storage 69-2 for any other medical equipment, monitoring equipment robotic control equipment. Nursing care module 69-1 may house one or more sets of robotic arms, and hands or may include robotic humanoids. The Robotic arms may be mounted on a rail system in the top of the nursing care module 69-1 or may be mounted from the walls, or floor. Nursing care module 69-1 may comprise a 3D vision system 69-3 or any other sensor system which may track and monitor patient and/or robotic movement within the module.

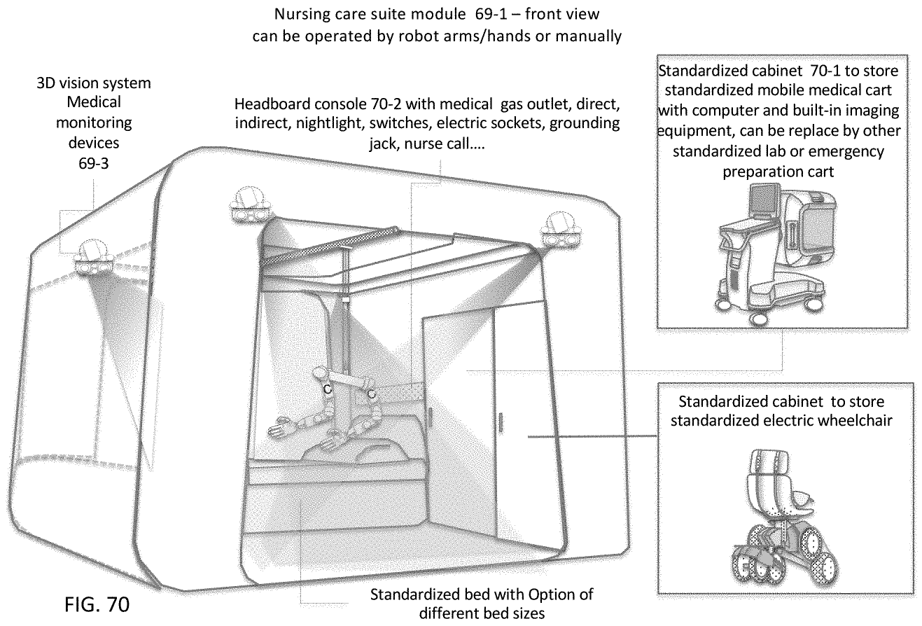

FIG. 70 is a block diagram illustrating a robotic nursing care module 69-1 with standardized cabinets 70-1 in accordance with the present disclosure. As shown in FIG. 70, nursing care module 69-1 comprises 3D vision system 69-3, and may further comprise cabinets 70-1 for storing mobile medical carts with computers, and/or in imaging equipment, that can be replace by other standardized lab or emergency preparation carts. Cabinets 70-1 may be used for housing and storing other medical equipment, which has been standardized for robotic use, such as wheelchairs, walkers, crutches, etc. Nursing care module 69-1 may house a standardized bed of various sizes with equipment consoles such as headboard console 70-2. Headboard console 70-2 may comprise any accessory found in a standard hospital room including but not limited to medical gas outlets, direct, indirect, nightlight, switches, electric sockets, grounding jacks, nurse call buttons, suction equipment, etc.

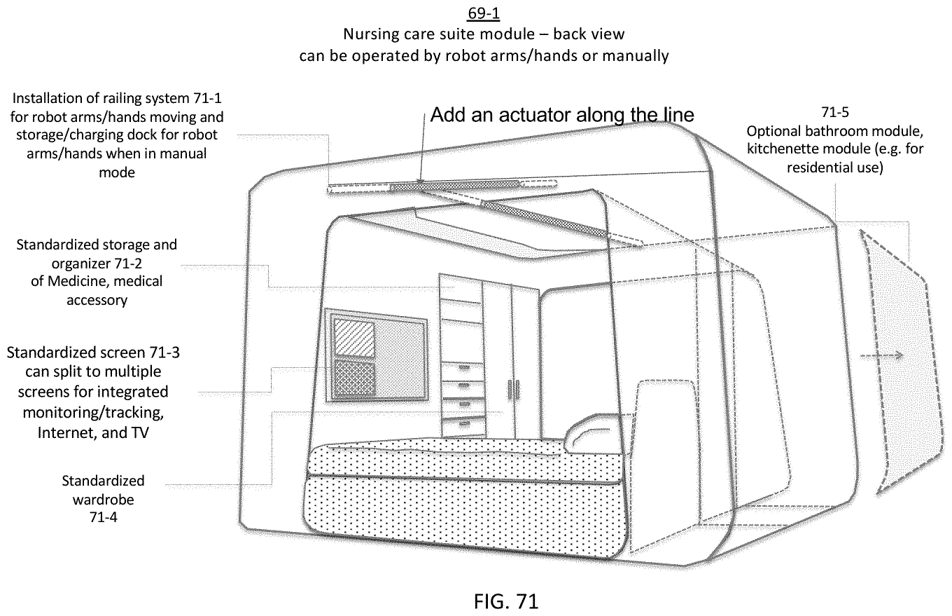

FIG. 71 is a block diagram illustrating a back view of a robotic nursing care module 69-1 with one more standardized storages 71-2, a standardized screen 71-3, a standardized wardrobe 71-4 in accordance with the present disclosure. In addition, FIG. 71 depicts railing system 71-1 for robot arms/hands moving and storage/charging dock for robot arms/hands when in manual mode. Railing system 71-1 may allow for horizontal movement in any direction and left/right. Front and back. It may be any type of rail or track and may accommodate one or more robot arms and hands. Railing system 71-1 may incorporate power and control signals and may include wiring and other control cables necessary to control and or manipulate the installed robotic arms. Standardized storages 71-2 may be any size and may be located in any standardized position within module 69-1. Standardized storage 71-2 may be used for medicines, medical equipment, and accessories or may be use for other patient items and/or equipment. Standardized screen 71-3 may be a single or multiple multi purpose screens. It may be utilized for internet usage, equipment monitoring, entertainment, video conferencing, etc. There may be one or more screens 71-3 installed within a nursing module 69-1. Standardized wardrobe 71-4 may be used to house a patient's personal belongings or may be used to store medical or other emergency equipment. Optional module 71-5 may be coupled to or otherwise co-located with standardized nursing module 69-1 and may include a robotic or manual bathroom module, kitchen module, bathing module or any other configured module that may be required to treat or house a patient within the standard nursing suite 69-1. Railing systems 71-1 may connect between modules or may be separate and may allow one or more robotic arms to traverse and/or travel between modules.

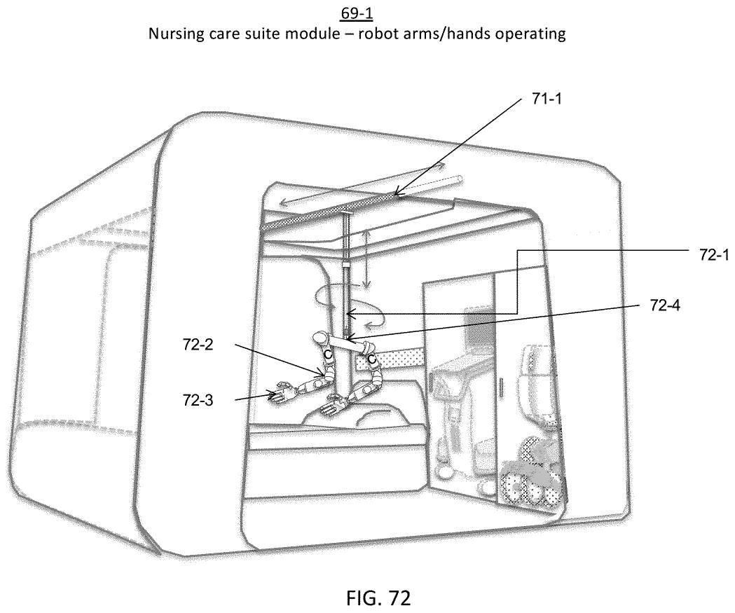

FIG. 72 is a block diagram illustrating a robotic nursing care module 69-1 with a telescopic lift or body 72-1 with a pair of robotic arms 72-2 and a pair of robotic hands 72-3 in accordance with the present disclosure. Robot arms 72-2 are attached to the shoulder 72-4 with a telescopic lift 72-1 that moves vertically (up and down) and horizontally (left and right), as a way to move robotic arms 72-2 and hands 72-3. The telescopic lift 72-1 can be moved as a shorter tube or a longer tube or any other rail system for extending the length of the robotic arms and hands. The arm 14-2 and shoulder 72-4 can move along the rail system 71-1 between any positions within the nursing suite 69-1. The robotic arms 72-2, hands 72-3 may move along the rail 71-1 and lift system 72-1 to access any point within the nursing suite 69-1. In this manner, the robotic arms and hands can access, the bed, the cabinets, the medical carts for treatment or the wheel chairs. The robotic arms 72-2 and hands 72-3 in conjunction with the lift 72-1 and rail 71-1 may aide to lift a patient to sit a sitting or standing position or may assist placing the patient in a wheel chair or other medical apparatus.

The nursing care suite module 69-1 further has the robotic arms 72-2 with one or more linear actuators in the x-axis, the y-axis, and z-axis, and one or more rotational actuators in the x-axis, the y-axis, and z-axis, plus an optional x-rail and an optional y-rail, and an optional z-rail to extend reachability for the robotic arms 72-2. The processor 182-12 can also calibrate the nursing care suite module 69-1 by adding some markers, that operates with the micro minimanipulations or macro minimanipulations.

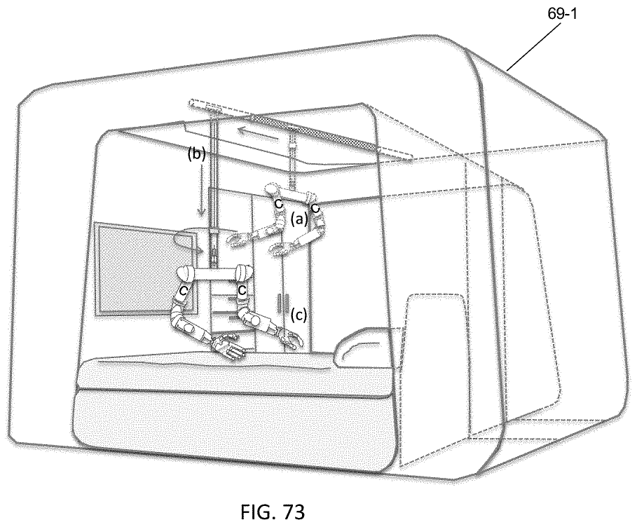

FIG. 73 is a block diagram illustrating a first example of executing a robotic nursing care module with various movements to aid an elderly patient in accordance with the present disclosure. Step (a) may occur at a predetermined time or may be initiated by a patient. Robot arms 72-2 and robotic hands 72-3 take the medicine or other test equipment from the designated standardized location (e.g. storage location 71-2). During step (b) robot arms 72-2, hands 72-3, and shoulders 72-4 moves to the bed via rail system 71-1 and to the lower level and may turn to face the patient in the bed. At step (c) robot arms 72-2 and hands 72-3 perform the programed/required minimanipulation of giving medicine to a patient. Because the patient may be moving and is not standardized, 3D real time adjustment based on patient, standard/non standard objects position, orientation may be utilized to ensure successful a result. In this manner, the real time 3D visual system allows for adjustments to the otherwise standardized minimanipulations.

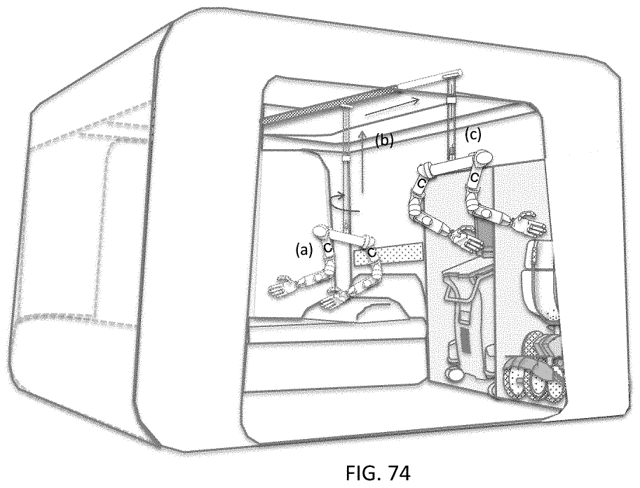

FIG. 74 is a block diagram illustrating a second example of executing a robotic nursing care module with the loading and unloading a wheel chair in accordance with the present disclosure. In position, (a) robot arms 72-2 and hands 72-3 perform minimanipulations of moving and lifting the senior/patient from a standard object, such as the wheel chair, and placing them on another standard object, such as laying them on the bed, with 3D real time adjustment based on patient, standard/non standard objects position, orientation to ensure successful result. During step (b) the robot arms/hands/shoulder may turn and move the wheelchair back to the storage cabinet after the patient has been removed. Additionally and/or alternatively, if there is more then one set of arms/hands, step (b) may be performed by one set, while step (a) is being completed. Cabinet. During step (c) the robot arms/hands open the cabinet door (standard object), push the wheelchair back in and close the door.

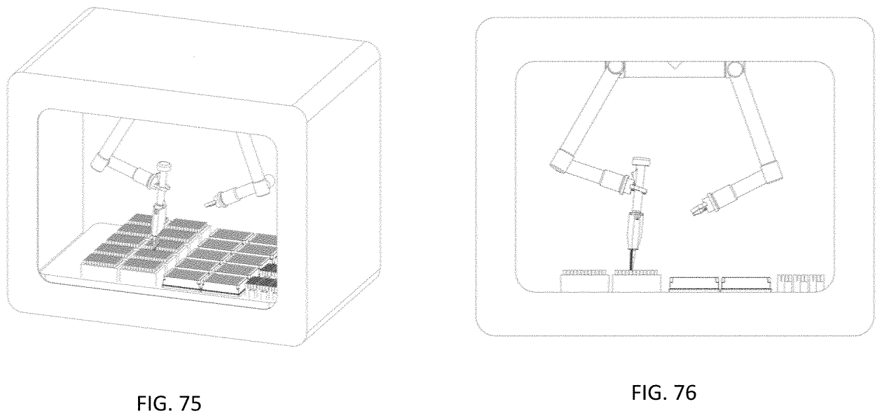

FIG. 75 is a block diagram illustrating one embodiment of an isometric view in calibrating and operating a chemical embodiment with the robot with one or more robot arms coupled to one or more robotic end effectors in accordance with the present disclosure.

FIG. 76 is a block diagram illustrating one embodiment of a front view in calibrating and operating a chemical embodiment with the robot with one or more robot arms coupled to one or more robotic end effectors.

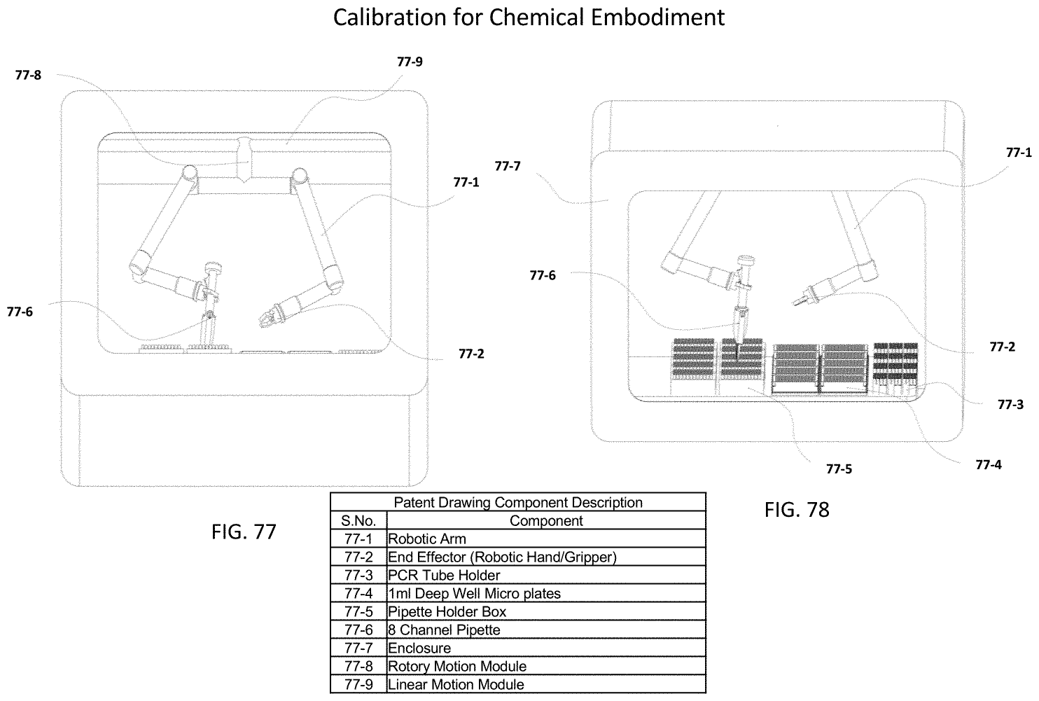

FIG. 77 is a block diagram illustrating one embodiment of a bottom angled view in calibrating and operating a chemical embodiment with the robot with one or more robot arms coupled to one or more robotic end effectors.

FIG. 78 is a block diagram illustrating one embodiment of a top angled view in calibrating and operating a chemical embodiment with the robot with one or more robot arms coupled to one or more robotic end effectors.

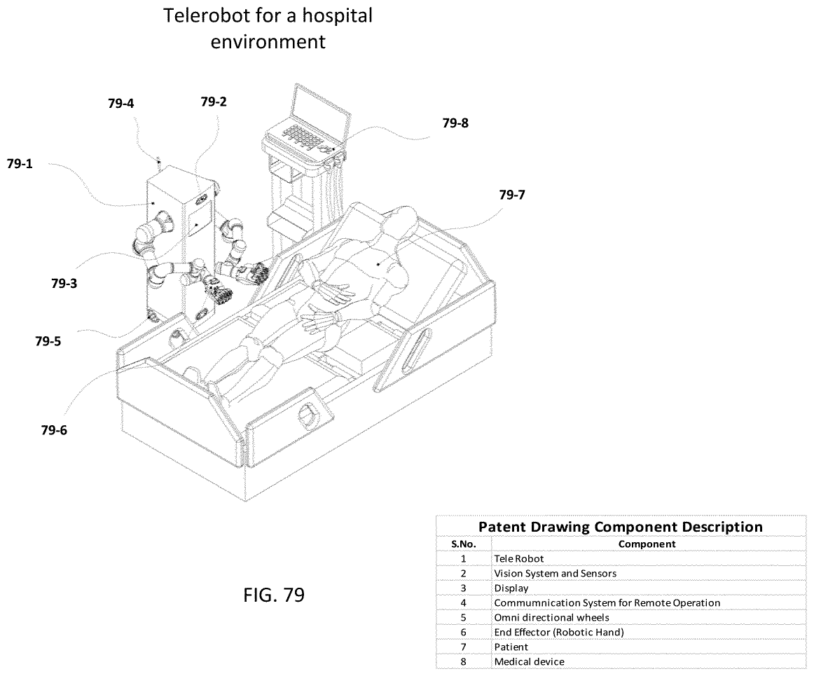

FIG. 79 is a block diagram illustrating a telerobotic for a hospital environment with operating one or more robot arms coupled to one or more robotic end effectors for distance (or remote) automation.

Telerobotics provides a remote or distance length automation for food preparation, healthcare, manufacturing, surveillance, etc., where an operator sends an action primitive (AP), whether a micro minimanipulation or a maco minimanipulation telerobotics to carry out the specific action primitive at a remote site, such as picking a book. The operator operates, controls, or navigates the robot through a sequence of parameterized commands.

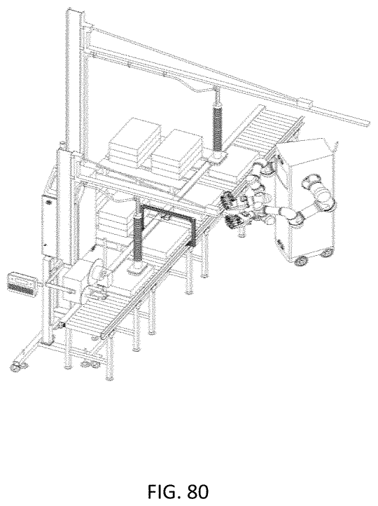

FIG. 80 is a block diagram illustrating a telerobotic for a manufacturing environment with operating one or more robot arms coupled to one or more robotic end effectors for distance (or remote) automation.

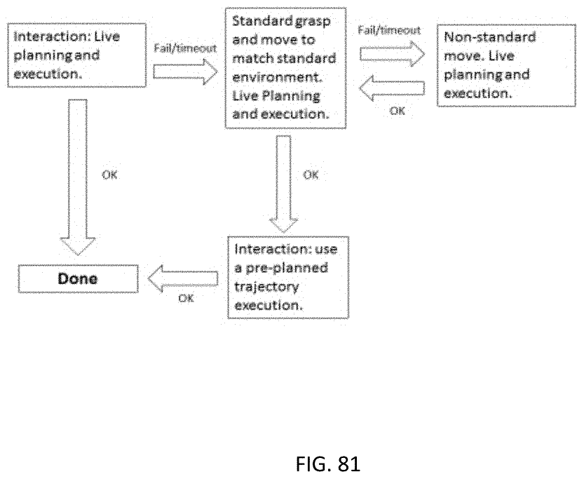

FIG. 81 depicts one embodiment of the process in the object interactions in an unstructured environment. In order to move objects that are not in the direct standard environment, they need to be grasped using a standard grasp (a fingers joint space trajectory that has been tested before) and moved (using live Motion planning) If they cannot be grasped (because for example the handle is blocked), a non-standard move (which can include pushing the objects in some way) is planned live and executed, then another standard grasp and move attempt is made. This procedure will be repeated until an object is in the expected relation to the robot, then for all other objects.

An example for this in the kitchen context is grasping and moving ingredients and tools from the storage area (cluttered, unpredictable, changes often) to the worktop surface into a defined Poses, then moving the robot to the defined configuration, then executing a trajectory that grasps and mixes the ingredients using the tools.

With this method, optimal Cartesian and Motion Plans for standard environments are generated off-line in a dedicated and calculation resource intense way and then transferred to be used by the robot. The data modeling is implemented either by retaining the regular FAP structure and using plan caching, or by replacing some Cartesian trajectories in the FAPs by pre-planned joint space trajectories, including joint space trajectories to connect the trajectories for individual APSBs inside the APs to even replace some parts of live motion planning during the manipulations in the standard environment. In the latter case, there are two sets of FAPs: One set that has “source” Cartesian trajectories suitable for planning, and one with optimized joint space trajectories.

Tolerances for the differences between real direct environment and direct environment of the saved optimised trajectory, which can be determined using experimental methods, are saved per trajectory or per FAPSB.

Using pre-planned manipulations can be extended to include positioning the robot, especially along linear or axes, to be able to execute pre-planned manipulations on a variety of positions. Another application is placing a humanoid robot in a defined relation to other objects (for example a window in a residential house) and then starting a pre-planned manipulation trajectory (for example cleaning the window).

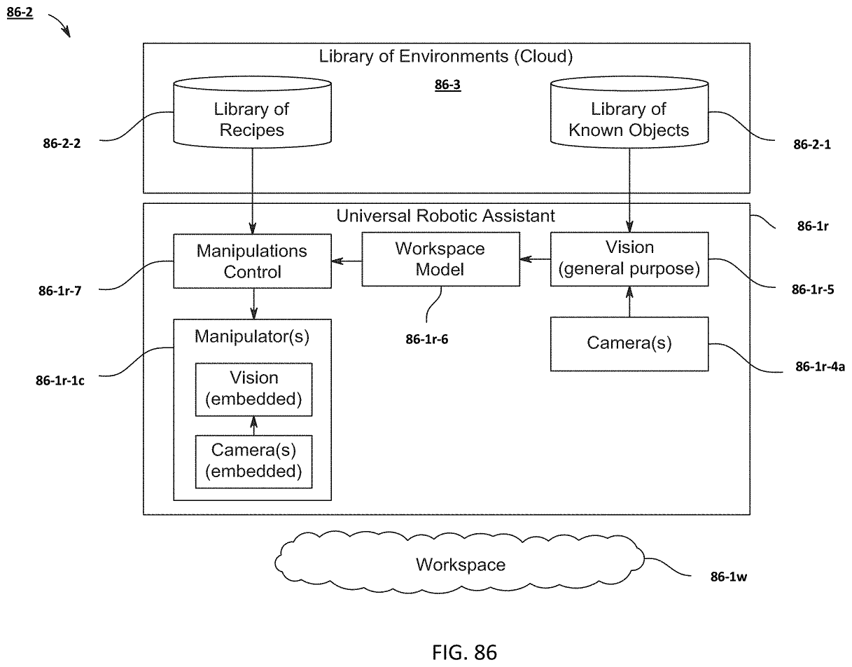

The time management scheme that utilizes proposed applications is described herein. The time-course of planning and execution shown in FIG. 81 represent one preferable scenario when all planning times are less than execution time of the previous APSB. However, this might not be the case when the complexity of the inverse kinetics (IK) problem increases as happens in complex or changing environment. This happens because the number of constraints increases when checking if Cartesian trajectory is executable for more complex environment. As a result the waiting time between the consecutive APSBs becomes non-zero as shown in FIG. 86. In one embodiment, the time management scheme minimizes the sum of these waiting times.

Furthermore, we propose that time management scheme must not only reduce the average sum of waiting times between the executions of movements but also reduce the variability of total waiting time. Specifically, this may be significant for cooking processes where the recipes set up the required timing for the operations. Thus, we introduce the cost function which is given by the probability of cooking failure, namely P (τ>τ_{failure}), where u is the total time of operation execution. Given the probability distribution p(τ) is determined by its average <τ> and the variance σ_{τ}² and neglecting higher order moments

$$P ( τ > {τ}_{failure} ) = {\int }_{{τ}_{failure}}^{∞} p ( τ ) d τ = f ( \frac{〈 τ 〉 - {τ}_{failure}}{{σ}_{τ}} ) ,$$

some monotonic increasing function, (which is for example just the error function ƒ(x)=(x) if the higher order moments indeed vanish and p(τ) has normal distribution). Therefore for the time management scheme it is beneficial to reduce both the average time and its variance, when the average is below the failure time. Since the total time is the sum of consequential and independently obtained waiting and execution times, the total average and variance are the sums of individual averages and variances. Minimizing the time average and variance at each individual scheme improves the performance by reducing the probability of cooking failure.

To reduce the uncertainty and thus the variance of the planning times (and therefore the variance in the waiting times) we propose to use the data sets of pre-planned and stored sequences that perform typical FAPs. These sequences are optimized beforehand with heavy computational power for the best time performance and any other relevant criteria. Essentially, their uncertainty is reduced to zero and thus they have zero contribution to the total time variance. So if the time management scheme finds a solution that allows the system to come to a pre-defined state from where the sequence of actions to reach the target state is known and does so before the cooking failure time, the probability of cooking failure is reduced to zero since it has zero estimated time variance. In general, if the pre-defined sequence is just a part of a total AP it still does not contribute to the total time variance and has the beneficial effect on uncertainty of the total execution time.

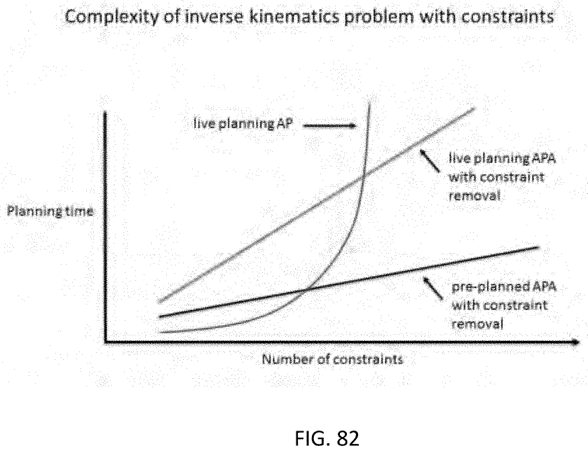

To reduce the complexity and thus the average of the planning times (and therefore the average of the waiting times) we propose to use the data sets of pre-planned and stored configurations for which the number of constraints is minimal. As shown in FIG. 82 that illustrated complexity of inverse kinematics with constraints, if the complexity of inverse kinematics algorithm and thus the average time to find an executable solution increases faster than linear with the number of constraints (which is the case for all algorithms up to date) than we propose to use FAP alternatives (FAPA) obtained using pre-planned Cartesian trajectories or joint trajectories and object interactions that result in constraint removal. If Cartesian trajectory of the found sequence of solutions of IK problem cannot be executed due to a number of constraints the scheme implements simultaneous attempt to find FAPSB which will result in the removal of these constraints one-by one or several at a time. Performing a sequence of FAPSBs for consecutive removal of constraints will lead to linear dependency of the total waiting time on the number of constraints as shown in Illustration 8, therefore providing the lower upper boundary for the estimated waiting time while performing AP. To reduce the slope of that linear curve we propose to use a set of pre-planned FAPSBs to retract the robot arm to one the pre-set states and another set of pre-planned FAPSBs to remove the objects from the direct environment which may block the path and thus provide the constraints for Cartesian trajectory solutions of IK problem.

The logic of this scheme as follows, once the timeout to find a solution is reached (typically set by the execution time of previous FAPSB) and executable trajectory is not found we perform a transitional FAPSB from the incomplete FAPA which does not lead to the target state but rather leads to the new IK problem with reduced complexity. In effect we trade the unknown waiting time with long tail distribution and high average into a fixed time spent on the additional FAPSB and unknown waiting time for the new IK problem with lower average.

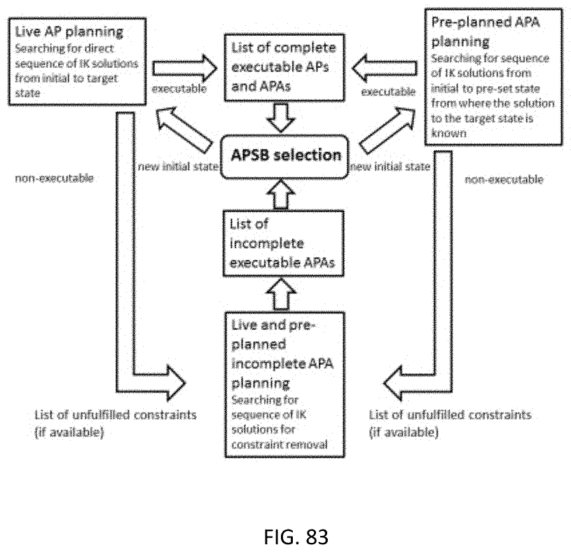

The time course of the decisions made in this scheme is shown in FIG. 83, which shows information flow and generation of incomplete FAPAs. Before the timeout is reached we accumulate a set of complete FAPA and incomplete FAPA, when the timeout is reached we choose the FAPSB from the appropriate APA for execution according to the selection criteria described in the previous sections. If no complete APA is found we choose FAPSB from the set of incomplete FAPAs to avoid large waiting times. The choice of FAPSB from the incomplete FAPA is driven by the list of unfulfilled constraints for the non-executable solutions of IK problem. Namely we preferentially remove the constraints that are most often unsatisfied and prevent solutions of IK problem from execution. The example for this scenario would be the situation when a certain container blocks the path for the robotic arm to perform an action behind it, thus if no solution is found before the timeout we do not wait for the solution to emerge and instead we grab and remove that container from direct environment to a pre-set location outside of it, even if we did not obtain the complete FAPA to finish the FAP. In the case when the list of unsatisfied constraints is unavailable we reduce the number of constraints in a pre-planned manner where we remove the maximum number of constraints at a time. The example for such a pre-FAPA can be relocation of the object to a dedicated area with no other external objects or the retraction of the robotic arm to a standard initial position.

Between the internal and external constraints, the internal constraints are due to the limitations of the robotic arm movements and their role is increased when the joints are in complex positions. Thus the typical constraint removal APSB is the retraction of the robotic arm to one the pre-set joint configurations. The external constraints are due to the objects located in the direct environment. The typical constraint removal APSB is the relocation of the object to one of the pre-set locations. The separation of internal and external constraints is used for the selection of APA from the executable complete and incomplete sets.

To combine the complexity reduction with the uncertainty reduction to decrease both the average and the variance of the total execution time, the following structure of the pre-planned and stored data sets is proposed. The sequences of the IK solutions are stored for the list of manipulations with each type of objects that are executable in the dedicated area. In this area we have no external objects and the robotic arm is in one of the pre-defined standard positions. This ensures the minimal number of constraints. So if the direct solution for FAP is not readily obtained we find and use the solution for FAPA which leads to relocation of the object under consideration to a dedicated area, where the manipulation is performed. This result in a massive constraint removal and allows for the usage of pre-computed sequences that minimizes the uncertainty of the execution times. After the manipulation is performed in the dedicated area the object is returned to the working area to complete the FAP.

In some embodiments, time management system that minimizes the probability of failure to meet the temporal deadline requirements by minimizing the average and the variance of waiting times, comprising of pre-defined list of states and corresponding list of operations, pre-computed and stored set of optimized sequences of IK solutions to perform the operations in the pre-defined state, parallel search and generation of AP and APAs (Cartesian trajectories or sequences of IK solutions) towards the target state and the set of the pre-defined states, APSB selection among the executable APAs or AP, based on the performance metrics for the corresponding APA.

In some embodiments, the average and the variance of waiting times may be minimized with the use of pre-defined and pre-calculated states and solutions, which essentially produce zero contribution to the total average and variance when performed in a sequence of actions, from initial state to pre-defined state where the stored sequence is executed and then back to target state.

In some embodiments, the choice of the pre-defined states with minimal number of constraints, the empirically obtained list may include, but not limited to,
a. Pre-defined state: the object is held by the robot in the dedicated area in a standardized position. These states are used when it is not possible to execute the action at the location of the object due to collisions and lack of space and thus relocation to a dedicated space is performed first;
b. Pre-defined state: the robotic arms (and their joints) are at the standard initial configuration. These states are used when the current joint configurations have complex structure and prevents execution due to internal collisions of the robotic arms, so the retraction of the robotic arms is done before new attempt to perform an action; and
c. Pre-defined state: the external object is held by the robot in the dedicated area. These states are used when the external object blocks the path and causes a collision on a found non-executable trajectory, the grasping and the relocation of the object to the storage area is performed before returning to the main sequence.
   [1] In some embodiments, the APSB selection scheme performs the following sequence of choices:
d. If at a timeout one or several executable AP or APAs are found make a selection according to the performance metric based on, but not limited to total time of execution, energy consumption, aesthetics and the like; and
e. If at a timeout non-executable solution is found, make the selection among the incomplete APAs which lead from current state to one of the pre-defined states even when the complete sequence to the target state is not known; and
f. The APSB selection among the sets of incomplete APA is done according to the performance metric plus the number of the constraints removed by the incomplete APA. The preference is given to the incomplete APA which removes the maximum number of constraints.

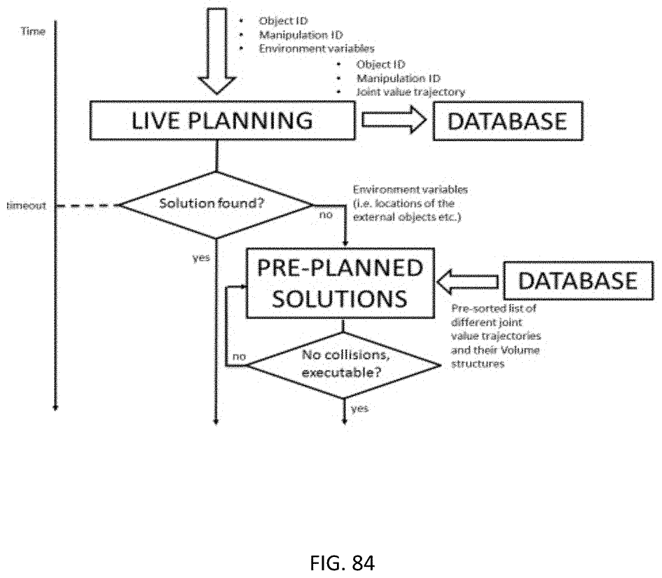

FIG. 84 is a block diagram illustrating write-in and read-out scheme for a database of pre-planned solutions. The database of pre-planned solutions is created for the library of objects and corresponding manipulations with these objects. Numerous solutions of joint value trajectories are stored for each object and manipulation combination. These solutions differ in initial configuration of the robotic arms and the object. These datasets can be pre-calculated by systematically varying and sampling Cartesian coordinates of the initial location and configuration of the robotic arm and the object. Such database can be updated and expanded by writing in the joint value trajectories for the successful live planning operation. If the life planning procedure failed to produce a solution before the timeout, the scheme attempts to find a pre-stored solution that satisfies no collision conditions with current direct environment by comparing the volume of the pre-stored joint value trajectory with excluded volume due to the external objects in the direct environment. The database is structured in such a way that the data list of pre-stored solutions is sorted according to the performance metric, so that the most desirable solutions were attempted first.

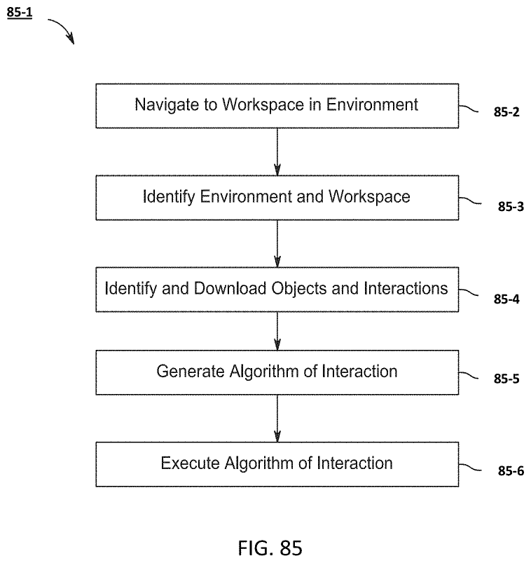

FIG. 85 is a flow chart 85-1 illustrating a process for executing an interaction using the robotic assistant 86-1r, according to an exemplary embodiment. In some embodiments, Typical application of a Robotic assistant system may include, for example, three steps: Get to workspace (kitchen, bathroom, warehouse, etc.), scan the workspace (detect objects and their attributes) and change the workspace (manipulate objects) according to the recipe.

As shown, at step 85-3, the robotic assistant 86-1r navigates to a desired or target environment or workspace in which a recipe is to be performed. In the example embodiment described with reference to FIG. 86, the robotic assistant 86-1r navigates to a robotic kitchen type workspace 86-1w within a robotic home type environment 86-3. For example, the robotic home environment 86-3 can include multiple rooms, such as a bathroom, living room and bedrooms, and thus, at step 85-2, the robotic assistant 86-1r can navigate from one of those rooms to the kitchen in order to perform a recipe. In the example embodiment described with reference to FIG. 85, the robotic assistant 86-1r is used to execute a recipe to cook a desired dish (e.g., chicken pot pie).

Navigating to the target environment 86-3 and workspace 86-1w can be triggered by a command received by the robotic assistant locally (e.g., via a touchscreen or audio command), received remotely (e.g., from a client system, third party system, etc.), or received from an internal processor of the robotic assistant that identifies the need to perform a recipe (e.g., according a predetermined schedule). In response to such a trigger, the robotic assistant 86-1r moves and/or positions itself at an optimal area within the environment 86-3. Such an optimal area can be a predetermined or preconfigured position (e.g., position 0, described in further detail below) that is a default starting point for the robotic assistant. Using a default position enables the robotic assistant 86-1r to have a starting point of reference, which can provide more accurate execution of commands.

As described above, the robotic assistant 86-1r can be a standalone and independently movable structure (e.g., a body on wheels) or a structure that is movably attached to the environment or workspace (e.g., robotic parts attached to a multi-rail and actuator system). In either structural scenario, the robotic assistant 86-1r can navigate to the desired or target environment. In some embodiments, the robotic assistant 86-3 includes a navigation module that can be used to navigate to the desired position in the environment 86-3 and/or workspace 86-1w.

In some embodiments, the navigation module is made up of one or more software and hardware components of the robotic assistant 86-1r. For example, the navigation module that can be used to navigate to a position in the environment 86-3 or workspace 86-1w employs robotic mapping and navigation algorithms, including simultaneous localization and mapping (SLAM) and scene recognition (or classification, categorization) algorithms, among others known to those of skill in the art, that are designed to, among other things, perform or assist with robotic mapping and navigation. At step 85-2, for instance, the robotic assistant 86-1r navigates to the workspace 86-1w in the environment 86-3 by executing a SLAM algorithm or the like to generate or approximate a map of the environment 86-3, and localize itself (e.g., its position) or plan its position within that map. Moreover, using the SLAM algorithm, the navigation module enables the robotic assistant 86-1r to identify its position with respect or relative to distinctive visual features within the environment 86-3 or workspace 86-1w, and plan its movement relative to those visual features within the map. Still with reference to step 85-2, the robotic assistant 86-1r can also employ scene recognition algorithms in addition to or in combination with the navigation and localization algorithms, to identify and/or understand the scenes or views within the environment 86-3, and/or to confirm that the robotic assistant 502r achieved or reached its desired position, by analyzing the detected images of the environment.

In some embodiments, the mapping, localization and scene recognition performed by the navigation module of the robotic assistant can be trained, executed and re-trained using neural networks (e.g., convolutional neural networks). Training of such neural networks can be performed using exemplary or model workspaces or environments corresponding to the workspace 86-1w and the environment 5000.

It should be understood that the navigation module of the robotic assistant 86-1r can include and/or employ one or more of the sensors 86-1r-4 of the robotic assistant 86-1r, or sensors of the environment 86-3 and/or the workspace 86-1w, to allow the robotic assistant 86-1r to navigate to the desired or target position. That is, for example, the navigation module can use a position sensor and/or a camera, for example, to identify the position of the robotic assistant 86-1r, and can also use a laser and/or camera to capture images of the “scenes” of the environment to perform scene recognition. Using this captured or sensed data, the navigation module of the robotic assistant 86-1r can thus execute the requisite algorithms (e.g., SLAM, scene recognition) used to navigate the robotic assistant 86-1r to the target location in the workspace 86-1w within the environment 86-3.

At step 85-3, the robotic assistant 86-1r identifies the specific instance and/or type of the workspace 86-1w and/or environment 86-3, in which the robotic assistant navigates to at step 85-2 to execute a recipe. It should be understood that the identification of step 85-3 can occur prior to, simultaneously with, or after the navigation of step 85-2. For instance, the robotic assistant 86-1r can identify the instance or type of the workspace 86-1w and/or environment 86-3 using information received or retrieved in order to trigger the navigation of step 85-2. Such information, as discussed above, can include a request received from a client, third party system, or the like. Such information can therefore identify the workspace and environment with which a request to execute the recipe is associated. For example, the request can identify that the workspace 86-1w is a RoboKitchen model 1000. ON the other hand, during or after the navigation of step 85-2, the robotic assistant can identify that the environment and workspace through which it is navigating is a RoboKitchen (model 1000), by identifying distinctive features in the images obtained during the navigation. As described below, tis information can be used to more effectively and/or efficiently identify the objects therein with which the robotic assistant can interact.

At step 85-4, the robotic assistant 86-1r identifies the objects in the environment 86-3 and/or workspace 86-1w and thus with which the robotic assistant 86-1r can communicate. Identifying of the objects of step 85-4 can be performed either (1) based on the instance or type of environment and workspace identified at step 85-3, and/or (2) based on a scan of the workspace 86-1w. In some embodiments, identifying the objects at step 85-4 is performed using, among other things, using a vision subsystem of the robotic assistant 86-1r, such as a general-purpose vision subsystem (described in further detail below). As described in further detail below, the general-purpose vision subsystem can include or use one or more of the components of the robotic assistant 86-1r illustrated in 86, and/or other of the systems or components illustrated in the ecosystem 86-2, such as cameras and other sensors, memories, and processors. It should be understood that, in some embodiments, the object identification of step 85-4 is performed based on the scan performed by the general-purpose vision subsystem, which can leverage a library of known objects to more accurately and/or efficiently identify objects.

FIG. 86 illustrates aspects of the cloud computing system 86-2 and of the robotic assistant 86-1r, and the components and interactions there between that are used to, among other things, identify objects at step 85-4. As shown, the cloud computing system 86-2 can store a library of environments (and/or workspaces), including for example a library definition of environment 86-3. The library definition of the environment 86-3 (and any other of the environments defined in the library of environments) can include any data known to those of skill in the art that describes and/or is otherwise associated with or to the environment 86-3. For example, in connection with each environment definition, including the definition of the environment 86-3, the cloud computing system 86-2 stores a library of known objects (“object library”) 86-2-1 and a library of recipes (“recipe library”) 86-2-2. The library of known objects 86-2-1 includes data definitions of objects that are standard to or typically known to be in the environment 86-3. The recipe library includes data definitions of recipes that can be performed or executed in the environment 86-3.

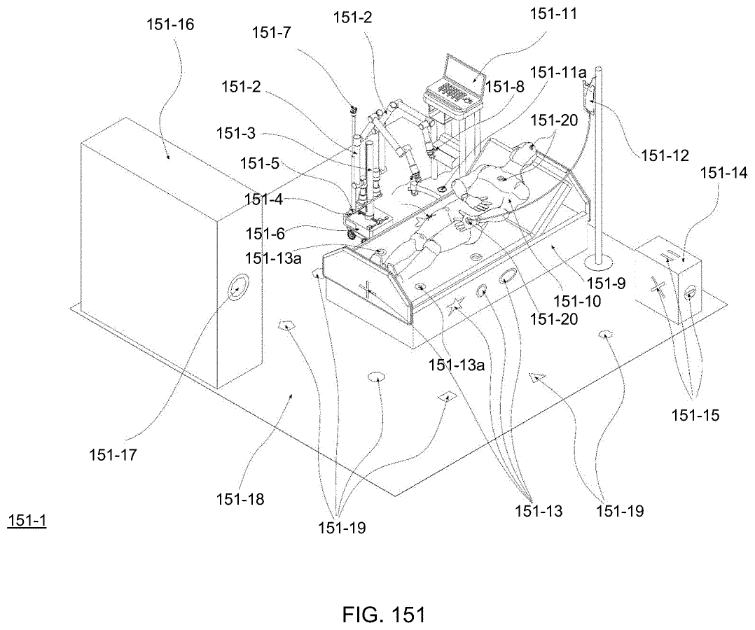

Still with reference to FIG. 86, as illustrated, exemplary aspects of the robotic assistant 86-1r can include at least one camera 86-1r-4a (and/or other sensors), a general-purpose vision subsystem 86-1r-5, a workspace model 86-1w-1, a manipulations control module 86-1r-7, and at least one manipulator (e.g., end effector) 86-1r-1c. The general-purpose vision subsystem 86-1r-5 (which is described if further detail below) is a subsystem of the robotic assistant 86-1r made up of hardware and/or software and is configured to, among other things, visualize, image and/or detect objects in a workspace or environment. The workplace model 86-1w-1 is a data definition of the workspace 86-1w, which can be created and updated in real-time by the robotic assistant 86-1w, in order to be readily aware of and/or understand the parts and processes of the of the workspace, for instance, for quality control. For instance, the data definition of the workspace 86-1w can include a compilation of the data definitions of the objects identified to be present in the environment 86-3. The manipulations control module 86-1r-7 can be a combination of hardware and/or software configured to identify recipes to execute and to generate algorithms of interaction that define the manner in which the robotic assistant 86-1r is to be commanded in order to accurately and successfully execute the recipe. For instance, the manipulations control module 86-1r-7 can identify which interactions can or should be performed in order to perform each command of the recipe as efficiently and effectively as possible. The manipulator 86-1r1-c can be a part of the robotic assistant 86-1r or its anatomy 86-1r-1, such an end effector 86-1r1-c, which can be used to manipulate and/or interact with an object in the environment 86-3. The manipulator 86-1r-1c can include a corresponding and/or embedded vision subsystem 86-1r-1c-A and/or a camera (or other sensor) 86-1r-1c-B. The workspace 86-1w is also illustrated in FIG. 151, which is the workspace in or with which the robotic assistant 86-1r is to execute the recipe.

Still with reference to FIG. 86 the objects corresponding to the environment 86-3 and/or the workspace 86-1w are identified based on either the instance/type of the environment 86-3 and/or workspace 86-1w, and/or by scanning the workspace 86-1w to detect the objects therein. An environment and/or workspace can be made up of or include known objects, which are those objects that are always or typically found in the environment 86-1w or workspace 86-3. For instance, in a kitchen type environment or workspace, a knife can be a “known” object, since a knife is typically found in a kitchen, while a roll of string, if detected in the kitchen, would be deemed to be an “unknown” object, since it is typically not found in a kitchen. Thus, in some embodiments, at step 85-4, the robotic assistant 85-4 can identify the objects that are known in the environment 86-3 and/or workspace 86-1w.

Moreover, at step 85-4, objects can be identified using the general-purpose vision subsystem 86-1r-5 of the robotic assistant 86-1r, which is used to scan the environment 86-3 and/or workspace 86-1w and identify the objects that are actually (rather than expectedly) present in therein. The objects identified by the general-purpose vision subsystem 86-1r-5 can be used to supplement and/or further narrow down the list of “known” objects identified as described above based on the specific instance or type of environment and/or workspace identified at step 85-3. That is, the objects recognized by the scan of the general-purpose vision subsystem 86-1r-5 can be used to cut down the list of known objects by eliminating therefrom objects that, while known and/or expected to be present in the environment 86-3 and/or workspace 86-1w, are actually not found therein at the time of the scan. Alternatively, the list of known objects can be supplemented by adding thereto any objects that are identified by the scan of the general-purpose vision subsystem 86-1r-5. Such objects can be objects that were not expected to be found in the environment 86-3 and/or workspace 86-1w, but were indeed identified during the scan (e.g., by being manually inserted or introduced into the environment 86-3 and/or workspace 86-1w). By identifying the identification of objects using these two techniques, an optimal list of objects with which the robotic assistant 86-1r is to interact is generated. Moreover, by referencing a pre-generated list of known objects, errors (e.g., omitted or misidentified objects) due to incomplete or less-than-optimal imaging by the general-purpose vision subsystem 86-1r-5 can be avoided or reduced.

As shown in FIG. 86, the general-purpose vision subsystem 86-1r-5 includes or can use a camera 86-1r-4a (or multiple cameras and/or other sensors) to capture images and thereby visualize the environment 86-3 and/or workspace 86-1w. The general-purpose vision subsystem 86-1r-5 can identify objects based on the obtained images, and thereby determine that those objects are indeed present in the environment 86-3 and/or workspace 86-1w. The general-purpose vision subsystem 86-1r-5 is now described in further detail.

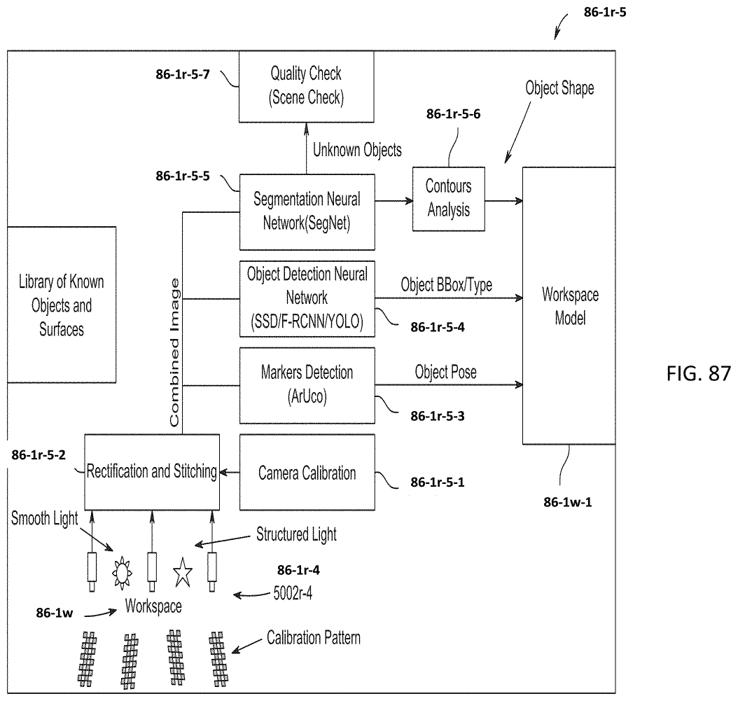

FIG. 87 illustrates an architecture of a general-purpose vision subsystem 86-1r-5, according to an exemplary embodiment. As shown, the general-purpose vision subsystem 86-1r-5 is made up of modules and components (e.g., cameras) configured to provide imaging, object detection and object analysis, for the purpose of identifying objects within the environment 86-3 and/or workspace 86-1w. The modules and systems of the general-purpose vision subsystem 86-1r-5 can leverage the library of known objects (and surfaces) stored in the cloud computing system 86-2 to more accurately or efficiently identify objects. Information about the identified objects can be stored in the workspace model 86-1r-6, which as described above is a data definition of the workspace 86-3.

Still with reference to FIG. 87, the modules of or corresponding to the general-purpose vision subsystem 86-1r-5 can include: a camera calibration module 86-1r-5-1, rectification and stitching module 86-1r-5-2, a markers detection module 86-1r-5-3, an object detection module 86-1r-5-4, a segmentation module 86-1r-5-5, a contours analysis module 86-1r-5-6, and a quality check module 86-4-5-7. These modules can consist of code, logic and/or the like stored in one or more memories 86-1r-3 and executed by one or more memories 86-1r-2 of the robotic assistant 86-1r. While each module is configured for a specific purpose, the modules are designed to detect objects and/or analyze objects in order to provide information (e.g., characteristics) about those objects. The object detection and/or analysis of these modules is performed using the illustrated cameras 86-1r-4 to image the illustrated workspace 86-1w.

In some embodiments, the cameras 86-1r-4 illustrated in FIG. 87 can be deemed to correspond (exclusively or non-exclusively) to a camera system of the general-purpose vision subsystem 86-1r-5. It should be understood that while FIG. 87 illustrates just three cameras, the general-purpose subsystem 86-1r-5 and/or the camera system can include or be associated with any number of cameras. In some embodiments, the number (and other characteristics) of the cameras can be based on the size and/or structure of the workspace. For example, a three meter by one meter cooking surface can require at least three cameras mounted 1.2 meters high above the top-facing surface of the workspace 86-1w. Thus, the cameras 86-1r-4 can be cameras that are embedded in the robotic assistant 86-1r and/or cameras that are logically connected thereto (e.g., cameras corresponding to the environment 86-3 and/or the workspace 86-1w).

The camera system can also be said to include the illustrated structured light and smooth light, which can be built or embedded in the cameras 86-1r-4 or separate therefrom. It should be understood that the lights can be embedded in or separate from (e.g., logically connected to) the robotic assistant 86-1r. Moreover, the camera system can also be said to include the illustrated camera calibration module 86-1r-5-1 and the rectification and stitching module 86-1r-5-2.

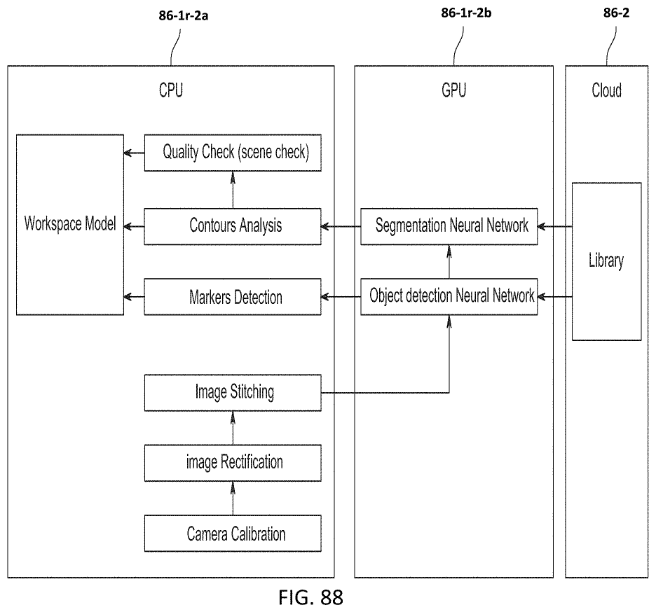

FIG. 88 illustrates an architecture for identifying objects using the general-purpose vision subsystem 86-1r-5, according to an exemplary embodiment. As shown in FIG. 88, a CPU such as processor 86-1r-2a of the robotic assistant 86-1r handles certain functions of the object identification of step 85-4 of FIG. 84, including camera calibration, image rectification, image stitching, marker detection, contour analysis quality (or scene) check, and management of the workspace model. A graphics processing unit (GPU) such as processor 86-1r-2b of the robotic assistant 86-1r handles certain functions of the object identification of step 85-4 of FIG. 84, including object detection and segmentation. And, the cloud computing system 86-2, including its own components (e.g., processors, memories) provide storage, management and access to the library of known objects.

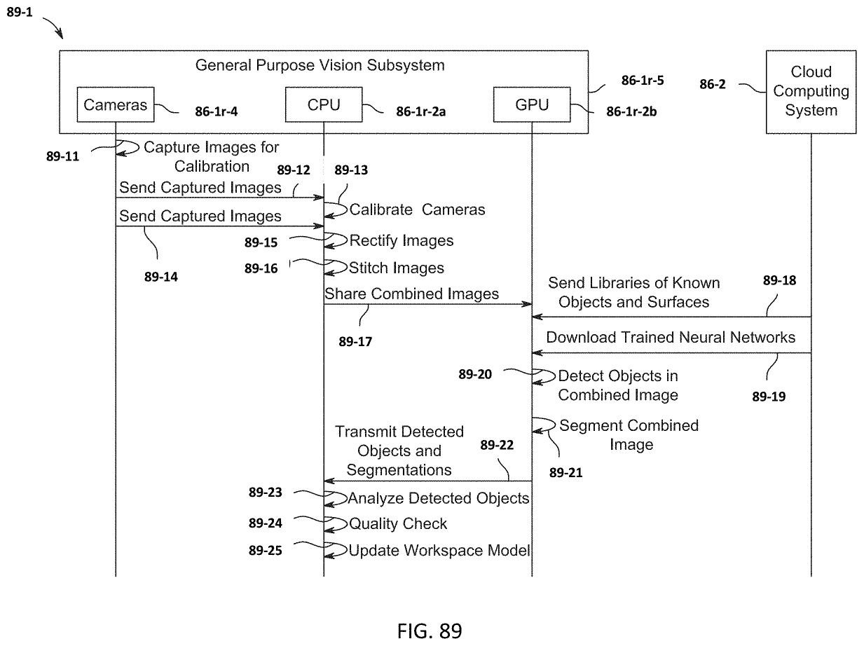

FIG. 89 illustrates a sequence diagram 89-1 of a process for identifying objects in an environment or workspace, according to an exemplary embodiment. The exemplary process 89-1 illustrated in FIG. 89 is described in conjunction with features and aspects of other figures described herein, including FIG. 88 which illustrates an exemplary general-purpose vision subsystem. As shown, the process includes functionality performed by the general-purpose vision subsystem 86-1r-5 of the robotic assistant 86-1r, and the cloud computing system 86-2. The general-purpose vision subsystem 86-1r-5 includes and/or is associated with cameras 86-1r-4, CPU 86-1r-2a, and GPU 86-1r-2b. As discussed herein, the cameras can include cameras that exclusively correspond to the robotic assistant 86-1r (e.g., cameras embedded in the robot anatomy 86-1r-1). It should be understood that the general-purpose vision subsystem 86-1r-5 can include and/or be associated with other devices, components and/or subsystems not illustrated in FIG. 89.

At step 89-11, the cameras 86-1r-4 are used to capture images of the workspace 86-1w for calibration. Prior to capturing the images to be used for camera calibration, a checkerboard or chessboard pattern (or the like, as known to those of skill in the art) is disposed or provided on predefined positions of the workspace 86-1w. The pattern can be formed on patterned markers that are outfitted on the workspace 86-1w (e.g., top surface thereof). Moreover, in some embodiments such as the one illustrated in FIG. 87 in which the camera system of the general-purpose vision subsystem 86-1r-5 includes two or more cameras, the cameras 86-1r-4 are arranged for imaging such that the field of view of neighboring (e.g., adjacent) cameras overlap, thereby allowing at least a portion of the pattern to be visible by two cameras. Once the cameras 86-1r-4 and 86-1w have been configured for calibration, the calibration images are obtained at step 89-11. At step 89-12, the captured calibration images are transmitted from and/or made available by the cameras to the CPU 86-1r-2a. It should be understood that the image capturing performed by the cameras 86-1r-4 at step 89-11, the transmission of the images to the CPU 86-1r-2a at step 89-12, and the calibration of cameras 89-13 by the CPU 86-1r-2a can be performed in sequential steps, or in real time, such that the calibration of step 89-13 occurs “live” as the cameras are capturing the images at step 89-11.

In turn, at step 89-13, calibration of the cameras is performed to provide more accurate imaging such that optimal and/or perfect execution of commands of a recipe can be performed. That is, camera calibration enables more accurate conversion of image coordinates obtained from images captured by the cameras 86-1r-4 into real world coordinates of or in the workspace 86-1w. In some embodiments, the camera calibration module 86-1r-5-2 of the general-purpose vision subsystem 86-1r-5 is used calibrate the cameras 86-1r-4. As illustrated, the camera calibration module 86-1r-5-2 can be driven by the CPU 86-1r-2a.

The cameras 86-1r-4, in some embodiments, are calibrated as follows. The CPU 86-1r-2a detects the pattern (e.g., checkerboard) in the images of the workspace 86-1w captured at step 89-11. Moreover, the CPU 86-1r-2a locates the internal corners in the detected pattern in of the captured images. The internal corners are the corners where four squares of the checkerboard meet and that do not form part of the outside border of the checkerboard pattern disposed on the workspace 86-1w. For each of the identified internal corners, the general-purpose vision subsystem 86-1r-5 identifies the corresponding pixel coordinates. In some embodiments, the pixel coordinates refer to the coordinate on the captured images at which the pixel corresponding to each of the internal corners is located. In other words, the pixel coordinates indicate where each internal corner of the checkerboard pattern is located in the images captured by the cameras 500r-4, as measured in an array of pixel.

Still with reference to the calibration of step 89-13, real world coordinates are assigned to each of the identified pixel coordinates of the internal corners of the checkerboard pattern of. In some embodiments, the respective real-world coordinates can be received from another system (e.g., library of environments stored in the cloud computing system 86-2) and/or can be input to the robotic apparatus 86-1r and/or the general-purpose vision subsystem 86-1r-5. For example, the respective real-world coordinates can be input by a system administrator or support engineer. The real-world coordinates indicate the real-world position in space of the internal corners of the checkerboard pattern of the markers on the workspace 86-1w.

Using the calculated pixel coordinates and real-world coordinates for each internal corner of the checkerboard pattern, the general-purpose vision subsystem 86-1r-5 can generate and/or calculate a projection matrix for each of the cameras 86-1r-4. The projection matrix thus enables the general-purpose vision subsystem 86-1r-5 to convert pixel coordinates into real world coordinates. Thus, the pixel coordinate position and other characteristics of objects, as viewed in the images captured by the cameras 86-1r-4, can be translated into real world coordinates in order to identify where in the real world (as opposed to where in the captured image) the objects are positioned.

As described herein, the robotic assistant 86-1r can be a standalone and independently movable system or can be a system that is fixed to the workspace 86-1w and/or other portion of the environment 86-3. In some embodiments, parts of the robotic assistant 86-1r can be freely movable while other parts are fixed to (and/or be part of) portions of the workspace 86-1w. Nevertheless, in some embodiments in which the camera system of the general-purpose vision subsystem 86-1r-5 is fixed, the calibration of the cameras 86-1r-4 is performed only once and later reused based on that same calibration. Otherwise, if the robotic assistant 86-1r and/or its cameras 86-1r-4 are movable, camera calibration is repeated each time that the robotic assistant 86-1r and/or any of its cameras 86-1r-4 change position.

It should be understood that the checkerboard pattern (or the like) used for camera calibration can be removed from the workspace 86-1w once the cameras have been calibrated and/or use of the pattern is no longer needed. Although, in some cases, it may be desirable to remove the checkerboard pattern as soon as the initial camera calibration is performed, in other cases it may be optimal to preserve the checkerboard markers on the workspace 86-1w such that subsequent camera calibrations can more readily be performed.

With the cameras 86-1r-4 calibrated, the general-purpose vision subsystem 86-1r-5 can begin identifying objects with more accuracy. To this end, at step 89-14, the cameras 86-1r-4 capture images of the workspace 86-1w (and/or environment 86-3) and transmit those captured images to the CPU 86-1r-2a. The images can be still images, and/or video made up of a sequence of continuous images. Although the sequence diagram 89-1 of FIG. 89 only illustrates single transmission of captured image data at step 89-14, it should be understood that images can be sequentially and/or continually captured and transmitted to the CPU 86-1r-2a for further processing (e.g., in accordance with steps 89-15 to 89-25).

At step 89-15, the captured images received at step 89-14 are rectified by the rectification and stitching module 86-1r-5-2 using the CPU 86-1r-2a. In some example embodiments, rectification of the images captured by each of the cameras 86-1r-4 includes removing distortion in the images, compensating each camera's angle, and other rectification techniques known to those of skill in the art. In turn, at step 89-16, the rectified images captured from each of the cameras 86-1r-4 are stitched together by the rectification and stitching module 86-1r-5-2 to generate a combined captured image of the workspace 86-1w (e.g., the entire workspace 86-1w). The X and Y axes of the combined captured image are then aligned with the real-world X and Y axes of the workspace 86-1w. Thus, pixel coordinates (x,y) on the combined image of the workspace 86-1w can be transferred or translated into corresponding (x,y) real world coordinates. In some embodiments, such a translation of pixel coordinates to real world coordinates can include performing calculations using a scale or scaling factor calculated by the calibration module 86-1r-5-2 during the camera calibration process.

In turn, at step 89-17, the combined (e.g., stitched) image generated by the rectification and stitching module 86-1r-5-2 is shared (e.g., transmitted, made available) with other modules, including the object detection module 86-1r-5-4, to identify the presence of objects in the workspace 86-1w and/or environment 86-3 by detecting objects within the captured image. Moreover, at step 89-18, the cloud computing system 86-2 transmits libraries of known objects and surfaces stored therein to the general-purpose vision subsystem 86-1r-5, and in particular to the GPU 86-1r-2b. As discussed above, the libraries of known objects and surfaces that is transmitted to the general-purpose vision subsystem 86-1r-5 can be specific to the instance or type of the environment 86-3 and/or the workspace 86-1w, such that only data definitions of objects known or expected to be identified are sent. Transmission of these libraries can be initiated by the cloud computing system 86-2 (e.g., pushed), or can be sent in response to a request from the GPU 86-1r-2b and/or the general-purpose vision subsystem 86-1r-5. It should be understood that transmission of the libraries of known objects can be performed in one or multiple transmissions, each or all of which can occur immediately prior to or at any point before the object detection of step 89-20 is initiated.

At step 89-10, the GPU 86-4-2b of the general-purpose vision subsystem 86-1r-5 of the robotic apparatus 86-1r downloads trained neural networks or similar mathematical models (and weights) corresponding to the known objects and surfaces associated with step 89-18. These neural networks are used by the general-purpose vision subsystem 86-1r-5 to detect or identify objects. As shown in FIG. 185, such models can include a neural network such as convolutional neural networks (CNN), faster convolutional neural networks (F-CNN), you only look once (YOLO) neural networks, and single-shot detector (SSD) neural networks, for object detection and a neural network for image segmentation (e.g., SegNet). To maximize the accuracy and efficiency of the neural networks and their application to detect objects and perform image segmentation, the downloaded neural networks are specifically configured for the workspace 86-1w (and/or environment 86-3) by being trained only for the known objects and surfaces of the workspace 86-1w (and/or environment 86-3). Thereby, the neural networks need not account for objects or surfaces that are not known to the workspace 86-1w (and/or environment 86-3). That is, targeted or particularized neural networks—e.g., ones trained only for the known objects in the workspace and/or environment—can provide faster and less complex object identification processing by avoiding the burdens of considering and dismissing objects that are not known (and therefore less likely) to be present in the environment 86-3 and/or the workspace 86-1w. It should be understood that the neural networks (and/or other models) can be trained and obtained from the cloud computing system 86-2 (as shown in FIG. 86), or from another component of the ecosystem 5000. Alternatively, although not illustrated in FIG. 86, the neural networks (and/or other models) can be trained and maintained by the robotic assistant 86-1r itself.

In turn, at step 89-20, the object detection module 86-1r-5-4 uses the GPU 86-1r-2b to detect objects in the combined image (and therefore implicitly in the real-world workspace 86-1w and/or environment 86-3) based on or using the received and trained object detection neural networks (e.g., CNN, F-CNN, YOLO, SSD). In some embodiments, object detection includes recognizing, in the combined image, the presence and/or position of objects that match objects included in the libraries of known objects received at step 89-18.

Moreover, at step 89-21, the segmentation module 86-1r-5-5 uses the GPU 86-1r-2b segments portions of the combined image and assign an estimated type or category to that segment based on or using the trained neural network such as SegNet received at step 89-10. It should be understood that, at step 89-21, the combined image of the workspace 86-1w is segmented into pixels, though segmentation can be performed using a unit of measurement other than a pixel as known to those of skill in the art. Still with reference to step 89-21, each of the segments of the combined image is analyzed by the trained neural network in order to be classified, by determining and/or approximating a type or category to which the contents of each pixel correspond. For example, the contents or characteristics of the data of a pixel can be analyzed to determine if they resemble a known object (e.g., category: “knife”). In some embodiments, pixels that cannot be categorized as corresponding to a known object can be categorized as a “surface,” if the pixel most closely resembles a surface of the workspace, and/or as “unknown,” if the contents of the pixel cannot be accurately classified. It should be understood that the detection and segmentation of steps 89-20 and 89-21 can be performed simultaneously or sequentially (in any order deemed optimal).

In turn, at step 89-22, the results of the object detection of step 89-20 and the segmentation results (and corresponding classifications) of step 89-21 are transmitted by the GPU 86-1r-2b to the CPU 86-1r-2a. Based on these, at step 89-23, the object analysis is performed by the marker detection module 86-1r-5-3 and the contour analysis module 86-1r-5-6, using the CPU 86-1r-2a, to, among other things, identify markers (described in further detail below) on the detected objects, and calculate (or estimate) the shape and pose of each of the objects.

That is, at step 89-23, the marker detection module 86-1r-5-3 determines whether the detected objects include or are provided with markers, such as ArUco or checkerboard/chessboard pattern markers. Traditionally, standard objects are provided with markers. As known to those of skill in the art, such markers can be used to more easily determine the pose (e.g., position) of the object and manipulate it using the end effectors of the robotic assistant 86-1r. Nonetheless, non-standard objects, when not equipped with markers can be analyzed to determine their pose in the workspace 86-1w using neural networks and/or models trained on that type of non-standard object, which allows the general-purpose vision subsystem 86-1r-5 to estimate, among other things, the orientation and/or position of the object. Such neural networks and models can be downloaded and/or otherwise obtained from other systems such as the cloud computing system 86-2, as described above in detail. In some embodiments, analysis of the pose of objects, particularly non-standard objects, can be aided by the use of structured lighting. That is, neural networks or models can be trained using structured lighting matching that of the environment 86-3 and/or workspace 86-1w. The structured lighting highlights aspects or portions of the objects, thereby allowing the module 86-1r-5-3 to calculate the object's position (and shape, which is described below) to provide more optimal orientation and positioning of the object for manipulations thereon. Still with reference to stop 89-23, analysis of the detected objects can also include determining the shape of the objects, for instance, using the contours analysis module 86-1r-5-6 of the general-purpose vision subsystem 86-1r-5. In some embodiments, contour analysis includes identifying the exterior outlines or boundaries of the shape of detected objects in the combined image, which can be executed using a variety of contour analysis techniques and algorithms known to those of skill in the art. At step 89-24, a quality check process is performed by the quality check module 86-1r-5-7 using the CPU 86-1r-2a, to further process segments of the image that were classified as unknown. This further processing by the quality check process serves as a fallback mechanism to provide last minute classification of “unknown” segments.

The results of the analysis of step 89-23 and the quality check of step 89-24 are used to update and/or generate the workspace model 86-1w-1 corresponding to the model 86-1w. In other words, data identifying the objects, and their shape, position, segment types, and other calculated or determined characteristics thereof are stored in association with the workspace model 86-1w-1.

Moreover, with reference to step 85-4, the process of identifying objects and downloading or otherwise obtaining information associated with each of the objects into the workspace model 86-1w-1 can also include downloading or obtaining interaction data corresponding to each of the objects. That is, as described above in connection with FIG. 85, object detection includes identifying objects present in the environment 86-3 and/or the workspace 86-1w. In addition, characteristics such as marker information, shape and pose associated with each object is determined or calculated for the identified objects. The detected presence and characteristics of these objects is stored in association with the workspace model 86-1w-1. Moreover, the robotic assistant 86-1r can also store, in the workspace model 86-1w-1, in association with each of the detected objects, object information downloaded or received from the cloud computing system 86-2. Such information can include data that was not calculated or determined by the general-purpose vision subsystem 86-1r-5 of the robotic assistant 86-1r. For instance, this data can include weight, material, and other similar characteristics that form part of the template or data definition of the objects. Other information that is downloaded to the workspace model in connection with each object are data definitions of interactions that can be performed, by the robotic assistant 86-1r in the context of the workspace 86-1w and/or environment 86-3, on or with each of the detected objects. For instance, in the case of a blender type object, the object definition of the blender can include data definitions of interactions such as “turn on blender,” “turn off blender,” “increase power of blender,” and other interactions that can be performed on or using the blender.

For example, a recipe to be performed in a kitchen can be to achieve a goal or objective such as cooking a turkey in an oven. Such a recipe can include or be made up of steps for marinating the turkey, moving the turkey to the refrigerator to marinate, moving the turkey to the oven, removing the turkey from the oven, etc. These steps that make up a recipe are made up of a list or set of specifically tailored (e.g., ordered) interactions (also referred to interchangeably as “manipulations”), which can be referred to as an algorithm of interactions. These interactions can include, for example: pressing a button to turn the oven on, turning a knob to increase the temperature of the oven to a desired temperature, opening the oven door, grasping the pan on which the turkey is placed and moving it into the oven, and closing the oven door. Each of these interactions is defined by a list or set of commands (or instructions) that are readable and executable by the robotic assistant 86-1r. For instance, an interaction for turning on the oven can include or be made up of the following list of ordered commands or instructions:

Move finger of robotic end effector to real world position (x1, y1), where (x1, y1) are coordinates of a position immediately in front of the oven's “ON” button;

Advance finger of robotic end effector toward the “ON” button until X amount of opposite force is sensed by a pressure sensor of the end effector; and

Retract finger of robotic end effector the same distance as in the preceding command.

As discussed in further detail below, the commands can be associated with specific times at which they are to be executed and/or can simply be ordered to indicate the sequence in which they are to be executed, relative to other commands and/or other interactions (and their respective timings). The generation of an algorithm mf interaction, and the execution thereof, is described in further detail below with reference to steps 85-5 and 85-6 of FIG. 85. Nonetheless, for clarity, interactions by the robotic assistant 86-1r are now described.

As described herein, the robotic assistant 86-1r can be deployed to execute recipes in order to achieve desired goals or objectives, such as cooking a dish, washing clothes, cleaning a room, placing a box on a shelf, and the like). To execute recipes, the robotic assistant 86-1r performs sequences of interactions (also referred to as “manipulations”) using, among other things, its end effectors 86-1r-1c and 86-1r-1n. In some embodiments, interactions can be classified based on the type of object that is being interacted with (e.g., static object, dynamic object). Moreover, interactions can be classified as grasping interactions and non-grasping interactions.

Non-exhaustive examples of types of grasping interactions include (1) grasping for operating, (2) grasping for manipulating, and (3) grasping for moving. Grasping for operating refers to interactions between one or more of the end effectors of the robotic assistant 86-1r and objects in the workspace 86-1w (or environment 86-3) in which the objective is to perform a function to or on the object. Such functions can include, for example, grasping the object in order to press a button on the object (e.g., ON/OFF power button on a handheld blender, mode/speed button on a handheld blender). Grasping for manipulating refers to interactions between one or more of the end effectors of the robotic assistant 86-1r and objects in the workspace 86-1w (or environment 86-3) in which the objective is to perform a manipulation on or to the object. Such manipulations can include, for example: compressing an object or part thereof; applying axial tension on an X,Y or an X,Y,Z axis; compressing and applying tension; and/or rotating an object. Grasping for moving refers to interactions between one or more of the end effectors of the robotic assistant 86-1r and objects in the workspace 86-1w (or environment 86-3) in which the objective is to change the position of the object. That is, grasping for moving type interactions are intended to move an object from point A to point B (and other points, if needed or desired), or change its direction or velocity.

On the other hand, non-exhaustive examples of types of non-grasping interactions include (1) operating without grasping; (2) manipulating without grasping; and (3) moving without grasping. Operating an object without grasping refers to interactions between one or more of the end effectors of the robotic assistant 86-1r and objects in the workspace 86-1w (or environment 86-3) in which the objective is to perform a function without having to grasp the object. Such functions can include, for example, pressing a button to operate an oven. Manipulating an object without grasping refers to interactions between one or more of the end effectors of the robotic assistant 86-1r and objects in the workspace 86-1w (or environment 86-3) in which the objective is to perform a manipulation without the need to grasp the object. Such functions can include, for example, holding an object back or away from a position or location using the palm of the robotic hand. Moving an object without grasping refers to interactions between one or more of the end effectors of the robotic assistant 86-1r and objects in the workspace 86-1w (or environment 86-3) in which the objective is to move an object from point A to point B (and other points, if needed or desired), or change its direction or velocity, without having to grasp the object. Such non-grasping movement can be performed, for example, using the palm or backside of the robotic hand.

While interactions with dynamic objects can also be classified into grasping and non-grasping interactions, in some embodiments, interactions with dynamic objects (as opposed to static objects) can be approached differently by the robotic assistant 86-1r, as compared with interactions with static objects. For example, when performing interactions with dynamic objects, the robotic assistant additionally: (1) estimates each object's motion characteristics, such as direction and velocity; (2) calculates each objects expected position at each time instance or moment of an interaction; and (3) preliminarily positions its parts or components (e.g., end effectors, kinematic chains) according to the calculated expected position of each object. Thus, in some embodiments, interactions with dynamic objects can be more complex than interactions with static objects, because, among other reasons, they require synchronization with the dynamically changing position (and other characteristics, such as orientation and state) of the dynamic objects.

Moreover, interactions between end effectors of the robotic assistant 86-1r and objects can also or alternatively be classified based on whether the object is a standard or non-standard object. As discussed above in further detail, standard objects are those objects that do not typically have changing characteristics (e.g., size, material, format, texture, etc.) and/or are typically not modifiable. Non-exhaustive, illustrative examples of standard objects include plates, cups, knives, lamps, bottles, and the like. Non-standard objects are those objects that are deemed to be “unknown” (e.g., unrecognized by the robotic assistant 86-1r), and/or are typically modifiable, adjustable, or otherwise require identification and detection of their characteristics (e.g., size, material, format, texture, etc.). Non-exhaustive, illustrative examples of non-standard objects include fruits, vegetables, plants, and the like.

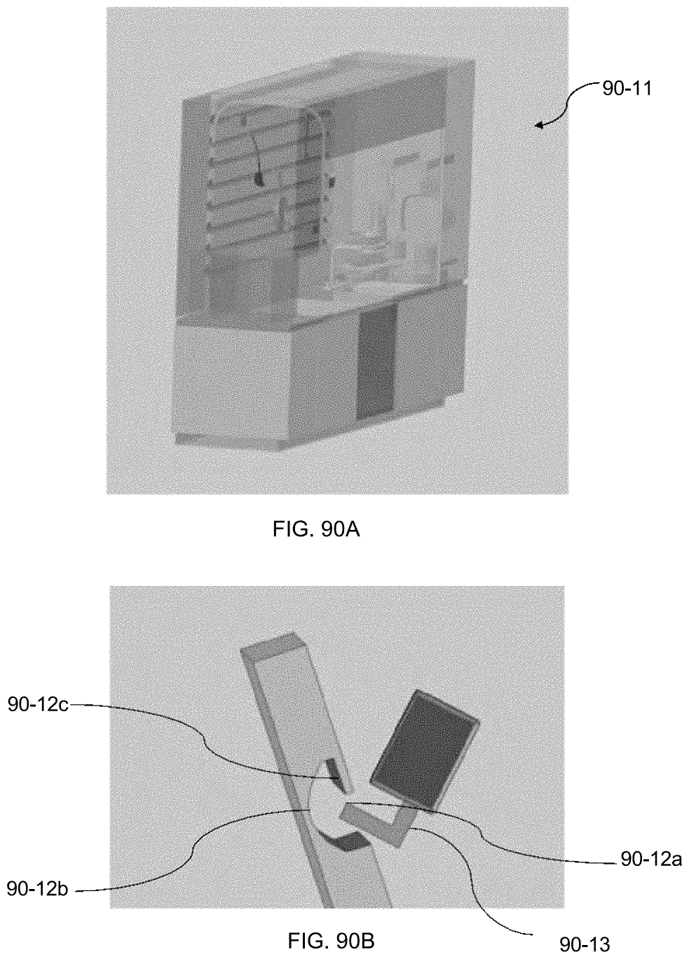

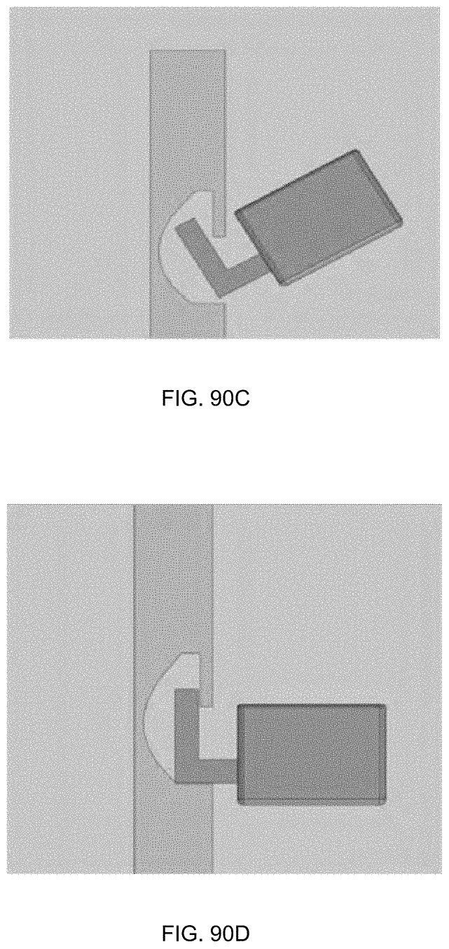

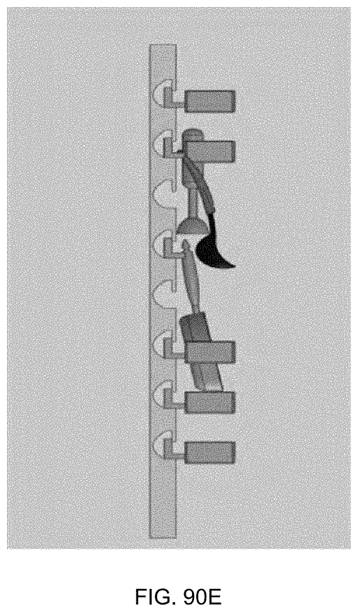

FIGS. 90A-90E in one exemplary embodiment of the present disclosure, illustrates a wall locking mechanism 90-11 for the one or more objects. The wall locking mechanism 90-11 includes an opening 90-12a for receiving the one or more objects. The opening 90-12a extends into a socket 90-12b, which configured to retain a portion of a wall mount bracket 19-13 fixed to the one or more objects. Further, a stopper 90-12c is provided to the opening 90-12a, which extends parallel to the surface of the wall and is configured to lock the portion of the wall mount bracket 19-13 into the socket 90-12b.

In an embodiment, for storing the one or more objects the robotic system is adapted approach the wall locking mechanism 90-11 and orient the one or more objects at a predetermined angle for inserting the wall mount bracket 90-13 of the one or more objects. At this stage, the robotic system tilts the one or more objects suitably, to lock the wall mount bracket 90-13 into the opening 90-11a.

In an embodiment, the opening 90-11a, the socket 90-11b and the stopper 90-11c may be configured corresponding to the configuration of the wall mount bracket 90-13 provisioned to the one or more brackets.

In an embodiment, the wall locking mechanism 90-11 may be configured to directly receive and store the one or more objects. In an embodiment, a magnet may be provided in the socket 90-11b, for providing extra locking force to the one or more objects. In an embodiment, the magnet may be provided to the wall mount bracket 90-13 or may be directly mounted to the one or more objects for fixing onto the wall locking mechanism 90-11. In an embodiment, wall mount mechanism is defined in at least one of a kitchen environment, a structured environment or an un-structured environment.

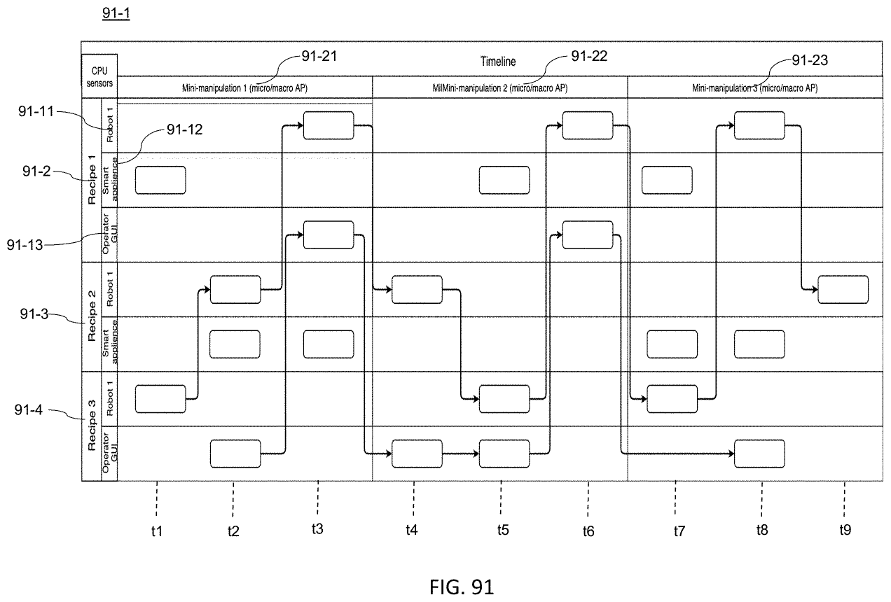

FIG. 91 is a block diagram illustrating one example of a flow diagram 91-1 showing a robotic kitchen preparing multiple recipes at the same time (or parallel cooking) with the execution of the minimanipulations with a first robot (robot 1), a smart appliance, and an operator graphical user interface (GUI). The operator graphical user interface (GUI) can be used to send a voice command or a graphic command to an operator. The robotic kitchen receives three recipes from customer orders, a first recipe 91-2, a second recipe 91-3, and a third recipe 91-4. For simplicity and illustrations, the robotic kitchen in this example has a first robot 91-11, a smart appliance 91-12, and an operator GUI 91-13. A computer processor at the robotic kitchen has to manage the different recipes through the execution of a plurality of minimanipulations by the first robot 91-11, the smart appliance 91-12, and the operator GUI 91-13 to avoid potential collusions between the execution of minimanipulations carried out by and between the first robot 91-11, the smart appliance 91-12, or the operator GUI 91-13. In this example, three minimanipulations 91-21, 91-22, 91-23 are executed across a time line. Each of the three minimanipulations 91-21, 91-22, 91-23 can be either a micro AP or a macro AP. At time t1, the first smart appliance executes the first minimanipulation 91-21 as part of the first recipe 91-2 and the first robot 91-11 executes the first minimanipulation 91-21 as part of the third recipe 91-4. At time t2, the first robot 91-11 executes the first minimanipulation 91-21 as part of the second recipe 91-3, the smart appliance 91-12 executes the first minimanipulation 91-21 as part of second recipe 91-3, and the operator GUI 91-13 executes the first minimanipulation 91-21 as part of the third recipe 91-4. At time t3, the first robot 91-11 executes the first minimanipulation 91-21 as part of the first recipe 91-2, the operator GUI 91-13 executes the first minimanipulation 91-21 as part of first recipe 91-2, and the smart appliance 91-13 executes the first minimanipulation 91-21 as part of the second recipe 91-3.

At time t4, the first robot 91-11 executes the second minimanipulation 91-22 as part of the second recipe 91-3, and the operator GUI 91-13 executes the second minimanipulation 91-22 as part of third recipe 91-4. At time t5, the smart appliance 91-12 executes the second minimanipulation 91-22 as part of the first recipe 91-2, the first robot 91-11 executes the second minimanipulation 91-22 as part of the third recipe 91-4, and the operator GUI 91-13 executes the second minimanipulation 91-22 as part of third recipe 91-4. At time t6, the first robot 91-11 executes the second minimanipulation 91-22 as part of the first recipe 91-2, and the operator GUI 91-13 executes the second minimanipulation 91-22 as part of first recipe 91-2.

At time t7, the smart appliance 91-12 executes the third minimanipulation 91-23 as part of the first recipe 91-2, the smart appliance 91-12 executes the third minimanipulation 91-23 as part of the second recipe 91-3, and the first robot 91-11 executes the third minimanipulation 91-23 as part of the third recipe 91-4. At time t8, the first robot 91-11 executes executes the third minimanipulation 91-23 as part of the first recipe 91-2, the smart appliance 91-12 executes the third minimanipulation 91-23 as part of the second recipe 91-3, and the operator GUI 91-13 executes the third minimanipulation 91-23 as part of the third recipe 91-4. At time t9, the first robot 91-11 executes executes the third minimanipulation 91-23 as part of the second recipe 91-3.

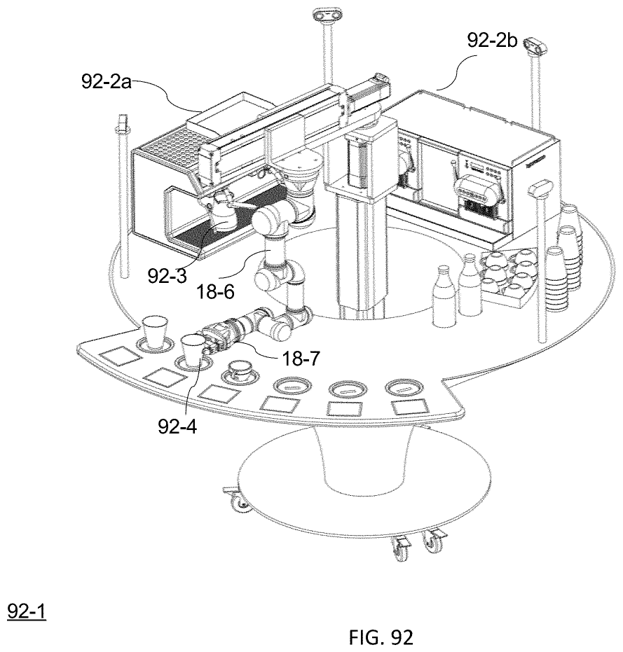

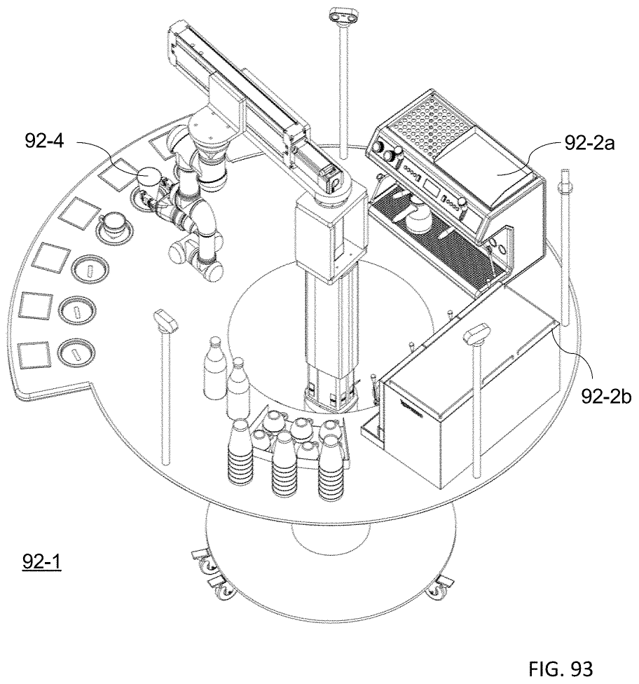

FIG. 92 is a block diagram illustrating an isometric front view of a robo café 92-1 (or café barista) for a robot to serve a variety of drinks to customers. FIG. 93 is a block diagram illustrating an isometric back view of the robotic café 92-1 for a robot to serve a variety of drinks to customers. Drinks may include, but not limited, to latte, cappuciono, caffe mocha, espresso. The robo café (or robotic café) 92-1 comprises one or more robotic arms 18-6 and one or more robotic end effectors 18-7 that executes one or more minimanipulations to prepare a coffee order in response to an order request from a customer, which a processor in the robo café 92-1 may receive the order from an electronic device from the customer. The executed one or more minimanipulations may be part of a minimanipulation library for preparing a variety of coffees. The one or more robotic arms 18-6 and one or more robotic end effectors 18-7 in the robo café 92-1 executes one or more minimanipulations to operate the one or more coffee machines 92-2a, 92-2b, and the one or more cups or pitchers 92-3, to prepare the requested coffee from the electronic order of the customer. When the one or more robotic arms 18-6 and one or more robotic end effectors 18-7 has completed executing the one or more minimanipulations to finish preparing the requested order, the one or more robotic arms 18-6 and one or more robotic end effectors 18-7 places the coffee cup at a designated location 92-4 corresponding to the location of the requested customer.

The robo café 92-1 serves as one illustration in the application of the present disclosure. Other types of food module can be customized for the robot to access a minimanipulation library or minimanipulation libraries where the one or more robotic arms and one or more robotic end effectors provides some food offerings, like smoothies, boba (or tapioca or pearl) drinks, etc.

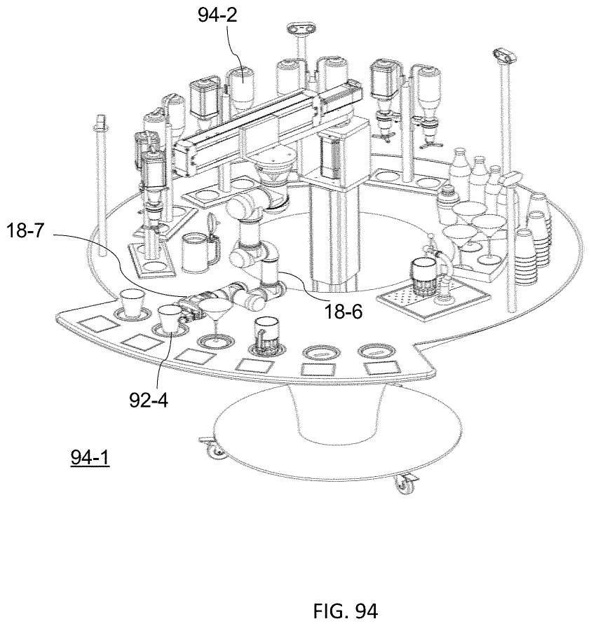

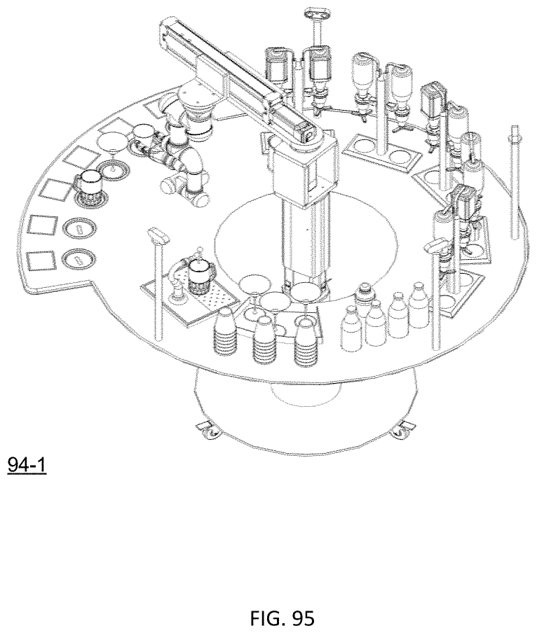

FIG. 94 is a block diagram illustrating an isometric front view of a robotic bar (barista alcohol or robo bar) 94-1 for a robot to serve a variety of drinks to customers in accordance with the present disclosure. FIG. 95 is a block diagram illustrating an isometric back view of the robotic café 94-1 for a robot to serve a variety of drinks to customers. Drinks 94-2 may include, but not limited, vodka, gin, baijiu, shōchū, soju, tequila, ruin, whisky, brandy, black Russian, daiquiri, gin and tonic, long island iced tea, mai tai, Manhattan, margarita, martini, tequila sunrise, are example of drinks. Mixed drinks can also include non-alcoholic drinks. The robo bar (or robotic bar) 17-8 comprises one or more robotic arms 18-6 and one or more robotic end effectors 18-7 that executes one or more minimanipulations to prepare an alcoholic or non-alcoholic drink order in response to an order request from a customer, which a computer processor in the robo bar 94-1 may receive the order from an electronic device from the customer. The executed one or more minimanipulations may be part of a minimanipulation library for preparing a variety of alcoholic or non-alcoholic drinks. The one or more robotic arms 18-6 and one or more robotic end effectors 18-7 in the robo bar 94-1 executes one or more minimanipulations to operate the one or more drink station 94-2, to prepare the requested drink from the electronic order of the customer. When the one or more robotic arms 18-6 and one or more robotic end effectors 18-7 has completed executing the one or more minimanipulations to finish preparing the requested order, the one or more robotic arms 18-6 and one or more robotic end effectors 18-7 places the drink at a designated location 92-4 corresponding to the location of the requested customer.

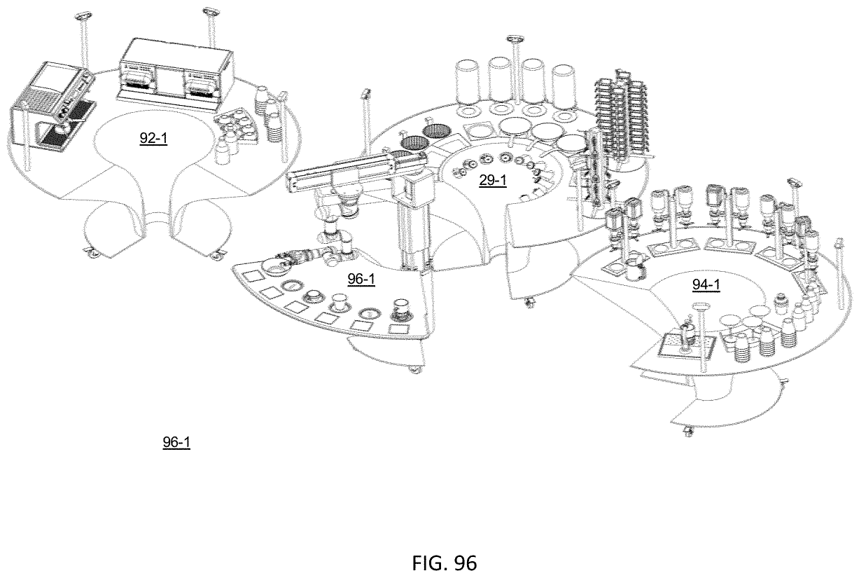

FIG. 96 is a block diagram illustrating a mobile, multi-use robot module 96-1 for fitting with either a cooking station 29-1, a coffee station 92-1, or a drink station 94-1. Generally, the multi-use robot module 17-4 can operate and fitted with any worktop, such as a cooking worktop, a coffee worktop, a drink worktop, or other types of worktops, where each worktop can have a different environment, such as in a cooking worktop with a different sets of cookware and utensils. The multi-use robot module 96-1 can be moved to connect with the cooking station prepare a variety of food dishes based in which the multi-use robot module 96-1 accesses and executes a minimanipulation library containing or more minimanipulations for preparing food dishes. The multi-use robot module 96-1 can be moved to connect with the coffee station 92-1 to prepare a variety of coffee drinks based in which the multi-use robot module 96-1 accesses and executes a minimanipulation library containing or more minimanipulations for preparing a variety of coffee drinks. The multi-use robot module 96-1 can be moved to connect with the drink station 94-1 to prepare a variety of alcoholic or non-alcoholic drinks based in which the multi-use robot module 96-1 accesses and executes a minimanipulation library containing or more more minimanipulations for preparing a variety of alcoholic or non-alcoholic drinks.

A system for mass production of a robotic kitchen module comprising a kitchen module frame for housing a robotic apparatus in an instrumented environment, the robotic apparatus having one or more robotic arms and one or more effectors, the one or more robotic arms including a share joint, the kitchen module having a set of robotic operable parameters for calibration verifications to an initial state for operation by the robotic apparatus; and one or more calibration actuators coupled to a respective one of the one or more robotic arms, each calibration actuator corresponding to an axis on x-89-21 each actuator in the one or more calibration three-degree actuators having at least three degrees of freedom, the one or more actuators comprising a first actuator for compensation of a first deviation on the x-axis, a second actuator for compensation of a second deviation on the y-axis, a third actuator for compensation of a third deviation on the z-axis, and a fourth actuator for compensation of a fourth deviation on rotational on x-rail; and a detector for detecting one or more deviations of the positions and orientations in one or more reference points in the original instrumented environment and a target instrumented environment thereby generating a transformational matrix, applying the one or more deviations to one or more minimanipulations by adding or subtracting to the parameters in the one or more minimanipulations. The detector comprises at least one probe. The kitchen module frame has a physical representation and a virtual representation, the virtual representation of the kitchen module frame being fully synchronized with the physical representation of the kitchen module frame.

A robotic multi-function platform comprising an instrumental environment having an operation area and a storage space, the storage area having one or more actuators, one or more rails, a plurality of locations, and one or more placements; one or more weighting sensors, one or more camera sensors, and one or more lights a processor executed to operate receiving a command to locate an identified object, the processor identifying the object location of the object in the storage area, the processor activating the one or more actuators to move the object from the storage area to the operation area of the instrumented environment. The storage space comprises a refrigerated area, the refrigerated area including one or more sensors and one or more actuators, and one or more automated doors with one or more actuators. The instrumented environment comprises one or more electronic hooks to change the orientation of the object.

A multi-functional robotic platform comprising one or more robotic apparatus; one or more end effectors; one or more operation zones; one or more sensors; one or more safety guards; a minimanipulation library comprising one or more minimanipulations; a task management and distribution module receiving an operation mode, the operation mode including a robot mode, a collaborative mode and a user mode, wherein in the collaborative mode, the task management and distribution module distributing one or more minimanipulations to a first operation zone for a robot and a second operation zone for the user; and an instrumented environment with one or more operational objects adopted for human and one or more robotic apparatuses interactions.

A method of structuring the execution of a robot movement or environment interaction sequence, defined by a pre-determined and -verified set of action primitives with well-defined starting and ending boundary configurations and execution steps, well defined through parameters, and executed in a sequence comprising (a) sensing and determining the robot configuration in the world using robot-internal and -external sensory systems, (b) using additional sensory systems to image the environment, identify objects therein, locating and mapping them accordingly, (c) developing a set of transformation parameters captured in one or more transformation matrices thereafter applied to the robot system as part of an adaptation step to compensate for any deviations between the physical system configuration and the pre-defined configuration defined for the starting point of a particular command sequence, (d) aligning the robotic system into one of multiple known possible set of starting configurations best-matched to the first of multiple sequential action primitives, (e) executing the pre-defined sequence of action primitives by way of a series of linked execution steps, each of the steps constrained to start and end at each respective step's pre-defined starting and exit configuration, whereby each step sequences into a succeeding step, only after satisfying a set of pre-defined success criteria for each of the respective steps, (g) completing the pre-determined set of steps within one or more AP required for the execution of a specific command sequence, (h) performing the steps of sensing the robot and environment and associated steps of imaging, identification and mapping, with a subsequent adaptation process involving the computation and application of a set of configuration transformation parameters to the robot system, ideally only at the beginning and end of the entire command sequence, and (i) storing all parameters associated with each of the aforementioned steps in a readily accessible database or repository. The execution sequence and associated boundary configurations of each action primitive are described by parameters that can be defined by an outside process involving simulation of the process in a virtual world developed on a computerized model, allowing for the extraction of all needed configuration parameters based on the idealized representation of the robotic system, its environment and the command sequence steps, or using a teach playback method by which the robot can be moved, either manually or through a teach-pendant interface by a human operator, allowing for the encoding and storage of all the individual steps and their associated configuration parameters, or manual encoding by having the human define all the respective movement and interaction steps using joint- and/or cartesian positions and configurations with associated time-stamps, and thereby build execution steps through a set of user-defined action primitives along a user-defined time-scale, which are then manually combined into a specific set of command sequences, or capturing the sequences and their associated parameters by monitoring a professional practitioner carrying out the desired movements and interactions and converting these into machine-readable and -executable command sequences. the parameters captured and stored for future use, include, but are not limited to parameters that describe allowable poses or configurations of the robotic system handling or grasping any particular tool needed in the execution of a particular process step within a particular command sequence, and Individual process steps broken down into macro APs, whereby a sequence of macro-APs constitutes a particular single process step within the entire command sequence, and further structuring each macro-AP into a sequence of smaller micro-APs or process-steps, whereby a sequence of micro-APs constitutes a single macro-AP, and the starting and exit configurations of each macro- and micro-AP that the robotic system and its associated tools have to pass through between each AP, before being allowed to proceed to the next macro- and micro-AP within a given sequence, and the associated success criteria needing to be satisfied before starting and concluding each macro- and micro-AP within each sequence, based on sensory data from the robotic system, the environment and any significant process variables. The experimental verification and validation ensure a guaranteed performance specification, ensuring the final sequence parameters can be stored within an MML process database. A possible set of starting configurations for each command sequence has been identified and stored in on-board system memory, allowing the system to select the closest best-match configuration based on a comparison of robot-internal and external environmental sensory data. Reconfiguring a robotic system from a current configuration, to a new and different configuration pre-defined as the starting configuration for one or more steps within a cooking sequence, with each cooking step describes a sequentially-executed set of APs, the steps of said adaptation process consisting of a reconfiguration process which includes sensing and determining the robot configuration in the world using robot-internal and -external sensory systems, using additional sensory systems to image the environment, identify objects therein, locating and mapping them accordingly, developing a set of transformation parameters captured in one or more transformation vectors and/or matrices thereafter applied to the robot system as part of an adaptation step to compensate for any deviations between the physical system configuration and the pre-defined configuration defined for the starting point of a particular step within a given command sequence, aligning the robotic system into one of multiple known possible set of starting configurations best-matched to the first of multiple sequential action primitives, and returning control to the central control system for execution of any follow-on robotic movement steps described by a sequence of APs within a particular recipe execution process. The defined adaptation process for the robotic systems is performed at one or more of the following situations at the beginning of the entire command sequence as defined by the first AP and its associated robotic system starting configuration parameters within a particular recipe execution sequence, or at the conclusion of a cooking sequence as defined by the last AP and its associated robotic system starting configuration parameters within a particular recipe execution sequence, at the beginning or conclusion of any particular AP, with its associated starting and exiting robot system configuration parameters, so defined as a critical AP within the recipe execution process so to ensure eventual successful recipe execution, at any step interval within a particular recipe execution sequence, with the step interval determined a-priori by the operator or the robot system controller, or at the conclusion of any particular AP step within a robotic cooking sequence, with its associated exiting robot system configuration parameters, whereby a numerically determined execution-error metric based on deviations from pre-defined success criteria and their associated parameters, exceeds a threshold defined for each AP step. The adaptation process is not allow to occur at every time-step within the controller execution loop of the AP execution sequence, nor at a rate that results in a computational delay or stack-up of execution time that exceeds the time-interval defined by the fixed time difference two succeeding time-steps of the robotic controller execution loop, thereby compromising the overall execution time while also jeopardizing the successful completion of the overall robotic cooking sequence.

A robotic kitchen system comprises a master robotic module assembly having a processor, one or more robotic arms, and one or more robotic end effectors; one or more slave robotic module assemblies, each robotic module assembly having one or more robotic arms and one or more robotic end effectors, the master robotic module assembly being positioned at one end that is adjacent to the one or more slave robotic module assemblies, wherein the master robotic module assembly receiving an order electronically to prepare one or more food dishes, the master robotic module assembly selecting a mode to operate for providing instructions and collaborating with the slave robotic module assemblies. The mode comprises a plurality of modes having a first mode and a second mode, during the first mode, the master robotic module assembly and the one or more slave robotic module assemblies preparing a plurality of dishes from the order, during a second mode, the master robotic module assembly and the one or more slave robotic module assemblies operate collectively to prepare different components of a same dish from the order, the different components of the same dish comprises an entrée, a side dish, and dessert. Depending on the selected mode, either as the first mode or the second mode, the processor at the master robotic assembly sends instructions to the processors at the one or more slave robotic assemblies for the master robotic assembly and the one or more slave robotic assembly to execute a plurality of coordinated and respective minimanipulations to prepare either a plurality of dishes, or a different components of a dish. The master robotic module assembly receives a plurality of orders and distributes the plurality of orders among the master robotic module assembly and the one or more slave robotic module assemblies in preparing a plurality of orders, one or more robotic arms and the one or more robotic end effectors of the master robotic module assembly preparing one or more distributed orders, and one or more robotic arms and the one or more robotic end effectors at each slave robotic module assembly in the one or more slave robotic module assemblies preparing the one or more distributed orders received from the master robotic module assembly. The master robotic module assembly receives a plurality of orders within a time duration, if the plurality of orders involving a same food dish, the master robotic module assembly allocates a larger portion to prepare the same food dish that is proportional to the number of orders for the same dish, the master robotic module assembly then distributing the plurality of orders among the master robotic module assembly and the one or more slave robotic module assemblies, one or more robotic arms and the one or more robotic end effectors of the master robotic module assembly or one or more robotic arms and the one or more robotic end effectors of the one or more slave robotic module assemblies preparing the same food dish in a larger portion proportional to the number of orders for the same food dish. The master robotic module assembly and the one or more slave robotic module assemblies prepares the plurality of dishes from the order for one customer. The master robotic module assembly and the one or more slave robotic module assemblies operate collectively to prepare different components of a same dish from the order for one customer.

A robotic system comprises a cooking station with a first worktop and a station frame, the worktop is placed on station frame, the worktop including a first plurality of standardized placements and a first plurality of objects, each placement being used to place an environmental object, the cooking station having an interface area; and a robotic kitchen module having one or more robotic arms and one or more robotic end effector, the robotic kitchen module having a first contour, the robotic kitchen module being attached to the interface area of the cooking station. The first worktop of the cooking station is changed to a second worktop, the second worktop including a second plurality of standardized placements. The first plurality of objects is changed to a second plurality of objects for use in the first worktop of the cooking station. The robotic kitchen module is a mobile module that can be detached from the interface area of the cooking station, the interface area providing space for a human to operate the cooking station instead of operated by the robotic kitchen module. The workstop comprises a food dish worktop, a coffee worktop, boiling, frying, and others. The plurality objects comprises coffee machines, bottles, ingredient carousel and others. A macro active primitive (AP) structure or a micro active primitive (AP) structure is selected to minimize the number of degree of freedom for the one or more robotic arms and the one or more robotic end effectors to operate in the environment of the cooking station. One or more entry/exit joint state configurations for operating one or more minimanipulations, micro action primitive, or macro primitive.

### Control Software Architecture

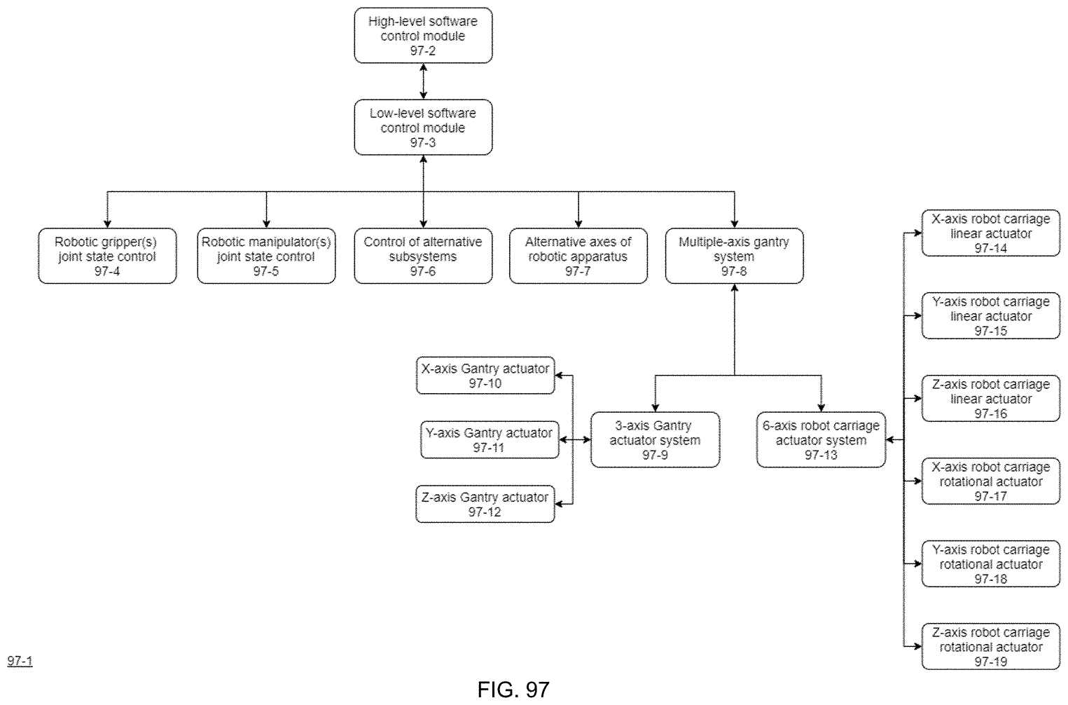

FIG. 97 is a block diagram depicting a control software architecture 97-1 of the robotic apparatus. The control software architecture comprises one or more control modules. In this embodiment, the control software architecture includes two software control modules: a high-level software control module 97-2 and a low-level software control module 97-3. A processor 182-1 executes the high-level software control module 97-2. The high-level software control module 97-2 is configured to handle a variety of different processes including but not limited to the planning of trajectories, interactions with and transformations of placements and/or devices and/or objects (or combination of) within the virtual model. The high-level software control module 97-2 is configured to communicate with the low-level software control module 97-3. The processor 182-1 executes the low-level software control module. The low-level software control module is configured to handle the control of hardware components of the robotic system. In this embodiment, the low-level software control module is a Programmable Logic Controller (PLC) that controls the robotic gripper(s) joint state 97-4 and robotic manipulator(s) 97-5 of the robotic apparatus. Additionally, the low-level software control module 97-3 is configured to interact with other electronic subsystems 97-6 and controls the non-robotic axes 97-7 of the robotic apparatus as well as the multiple axis gantry system 97-8. The above description provides one embodiment for implementing the high-level software control module 97-2 and low-level software control module 97-3. It is contemplated that many changes and modifications to the high-level software control module 97-2 and low-level software control module 97-3 may be made by one of ordinary skill in the art without departing from the spirit and scope of the claimed invention.

The multiple-axis gantry system comprises the main 3-axis gantry actuator system 97-9, controlling the X-axis gantry actuator 97-10, Y-axis gantry actuator 97-11 and Z-axis gantry actuator 97-12 as well as the 6-axis robot carriage actuator system 97-13 which controls the X-axis robot carriage linear actuator 97-14, the Y-axis robot carriage linear actuator 97-15, the Z-axis robot carriage linear actuator 97-16 and the X-axis robot carriage rotational actuator 97-17, Y-axis robot carriage rotational actuator 97-18, and Z-axis robot carriage rotational actuator 98-19.

### Minimanipulation Library

A robot system includes a library of minimanipulations (also referred to as “minimanipulation library”, or one or more libraries of minimanipulations. Each minimanipulation library comprises a plurality of minimanipulations, or one or more minimanipulations. The plurality of manipulations in a minimanipulation library can be decomposed into low-level manipulations or even action primitives (APs). In one embodiment, all minimanipulations in a minimanipulation library are parameterized (also referred to as “parameterized). In one embodiment, the parameters include the name of the minimanipulation, the placement to be interacted with, timing parameters such as start-point, end-point and duration of the minimanipulation, as well as other parameters such as environmental parameters including but not limited to temperature, humidity and location of other objects inside the operating environment, hardware parameters including but not limited to the type of robot system and gripper used, configuration of hardware architecture and number of actuators controlled by the robot controller. These parameterised minimanipulations include the structure of the trajectory and can be of different types such as pre-planned JST parameterised minimanipulations, or live-planned cartesian trajectory parameterised minimanipulations or motion-planned trajectory parameterised minimanipulations.

In one embodiment, the robotic apparatus is that of a robotic kitchen and the parameterised minimanipulations involve operations that are associated with recipe execution. Parameterised minimanipulations stored in the library of minimanipulations may include minimanipulations that handle kitchen utensils such as a spatula, cookware components such as a pot, and carry out different processes such as pouring or stirring of ingredients. By executing a sequence of parameterised minimanipulations a complete recipe can be carried out and a complete dish can be prepared.

Pre-planned JST are a type of parameterised minimanipulations that are saved in a cache and are retrieved when requested to be executed. In one embodiment, pre-planned JST minimanipulations are developed either by simulating a desired action inside a virtual environment of the etalon kitchen model or by recording a desired action on a physical model of the robotic apparatus. Multiple pre-planned JST parameterised minimanipulations of the same action may exist but they will have different parameter combinations such that all or a desired number of possible parameter combinations is stored in the library of minimanipulations.

As an example, the stirring pre-planned JST parameterised minimanipulations can be planned inside a virtual environment or recorded on a physical robotic apparatus multiple times with different manipulation parameters; e.g. utensil type can be small spatula, long spoon, tongs, and combined cookware type can be a pot, a pan, a wok. Another set of parameters that pre-planned JST minimanipulations can be pre-recorded or pre-planned for is the type of ingredient or combination of ingredients that the minimanipulation is stirring inside a cookware, such as chopped onions, diced potatoes or rice, as well as the state of the ingredient or combination of ingredients that the minimanipulation is stirring, e.g. raw rice, pre-cooked rice, raw onion, caramelised onion. Pre-planned JST minimanipulations with different timing parameters may also be developed e.g. stirring for 5 second or 10 second etc, as well as with different speed and direction of motion parameters e.g. stirring 2 times clockwise within 10 seconds or stirring 5 times counterclockwise within 10 seconds.

By having a global library of pre-planned JST parameterised minimanipulations that includes all or the desired number of pre-planned JST minimanipulations for stirring, with all or the desired number of unique parameter combinations for the same action, allows the system to carry out all or the desired number of stirring actions inside any physical robotic kitchen model of the exact same configuration. For example, as the robotic apparatus is carrying out a recipe involving pre-cooked rice inside a medium-sized pot that requires stirring for 5 seconds using a silicone spatula, the planning software simply requests a pre-planned JST stirring minimanipulation from the library, and sets all the desired parameters for this minimanipulation such that the stirring pre-planned JST parameterised minimanipulation with the corresponding parameters is selected.

Local parameterised minimanipulation library can be uniquely developed using live-planned cartesian trajectory parameterised minimanipulations. In one embodiment, a local parameterised minimanipulation library can be uniquely developed for each physical robotic kitchen model. The process of developing a local parameterised minimanipulation library is as follows.

Live-planned cartesian trajectory minimanipulations are parameterised by assigning different parameters including but not limited to environmental constraints, space constraints or time constraints. Live-planned cartesian trajectory parameterised minimanipulations are then re-planned for a number of times and for all or a desired number of parameter combinations, inside the operating environment of an etalon kitchen model. The success of parameter fit to the requested parameters is assessed after every planning iteration. Cartesian trajectory minimanipulations that have been successfully live-planned for a desired percentage of re-plans are then stored inside a global library of cartesian minimanipulations. On a physical model of the robotic kitchen, one or more of the calibration procedures explained in the current disclosure is executed in order to adjust the virtual model of the robotic kitchen to match the physical model of the robotic kitchen. Following that, cartesian trajectory parameterised minimanipulations from the global cartesian library of minimanipulations are subsequently live-planned multiple times. Cartesian trajectory minimanipulations that have been successfully live-planned for a desired percentage of re-plans are then stored inside a local library of cartesian minimanipulations. Cartesian minimanipulations stored inside the local library of cartesian minimanipulations can then be requested and executed by the robotic apparatus in the same way that pre-planned JST parameterised minimanipulations are executed from the library of minimanipulations. Re-planning of cartesian trajectory minimanipulations is repeated after a predetermined amount of time or after a deviation that affects specific minimanipulations is detected on the physical robotic apparatus. In this way, the local library of cartesian minimanipulations is updated to account for any changes to the physical environment.

### Functional Outcome Evaluation

One advantage of pre-planned JST minimanipulations over live-planned parameterised (also referred to as “parameterized” in the present disclosure) minimanipulations is that they can be pre-tested on a physical model of a robotic apparatus during a testing phase, before being saved and stored in the library of minimanipulations. This enables the evaluation of their respective level of performance based on predetermined evaluation criteria of their functional outcome. The performance level of such parameterised minimanipulations can, thus, be assigned as a parameter to each pre-planned JST parameterised minimanipulations found in the library of minimanipulations. One parameter can then be considered and utilised during sequence execution of robotic operations. Evaluation parameters are determined based on the operation and ideal functional outcome of each pre-planned JST minimanipulations, and are defined by the creator of the specific minimanipulations.

In another example, the robotic apparatus has an embodiment of a Robotic Kitchen, where pre-planned JST parameterised minimanipulation training of a stirring action can take place with the functional outcome of successfully stirring ingredients inside a piece of cookware. In this example, evaluation parameters may include aspects of the process that should be in place, e.g. the utensil should be inside the cookware. Additionally evaluation parameters may include aspects of the process that should not be in place, e.g. ingredients should not come out of the cookware or smells that would indicate that an ingredient is expired should not be present during execution. By repeating the training of a specific minimanipulation multiple times, and evaluating the functional outcome of each try, the creator is able to identify any additional evaluation parameters that might have not been obvious from the beginning. In the IV cannulation example, such evaluation parameters might be visual differences in the injection area amongst patients of different age, gender or with different anatomical dimensions.

All identified evaluation parameters are then classified into different use cases with each use case requiring at least one aspect of the minimanipulation to be performed differently from all other use cases, in order to ensure a successful functional outcome. All these cases are then translated into pre-planned JST parameterised minimanipulations that are programmed into the robotic apparatus.

The testing stage follows the training stage. During the testing stage, each of these parameterised minimanipulations is executed and tested multiple times. In this stage, all evaluation parameters are monitored by either sensors or the observer, and are compared to the ideal evaluation parameters. Thus, the level of performance for each manipulation is determined as the average of a sufficiently large number of tests. The level of performance can thus be assigned as a parameter of each pre-planned JST parameterised minimanipulation before each and every pre-planned JST parameterised minimanipulation is stored in the library of parameterised minimanipulations.

By obtaining the level of performance for each pre-planned JST parameterised minimanipulation and assigning it as a parameter equips every embodiment of the robotic apparatus with a higher level of reliability as the possibility of a successful functional outcome is predetermined, pre-tested and pre-verified. This remains true as long as all the parameters including the relative location between the robotic system and the object or the device it interacts with are identical to the parameters that the requested pre-planned JST parameterised minimanipulation was pre-tested in.

Another functional outcome evaluation is in a robotic apparatus embodiment of a robot doctor, performing intravenous cannulation (IV) on a patient's arm. In this example, the pre-planned JST parameterised minimanipulation is created by the creator during the training stage; in this case, a doctor or a trained professional. During this stage, evaluation parameter data is recorded by integrated sensors on the apparatus or by the creator, such as, for example, preparatory actions prior to injection e.g. fitting of a pressure band and cleaning the injection area, the location of the injection relative to a patient's arm, as well as the speed of motion, depth of injection etc. All these evaluation parameters are pre-determined and they are classified as to whether they can be evaluated by feedback data from sensors or an observer, in the case where no sensor that can evaluate this type of parameter exists.

### Transformation Matrix Applications

The execution of a pre-tested, pre-planned JST parameterised minimanipulations inside a physical robotic apparatus carries a level of reliability in terms of a successful functional outcome, however, it has to ensure that all the parameters of the requested minimanipulation are identical to the parameters of the minimanipulation as they were during the training and testing stage. In one embodiment, one of the significant parameters that applies to all minimanipulations inside the library of minimanipulations would be the relative location and orientation of the robotic system and the objects and/or placements and/or other devices (or combination of) that are to be interacted with during the execution of the requested manipulations.

In different embodiments of robotic apparatuses, frequently there are deviations to be expected when comparing a physical model to a virtual model. The system outlined in the present disclosure can apply a unique transformation matrix to the robotic system such that it ensures that any small deviations between a two-dimensional (2D) or three-dimensional (3D) physical and a 2D or 3D virtual model (also referred to as etalon model) of a robotic apparatus, or deviations between multiple different physical models of a robotic apparatus at specific reference points are compensated for.

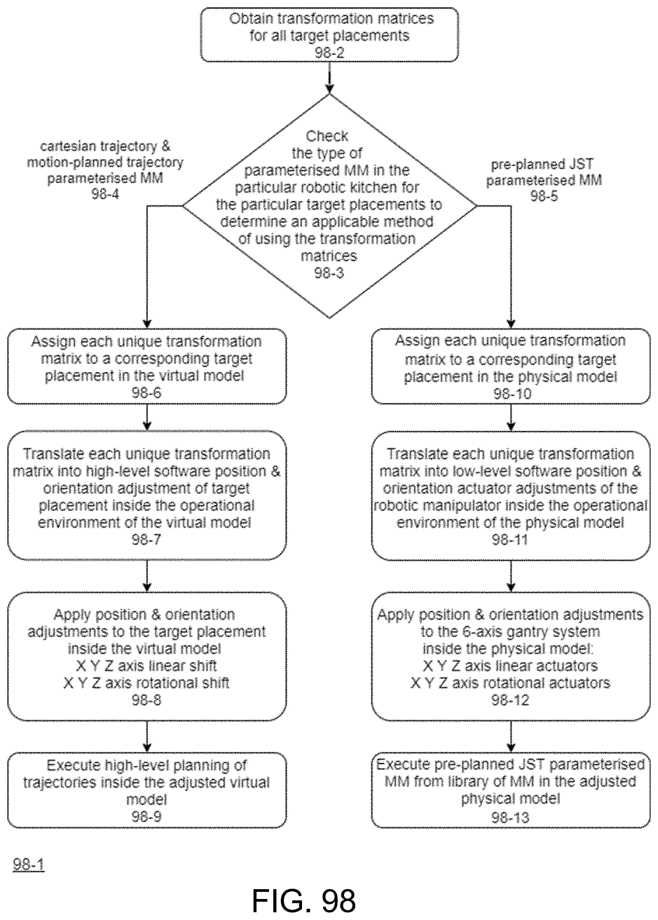

FIG. 98 is a block diagram depicting the process of transformation matrix (also referred to as “mathematical transformation” in one embodiment) application. In this embodiment, the model of the robotic apparatus comprises of a number of target placements inside the operational environment of a robotic kitchen. Other embodiments may include one or more target objects, one or more target placements and/or one or more target devices (or combination of) that the transformation matrices can be applied for in the same process. In this embodiment, the process of transformation matrix application starts by obtaining the transformation matrix for each target placement 98-2 inside the operational environment of the robotic kitchen that the robot intends to interact with. As there are two ways in which a transformation matrix can be applied to a robotic apparatus, the next step in the process checks the type of parameterised minimanipulations in the particular robotic kitchen for the particular target placements to determine the applicable method of using each transformation matrix 98-3. The process then sorts the transformation matrices into those that are associated with target placements involving cartesian trajectory and/or motion-planned trajectory parameterised minimanipulations 98-4, and those that are associated with target placements involving pre-planned JST parameterised minimanipulations 98-5.

For transformation matrices that are associated with target placements involving cartesian trajectory and/or motion-planned trajectory parameterised minimanipulations, each unique transformation matrix is assigned to its corresponding target placement in the virtual model 98-6. Each unique transformation matrix is then translated into a high-level software position and orientation adjustments of the target placement inside the virtual model 98-7. These positional and orientational adjustments are then applied to the target placement inside the virtual model (for X-, Y-, Z-axis linear shifts and X-, Y-, Z-axis rotational shifts) 98-8. Finally, the system can then execute high-level planning of trajectories inside the adjusted virtual model 98-9 (also referred to as “transformed virtual model”). In this way, live planning of trajectories can compensate for any positional and orientational deviations between the virtual model of the apparatus, where the trajectories are being planned, and the physical model of the apparatus, where trajectories are being executed. This transformation matrix application method increases the accuracy and reliability of operation as any differences between the physical and virtual models become negligible. This application more closely resembles a calibration procedure that ensures that live planning of trajectories inside a virtual model can be executed in the physical model with a higher degree of accuracy.

For pre-planned JST patameterised minimanipulations, each unique transformation matrix is assigned to its corresponding target placement in the physical model 98-10. Each unique transformation matrix is then translated into a low-level software position and orientation actuator adjustments (at the PLC level) of the robotic manipulator inside the physical model 98-11. These positional and orientational actuator adjustments are then applied to the 6-axis gantry system inside the physical model (for X-, Y-, Z-axis linear actuators and X-, Y-, Z-axis rotational actuators) 98-12. Finally, the system can then execute pre-planned JST parameterised minimanipulations from the library of minimanipulations in the adjusted physical model 98-13 (also referred to as “transformed physical model”). This transformation matrix application method allows the control of the 6-axis gantry actuators that can translate any required locational and orientational adjustments to the robotic arm (or equivalent) such that deviations between the physical model's and virtual model's relative location of the robotic arm and a target placement that is to be interacted with are compensated on the physical apparatus, thus ensuring that the two models are identical in that respect. In one embodiment, during execution, the processor 182-2 in a system (such as a robotic kitchen 1-1 or the engine 1-2) may use an adjusted minimanipulation to achieve a predefined functional outcome at a predetermined performance level.

An advantage of the transformation matrix application for pre-planned JST parameterised minimanipulation execution is the ability to optimise computational resources, at the robotic apparatus level, without compromising on the reliability and performance of the system as a whole. This is because this transformation matrix application ensures that the relative position and orientation of a robotic manipulator and target object and/or placement and or device (or combination of) is the same, both in the virtual model as well as in the physical model. Thus, miednimanipulations can be performed with a known level of performance of the functional outcome without the need for live planning. Additionally, this ensures that the timing parameters of such parameterised minimanipulations remain fit to the requested multi-stage process file, thus ensuring that critical operations can be performed with a high degree of time accuracy. As per the examples of the embodiments in the present disclosure, this is a very significant benefit for robotic applications in the chemical, biotech, medical, packing and food preparation industries.

Transformation matrices are created uniquely for each physical and virtual model pair and for each reference point that the robot can interact with inside an operational environment. In other words, any interaction point has a unique transformation matrix that includes linear and rotational shifts of the robotic arm (or equivalent) along or around the X, Y and Z axes. After the robotic arm is placed at the location and orientation where it interacts with an object and/or placement and/or device, the transformation matrix is applied to make any final adjustment to the relative location and orientation of the robotic arm and the reference point of object or placement or device to be interacted with. In one embodiment, during execution, the processor 182-2 in a system (such as a robotic kitchen 1-1 or the engine 1-2) may use an adjusted minimanipulation to achieve a predefined functional outcome at a predetermined performance level.

### Multiple Axis Gantry

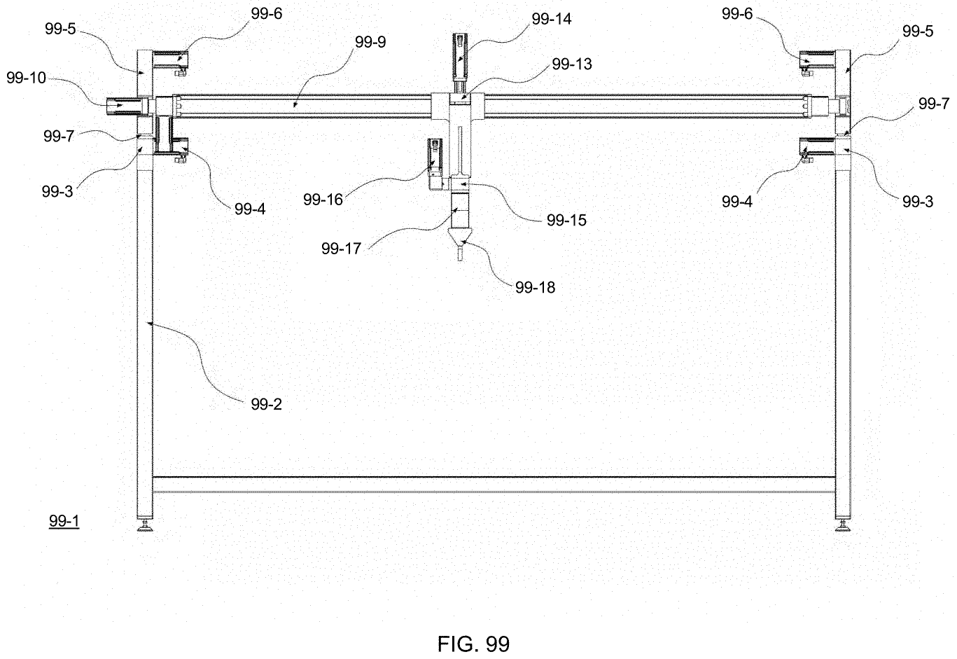

FIG. 99 depicts a front view of the multiple axis gantry system in accordance with the present invention.

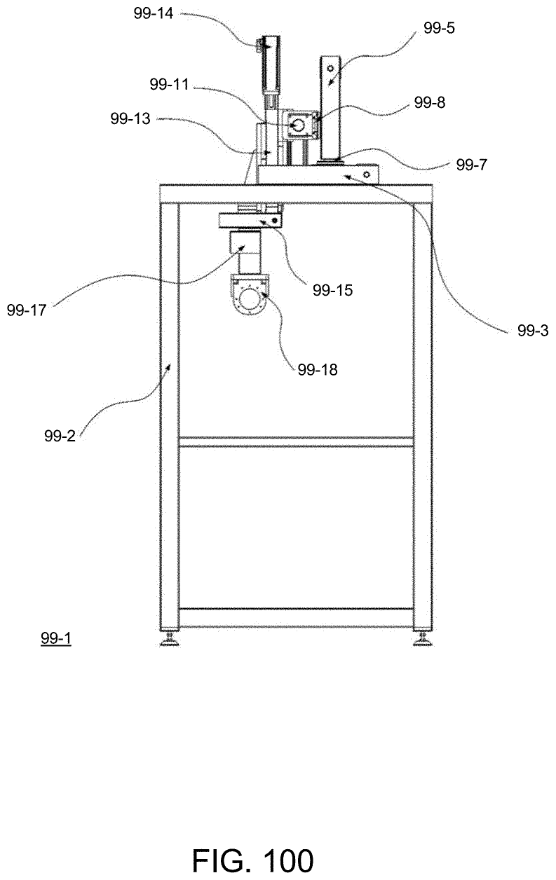

FIG. 100 depicts a side view of the multiple axis gantry system in accordance with the present invention.

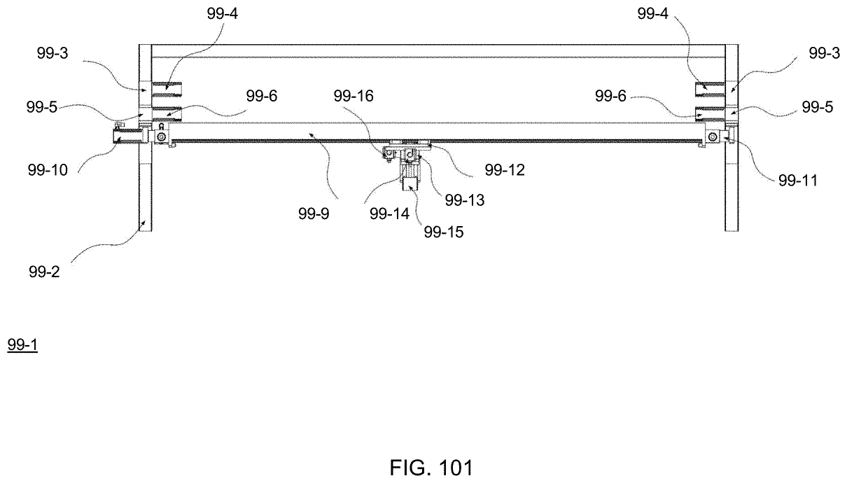

FIG. 101 depicts a top view of the multiple axis gantry system in accordance with the present invention.

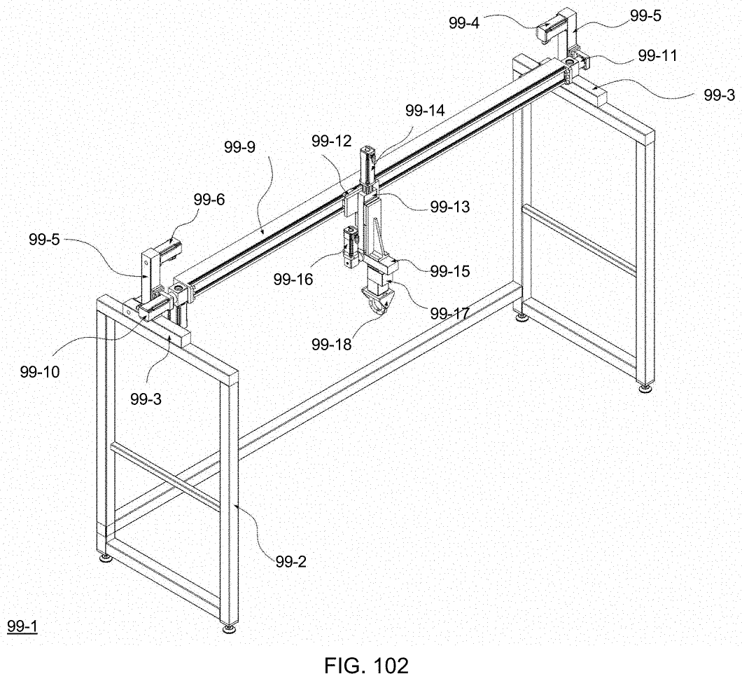

FIG. 102 depicts an isometric view of the multiple axis gantry system in accordance with the present invention.

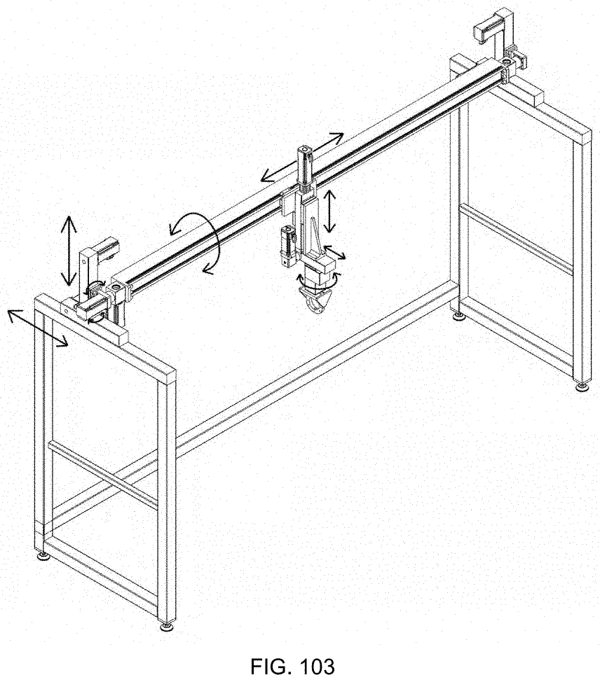

FIG. 103 depicts an isometric view of the multiple axis gantry (also referred to as “multi-axis gantry”) system which includes arrows that indicate the possible directions of motion for in accordance with the present invention.

FIGS. 99 to 103 are visual diagrams depicting a multiple axis gantry robotic system 99-1 that moves a robotic arm mount bracket 99-18 inside a volume (also referred to operation volume, operation space, operation workspace, operation theater, or instrumented environment), where the robot operates within the instrumented environment of the multiple axis gantry robotic system. An instrumented environment refers to a workspace in which a robot, placements and other objects are located within the workspace. The multiple axis gantry robotic system 99-1 includes multiple axes xx that are secured onto a frame 1 for providing actuating functions by using various different types of linear and/or rotary actuators, e.g. pneumatic actuators, hydraulic actuators, electric actuators etc.

A pair of y-axis gantry motors 99-4 move the robotic arm mount bracket 99-18 along a linear y-axis drive 99-3, and a separate pair of z-axis motors 99-6 move the gantry vertically along a linear z-axis drive 99-5. The motor pairs 99-4, 99-6 are able to move independently of each other such that they can twist the x-axis drive 99-9 around the z-axis and y-axis, respectively. A pair of bearings 99-7 allow for motion of the gantry to move around the z-axis when the y-axis motors move independently and, similarly, a second pair of bearings 99-8 enable motion of the gantry around the y-axis when the z-axis motors move independently.

The gantry system 99-1 incorporates a z-axis drive and motor 99-9 that carry the x-axis carriage 99-12 along the x-axis. The gantry is mounted on an x-axis rotation shaft 99-11 that allows the gantry to rotate around the x-axis using a x-axis rotary actuator 99-10.

The robot carriage interfaces to the gantry at the x-axis carriage 99-12. A z-axis motor 99-14 for the robotic arm system moves the robot system in the z-direction 99-13 and a y-axis motor 99-16 for the robotic arm system moves the robot carriage along a y-axis drive 99-15. Finally a rotary module 99-17, interfaced directly to the robotic arm mounting bracket 99-18, allowing rotation of the robot mounting bracket 99-18 along the z-axis.

FIG. 103 illustrates with arrows all possible motions of the multiple axis gantry system 99-1.

This multiple axis configuration of the gantry system 99-1 allows the robotic arm mount bracket 99-18 carrying one or more arms to reach any point within the workspace (or an instrumented environment of the robotic kitchen). Additionally, the multiple axis gantry 99-1 can make adjustments to the orientation of the robotic arm mount, both translational or rotational.

In one embodiment, the robotic system comprises a centralised control system 97-1 for controlling and interacting with different placements and/or subsystems integrated on the robotic kitchen system. The multiple axis gantry system moves the robot system to a cartesian location (X₁ Y₁ Z₁; Xᵣ Yᵣ Zᵣ) that matches the location of the robot system inside the etalon model such that interactions between the robotic system and a placement can be executed in the form of minimanipulations stored in a library. These minimanipulations have been created and tested on an etalon model of the robotic apparatus.

Variations between the etalon model and a robotic apparatus, the configuration of its operational environment as well as the location and orientation of placements present inside it, may exist due to manufacturing tolerances, installation mistakes or even planned changes during assembly of components. Such differences between the etalon model and the physical apparatus may result in failures during execution of minimanipulations. The multiple axis gantry can accommodate such differences between the etalon model and the physical apparatus, by applying orientational and translational transformations to the robotic system such that the relative location of the robotic system and a target placement that is to be interacted with, is optimised (also referred to as “optimized) and matched to the relative location of the robotic system and target placement in the etalon model.

By ensuring that the relative position is exactly the same or substantially exactly the same, the robotic system is able to execute minimanipulations from a library of minimanipulations, ensuring that a functional outcome with a high level of performance reliability can be expected, without the need of ensuring a high level of accuracy in terms of absolute positioning of the robotic system's components and/or placements. The methods of obtaining the transformational matrix are further described in the present disclosure.

There are several advantages to the system outlined in the present disclosure. For example, as the negative effects of placement mispositioning on the performance level of executions reduces, the level of tolerance required for the components at the manufacturing stage also correspondingly reduces, thus reducing the overall cost of component production. Furthermore, this multiple axis gantry system enables certain automatic calibration procedures, outlined in more detail in the present disclosure, that allow any robotic apparatus utilising this system to be set-up and configured much faster, reducing time and cost of installation as well as cost of reprogramming the apparatus after changes to the operational environment.

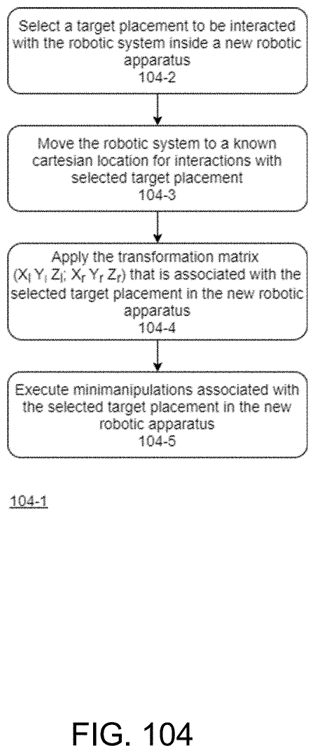

FIG. 104 is a block diagram depicting the process of adjusting the positional and orientational location of the robotic arm (or equivalent) using the multiple axis gantry systems, in accordance with the transformation matrix. In this embodiment, the model is that of a new robotic apparatus consisting of a robotic system mounted on the multiple axis gantry, and a placement. Firstly, the target placement that is to be interacted with the robotic system inside the new robotic apparatus is selected 104-2. The multiple axis gantry system then moves the robotic system to a known cartesian location where interactions between the selected target placement can take place 104-3. Following that, the transformation matrix (X₁ Y₁ Z₁; Xᵣ Yᵣ Zᵣ, where l=linear and r=rotational) that is associated with the selected target placement in the new robotic apparatus is applied 104-4. Minimanipulations that are associated with the selected target placement in the new robotic apparatus can then be executed 104-5.

### Independent Actuators for Multiple Robotic Arms

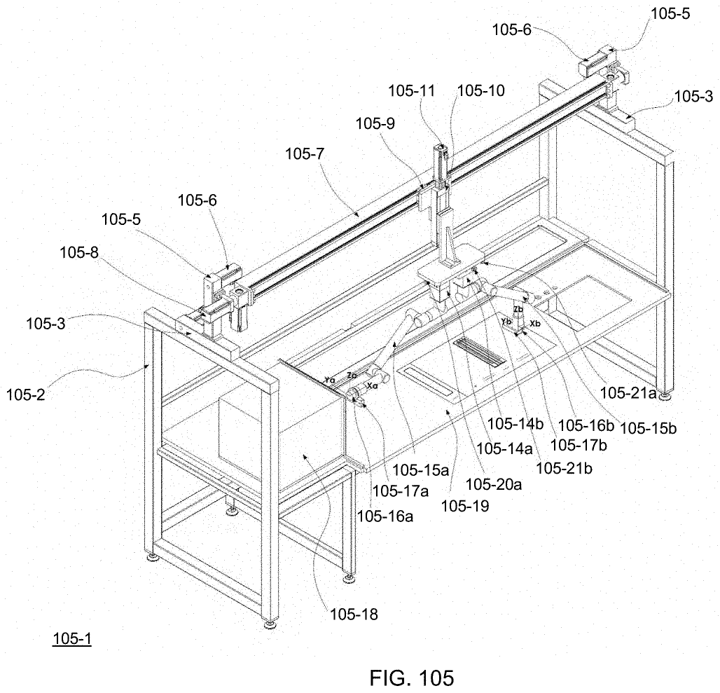

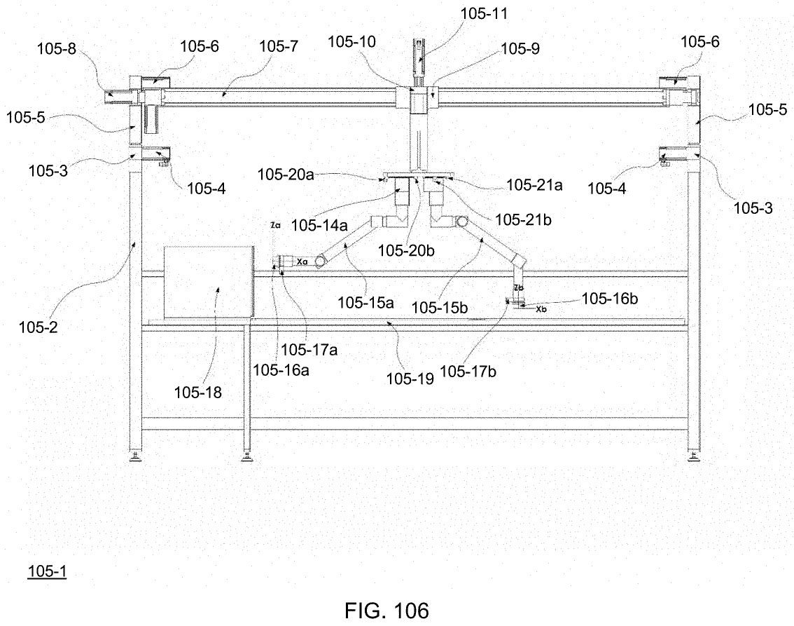

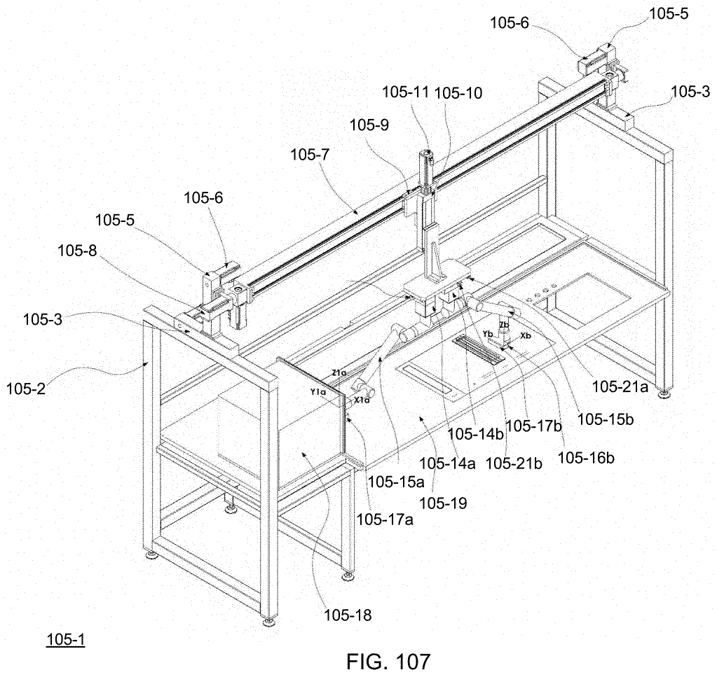

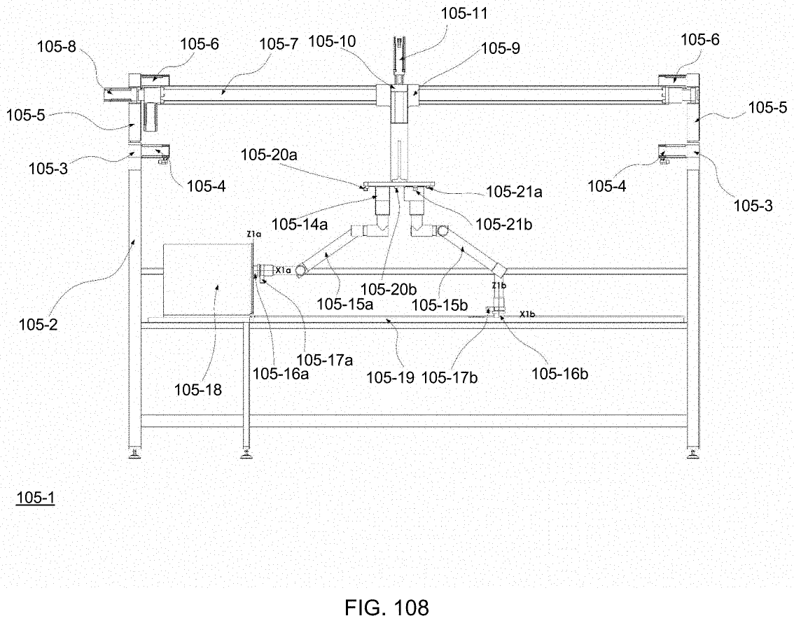

FIGS. 105 to 108 depict another embodiment of a robotic apparatus with the multiple axis gantry system. In this embodiment, there are two robotic arms, 105-15a and 105-15b, integrated onto the gantry at the mounting plate 105-20b. In this embodiment, each robotic arm is mounted onto separate, smaller multiple axis gantry systems 105-20a and 105-21, that is integrated onto the mounting plate. This allows each robotic arm's location to be adjusted independently. For instance, and as shown on the FIGs, the left Robotic arm 105-15a is interacting with an oven 105-18 whereas the right robotic arm is interacting with the worktop, 105-19. On the physical model of this robotic apparatus, the two placements, the oven 105-18 and worktop 105-19, can have certain deviations in terms of their location and orientation compared to the etalon virtual model of the apparatus. However, the locational and orientational deviations of the two placements will not be exactly the same. For example, the oven might have a +1 mm shift along the x-axis and the worktop might have a −1 mm along the x axis. In this embodiment, the unique transformation matrix that corresponds to the oven placement can be applied to the left robotic arm's multiple axis gantry system, 105-20a, thus, matching the location and orientation of the oven on the physical model to the one on the etalon virtual model. Similarly, the unique transformation matrix that corresponds to the worktop placement can be applied to the right robotic arm's multiple axis gantry system, 105-21, matching the location and orientation of the worktop on the physical model to the one on the etalon virtual model.

Different calibration procedures may be used to compensate for deviations during the installation of new robotic kitchens or deformation of a new robotic kitchen over time. One of ordinary skill in the art would recognize that the technology described in the present disclosure is applicable to other types of applications, like a medical instrumented environment, a chemical instrumented environment, etc. The automatic system calibration procedure based on force and torque sensing is detailed below.

### Force and Torque Sensing Based Technique for Calibration

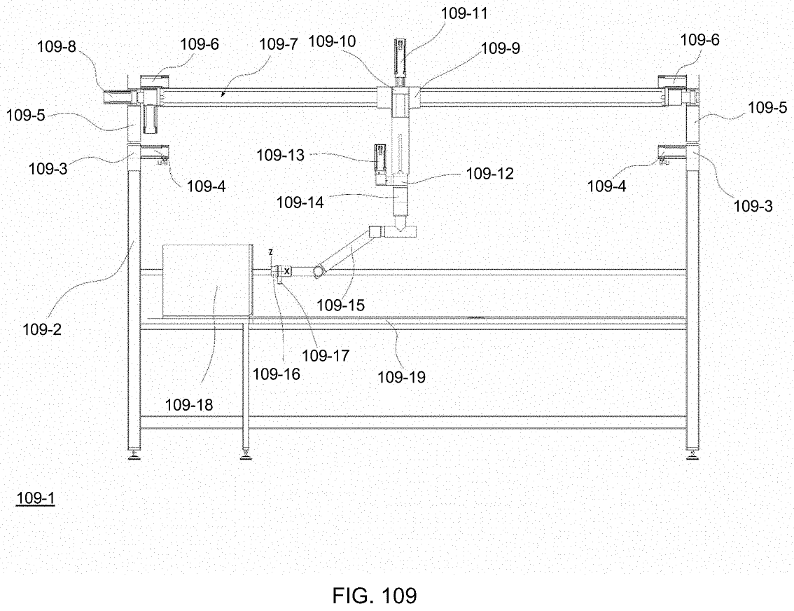

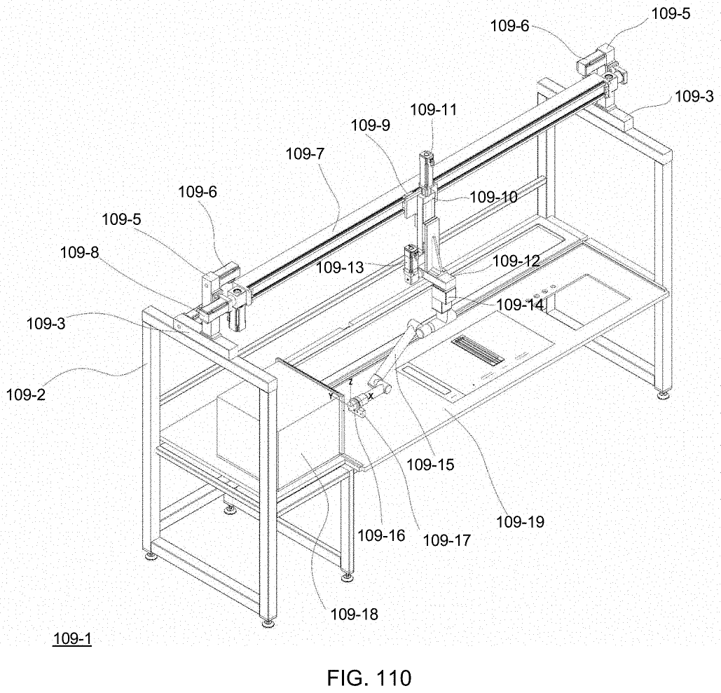

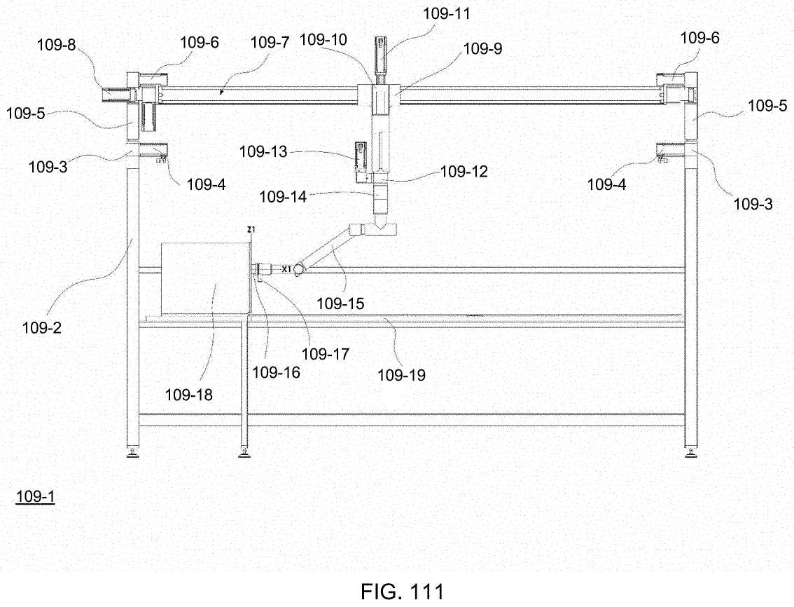

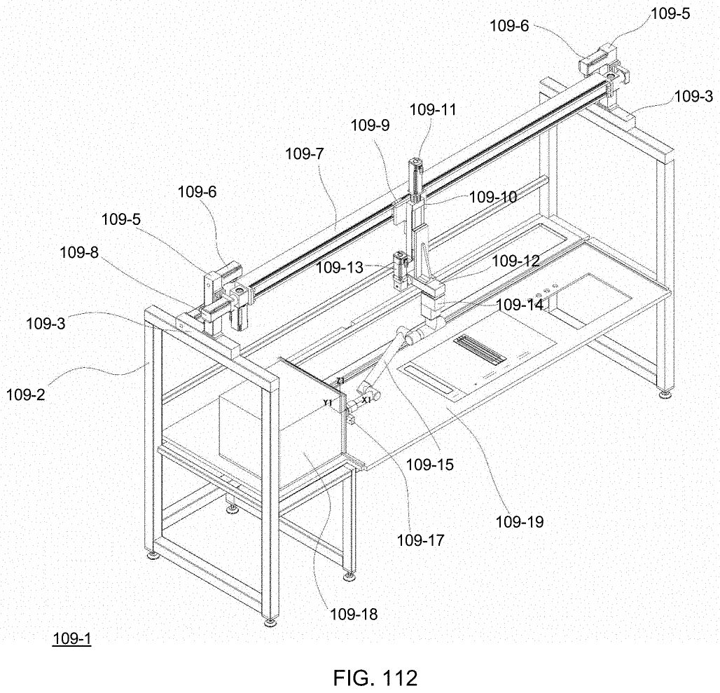

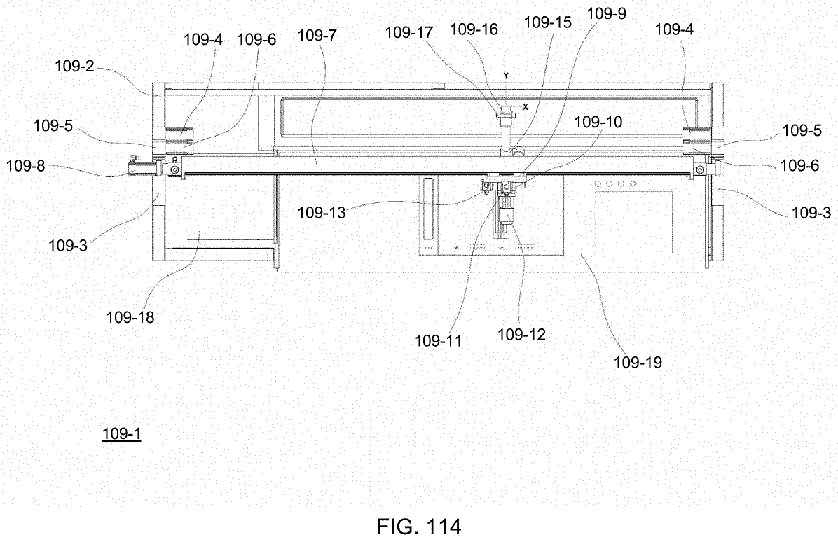

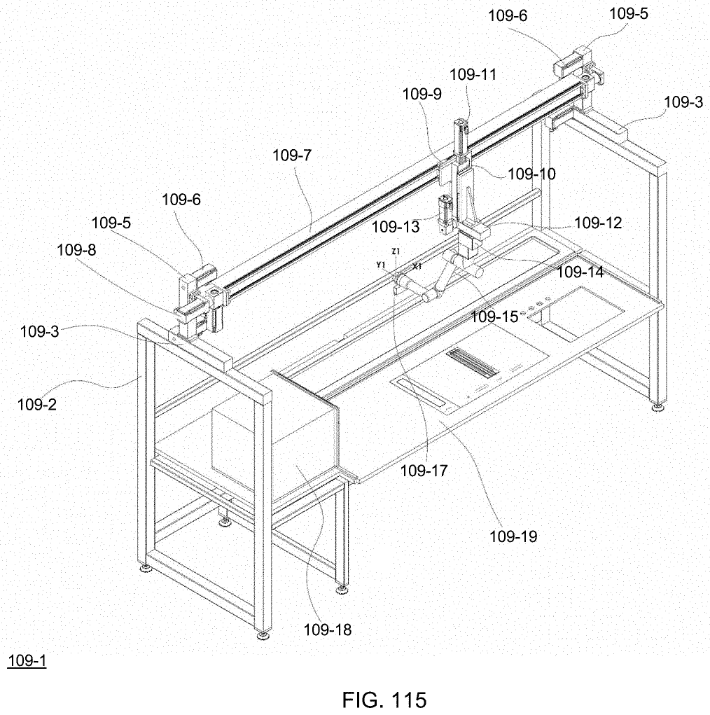

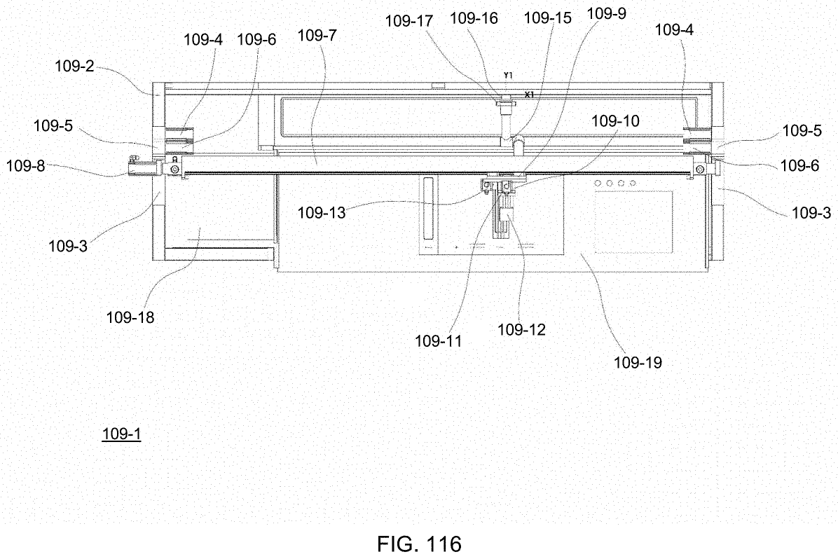

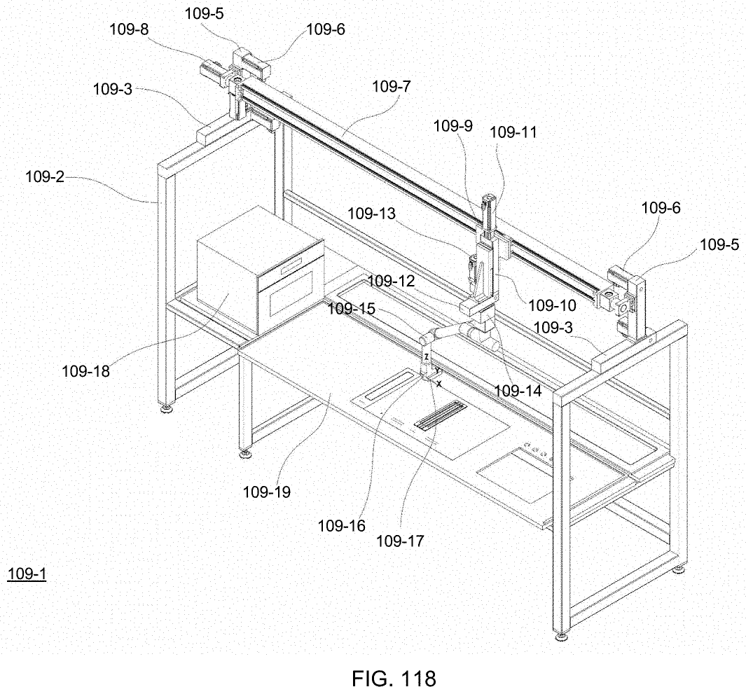

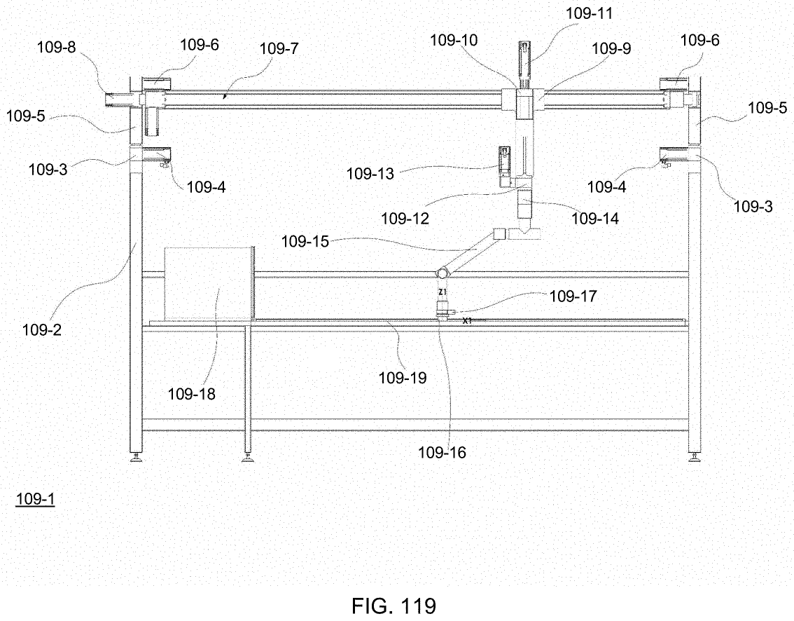

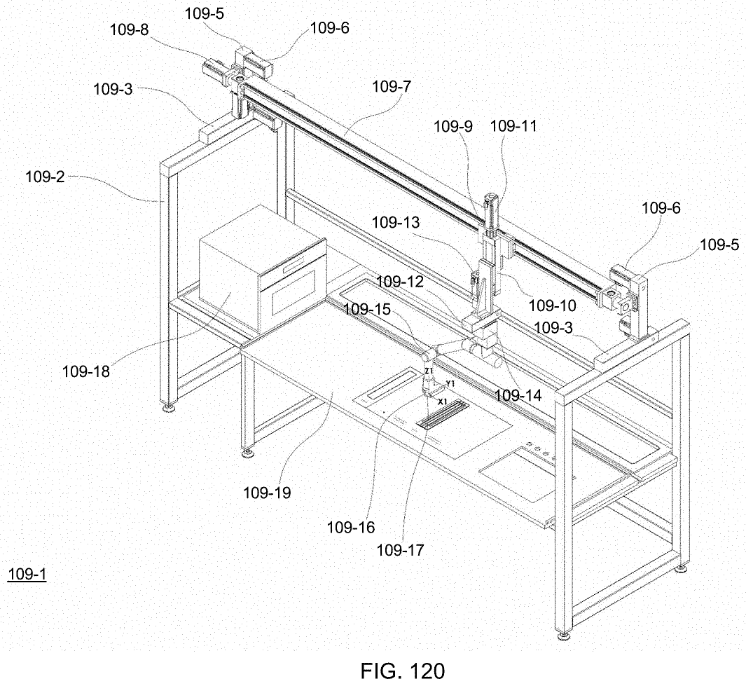

FIGS. 109 to 120 depict a robotic system 109-1. In this embodiment, the robotic system 109-1 interacts within an instrumented environment of a robotic kitchen, with an oven 109-18 and worktop 109-19, and carries a robotic arm 109-15, mounted on the robot carriage. A 6-axis force and torque sensor 109-16 is mounted as an end-effector on the robotic arm and incorporates a RGB-D camera module 109-17 that allows the system to identify objects and/or markers inside the environment. The term RGB-D refers to a RGB image and its corresponding depth image.

One aim of this calibration procedure is to automatically identify and determine the location and orientation of each placement that is present inside the robotic environment (or the instrumented environment of the robotic system 109-01), such as an oven 109-18. To achieve this, the system locates specific points of the placement and quantify their location within the 3D (three-dimensional) spatial volume of the robotic system 109-1. By comparing the 3D location of these points to the location of the exact same points of the same placement in an etalon kitchen, a processor in the robotic system is able to compute the positional shift of every point in x-y-z axes in the workspace. With this information, the robotic system thus determines the location and orientation of the specific placement, allowing the robotic system 109-1 to apply the computed shift to a library of minimanipulations (applicable to x-axis, y-axis, z-axis, rotary), in the form of a transformation matrix, and interact with the placement without requiring any training or teaching. As explained in the current disclosure, this is done by the use of pre-recorded JST parameterised minimanipulations that are stored inside a library of minimanipulations.

FIG. 109 to FIG. 121 depict the calibration procedure to determine the x-axis shift of a specific point on a placement using a 6 axis force and torque sensor.

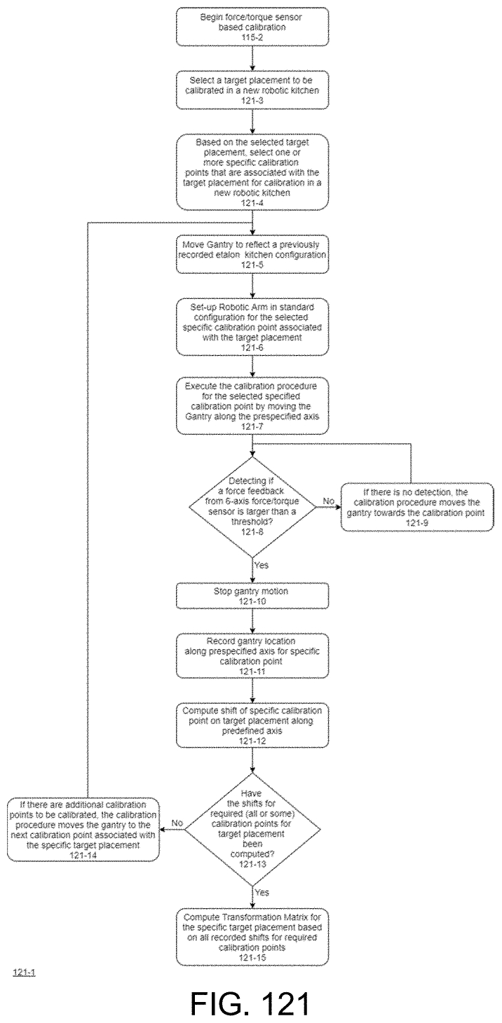

FIG. 121 is a block diagram depicting the calibration procedure with a 6-axis force/torque sensor. In this embodiment, the robotic apparatus is that of a robotic kitchen, with a single robotic arm mounted on the multiple-axis gantry system outlined in the present disclosure. In this embodiment, the target placement is an oven, mounted on a kitchen worktop.

The force and torque sensor calibration procedure begins 121-2 by selecting a target placement in a new robotic kitchen that is to be calibrated 121-3. Based on the selected target placement, one or more specific calibration points that are associated with the selected target placement are selected by the control system 121-4 in order to be able to detect the target placement's deviations in all axes that are relevant according to the type, location orientation as well as the robotic interactions that are associated with the specific target placement. The multiple axis gantry then moves the robotic system to reflect a previously recorded, initial etalon kitchen configuration 121-5.

In the example depicted on FIG. 109 to FIG. 112, the gantry system moves the robotic module along the x-axis to an initial location (or a default location at initialization of the robotic system). The initial location is such that the 6-axis force and torque sensor, and the robotic system as a whole, has a clear path toward the specific calibration point located on the target placement without any collisions, and is at a small distance away from the placement such that the 6-axis force and torque sensor and the target placement's calibration point are not in contact.

The robotic arm 109-15 with the mounted 6-axis force and torque sensor is placed in a predetermined, standard configuration of known joint state parameters that matches the Etalon Kitchen model's robotic arm configuration for the selected specific calibration point associated with the target placement 121-6. The robotic arm remains in this configuration throughout the calibration procedure.

Subsequently, the calibration procedure is executed by moving the gantry along the prespecified axis associated with the selected specified calibration point 121-7.

In the example on FIGS. 109 to 112, the system only operates the x-axis drive motor of the multiple axis gantry, moving the 6-axis force and torque sensor towards the oven xx (target placement).

As the calibration procedure is being executed, the system is reading the feedback from the 6-axis force/torque sensor, looking out for a spike in force that would indicate that the sensor and target placement are in contact 121-8. If there is no detection by the sensor, the calibration procedure moves the gantry further towards the calibration point 121-9.

Any gantry motion stops immediately when the 6-axis force and torque sensor detect the presence of the placement 121-10. At that moment, location of the gantry along the prespecified axis for the specific calibration point is recorded 121-11. In another embodiment, the force detection that would indicate the touching of the robotic arm or the end-effector attached to the robotic arm may be carried out by the motors of the robotic arm using current sensing.

In the example of FIG. 109 to FIG. 112, the x-axis location of the gantry is recorded as the x-axis location of the first specific calibration point of the target placement, x₁.

Following that, the control system compares the recorded x-axis gantry location x₁ with the known x-axis gantry location from the etalon model, x₁′, and computes the shift, Δx₁, of the specific calibration point on target placement along the predefined axis 121-12, such that Δx₁=x₁′−x₁.

The system then checks if all required calibration points for the selected target placement have been calibrated and their corresponding shifts recorded 121-13. If there are additional calibration points to be calibrated, the calibration procedure moves the gantry to the next calibration point associated with the specific target placement 121-14.

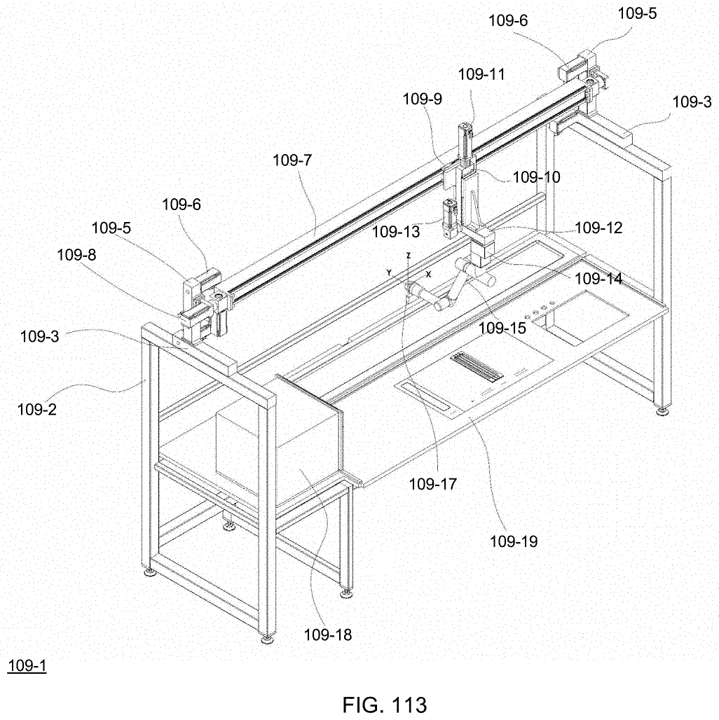

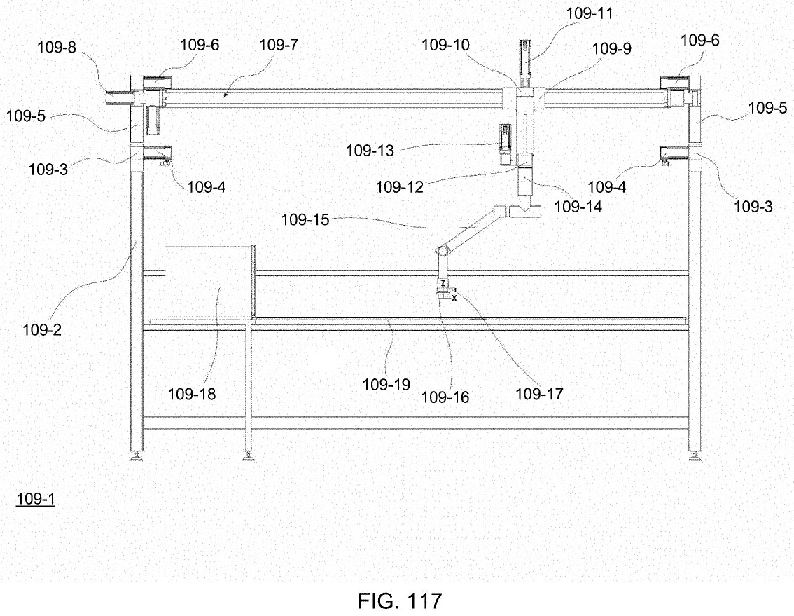

FIG. 113 to FIG. 116 show the same calibration procedure performed for the y-axis of the oven on the robotic kitchen, obtaining the y-axis gantry location, recorded as the first y-axis placement location data, y₁. Similarly, as shown on FIG. 117 to FIG. 120, the same calibration procedure may be performed for the z-axis gantry location, recorded as the first z-axis placement location data, z₁.

Depending on the type of placement, there may be multiple calibration points on the same axis that require calibration in order to complete the calibration process. Iterating this process l, m and n number of specific calibration points in the x, y and z directions respectively, result in x-axis gantry location data x₁, y-axis gantry location data yₘ and z-axis gantry location data zₙ values. All of these points have corresponding known values that are obtained from the etalon kitchen, referred to as x₁′, x₂′, . . . , x₁′, y₁′, y₂′, . . . , yₘ′; z₁′, z₂′, . . . , zₙ′. The difference, A, between these values is computed by

$$Δ {x}_{1} = {x}_{1}^{′} - {x}_{1} , Δ {x}_{2} = {x}_{2}^{′} - {x}_{2} , … , Δ {x}_{1} = {x}_{1}^{′} - {x}_{1} ;$$

$$Δ {y}_{1} = {y}_{1}^{′} - {y}_{1} , Δ {y}_{2} = {y}_{2}^{′} - {y}_{2} , … , Δ {y}_{m} = {y}_{m}^{′} - {y}_{,} ;$$

$$Δ {z}_{1} = {z}_{1}^{′} - {z}_{1} , Δ {z}_{2} = {z}_{2}^{′} - {z}_{2} , … , Δ {z}_{n} = {z}_{n}^{′} - {z}_{n} .$$

Upon completion of this calibration procedure, a list of values of dimensional shifts in the x, y and z dimensions is produced, each representing a linear displacement of a specific calibration point on the target placement. These values are then processed by the control system and a transformation matrix for the specific target placement is computed based on all recorded shifts of the calibration points 121-15.

### Marker Based Technique for Calibration

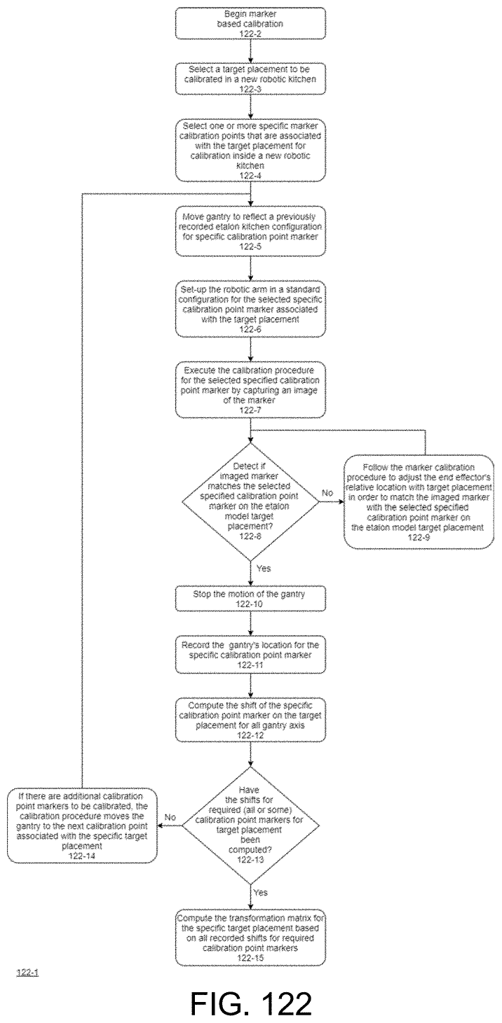

FIG. 122 is a block diagram depicting the marker calibration procedure. In this embodiment, the robotic apparatus is that of a robotic kitchen, with a single robotic arm mounted on the multiple-axis gantry system outlined in the present disclosure.

The marker calibration procedure begins 122-2 by selecting a target placement in a new robotic kitchen that is to be calibrated 122-3. Based on the selected target placement, one or more specific marker calibration points that are associated with the selected target placement are selected by the control system 122-4 in order to be able to detect the target placement's deviations in all axes that are relevant according to the type, location orientation as well as the robotic interactions that are associated with the specific target placement. The multiple axis gantry then moves the robotic system to reflect a previously recorded, initial etalon kitchen configuration 122-5.

The robotic arm xx is subsequently placed in a predetermined, standard configuration of known joint state parameters that matches the etalon kitchen model's robotic arm configuration for the selected specific calibration point associated with the target placement 122-6. The robotic arm remains in this configuration throughout the calibration procedure. Subsequently, the marker calibration procedure is executed by capturing an image of the marker 122-7.

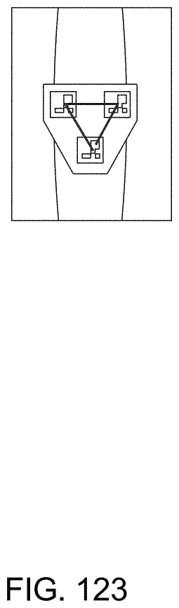

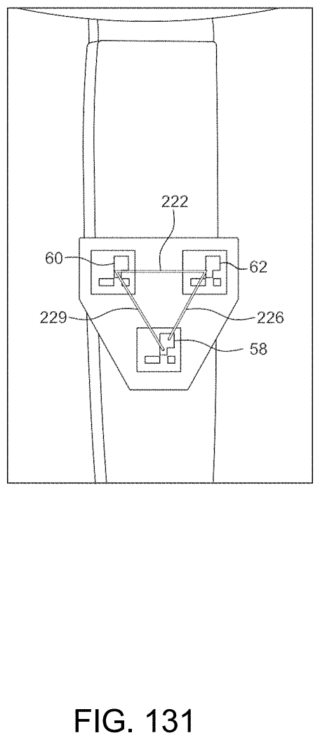

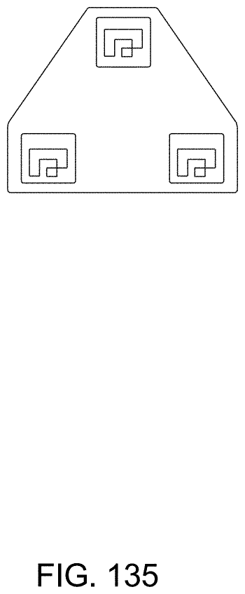

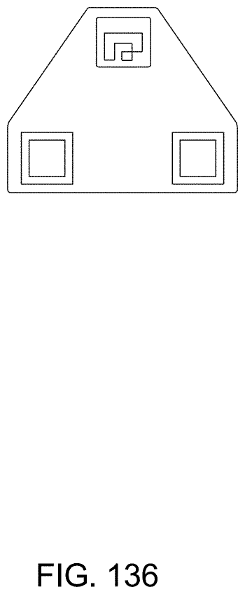

The system then compares the imaged marker to the image of the selected specified calibration point marker (also referred to as “a visual marker”) in the etalon model target placement and detects if the two are the same 122-8. If the two markers are different, the system follows the marker calibration procedure shown on FIG. 123 to FIG. 149 in order to adjust the robotic arm's relative location with the target placement, in order to match the imaged marker with the selected specified calibration point marker on the etalon model target placement 122-9.

The detection is repeated until the two marker images are the same, and then, any gantry motion stops 122-10. At that moment, the location of the gantry for the specific calibration point is recorded 122-11. Following that, the control system compares the recorded axes location with the known axes gantry location from the etalon model and computes the shift of the specific marker calibration point on target placement for all axes 122-12.

The system then checks if all required marker calibration points for the selected target placement have been calibrated and their corresponding shifts computed 122-13. If there are additional marker calibration points to be calibrated, the calibration procedure moves the gantry to the next marker calibration point associated with the specific target placement 122-14.

Once all required calibration point markers for the target placement have been computed, the transformation matrix for the specific target placement is computed 122-15.

### Transformation Matrix Computation for Marker Calibration Procedure

Marker based technique for placement calibration uses one or more markers placed on the placement or at a specific location around the placement that is to be interacted with, this is herein referred to as the target placement. In some embodiments, the target placement may be a component or device being subjected to one or more interactions. The one or more markers enable computation of position parameters comprising distance, orientation, angle, and slope, of the one or more manipulation devices with respect to the target placement. The system can then compare the values of these position parameters to the corresponding position parameters of the one or more manipulation devices in the etalon kitchen.

The difference between the etalon kitchen positional parameters of the one or more manipulation devices and the new, similar kitchen environment positional parameters of the one or more manipulation devices are then interpreted as a transformation matrix by the system. This transformation matrix can be applied to the library of executions for the target placement type, and achieve successful interaction and manipulation of the target placement and/or its objects without the need for retraining of the system. By applying this transformation matrix into the execution library, the system can perform executions with a guaranteed functional outcome and a reliability of performance that is predefined by sensotic data. This is because, the calibration method enables the system to place the one or more manipulation devices and, more specifically, their end effectors, at the exact location with correct orientation relative to the target placement, where manipulations that interact with the target placement and its objects have been pre-tested and pre-verified, and are stored in the manipulation library.

The marker can be made up of one or more 2D patterns, which are placed on the placement. Because markers have a pattern that is known to the end effector 109-16 and/or the robotic assistant, the markers can more easily be detected, such that the estimation of the pose of the placement can be more computationally efficient and accurate. That is, markers can be used more reliably and accurately to compute the orientation and distance between the placement and end effector, and/or its cameras (which, in some embodiments, make up an embedded vision system, as described in further detail below). Markers placed on the one or more placements enable estimation of pose and orientation of the one or more placements with respect to the end effector of the robotic arm. This can be used for calibration and check of positioning accuracy, damage or run-out of the one or more placements.

As an example, the one or more markers may include, but not limited to, Quick Response (QR) codes, Augmented Reality (AR) markers, Infrared (IR) markers, chessboard/checkerboard markers, geometry and color markers, and combinations thereof (e.g., triangle marker, which comprises of three other markers placed in the vertices of equilateral triangle). Markers are used for computing the orientation and distance between the placement and dynamic image capturing devices embedded in the one or more manipulating devices such as the end effector of the robotic arm. The types of markers that may be used depends on, for example, scene, placement type and structure, lighting conditions and the like. Different types of markers enable the computation of distance and orientation of the placement with different use of computational resources. Each type of marker has characteristics that are considered for their selection, and which are known by the robotic assistant 109-1 and that can be considered during a manipulation. These characteristics can include: orientation/symmetry; maximum viewing angle (maximum allowed angle that the marker can be detected from); tolerance to variations of lighting; ability to encode values; detection accuracy (e.g., in pixels); built in correction capabilities; computation resources, and the like. Based on these, optimal markers can be selected and used for particular objects and conditions of the environment and/or workspace.

Each type of marker has different advantages. For example, some markers are oriented and some are not; detection of some markers is computationally more efficient than of other markers; detection of some kinds of markers is more precise due to angle and lighting conditions tolerance. For example, AR markers are oriented, encode integer values, and their detection is computationally efficient. Chessboard markers, on the other hand, are often not oriented and require almost twice as much or more computational resources to be detected. However, chessboard markers can be localized with higher (subpixel) accuracy and have built in mistakes correction capabilities. Further, IR markers are a special kind of pattern, implemented with small reflective points placed to the known points on the objects and visible in infra-red lighting. In conjunction with infrared light source and camera, reflective points may play a role of marker corners and used for pose estimation. To make sure that systems of markers or placement work flawlessly, remote identification technology such as Radio Frequency Identification (RFID) and/or Near Field Communication (NFC) in combination of different types of visual markers may be implemented. Integrated solutions of these two types of technologies increase the reliability of the system and placement identification in different environments.

Markers may vary and may be of different types and configurations to set up the distance to the placement and space orientation of the placement. Basically, almost every geometric shape with at least 3 sharp corners and some pattern inside can be used as an explicit marker. A calibrated camera system is able to compute the distance to and pose of the marker placed on the placement, using the known distances between corners of the markers. The pattern contained in the marker may be used to filter out false detections and to encode an integer placement's identifier (Id), or placement's group Id. In addition to that, the contained geometry pattern may plays a significant role in placement's design and typically is based on company logo or symbolics. One of the key features of high quality marker detection technology is good design of internal pattern, information capacity of the internal pattern and robust detection in various lighting conditions and poses.

Using markers and marker detection for the purpose of calibration, particularly for determining any shifts in orientation of placements inside an environment, increases the system's adaptability and reduces set-up time because placements can be placed at different locations and orientations inside an environment, and they can be quickly detected and their positional and orientational shift determined thus allowing for standard manipulations form the etalon kitchen to be used with a simple shift matrix applied accordingly.

In some embodiments, using markers for calibration, as described in detail herein, includes: detecting markers on placements in the images obtained from related cameras (e.g., overhead cameras of a general-purpose vision subsystem, described herein, which can be used for global scene monitoring); calculating real world coordinates of the markers at given time periods (e.g., every 10 milliseconds); estimating the trajectory (e.g., velocity and direction) to get to the placement; calculating the expected position and pose of the placement; moving the one or more manipulating devices (also referred as end effector) to the estimated position in advance; holding the end effector in the required position, pose and configuration and finally performing the required operations for calibration as described below.

As discussed above, one type of marker that can be provided on an object is a triangle marker. A triangle marker includes three detectable markers or patterns placed at the vertices of an equilateral triangle.

FIG. 123 illustrates a triangle marker made up of three 2D binary code markers (e.g., AR markers), according to an exemplary embodiment;

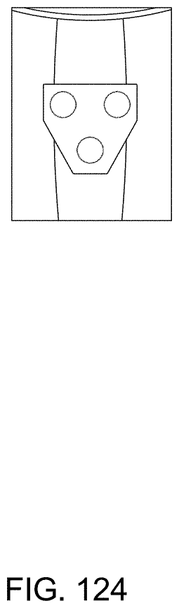

FIG. 124 illustrates a triangle marker made up of three colored circle shapes, according to an exemplary embodiment;

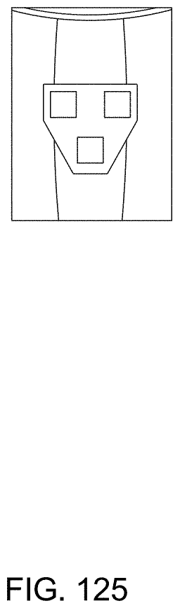

FIG. 125 illustrates a triangle marker made up of three colored square shapes, according to an exemplary embodiment; and

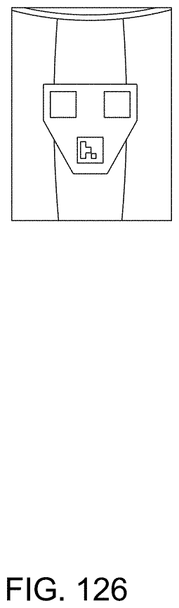

FIG. 126 illustrates a triangle marker made up of both binary code markers and colored shape markers, according to an exemplary embodiment.

In some embodiments, AR markers and other binary markers are made up of detectable black and white patterns that have identifiable sides (e.g., top/bottom/left/right) that encode an integer value. These markers are ideally properly oriented, since the triangle itself is symmetrical, therefore extra information may be necessary to detect its top/bottom. Colored shape (e.g., circle, square) markers are another option. The color of each shape functions as an identifier of the triangle's top and/or bottom sides (e.g., blue circle means bottom side of triangle).

In some embodiments, triangle markers are disposed and/or applied to placements at areas where certain minimanipulations from the minimanipulation library that involve the interaction with objects inside the placement or the placement device itself, begin or end.

Adjusting the robotic arm can, in some embodiments, be performed as follows:

The one or more gantry actuators may move the one or more manipulation devices towards the triangle shaped marker until at least one side of the triangle-shaped marker has a preferred length (or range of sizes, threshold size). As an example, the end effector may be moved or positioned toward the triangle-shaped marker, until at least one side of the triangle marker, as viewed through imaging captured by a camera of the end effector, measures for instance 225 pixels.

Further, the one or more processors may rotate the one or more manipulation devices until a bottom vertex of the triangle-shaped marker is disposed in a bottom position of the real-time image of the target object captured by the camera of the one or more manipulation devices. Thereafter, the one or more processors may shift the one or more manipulation devices along an X-axis and/or Y-axis of the real-time image of the target object until a center of the triangle-shaped marker is positioned at the center of the real-time image of the target object captured by the camera of the one or more manipulation devices.

Finally, a slope of the angle of the camera relative to the triangle-shaped marker is adjusted by moving the end effector until each angle of the triangle-shaped marker is at least one of equal to approximately 60 degrees or equal to a predetermined maximum difference between the angles that is smaller than their difference prior to initiating the adjustment of the position of the one or more manipulation devices. In some embodiments, achieving at least one of the two conditions mentioned above, indicates that the one or more manipulation devices have reached the optimal standard position.

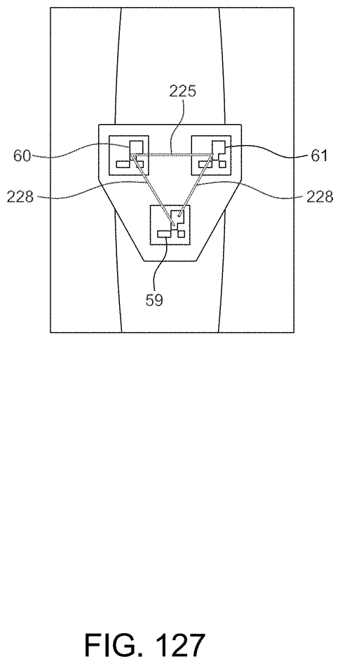

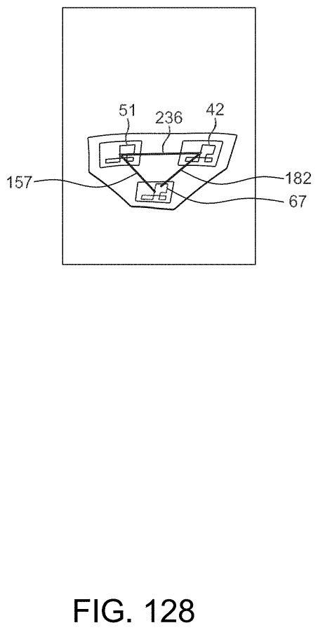

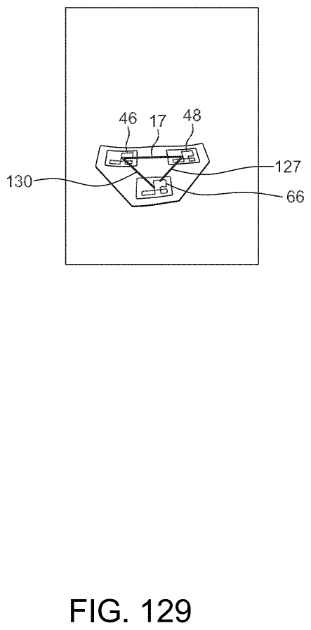

These above-referenced steps can be iteratively performed until all angles of the triangle are equivalent to 60 degrees and all sides of the triangle are equal to a required or predetermined size, as viewed through the image captured by the camera of the end effector. In turn, once the camera plane and the triangle are aligned—e.g., such that they are parallel to one another, and the triangle is on the optical axis of the camera, the projected triangle, as seen by the camera of the end effector, is also equilateral. This means that all sides of the triangle are equal (or substantially equal) to each other and all angles are equal (or substantially equal) to 60 degrees. FIG. 127 illustrates imaging of a triangle-shaped marker, according to an exemplary embodiment in which the triangle marker and the camera plane are substantially aligned, such that there is no slope. More specifically, in FIG. 127, the angles measure 60, 61 and 59 degrees, and their respective vertices measure 228, 228 and 225 pixels. When the end effector identifies a slope between the planes of the camera and the triangle-shaped marker, one of the triangle's angles, as imaged by the camera, is seen as being larger than the other two angles. This angle disparity indicates that the vertex having the apparently larger angle is closer or farther to the camera than the other two angles or vertices. This can be seen in FIGS. 128 and 129, which illustrate a same triangle marker image from two different angles or directions. In FIG. 128, the triangle marker is imaged such that the vertex furthest from the camera is imaged as having the largest angle (87 degrees, versus 51 and 42 degrees), and in FIG. 129, the triangle marker is imaged such that the vertex closest to the camera (e.g., the furthest vertex in FIG. 128) is imaged as having the largest angle (86 degrees, versus 46 and 48 degrees).

In some embodiments, the vertex positions and movements of the triangle marker (e.g., during positioning) can be identified and/or calculated using a mathematical model that receives, as inputs, three axes X, Y and Z. X and Y are angles of the triangle—the fourth angle is therefore determinable based thereon—and the Z axis is a distance from the camera to the object. Distance is defined and/or calculated by the size of each of the triangle's axes. That is, closer triangles to the camera of the end effector result in longer sides of the triangle being imaged. Using these assumptions and information with the model, the end effector can be moved (e.g., forward, backward, left, right) as needed in order to make the sides equal in the imaging of the marker. Depending on the slopes of the camera at various positions, altered as the camera is rotated to the right, left, front and/or back, the angles of the triangle-shaped marker, as visualized by the camera, are changed. The bigger the angle is or becomes on the image of the camera, the further it is or moves from the camera. Because the sum of all angles of a triangle always equal 180 degrees, the robotic assistant 109-1 can calculate or determine which angles of the triangle are being observed by the camera, and the position in which the angles are positioned in relation to the camera. In this way, the end effector, depending on the images captured by its camera, can calculate or identify how the end effector should move—e.g., to which side, distance and inclination—in order to reach or achieve the position 0.

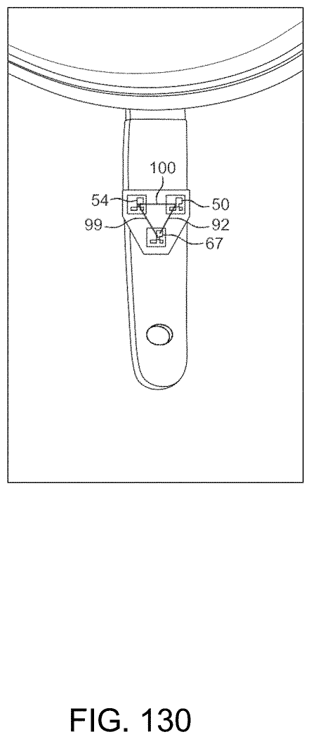

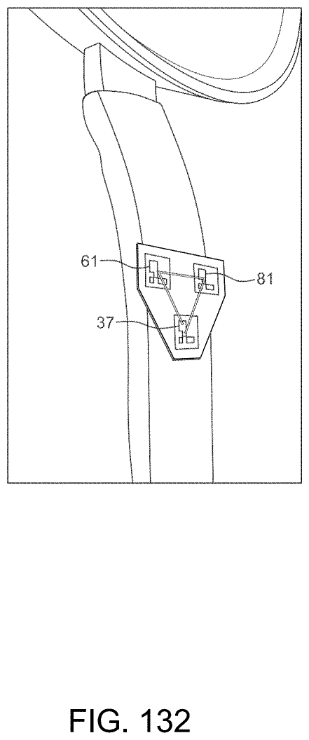

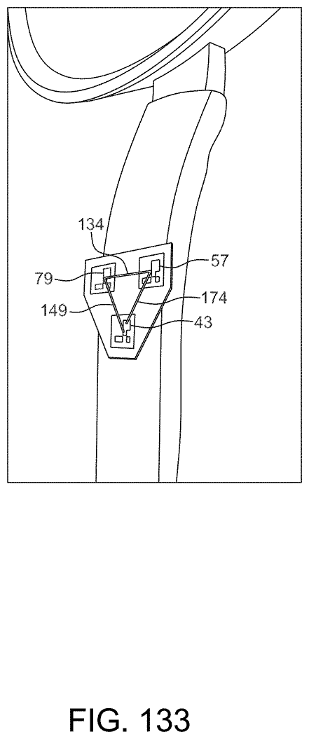

When the imaged triangle-shaped marker is determined to match the angle of two of its vertices, it becomes possible for the robotic assistant 109-1 to calculate the inclinations and lengths of the sides of the triangle, which thereby also makes it possible to calculate the distance from the camera to the triangle marker. As a result, the robotic assistant can, in turn, move in the opposite direction (e.g., in the direction of decreasing angle) to achieve the position 0 of the end effector. FIGS. 130 to 133 illustrate triangle-shaped markers disposed on a placement (e.g., the oven's door) as viewed through camera image of the end effector, according to an exemplary embodiment. Each of the images illustrated in FIGS. 130 to 133 demonstrate the above-mentioned characteristics and principles of the triangle-shaped markers. For example, FIGS. 130 and 133 illustrate relative changes in angles of the vertices of the triangle markers as the camera is moved (e.g., rotated) front-to-back or back-to-front, thereby changing its slope. FIGS. 132 and 133 illustrate relative changes of angles of the vertices of the triangle markers as the camera of the end effector is moved (e.g., rotated) side to side, front to back and/or back to front. Such rotation causes the angles to be impacted accordingly, as described above.

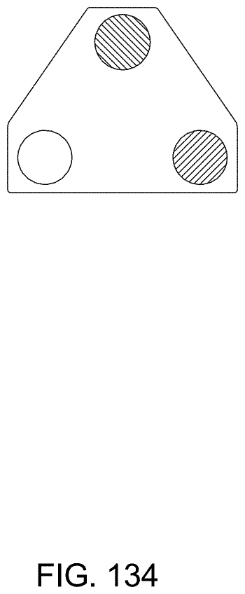

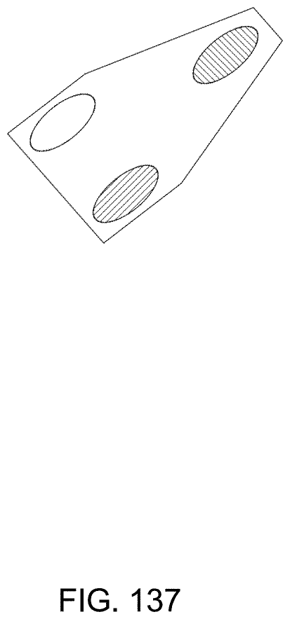

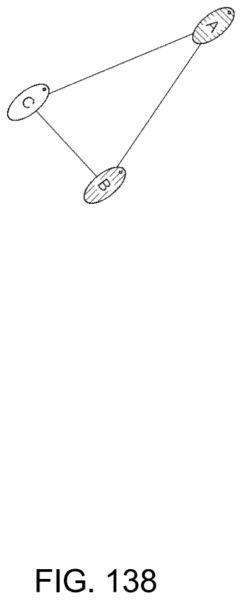

In some embodiments, the robotic assistant 109-1 can calculate the required shift or rotation of the end effector to position it at the target position, such as position 0, by using the visible and expected coordinates of a triangle marker. For the calculation, the robotic assistant 109-1 considers two triangle markers, illustrated in FIGS. 134 to 136 and 137 and 138. That is, FIGS. 134 to 136 illustrate different exemplary types of a triangle marker as imaged through a camera, from a same position, namely a position in front of the camera at a distance d0. The markers of FIGS. 134 to 136 form a triangleΔABCbetween each of the shapes of QR codes therein. FIG. 137 illustrates a triangle marker as then (e.g., at the time of performing a calculation for movement/positioning of the end effector) imaged by the camera of the end effector; and FIG. 138 illustrates the triangle formed by the triangle marker of FIG. 137, namely triangle Δ′A′B′C, which represents the triangle of the marker as then (e.g., at the moment of the calculation) imaged by the camera of the end effector.

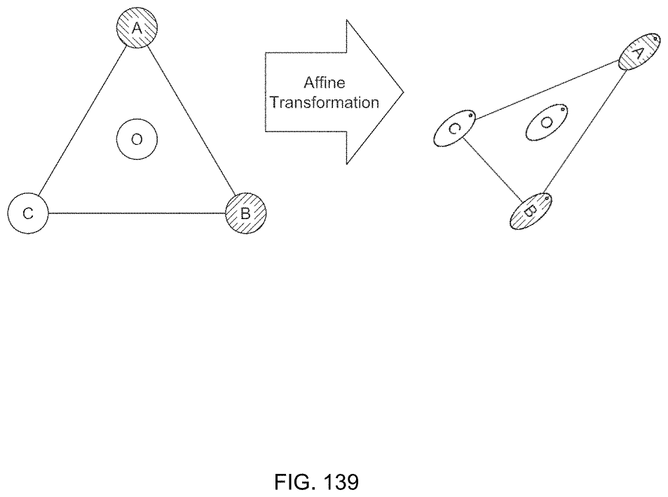

Using this information about the triangles ΔABC and Δ′A′B′C, the end effector and/or robotic assistant 109-1 can perform the affine transformation shown in FIG. 139, to calculate the required movement of the end effector and/or its camera to cause the triangle ΔABC to be visualized by the camera instead as Δ′A′B′C. In other words, the robotic assistant and/or end effector can calculate how to move the end effector and/or camera such that an image triangle can instead mirror the triangle as when it is positioned in front of the camera at a distance d0, thereby indicating that the cameras have been properly placed relative to the triangle-shaped marker.

To this end, the robotic assistant can calculate the parameters of an affine transformation of the points of the triangle ΔABC of FIG. 134 to points of the triangle Δ′A′B′C of FIG. 137 (or 138). Such an affine transformation can be represented as a composition of translation and linear transformation, for instance, as follows:

$${x}^{{->}^{′}} = {r}^{->} + M \cdot {x}^{->} , {R}^{->} = {O}^{->} - {O}^{{->}^{′}}$$

Therein, the center of triangle ΔABC can be represented as:

$${O}^{->} = \frac{{A}^{->} + {B}^{->} + {C}^{->}}{3} ,$$

And the center of triangle Δ [symbol] can be represented as:

$${O}^{{->}^{′}} = \frac{{A}^{{->}^{′}} + {B}^{{->}^{′}} + {C}^{{->}^{′}}}{3}$$

$$M \cdot {A}^{->} = {A}^{{->}^{′}} , M \cdot {B}^{->} * {B}^{{->}^{′}} ⇒ M \cdot [ \begin{matrix}{A}_{x} & {B}_{x} \\ {A}_{y} & {B}_{y}\end{matrix} ] = [ \begin{matrix}{{A}^{′}}_{x} & {{B}^{′}}_{x} \\ {{A}^{′}}_{y} & {{B}^{′}}_{y}\end{matrix} ]$$

$$M = [ \begin{matrix}{{A}^{′}}_{x} & {{B}^{′}}_{x} \\ {{A}^{′}}_{y} & {{B}^{′}}_{y}\end{matrix} ] \cdot {[ \begin{matrix}{A}_{x} & {B}_{x} \\ {A}_{y} & {B}_{y}\end{matrix} ]}^{- 1}$$

The centers of the triangles can be assumed to lie on the camera axis.
In turn, a matrix M is calculated as follows:
That is, M can be represented as a composition of rotation and stretching matrices, such that a pair of perpendicular vectors are formed that remain perpendicular after the transformation, as shown below:

$${{F}_{0}}^{⇁} \cdot {{F}_{1}}^{⇁} = 0 , {{T}_{0}}^{⇁} = M \cdot {{F}_{0}}^{⇁} , {{T}_{1}}^{⇁} = M \cdot {{F}_{1}}^{⇁} {{T}_{0}}^{⇁} \cdot {{T}_{1}}^{⇁} = 0$$

The perpendicularity of [symbol] and [symbol] indicates that that:

$${{F}^{->}}_{0} = ( \begin{matrix}x \\ y\end{matrix} ) , {{F}^{->}}_{1} = ( \begin{matrix}y \\ - x\end{matrix} ) ,$$

Thus, the perpendicularity of [symbol] ) and [symbol] indicate that:

$$- ( {M}_{11} {M}_{12} + {M}_{21} {M}_{22} ) \cdot {x}^{2} + ( {M}_{11}^{2} - {M}_{12}^{2} + {M}_{21}^{2} - {M}_{22}^{2} ) \cdot xy + ( {M}_{11} {M}_{12} + {M}_{21} {M}_{22} ) \cdot {y}^{2} = 0$$

$$U = {M}_{11} {M}_{12} + {M}_{21} {M}_{22} 2 V = {M}_{11}^{2} - {M}_{12}^{2} + {M}_{21}^{2} - {M}_{22}^{2} - U \cdot {x}^{2} + 2 UV \cdot xy + U \cdot {y}^{2} = 0 ⇒ ( \begin{matrix}x = 1 , y = 0 U = 0 \\ x = ( \frac{V}{U} + \sqrt{\frac{{V}^{2}}{{U}^{2}} + 1} ) yU \neq 0\end{matrix}$$

In turn, after two vectors that remain perpendicular prior to and after the transformation have been identified, the robotic assistant and/or end effector identify or determine parameters of M, including (1) rotation angle α and coefficients of stretching: k₀ and k₁ as follows, for example:

$$sin ( α ) = \frac{{{F}_{0}}^{->} \times {{T}_{0}}^{->}}{\vert {{F}_{0}}^{->} \vert \vert {{T}_{0}}^{->} \vert} , cos ( α ) = \frac{{{F}_{0}}^{->} \cdot {{T}_{0}}^{->}}{\vert {{F}_{0}}^{->} \vert \vert {{T}_{0}}^{->} \vert} , {k}_{0} = \frac{\vert {{T}_{0}}^{->} \vert}{\vert {{F}_{0}}^{->} \vert} , {k}_{1} = \frac{\vert {{T}_{1}}^{->} \vert}{\vert {{F}_{1}}^{->} \vert}$$

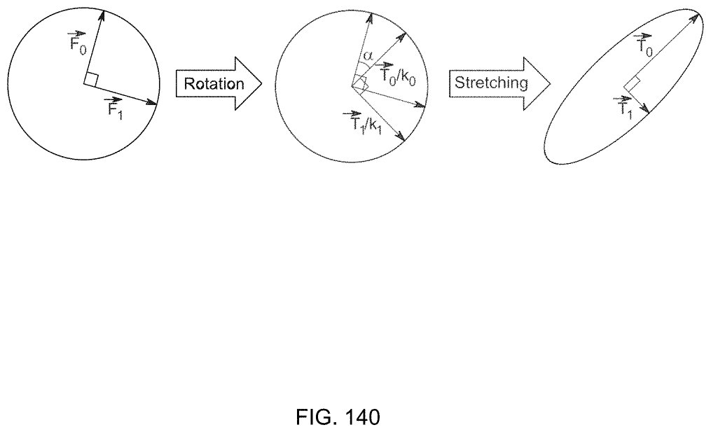

FIG. 140 illustrates the parameters of the rotation and stretching parts of the affine transformation, prior to the rotation, after the rotation, and after the stretching, according to an exemplary embodiment. Having identified the parameters of the affine transformation, the necessary camera movement needed to place the camera at the desired position (e.g., position 0) is calculated. For example, the rotation of the camera can, in some embodiments, be equal to the rotation angle α calculated for the affine transformation (and shown in FIG. 140). Stretching by k₀ and k₁ indicates the distance between the triangle and the camera and its rotation around the axis, parallel to the camera plane. In this regard, let

For example, let

$${k}_{i} = min [ {k}_{0} , {k}_{1} ] , {k}_{j} = max [ {k}_{0} , {k}_{1} ] . \\ Then , \\ \dot{d} = \frac{d}{{k}_{j}}$$

is the current distance between the camera and the triangle. β is the angle of rotation of the triangle relative to the axis [symbol] namely

$$cos [ β ] = \frac{{k}_{i}}{{k}_{j}} \cdot sin [ β ]$$

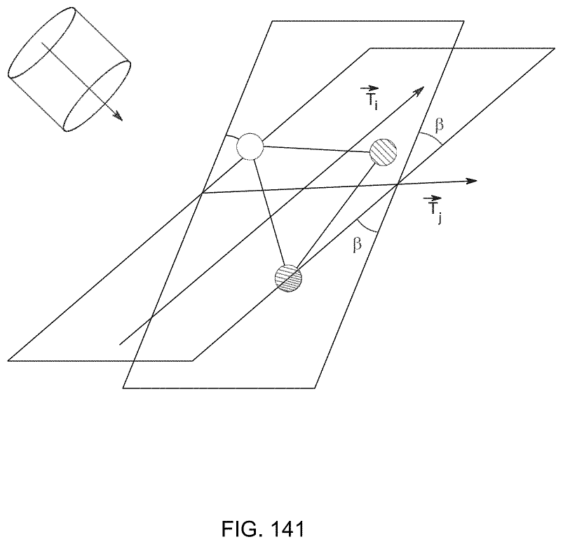

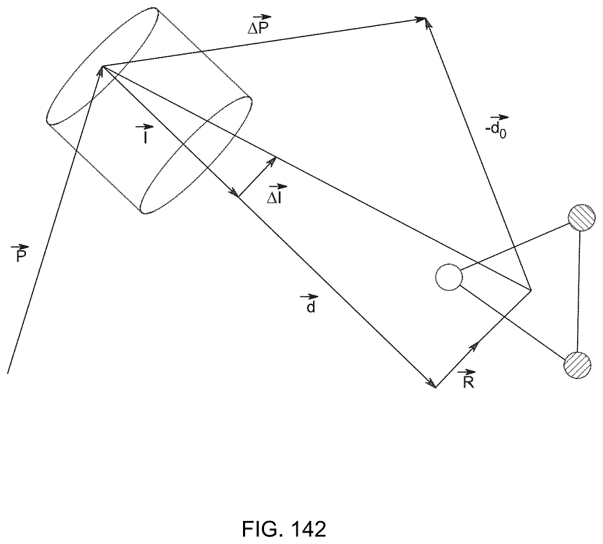

In some embodiments, it may not be possible to calculate sin(β) from the initial data, for example, because there are two possible triangle positions that correspond to the same camera image and thus, only the absolute value of sin(β) can be found, while its sign is unknown. Therefore, calculating sin(β) can be performed as follows. First, to decrease the angle β, the camera of the end effector must be moved along the axis [symbol] , as shown in FIG. 141, which illustrates imaging of a triangle of a triangle marker by the camera of an end effector, according to an exemplary embodiment. The necessary movement of the camera in order to reach the target position of the camera of the end effector relative to the object (e.g., position 0), is calculated as follows:
Let [symbol] be the then-present position of the camera, directed along l̅ and rotated relative to it by angle ω. Further calculations are made in camera's relative coordinate system, as follows:

$$Δ {P}^{->} = {d}^{->} + {R}^{->} \cdot τ \frac{d}{{d}_{0}} - {{d}^{->}}_{0} , \\ where \text{:}$$

$${d}^{->} = ( \begin{matrix}{0}^{->} \\ d\end{matrix} ) , {R}^{->} = ( \begin{matrix}{R}^{->} \\ 0\end{matrix} ) , {{d}^{->}}_{0} = {d}_{0} \cdot ( \begin{matrix}{{T}^{->}}_{1} \cdot sin [ β ] \\ cos [ β ]\end{matrix} ) ,$$

and τ indicates a coefficient of proportionality between the actual length of the object and its dimensions in the image from the camera.
Accordingly, as shown in FIG. 142, which illustrates the imaging of a triangle marker by a camera of an end effector, for calculating required movement of the camera, according to an exemplary embodiment, Δl̅= [symbol] .
Because the camera movement is in some embodiments calculated based on its own relative coordinate system, it can be necessary to transfer the camera's relative coordinate system to an absolute coordinate system. To do so, matrix A must be calculated as shown below, keeping in mind that it is known that an orthogonal transformation can be represented as a composition of three rotations relative to X and Z axis:

$$A = Az [ ξ ] \cdot Ax [ ψ ] \cdot Az [ ω ] ,$$

where ψ, ξ, ω are Euler angles (e.g., ψ is the precession angle; ξ is the nutation angle; and ω is the intrinsic rotation angle). Matrix A is therefore calculated as follows:

$${A}_{x} [ φ ] = ( \begin{matrix}1 & 0 & 0 \\ 0 & cos [ φ ] & - sin [ φ ] \\ 0 & sin [ φ ] & cos [ φ ]\end{matrix} ) , {A}_{z} [ φ ] = ( \begin{matrix}cos [ φ ] & - sin [ φ ] & 0 \\ sin [ φ ] & cos [ φ ] & 0 \\ 0 & 0 & 1\end{matrix} )$$

$$\overline{l} = ( \begin{matrix}sin [ ψ ] \cdot sin [ ξ ] \\ - sin [ ψ ] \cdot cos [ ξ ] \\ cos [ ψ ]\end{matrix} )$$

The Euler angles can be calculated from the following equations:

$$\overline{l} \text{:} cos [ ψ ] = {l}_{z} , sin [ ψ ] = \sqrt{1 - {l}_{z}^{2}} , sin [ ξ ] = \frac{{l}_{x}}{sin [ ψ ]} , cos [ ξ ] = \frac{- {l}_{y}}{sin [ ψ ]}$$

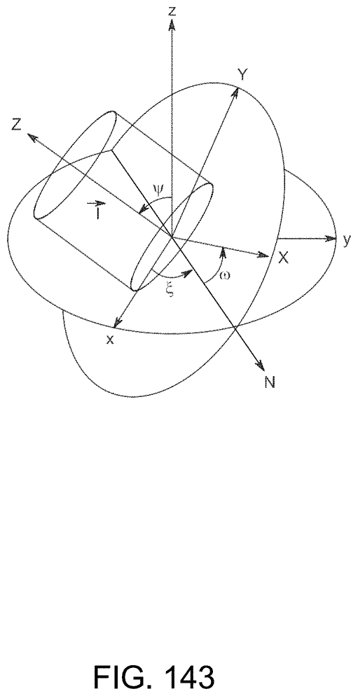

FIG. 143 illustrates the calculated angles used to translate from the camera's relative coordinate system to an absolute coordinate system, according to an exemplary embodiment. The result of the translation from one coordinate system to the other can be expressed as:

$$Δ \overline{{P}_{absolute}} = A \cdot Δ \overline{P} , Δ \overline{{I}_{absolute}} = A \cdot Δ \overline{I} , Δω = α$$

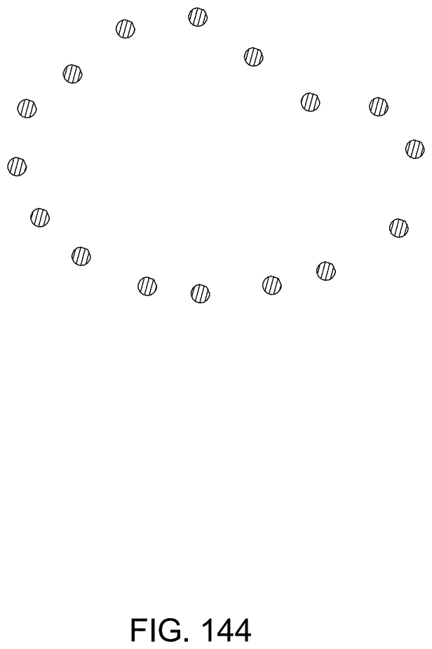

In the camera or end effector movement calculations described herein (e.g., to move the camera or end effector), in some embodiments, it is assumed that the camera image has no aberration affects and that any movement of the triangle perpendicular to the camera axis does not change its size on the image. The movement calculation algorithm may, in some cases, calculate the exact movement of the camera, but does it with an appropriate degree of accuracy. Nonetheless, the described algorithms decrease inaccuracies rapidly as the camera approaches the target or desired camera/end effector position, thus minimizing their impact on final positioning.
In some embodiments, a triangle marker can be created for use with a placement by using the placement's own contour points (or contour of a portion of the placement). To this end, a series of points, n points, \vec{A}₀, \vec{A}₁, \vec{A}₂, . . . \vec{A}ᵢ, . . . , \vec{A}ₙ is received from a sensor (e.g., camera) of the robotic assistant or end effector. This series of points define the contour of an object, as imaged. FIG. 144 illustrates a series of points defining a part of an object to be interacted with by an end effector, according to an exemplary embodiment. It should be understood that the shape of the contour of the object can dictate which method or technique to use in order to obtain a triangular marker. For example, one technique to calculate a triangular marker from a placement's contour assumes that (1) the placement is highly planar, and (2) the shape of the object is not round or elliptic. Because the contour of the placement has several bends that are distinguishable from various points of view of imaging, these bends can be used as (or as a basis) for finding the vectors of polygon sides and calculating their length and angles between consequent sides, as illustrated for example by the following equation:

$${\vec{l}}_{i} = {\vec{A}}_{i + 1} - {\vec{A}}_{i} , {l}_{i} = \vert {\vec{l}}_{i} \vert , {α}_{i} = {\vec{l}}_{i} , {\vec{l}}_{i + 1} ⋀$$

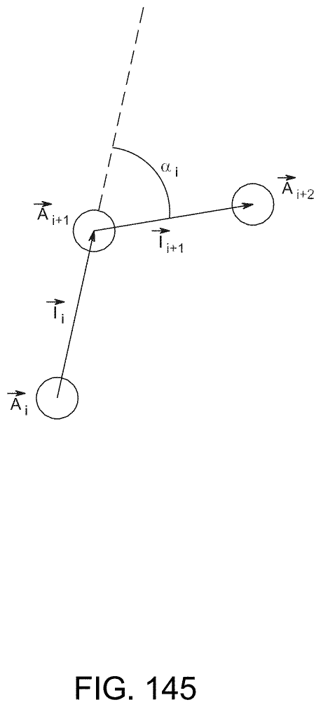

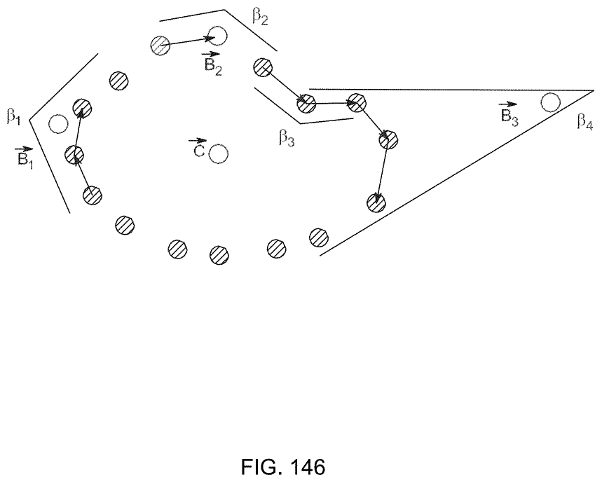

The parameters of the preceding equation are illustrated in connection wan FIG. 145, which illustrates the parameters with relation to three points from a series of points of a placement's contour. As these parameters are calculated by the end effector and/or robotic apparatus, bends can be identified, as represented by the following sequence:

$${\vec{l}}_{i} with \frac{{α}_{i}}{{l}_{i}} ⋁ a ,$$

where a is a parameter that defines the curvature of bends that are sought to be identified when calculating a marker. As bends are found, points for triangle marker \vec{B}ᵢ are constructed by intercepting sides \vec{l}_{first} and \vec{l}ₗₐₛₜ₊₁ in the bend sequence, as shown in FIG. 146.

As shown in FIG. 146, a single contour can include multiple bends. It should be understood that any of the bends of the contour can be used for calculating a marker. In some embodiments, bends having a higher curvature can be preferably used, as they can be more easily and efficiently recognized from different camera imaging angles.

In some embodiments, it is preferable to obtain the image of the placement from which contour points are analyzed to create a marker from a camera perspective in which the camera is imaging or looking straight down at the placement when the placement is placed on a plane that is parallel to the surface on which the object is positioned. Once the camera is so positioned, it is possible to use the sequence of points of the contour to create or identify the triangular marker as described herein.

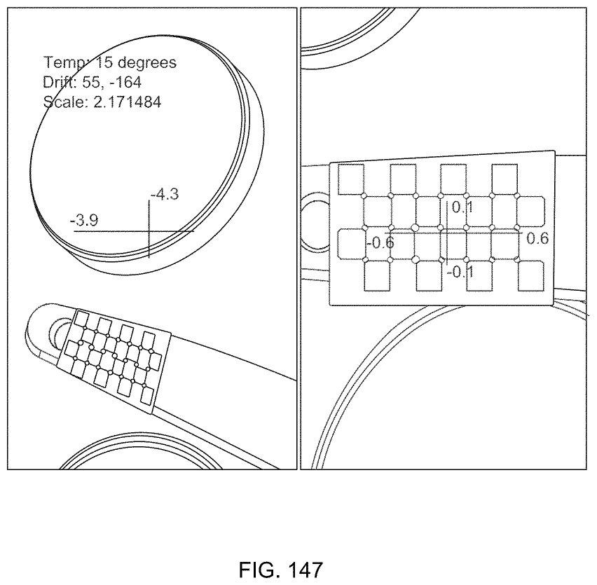

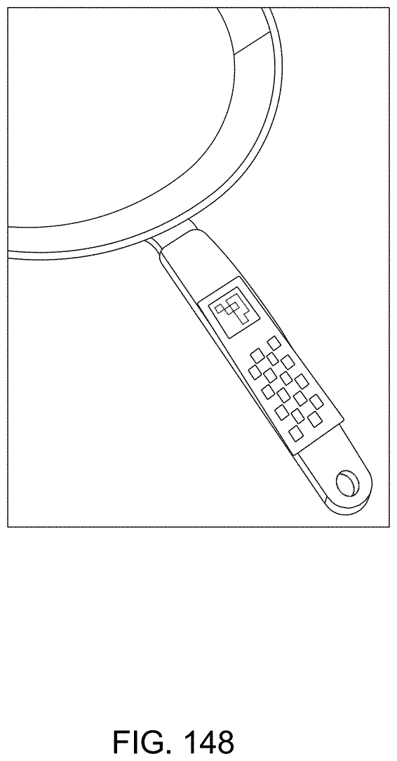

In some embodiments, a chessboard marker (also referred as chessboard-shaped marker or checkerboard marker) can be used as an alternative to other markers (e.g., as shown in FIG. 147), or in combination with other markers described herein (e.g., as shown in FIG. 148), to identify the location and other characteristics of objects. The chessboard marker enables a camera to efficiently identify internal corners with higher (e.g., subpixel) accuracy. Because a chessboard contains many internal corners, inaccuracies in detection of individual corners can be compensated using knowledge of the chessboard structure, at least because every corner should be on the line with several other corners). However, chessboard markers have one main disadvantage of being symmetrical, thereby making it difficult for the camera to understand the top and bottom of the chessboard marker. Therefore, the chessboard marker should always be used in combination with other markers or shape analyses as shown in the FIG. 148.

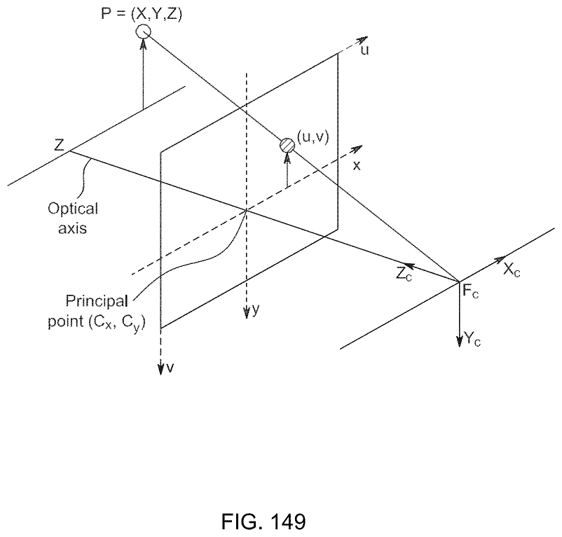

In some embodiments, chessboard marker-based positioning can be performed as follows, in connection with exemplary FIG. 149:

The one or more processors may calibrate the image capturing devices (eg: camera) associated with the one or more manipulation devices using the chessboard marker, i.e. the camera of the end effector is calibrated. In some embodiments, the calibration may include, but not limited to, estimating focus length, principal point and distortion coefficients of the image capturing device with respect to the chessboard-shaped marker. In some embodiments, camera calibration may be performed only once.

The one or more processors may identify image coordinates of corners of square slots in the chessboard marker in real-time images of the target object, i.e. the internal corners of the chessboard marker are located from the captured imaged, which is analyzed to identify points of interest therein such as the white points shown in FIG. 147.

Further, the one or more processors may assign real-world coordinates to each internal corner among the corners of the square slots in the real-time image based on the image coordinates. Assuming that origin of the real-world coordinate system is in the top-left internal corner of the chessboard marker, then the X and Y coordinates of the top right corner of the chessboard marker can be, for example: (6*cell_size_mm, 0); and the X and Y coordinates of the bottom left corner of the chessboard marker can be, for example: (0, 2*cell_size_mm). Accordingly, real world coordinates are assigned to each internal corner.

Based on the above, the end effector and/or robotic assistant can calculate or identify, among other things, the following information, which can be used with the chessboard marker to determine position of the one or manipulation devices and navigate the camera and/or the one or more manipulation devices:

Camera parameters (e.g., focus length, projection center, distortion coefficients);
On-image coordinates of internal corners (e.g., in pixels);
Real-world coordinates of internal corners (e.g., in mm).

In some embodiments, real-world coordinates and on-image coordinates can be calculated or converted from the other. In one example embodiment, this conversion can be expressed as:

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ]$$

In this exemplary expression,
(u,v): refers to on-image coordinates (e.g., computed after the tangential/radial distortion is eliminated);
fx, fy, cₓ, c_{y}: refer to camera focus and projection center points;
R and T: refer to rotation and translation matrices that can be found by placing known coordinates to equations and solving them (e.g., using Ransac).

Once R and T are known or identified, it is possible to know or identify the position of the camera with respect to the position of the marker, in which: (1) T1, T2 and T3 are X, Y and Z coordinates of the top-left chessboard corner; and (2) R11 . . . R33 are rotation components, as shown below:

$$[ \begin{matrix}\begin{matrix}( {cos φ}^{*} cos ϕ + \\ {sin φ}^{*} {sin θ}^{*} sin ϕ )\end{matrix} & \begin{matrix}( {sin φ}^{*} cos ϕ - \\ {cos φ}^{*} {sin θ}^{*} sin ϕ )\end{matrix} & ( {cos θ}^{*} sin ϕ ) & 0 \\ ( - {sin φ}^{*} cos θ ) & ( {cos φ}^{*} cos θ ) & ( sin θ ) & 0 \\ \begin{matrix}( {sin φ}^{*} {sin θ}^{*} cos ϕ - \\ {cos φ}^{*} sin ϕ )\end{matrix} & \begin{matrix}( - {cos φ}^{*} {sin θ}^{*} cos ϕ - \\ {sin φ}^{*} sin ϕ )\end{matrix} & ( {cos θ}^{*} cos ϕ ) & 0 \\ 0 & 0 & 0 & 1\end{matrix} ] \\ wher \text{e:} \\ θ = rotation around the \text{x-a} xis ( pitch ) \\ ϕ = rotation around the \text{y-a} xis ( roll ) \\ φ = rotation around the \text{z-a} xis ( yaw )$$

In some embodiments, the process of calibrating, identifying, assigning and determining are repeated until the position of the one or more manipulation devices is equal to the optimal standard position.

In some embodiments, the same approach can be applied to positioning on the base of the triangle marker, because its vertices are also at fixed positions relative to each other and so can be the base for RT matrix calculation.

### Laboratory Robot System Example

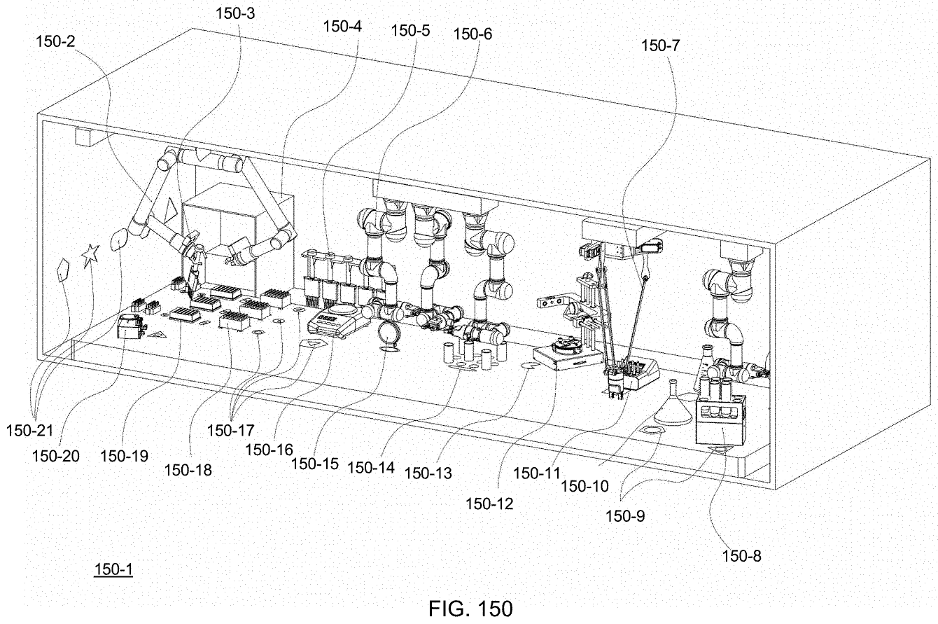

FIG. 150 depicts a robotic laboratory cabinet apparatus. This is an example of applications of the novel technology as described in the present disclosure. The apparatus comprises of different types of robotic systems; a robot system consisting of two robotic arms and mounted on a multiple axis gantry system 150-2 with an RGB-D camera 150-3 integrated onto the robotic arm mounts. Additionally, the apparatus includes multiple robotic arms 150-6 as well as delta type robots 150-7 mounted directly on the ceiling of the apparatus.

Several placements are mounted inside the working environment of this robotic apparatus. These placements are mounted at known fixed positions in accordance to an etalon model of this apparatus, and their corresponding calibration point markers are also present at specific locations, again, following the etalon model and in accordance to an ideal relative position where from all relevant minimanipulation that involve interactions with the specific placement can be performed with a high level of performance and after an application a transformation matrix.

In this embodiment, placements include a test tube holding device 150-8 with its corresponding calibration point marker 150-9 as well as a shelf storage cabinet 150-4 without a calibration point marker.

In this example, the marker calibration procedure can be followed to obtain a transformation matrix for the scientific scale 150-16. Following the marker calibration procedure detailed above, the selected target placement is assigned as the scientific scale 150-16, with a single specific marker calibration point 150-9 associated with it. The multiple axis gantry moves the robotic system to a cartesian location and sets-up the robotic arm in a standard configuration both reflecting a previously recorded etalon kitchen configuration for the scientific scale's specific calibration point. The marker calibration procedure is then executed until the imaged marker matches the scientific scale's calibration point marker on the etalon model. At that point, the multiple axis motion stops completely, and its location in terms of all axes is recorded. These recorded axes values are then compared to the etalon model's gantry configuration, and the shifts in all gantry axes are computed. From there, the transformation matrix of the scientific scale is calculated and thus, the robotic system is able to execute minimanipulations with a guaranteed functional outcome.

The force/torque sensing calibration method is used to compute the transformation matrix for placements without calibration point markers such as the shelf storage cabinet 150-4. As depicted on FIG. 150, there are several specific calibration points that are associated with the shelf storage cabinet 150-4, one on each side panel of the cabinet as well as one on the shelf. In this example, the force/torque sensor based calibration begins and the target placement is selected as the shelf storage cabinet. All specific calibration points that are associated with the shelf storage cabinet are then selected and ranked.

The gantry is moved to reflect a previously recorded etalon model configuration and the robotic arm is set-up in a standard configuration, all according to the first calibration point. The gantry moves the robotic system towards the calibration point until a force is detected. At that point, the multiple axis motion stops completely, and its configuration in terms of the prespecified axis is recorded. The recorded axis value is then compared to the etalon model's gantry configuration, and the shift in the prespecified gantry axes is computed. This procedure is then repeated for all specific calibration points that are associated with the shelf storage cabinet. Lastly, using all the shifts from all specific calibration points, the transformation matrix of the shelf storage cabinet is calculated and thus, the robotic system is able to execute minimanipulations with a guaranteed functional outcome.

### Telerobot Hospital Example

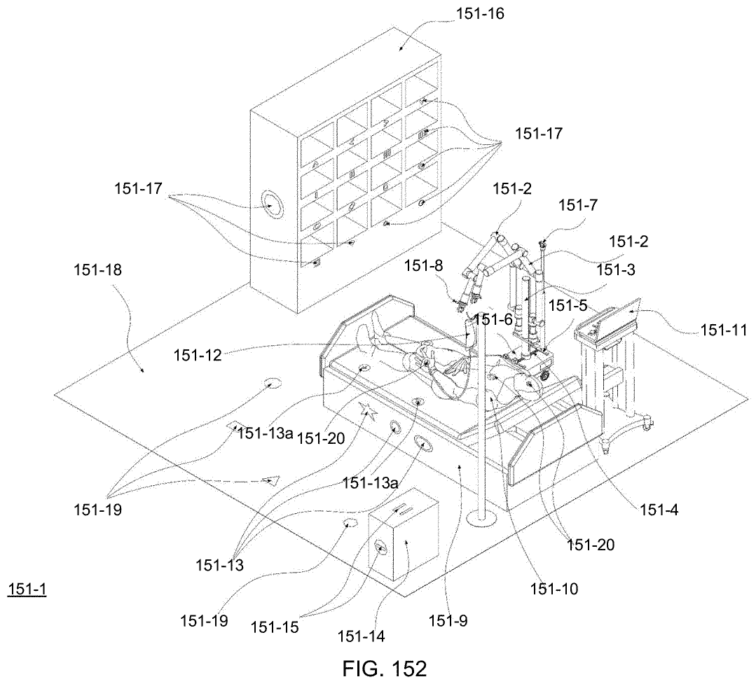

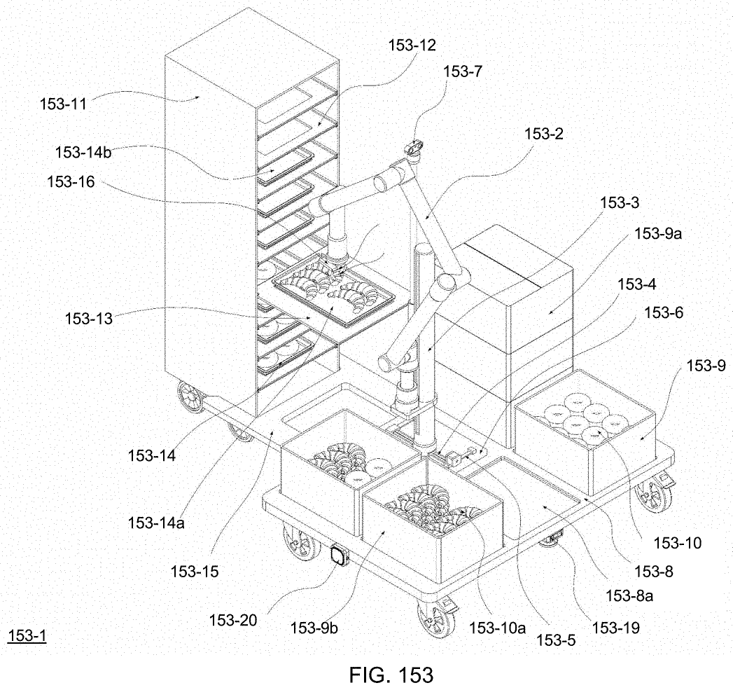

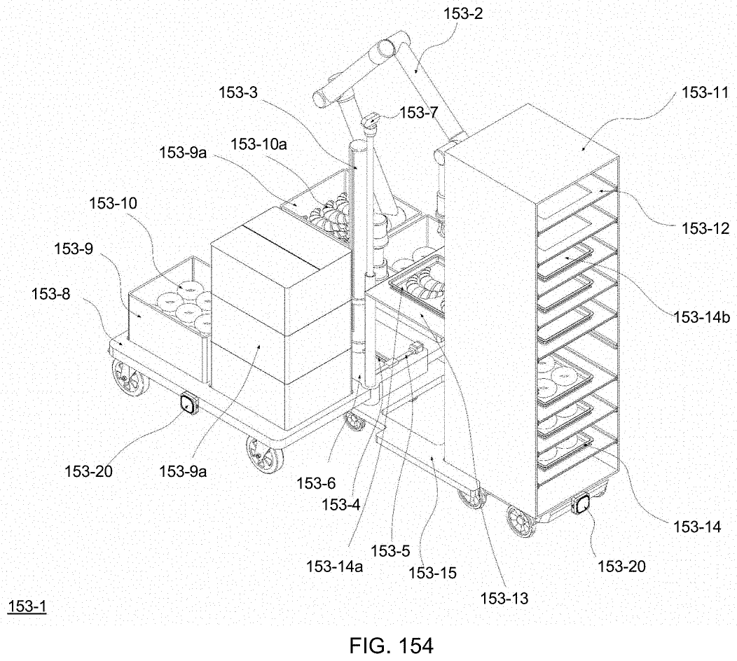

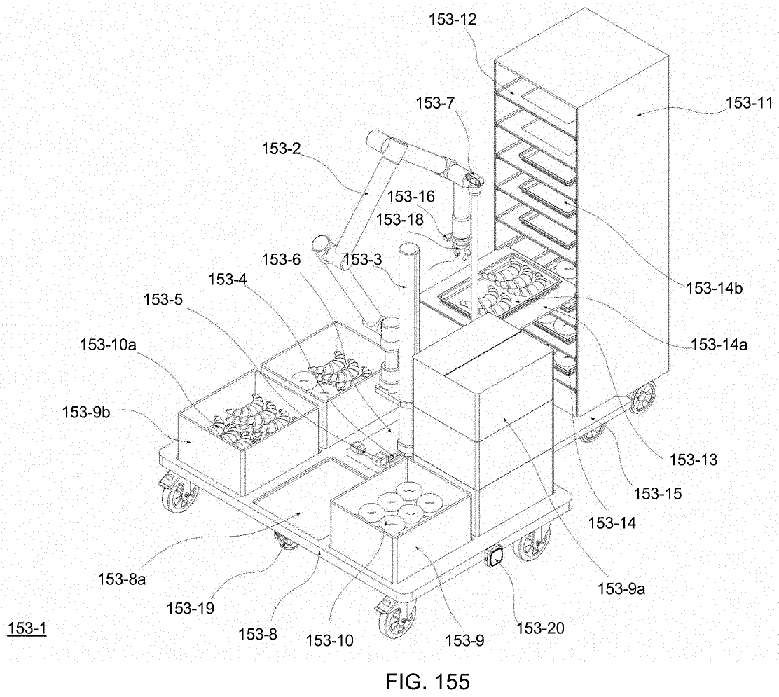

FIGS. 151 and 152 depict a robotic apparatus inside a hospital environment. The robotic apparatus comprises of a pair of robotic arm 151-2 mounted on a vertical motion drive 151-3 that moves the robot arm mount along the z-axis. A x-direction horizontal motion drive 151-4 is able to move the robotic arm mount along the x direction and a y-direction horizontal motion drive 151-5 is able to move the robotic arm mount along the y direction. All the aforementioned components are mounted on a Robotic system movable platform with wheels 151-6 that moves the robotic system around the hospital room. A vision system consisting of cameras and sensors 151-7 is integrated onto this platform and assists with the motion of the robotic system platform. RGB-D camera sensors 151-8 are mounted on the wrist of the robotic arm, next to the gripper and are used to carry out the market based calibration procedure concerned the present disclosure.

In this embodiment, the environment where the robotic system operates is a hospital room, with a hospital bed 151-9 where a patient 151-10 is resting. The environment is housing a number of placements with their calibration point markers such as: a medical instrument 151-11 with its calibration point marker 151-11a, a small medicine cabinet 151-14 with different calibration markers for each visible side 151-15, a bigger shelf cabinet 151-16 with multiple calibration markers 151-17 on all its sides as well as its shelves as well as floor calibration markers 151-19 placed on the floor 151-18 of this hospital room.

Calibration markers are also present on each visible side of the hospital bed 151-13 as well as on different locations on the bed mattress 151-13a. Finally, markers are also placed on the patient's body 151-20 at specific anatomical locations.

In this embodiment, both a force sensing based and a visual marker based calibration procedure may be used in order to navigate around the room. In this example, the room is considered to be the operational environment of this robotic apparatus. As such, the robotic system is able to interact with different placements around the room and execute minimanipulations form a library of minimanipulations by first applying a transformation matrix to the library.

In this example, the marker calibration procedure can be followed to obtain a transformation matrix for the markers on the patient body 151-20. Following the marker calibration procedure detailed above, the selected target placement is assigned as the patient body 151-20, with a single specific marker calibration point as the patient's hand, associated with it. The movable platform 151-6 with the multiple axis drive system moves the robotic system to a cartesian location and sets-up the robotic arm in a standard configuration, both reflecting a previously recorded etalon model configuration for the patient body's hand specific calibration point. The marker calibration procedure is then executed until the imaged marker on the patient's hand matches the patient body hand calibration point marker on the etalon model. At that point, the multiple axis drive's motion stops completely, and its location in terms of all axes is recorded. These recorded axes values are then compared to the etalon model's multiple axis drive configuration, and the shifts in all drive axes are computed such that the transformation matrix of the patient body hand is calculated. In this way, the robotic system is able to execute minimanipulations from the library of minimanipulations associated with the patient's hand and have a guaranteed functional outcome. An example of minimanipulation could be the insertion of the IV saline's needle 151-12 into the patient's hand, ensuring a very high level of performance and reliability of operation.

The force/torque sensing calibration method is used to compute the transformation matrix for placements without calibration point markers such as the small medicine cabinet 151-14. There are several specific calibration points that are associated with the small medicine cabinet 151-15, one on each side panel of the cabinet. In this example, the force/torque sensor based calibration begins and the target placement is selected as the small medicine cabinet. All specific calibration points that are associated with the small medicine cabinet are then selected and ranked.

The robotic system's movable platform and multiple axis drives are moved to reflect a previously recorded etalon model configuration and the robotic arm is set-up in a standard configuration, all according to the first calibration point. The multiple axis drive moves the robotic system towards the calibration point until a force is detected. At that point, the multiple axis motion stops completely, and its configuration in terms of the prespecified axis is recorded. The recorded axis value is then compared to the etalon model's multiple axis drive configuration, and the shift in the prespecified axis is computed. This procedure is then repeated for all specific calibration points that are associated with the small medicine cabinet. Lastly, using all the shifts from all specific calibration points, the transformation matrix of the small medicine cabinet is computed and thus, the robotic system is able to execute minimanipulations associated with the specific target placement from a library of minimanipulations.

### Tray Loading System

The FIGS. 153 to 155 above depict a tray loading robotic system platform. In this instance, the system is used to carry out the reloading of trays with items found in boxes.

A robotic manipulator in the form of a robotic arm 153-2, is mounted on a vertical motion drive 153-3 that moves the robotic arm along the Z-axis. This is mounted on a horizontal motor drive 153-4 where a pair of linear actuators move the robotic arm along x-direction. In turn, this is mounted on a secondary horizontal motion drive that moves the robotic arm along the y-direction 153-5.

These components are located on a movable platform with wheels 153-6 that allows the robotic system to move around the room. A number of multi-sensor systems 153-7 are also integrated into this movable platform and assist with. This multi-sensory system houses a variety of different sensors such as vision sensors, thermal sensors, laser sensors, radar sensors, proximity sensors, object identification sensors and RFID readers, all working together to analyse the environment and provide feedback to the robotic system.

A platform for object placement and arrangement 153-8 may be interfaced with the robotic system's movable platform and it is used as an unloading station. Its design includes some box placement locations 153-8a where opened boxes 153-9 as well as closed boxes 153-9a can be placed or stacked one on top of another. The boxes may contain different objects. In this embodiment, certain boxes 153-9 contain donuts 153-10 whereas other boxes 153-9b contain croissants 153-10a.

The system also comprises of an autonomous tray placement rack 153-11, vertically housing movable shelves 153-12 that can be extended 153-13 and retracted. The shelves contain placements where trays can be placed 153-14b. A mechanical coupling between the robot assembly and the rack assembly 153-15 allows the two systems to be coupled together and ensures a relative distance between them.

A RGB-D camera mounted on the robotic arm's wrist 153-16 is used for vision marker calibration as well as used to identify the type and size of objects inside the box, classify them and determine their location and orientation in order to optimise the grasping approach of the robotic arm.

Additionally, a 6-axis force/torque sensor 153-17 is mounted on the arm at the wrist such that the force/torque sensing calibration method can also be carried out. Lastly, a weight sensor 153-18 integrated onto the Robotic Arm's gripper mount enables weight data about objects that are carried by the gripper to be collected.

Minimanipulations are executed by the robotic arm. The manipulator interacts with the objects on the object placement and arrangement platform 153-8. In this embodiment, the robotic arm can open and close boxes, stack them on top of one another or transfer them onto empty placements 153-8a on the arrangement platform. The robot mounted RGB-D camera detects the location and orientation of the required object, picks it up from the box and places it onto a tray that has been previously placed on an extended shelf 153-14a, in the correct location and orientation. Similarly, The robotic system can also interact with the shelves, extending and retracting them as required.

Safety laser scanners 153-19 and radar sensors 153-20 can monitor the presence of foreign objects or humans, ensuring that the operations are executed safely and limiting the motion if required, enabling autonomous operation.

Once all the required objects are placed on the tray in the correct location, the robotic arm places the tray back into the drawers of the tray trolley.

### Grasping Validation

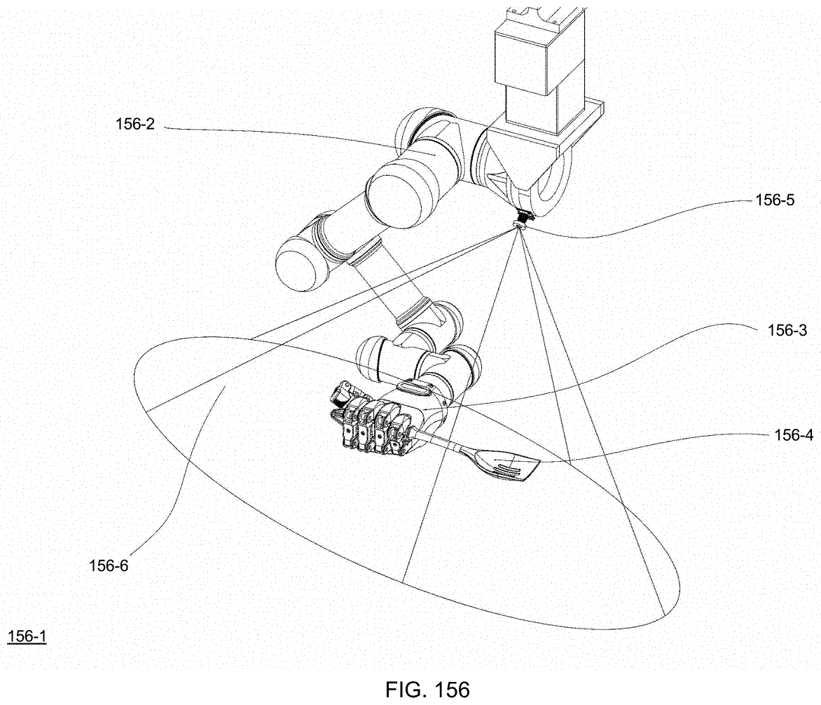

FIG. 156 depicts an embodiment of the robotic system that comprises of a robotics arm 156-2 with a five-finger anthropomorphic robotic hand 156-3 mounted as its end-effector. The robotic hand 156-3 is holding a spoon 156-4. A camera 156-5 mounted near the base of the robotic arm 156-2 has a clear view of the robotic hand 156-3 and spoon 156-6 within its field-of-view 156-6.

In one embodiment, this system can be used to confirm the type of utensil or tool that is currently being grasped by the robotic hand. This can be fed as a confirmatory feedback to the system during testing, to assess the functional outcome of parameterised minimanipulations.

In another embodiment, this system can be used as an extension of the marker calibration procedure 122-1. The calibration procedure may be followed to track the positional and orientational displacement of the grasped object along and around the X, Y and Z axis. With this information, a secondary transformation matrix can be computed and applied via the low-level control modules such that any deviations can be compensated for all minimanipulations that are executed with the specific tool.

In another embodiment, the secondary computed transformation matrix can be applied to the tool being held by the robotic hand on the virtual model of the robotic apparatus via the high-level control module. In this way, the orientation and position of the virtual model of the tool can be adjusted such that any deviations removed, and live-planning can be performed.

### Ventilation System

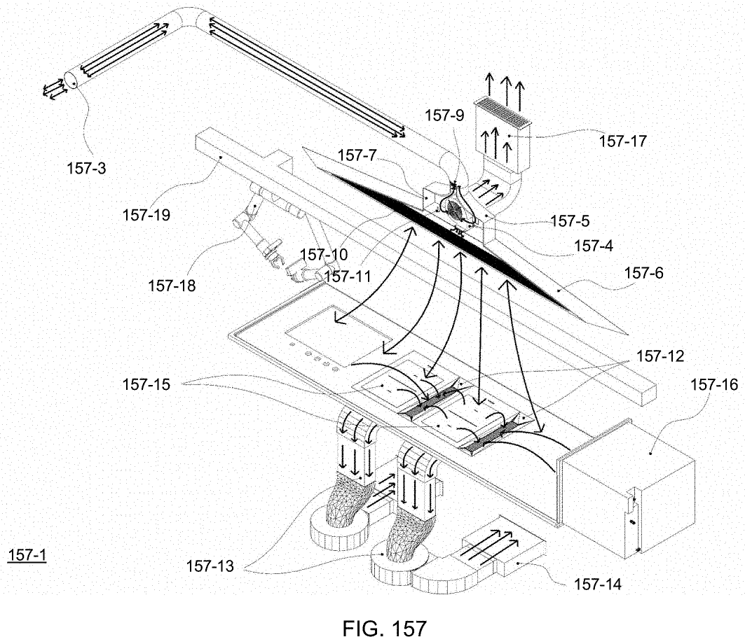

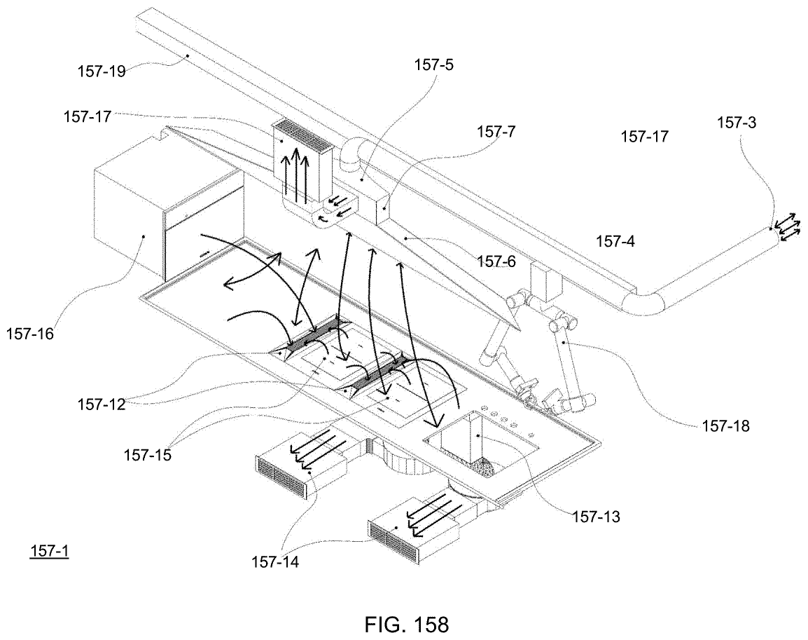

FIGS. 157 and 158 are visual diagrams depicting a ventilation system integrated onto a robotic apparatus. In this embodiment, the robotic system interacts within an instrumented environment of a robotic kitchen, and carries robot assembly 157-18 along a gantry 157-19. This environment incorporates cooking appliances such as an oven the 157-16 and induction hobs 157-15 that generate heat that is used for cooking. The ventilation system comprises of two separate systems: a downdraft extraction (ventilation system) 157-12 and an overhead fan 157-4 that forces air into or out of the robotic system.

A mid-duct 157-7 is used to converge the inlet air and mount the overhead fan. An air inlet/outlet duct 157-5 and an air outlet/inlet duct 157-6 are interfaced to the mid-duct and are used to direct the air inside the general ducting of the ventilation system.

HEPA filters at the inlet/outlet 157-9 and outlet/inlet 157-10 ducts are used to remove any contaminants or unwanted particles from the air inside the overhead ventilation system and an air quality sensor 157-11 provides data to the robotic system that is used to determine which function or set of functions of the overall system should be used at any given moment.

The overhead fan has two functions that are achieved by controlling the direction of motion of the fan's blades. The first function of the overhead fan is pushing air into the cooking environment. This creates a positive pressure inside the environment, directing the air downwards, through the ducting of the downdraft extraction system 157-13 and through a filter box 157-14.

The secondary function of the overhead system is extracting air out of the cooking environment. The air can be directed either into the recirculating system's filter box (Top) 157-17 or into a central ventilation system that can output air into the outside environment via an air inlet grill 157-3. This function also decreases the number of unwanted particles inside the instrumented environment by creating a negative pressure inside the cooking space.

Furthermore, a heating element as well as a humidifier device are also integrated into the ventilation system. These components can be independently controlled and adjust the temperature and humidity inside the working environment. The downdraft extraction system and overhead ventilation system can work independently of or in conjunction with each other. The general ventilation system can also be used in conjunction with the protective screen system, further isolating the cooking zone from the outside environment where the machine is placed. In this way, different combinations of the ventilation systems functions and the protective screen can be used, depending on the use case requested by the system.

In this embodiment, the air inside the cooking environment carries oil particles, food particles, water particles and causes unwanted smells, steam or smoke entering the environment where the robotic apparatus is located. In other embodiments of this technology, such as the robotic laboratory cabinet 151-1, the air inside the environment could carry bacterial contaminants or toxins that can be very harmful to humans in close proximity to the apparatus. Such harmful or unwanted particles that are suspended in the air inside the instrumented environment can also cause wear and tear on electronic components or compromise general visibility inside this space, reducing the system's functionality and reliability. Additionally, special environmental conditions might be required by the system to benefit the operations that the robotic system is carrying out. For example, during a chemical reaction, the robotic system can increase the humidity and temperature inside the instrumented environment in order to speed up a chemical reaction between two substances or decrease the pressure inside the instrumented environment in order to decrease the time for water evaporation. This innovative technology is also able to move unwanted particles away from any components that are above the operating zone. Such components include the robot system, cameras as well as any tools that are used by the robot. The system is used to control the direction of incoming and outgoing air inside the cooking volume of the robotic kitchen and combine the functionalities of these subsystems together with the heating element and humidifier to select the best approach to adjust the environmental parameters based on the quality of air inside the instrumented environment analysed (also referred to as “analyzed”) by the air quality sensor.

### Gripper and Tool Interface

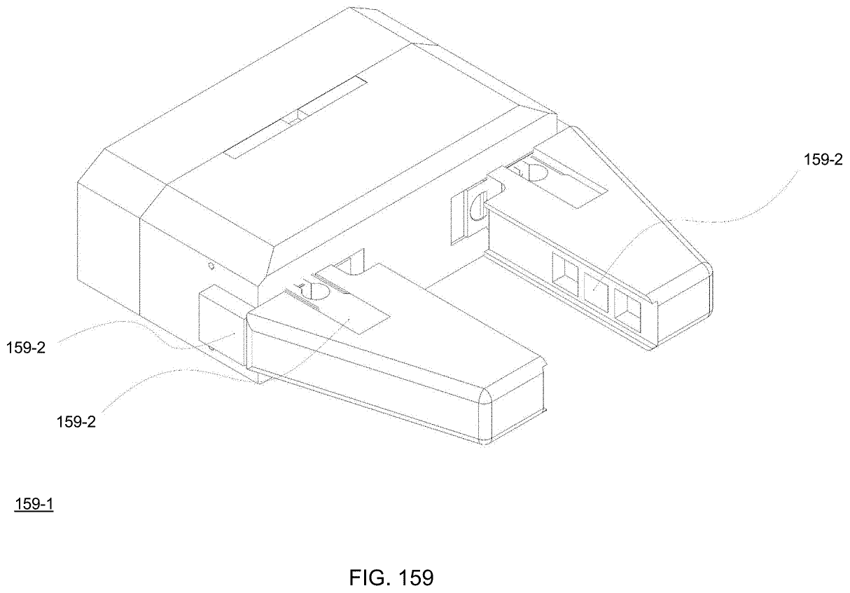

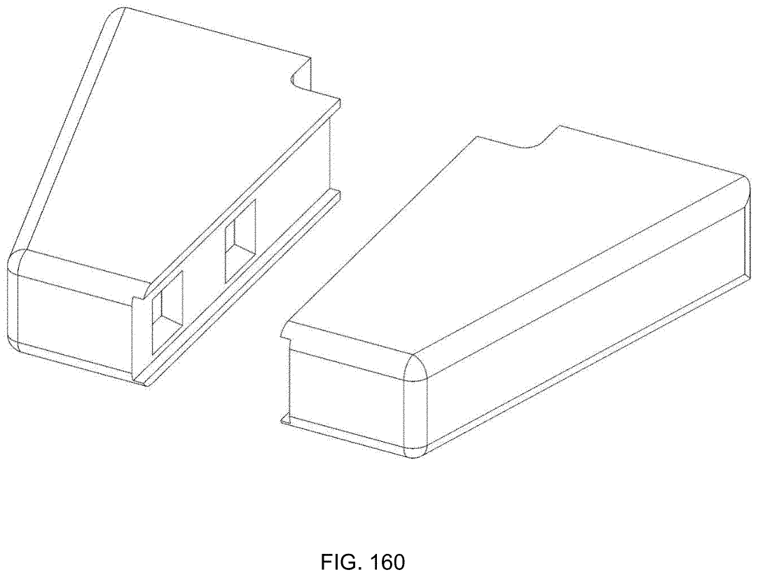

FIG. 159 depicts a 2-finger parallel gripper. In this tool interfacing concept, however, any type of gripper, such as parallel and angular, can be used, and the gripper's geometry can be altered such that the grasping of tools is optimised (also referred to as “optimized”) depending on the specific application and types of tools used. Furthermore, the gripper can be made up of any number of fingers and actuated by any type of actuation system, such as pneumatics, vacuum, hydraulic and servo-electric.

The gripper integrates a variety of different sensors 159-2 that may include a camera, weight sensor, radar sensor, laser sensor, proximity sensor etc that can be used to identify the tool being grasped and contribute to the sensoric data of the system as a whole.

FIG. 160 depicts the fingers of the parallel gripper 159-1. The gripper and tool interfacing concept for cooking, uses a simple gripper that interfaces with different tools that can be used to interact with ingredients of different types, sizes and structures.

Tools of different types and sizes, bearing the same interface can be used such as tongs, kitchen utensils like spoons, ladles and knives or other tools to control kitchen appliances such as capacitive stylus to control touch sensitive surfaces. The tools are stored at known locations inside the kitchen and are accessible by the robot. The gripper can pick up one tool type, use it for a specific action, place it back and pick up another tool type to carry out a different action. In order to grasp a tool, the gripper is positioned at the correct location and orientation by the robot inside the kitchen environment. It then moves the two fingers in parallel, closing the gap between them, and grasping the tool that is located in between them. The recesses of the gripper align with the congruent protrusions of the tool, thus locking it in place.

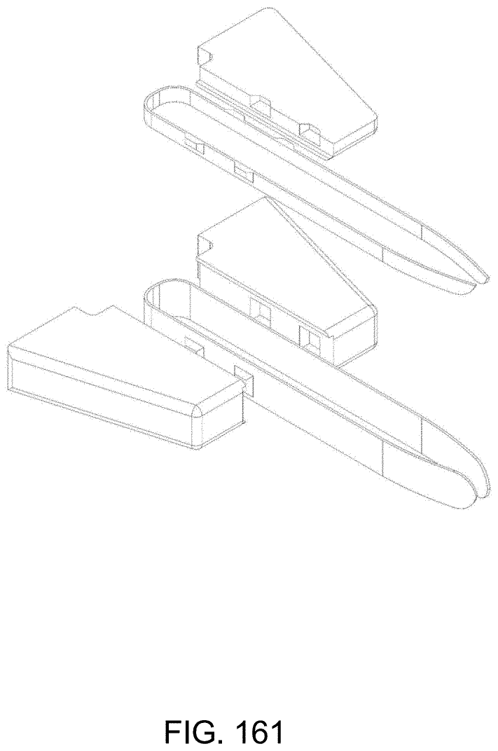

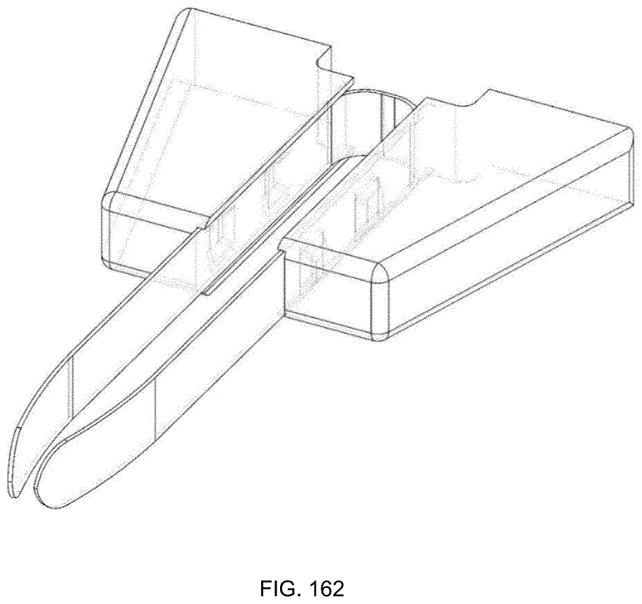

FIG. 161 is a section view of the gripper tool interface.

FIG. 162 is a transparent view of the gripper tool interface.

In the case of tools that are adjustable or deformable, such as the tongs, the gripper can control the closing of its fingers such that the tongs are firmly grasped but remain open. The position of the gripper's fingers is then controlled further to adjust the opening between the arms of the tongs in order to pick up and manipulate different objects and ingredients.

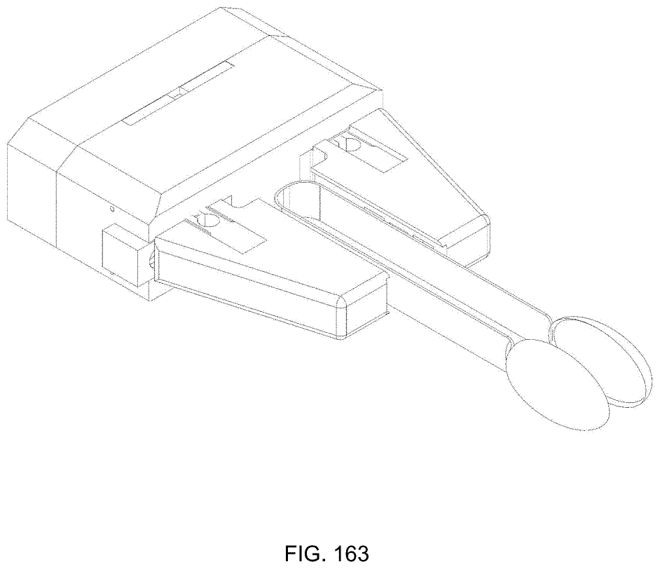

FIG. 163 depicts the gripper holding a set of tongs in the open position.

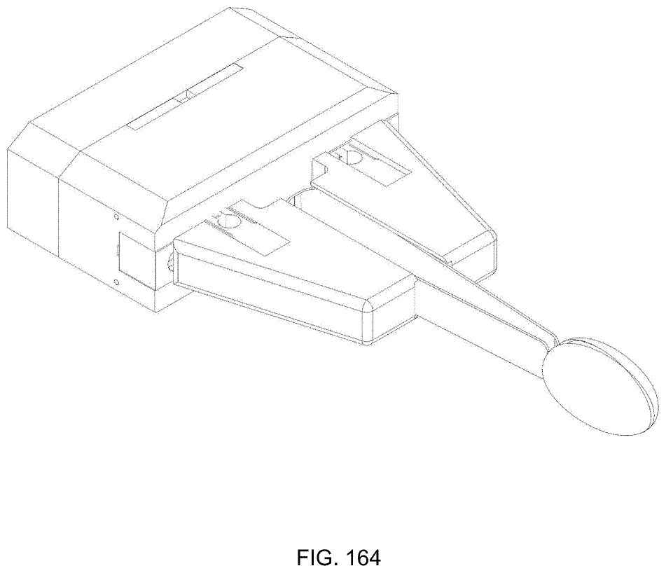

FIG. 164 depicts the gripper holding a set of tongs in the closed position.

Different types of tongs may be used with this type of parallel gripper interface. These may include spoon tongs for ingredient portioning, using the aforementioned controlled closing feature.

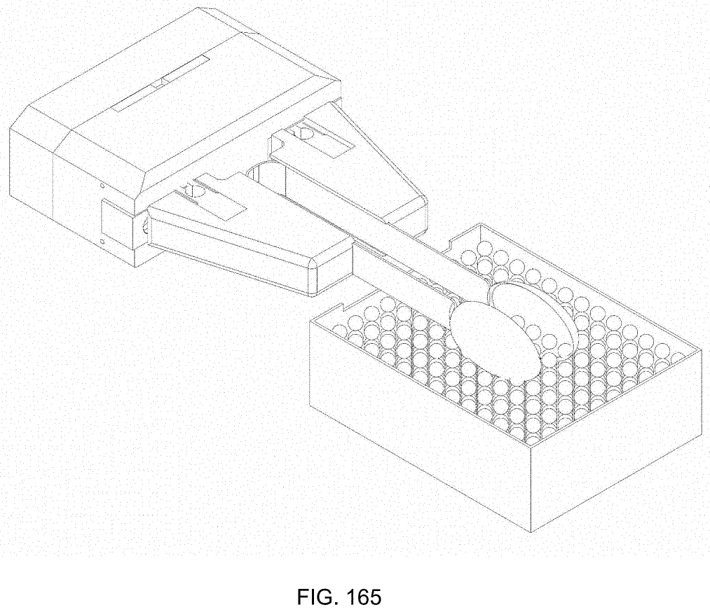

FIG. 165 depicts the gripper holding a set of tongs in the open position while immersed in a box containing an ingredient, depicted as spheres.

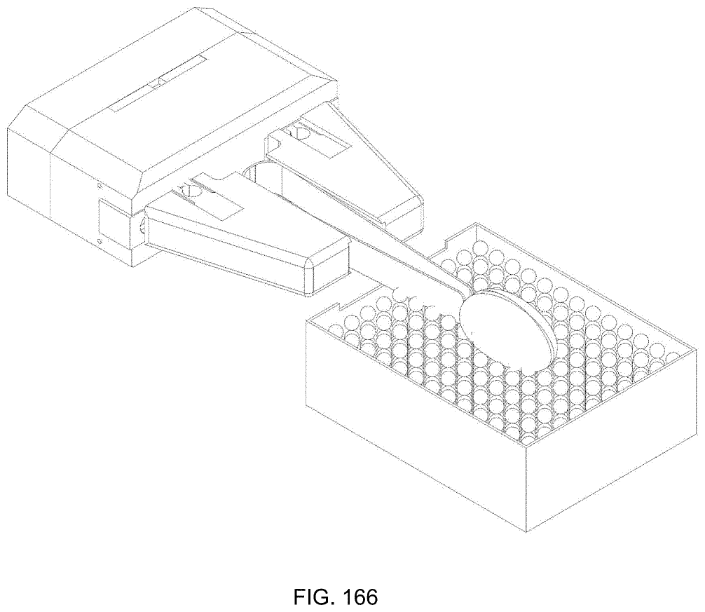

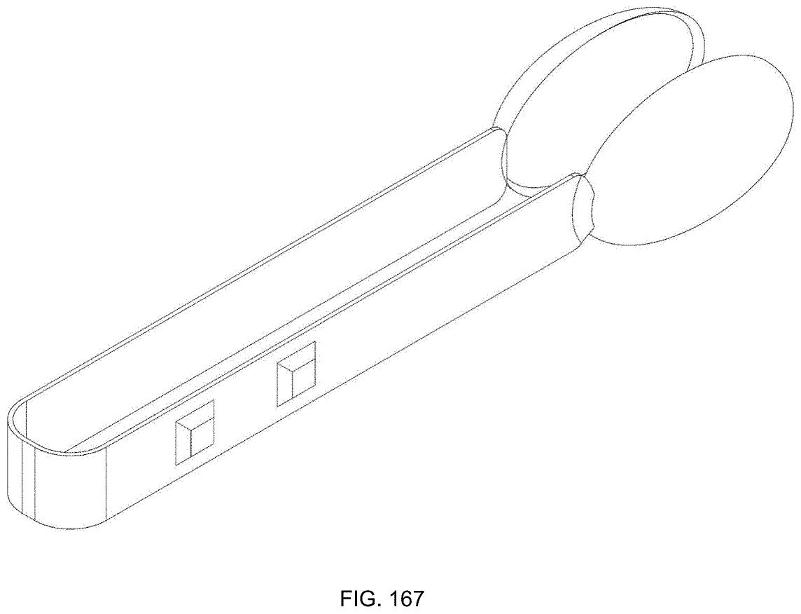

FIG. 166 depicts the gripper holding a set of tongs in the closed position while immersed in a box containing an ingredient, depicted as spheres. The tongs are holding an amount of ingredients inside the spoons.

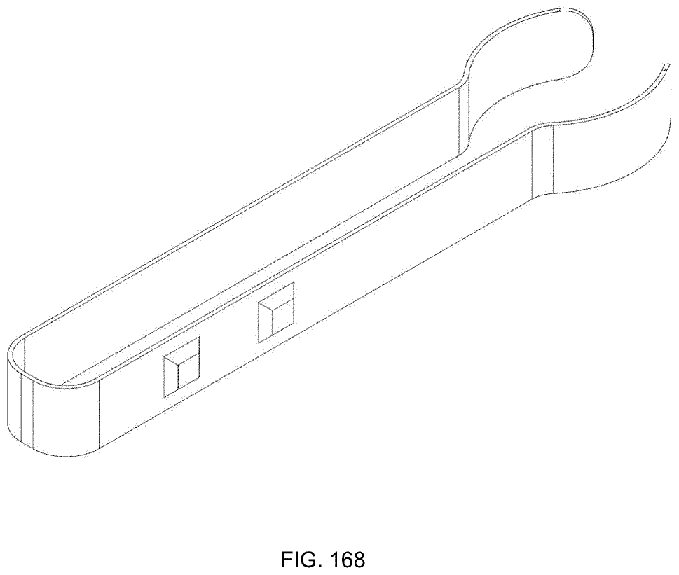

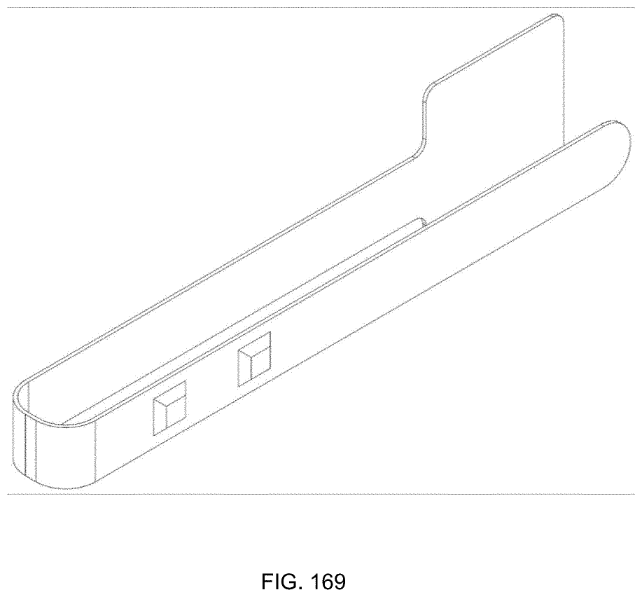

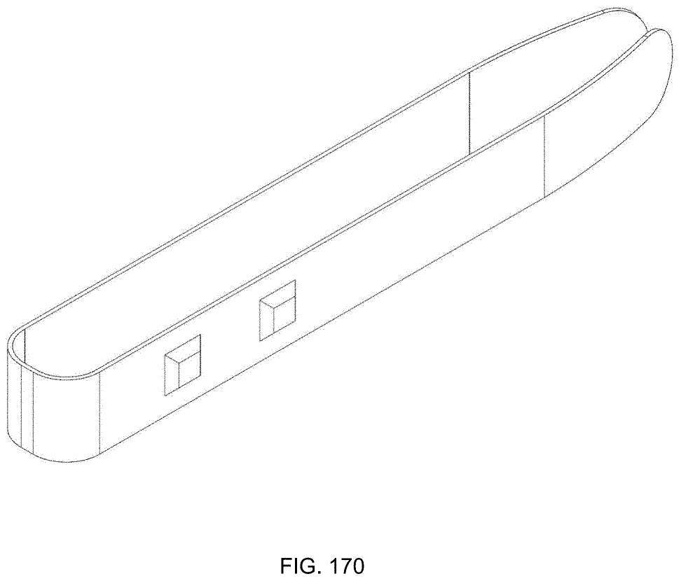

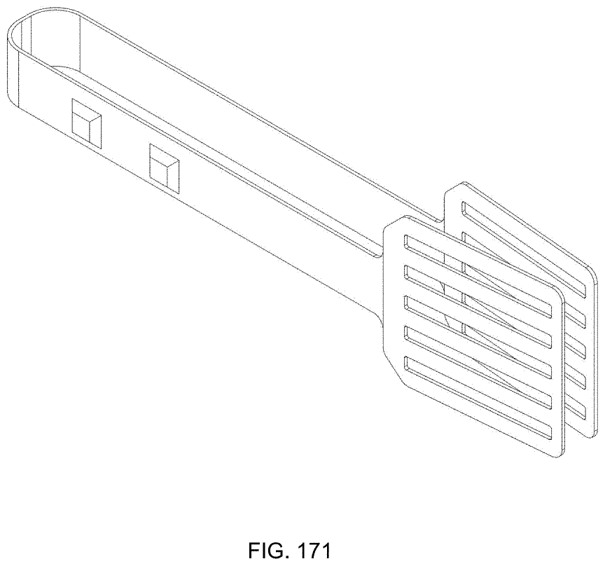

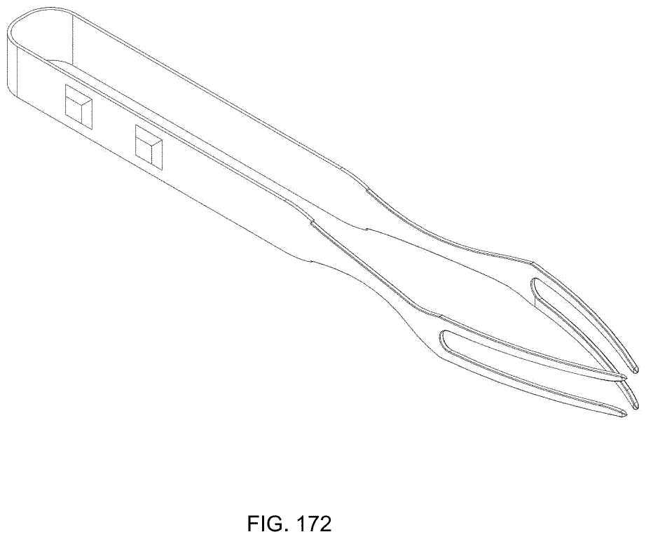

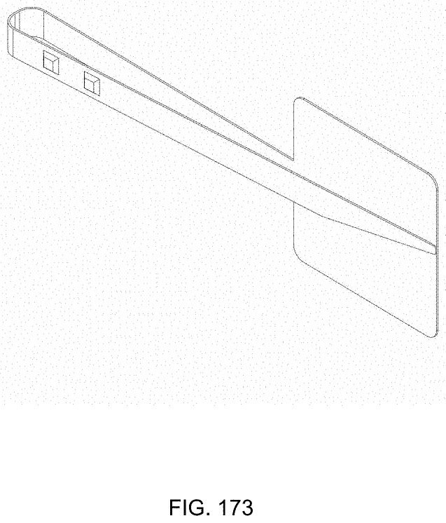

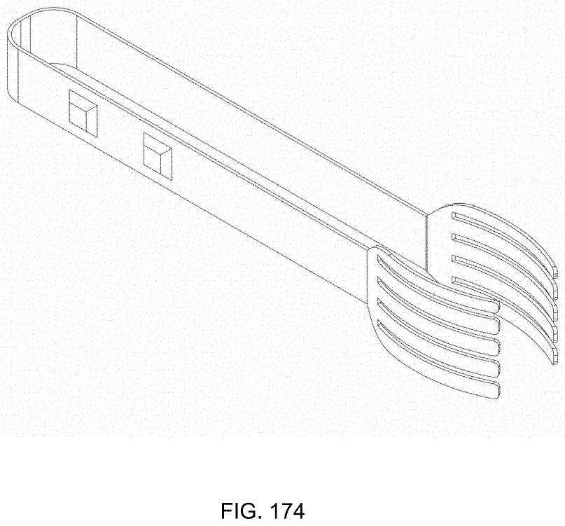

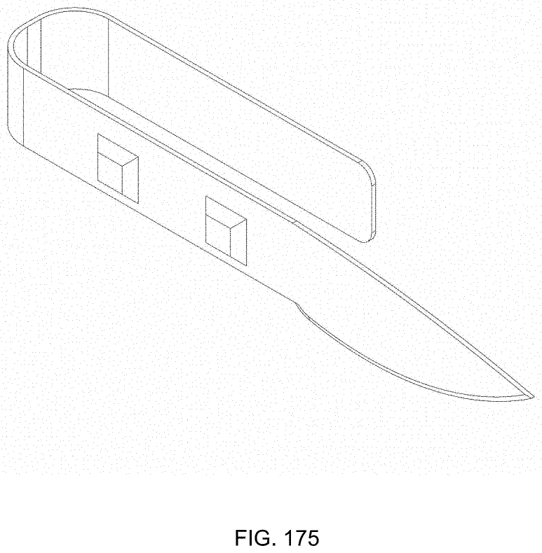

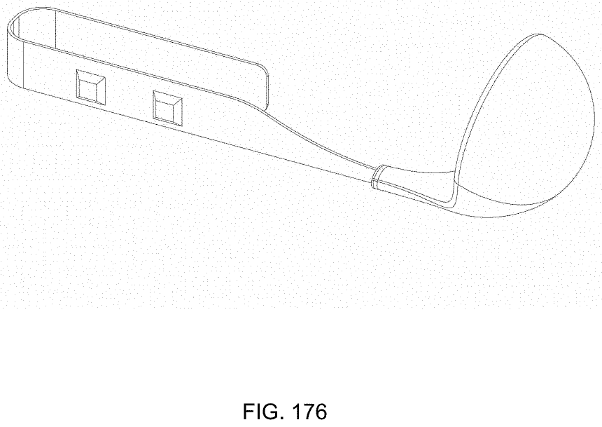

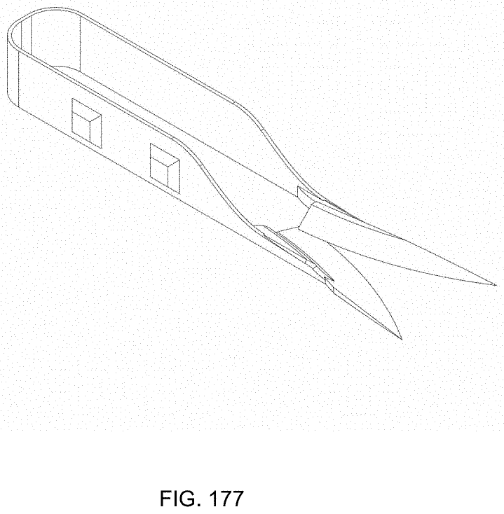

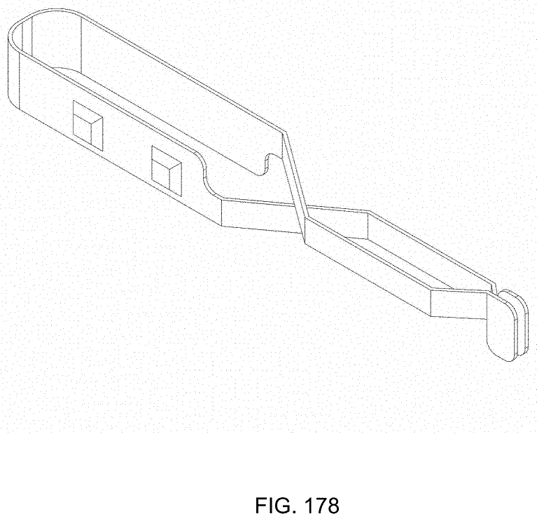

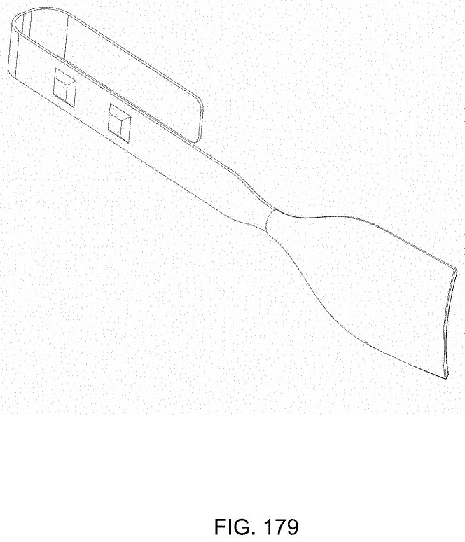

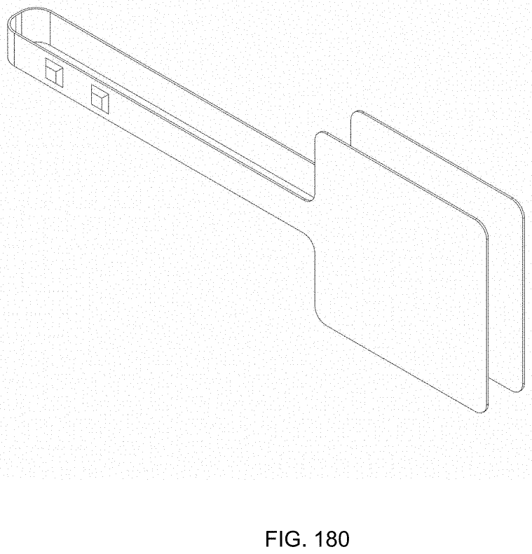

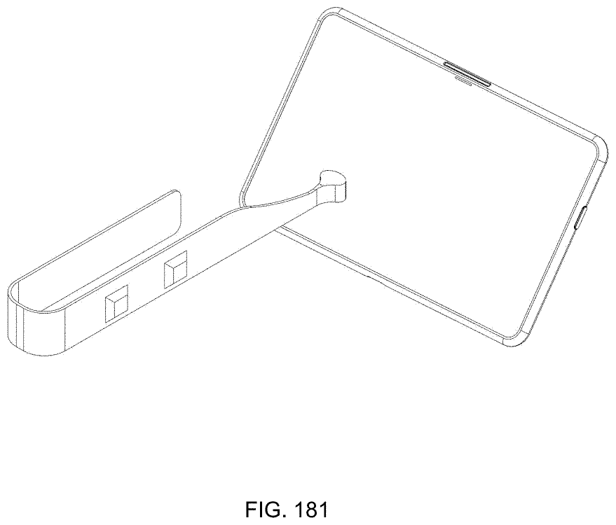

Other types of tongs also include flat tongs for picking up ingredients, flat tongs for flipping, for example, as shown in FIGS. 167-181.

FIG. 182-1 is a block diagram illustrating an example of a computer device, as shown in 182-1, on which computer-executable instructions 182-15 to perform the methodologies discussed herein may be installed and run. As alluded to above, the various computer-based devices discussed in connection with the present disclosure may share similar attributes. Each of the computer devices is capable of executing a set of instructions 182-15 to cause the computer device to perform any one or more of the methodologies discussed herein. The computer devices may represent any or all of the server, or any network intermediary devices. Further, while only a single machine is illustrated, the term “machine” shall also be taken to include any collection of machines that individually or jointly execute a set (or multiple sets) of instructions to perform any one or more of the methodologies discussed herein. The example computer system 182-1 includes a processor 182-2 (e.g., a central processing unit (CPU), a graphics processing unit (GPU), or both), a main memory 182-3 and a static memory 182-4, which communicate with each other via a bus 182-5. The computer system 182-1 may further include a video display unit 182-6 (e.g., a liquid crystal display (LCD)). The computer system 182-1 also includes an alphanumeric input device 182-7 (e.g., a keyboard), a cursor control device 182-8 (e.g., a mouse), a disk drive unit 182-9, a signal generation device 182-10 (e.g., a speaker), and a network interface device 182-11.

The disk drive unit 182-9 includes a machine-readable medium 182-11 on which is stored one or more sets of instructions (e.g., software 182-12) embodying any one or more of the methodologies or functions described herein. The software 182-12 may also reside, completely or at least partially, within the main memory 182-11 and/or within the processor 182-2 during execution thereof the computer system 182-1, the main memory 182-3, and the instruction-storing portions of processor 182-12 constituting machine-readable media. The software 182-12 may further be transmitted or received over a network 182-13 via the network interface device 182-14.

While the machine-readable medium 182-11 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any tangible medium that is capable of storing a set of instructions for execution by the machine and that cause the machine to perform any one or more of the methodologies of the present disclosure. The term “machine-readable medium” shall accordingly be taken to include, but not be limited to, solid-state memories, and optical and magnetic media.

A computer-implemented method for calibrating a robotic apparatus comprises moving at least one element of the robotic apparatus from a predetermined start configuration until the at least one element of the robotic apparatus is in contact with a predetermined surface of an object; recording a location value and/or an orientation value of the surface of the object based on the contact with the surface of the object; comparing the recorded location value and/or the recorded orientation value with an expected location value and/or with an expected orientation value to determine a positional deviation and/or an orientational deviation; and storing the determined positional and/or orientational deviation in a transformation data set. The contact with the surface is detected by an increase in electrical current or an increase in resistance detected for an electrical motor of the robotic apparatus.

A force sensor, a torque sensor, a force and torque sensor, a camera, a distance sensor, a sonar sensor, a lidar sensor or a combination thereof is use to detect the contact with the surface. The expected location and/or the expected orientation is a location and/or an orientation stored as part of or derivable from a model associates with the robotic apparatus.
The method for calibrating the robotic apparatus is repeated multiple times for different predetermined surfaces, moving the at least one element of the robotic apparatus along different axes, moving the at least one element of the robotic apparatus towards different directions or any combination thereof to record multiple location values and/or multiple orientation values. The transformation data set is created by combining and/or processing the multiple recorded location values and/or the multiple recorded orientation values. Processing the recorded location value and/or the recorded orientation value creates the transformation data set based on the determined positional deviation and/or the determined orientational deviation. The method further comprises receiving a minimanipulation to be executed by the robotic apparatus in a physical environment, the minimanipulation being pre-planned and/or pre-tested; receiving transformation information from the transformation data set, the received transformation information being associated with the received minimanipulation applying the received transformation information to the received minimanipulation to generate an adjusted minimanipulation; and executing the adjusted minimanipulation by the robotic apparatus.

A computer-implemented method for executing minimanipulations by a robotic apparatus comprises receiving a minimanipulation to be executed by the robotic apparatus in a physical environment, the minimanipulation being pre-planned and/or pre-tested; receiving transformation information from a transformation data set, the received transformation information being associated with the received minimanipulation; applying the received transformation information to the received minimanipulation to generate an adjusted minimanipulation; and executing the adjusted minimanipulation by the robotic apparatus. The minimanipulation is received from a minimanipulation library associated with the robotic apparatus, the minimanipulation library storing a plurality of minimanipulations, the plurality of minimanipulations being pre-planned and/or pre-tested. The the received minimanipulation and/or the plurality of minimanipulations has been pre-planned for and/or pre-tested with the robotic apparatus or another robotic apparatus one or more times during a testing or training phase to obtain a predetermined functional outcome when executing the received minimanipulation. The received minimanipulation and/or the plurality of minimanipulations has been pre-planned and/or pre-tested in the physical environment in which the adjusted minimanipulation is to be executed, in another physical environment of another robotic apparatus, in a virtual model of the physical environment, in a virtual model of another physical environment, or any combinations thereof. The method applies the received transformation information to the received minimanipulation that compensates positional and/or orientational deviations between the physical environment in which the robotic apparatus is to be executed and the physical environment or the virtual model based on which the received minimanipulation has been pre-planned and/or pre-tested during the testing or training phase. The physical environment in which the adjusted minimanipulation is to be executed is compared to the virtual model based on which the received minimanipulation has been pre-planned and/or pre-tested during the testing or training phase to determine positional and/or orientational deviations. The received minimanipulation has one or more parameters, and wherein applying the received transformation information to the received minimanipulation changes or adjusts at least one parameter value for at least one of the one or more parameters. At least one parameter value to be changed or adjusted is originally received from the minimanipulation library or another data storage. The method applies the received transformation information to the received minimanipulation to adapt the received minimanipulation to the physical environment in which the minimanipulation is to be executed by the robotic apparatus. The method further comprises receiving a sequence of minimanipulations for performing a certain task by the robotic apparatus, wherein the received minimanipulation is received as part of the sequence of minimanipulations; and executing the sequence of minimanipulations including the minimanipulation by the robotic apparatus after applying transformation information to at least some minimanipulations in the sequence of minimanipulations. The received minimanipulation is pre-planned and/or pre-tested by executing the received minimanipulation during the testing or training phase to obtain a functional outcome; evaluating a level of performance of the execution of the minimanipulation based on predetermined evaluation criteria for the functional outcome by comparing the functional outcome to the predetermined evaluation criteria; assigning the level of performance to the minimanipulation; and storing the level of performance with the minimanipulation in the minimanipulation library. The received minimanipulation is a joint state trajectory minimanipulation and/or one or more of the plurality of minimanipulations are joint state trajectory minimanipulations, and wherein the joint state trajectory minimanipulation is or the joint state trajectory minimanipulations are developed by simulating a desired action inside a virtual environment or by recording a desired action in the physical environment of the robotic apparatus or in another physical environment. The robotic apparatus comprises a multi-axis gantry system, the multi-axis gantry system comprising multiple axes, the multi-axis gantry system further comprising a robotic arm mount bracket attached to the multiple axes and carrying one or more robotic arms of the robotic apparatus. The multi-axis gantry system comprises at least two robotic arm mount brackets, each of the at least two robotic arm mount brackets carrying one or more robotic arms of the robotic apparatus, and wherein each of the at least two robotic arm mount brackets is movable independently of the other of the at least two robotic arm mount brackets. The adjusted minimanipulation comprises adjustment instructions in addition to the received minimanipulation, wherein the adjustment instructions move the robotic arm mount bracket of the multi-axis gantry system to compensate for the positional and/or orientational deviations. The received minimanipulation is executed as pre-planned and/or pre-tested without additional adjustments or modifications after the adjustment instructions were executed. The at least one element of the robotic apparatus is moved by the multi-axis gantry system from the predetermined start configuration along a predetermined axis towards the predetermined surface of the object, while a robotic arm of the robotic apparatus remains in its original configuration. The multi-axis gantry system comprises a plurality of motors or actuators to move the robotic arm mount bracket or the at least two robotic arm mount brackets independently in a x-axis, in a y-axis, in a z-axis, or any combination thereof and/or to rotate the robotic arm mount bracket or the at least two robotic arm mount brackets along or around the x-axis, along or around the y-axis, along or around the z-axis, or any combination thereof. Instead of or in addition to executing the adjusted minimanipulation by the robotic apparatus, the adjusted minimanipulation is stored in the minimanipulation library.

A computer-implemented method for executing minimanipulations by a robotic apparatus comprises providing a virtual model; receiving transformation information from a transformation data set, the transformation information including information about one or more positional and/or orientational deviations between a physical environment in which the robotic apparatus is to be executed and the virtual model; applying the transformation information to the virtual model to generate an adjusted virtual model matching at least in part with the physical environment; planning a trajectory for the robotic apparatus in the adjusted virtual model using a minimanipulation; and executing the minimanipulation by the robotic apparatus in the physical environment. The method applies the transformation information to the virtual model adjusts at least a part of the virtual model to the physical environment. The adjusted virtual model is used for live planning one or more trajectories for the robotic apparatus in the physical environment. The method further comprises sensing the physical environment by one or more sensors; comparing the virtual model with the sensed physical environment to determine the one or more positional and/or orientational deviations between the physical environment in which the robotic apparatus is to be executed and the virtual model; and computing the transformation data set based on the one or more positional and/or orientational deviations, wherein the transformation information in the transformation data set allows compensating the one or more positional and/or orientational deviations. The transformation data set is generated by a contact based calibration or adaption process, where the contact based calibration or adaption process comprises moving at least one element of the robotic apparatus from a start configuration until the at least one element of the robotic apparatus is in contact with a predetermined surface of an object; recording a location value and/or an orientation value of the surface of the object based on the contact with the surface of the object; comparing the recorded location value and/or the recorded orientation value with an expected location value and/or with an expected orientation value to determine a positional and/or orientational deviation; and storing the determined positional and/or orientational deviation in the transformation data set. The contact with the surface is detected by an increase in electrical current or an increase in resistance detected for an electrical motor of the robotic apparatus. A force sensor, a torque sensor, a force and torque sensor, a camera, a distance sensor, a sonar sensor, a lidar sensor or a combination thereof is use to detect the contact with the surface. The transformation data set is generated by a marker based calibration or adaption process, wherein the marker based calibration or adaption process comprises detecting a marker in the physical environment in which the robotic apparatus is to be executed; determining a location and/or an orientation of the marker by the robotic apparatus; comparing the determined location and/or the determined orientation of the marker with an expected location and/or an expected orientation of the marker to determine a positional and/or orientational deviation; and storing the determined positional and/or the determined orientational deviation in the transformation data set. The marker is affixed to one or more objects and/or living beings within the physical environment, is affixed to an particular element of the robotic apparatus, or is a particular part or element of one or more objects or living beings located within the physical environment. The marker is detected by a camera capturing one or more images of the marker, and wherein the one or more images of the marker are analyzed to determine the location and/or the orientation of the marker. The expected location and/or the expected orientation is a location and/or an orientation stored as part of or derivable from a model associates with the robotic apparatus or the virtual model. The expected location and/or the expected orientation corresponds to or is associated with the location and/or the orientation stored as part of or derivable from the model associates with the robotic apparatus or the virtual model. The contact based calibration or adaption process and/or the marker based calibration or adaption process for generating the transformation data set is repeated multiple times for different predetermined surfaces, moving the at least one element of the robotic apparatus along different axes, moving the at least one element of the robotic apparatus towards different directions or any combination thereof to record multiple location values and/or multiple orientation values. The transformation data set is created by combining and/or processing the multiple recorded location values and/or the multiple recorded orientation values. The transformation data set is one or more transformation matrices; and/or wherein the transformation information is stored and/or organized in the one or more transformation matrices. The transformation data set is one or more one-dimensional or multi-dimensional arrays; and/or wherein the transformation information is stored or organized in the one or more one-dimensional or multi-dimensional arrays. The transformation data set comprises one or more rules for compensating positional and/or orientational deviations between the physical environment in which the robotic apparatus is to be executed and the physical environment or the virtual model based on which the received minimanipulation has been pre-planned and/or pre-tested during the testing or training phase. The transformation data set is individually created for the robotic apparatus and the physical environment in which the robotic apparatus is to be executed; and/or wherein the transformation data set is unique. The received minimanipulation comprises one or more action primitives; and/or wherein one or more of the plurality of minimanipulations comprise one or more action primitives. The robotic apparatus comprises one or more robotic arms and one or more robotic end effectors. The robotic apparatus is or is part of a robotic kitchen, is a telerobot in a hospital environment, or is a robotic apparatus in a laboratory environment. A data processing system comprises a processor configured to perform a method. A computer program product comprising instructions which, when the program is executed by a computer, cause the computer to carry out a method. A computer-readable storage medium comprising instructions which, when executed by a computer, cause the computer to carry out a method.

A ventilation system for an operating environment of a robotic apparatus comprises a first ventilation subsystem adapted to extract air from the operating environment; and a second ventilation subsystem adapted to push air to the operating environment and to extract air from the operating environment; wherein the first ventilation subsystem is distinct from the second ventilation subsystem. The first ventilation subsystem is spatially distant from the second ventilation subsystem, and/or wherein the first ventilation subsystem is arranged at a first end of the operating environment and the second ventilation system is arranged at a second end of the operating environment, the first end being opposite to the second end. The first ventilation subsystem is a downdraft extraction ventilation subsystem, and/or wherein the second ventilation subsystem is an overhead fan. The second ventilation subsystem comprises at least one fan, blades of the at least one fan being movable in two opposite directions. For the ventilation system, in a first operation mode of the second ventilation subsystem, the at least one fan is operable to push air into the operating environment of the robotic apparatus by moving the blades of the at least one fan in a first direction to create a positive pressure inside the operating environment; and/or wherein, in a second operation mode of the second ventilation system, the fan is operable to extract air from the operating environment of the robotic apparatus by moving the blades of the at least one fan in a second direction to create an negative pressure inside the operating environment, the first direction being opposite to the second direction. The air extracted from the operating environment is directed into a recirculation system or into an outside environment. One or more high-efficiency particulate air, HEPA, filters adapts to remove contaminates and/or unwanted particles from air extracted from the operating environment and/or from air pushed to the operating environment. The ventilation system further comprises an air quality sensor. A protective screen encompasses at least a part of the operating environment and adapts to isolate the operating environment from an outside environment. A heating element adapts to control and/or adjust temperature inside the operating environment. A humidifier device adapts to control and/or adjust humidity inside the operating environment. The first ventilation subsystem is operable independently of the second ventilation subsystem, and/or the second ventilation subsystem is operable independently of the first ventilation subsystem. The first ventilation subsystem is operable in conjunction with the second ventilation subsystem, and/or the second ventilation subsystem is operable in conjunction with the first ventilation subsystem. A robotic system comprises a robotic apparatus and a ventilation system. The robotic apparatus comprises at least one robotic arm and at least one robotic end effector, the at least one robotic end effector being coupled to the at least one robotic arm. The robotic system is a robotic kitchen and the operating environment is a cooking environment. The robotic system is a laboratory robot and the operating environment is a robotic laboratory cabinet.

Some portions of the above are presented in terms of algorithms and symbolic representations of operations on data bits within a computer memory. These algorithmic descriptions and representations are the means used by those skilled in the data processing arts to convey most effectively the substance of their work to others skilled in the art. An algorithm is generally perceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared, transformed, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or “displaying” or “determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), erasable programmable ROMs (EPROMs), electrically erasable and programmable ROMs (EEPROMs), magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability.

An electronic device according to various embodiments of the disclosure may include various forms of devices. For example, the electronic device may include at least one of, for example, portable communication devices (e.g., smartphones), computer devices (e.g., personal digital assistants (PDAs), tablet personal computers (PCs), laptop PCs, desktop PCs, workstations, or servers), portable multimedia devices (e.g., electronic book readers or Motion Picture Experts Group (MPEG-1 or MPEG-2) Audio Layer 3 (MP3) players), portable medical devices (e.g., heartbeat measuring devices, blood glucose monitoring devices, blood pressure measuring devices, and body temperature measuring devices), cameras, or wearable devices. The wearable device may include at least one of an accessory type (e.g., watches, rings, bracelets, anklets, necklaces, glasses, contact lens, or head-mounted-devices (HIMDs)), a fabric or garment-integrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disk (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, or electronic picture frames.

In other embodiments, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automated teller machines (ATMs), points of sales (POSs), measuring instruments (e.g., water meters, electricity meters, or gas meters), or internet of things (e.g., light bulbs, sprinkler devices, fire alarms, thermostats, or street lamps). The electronic device according to an embodiment of the disclosure may not be limited to the above-described devices, and may provide functions of a plurality of devices like smartphones which have measurement function of personal biometric information (e.g., heart rate or blood glucose). In the disclosure, the term “user” may refer to a person who uses an electronic device or may refer to a device (e.g., an artificial intelligence electronic device) that uses the electronic device.

Moreover, terms such as “request”, “client request”, “requested object”, or “object” may be used interchangeably to mean action(s), object(s), and/or information requested by a client from a network device, such as an intermediary or a server. In addition, the terms “response” or “server response” may be used interchangeably to mean corresponding action(s), object(s) and/or information returned from the network device. Furthermore, the terms “communication” and “client communication” may be used interchangeably to mean the overall process of a client making a request and the network device responding to the request.

In respect of any of the above system, device or apparatus aspects, there may further be provided method aspects comprising steps to carry out the functionality of the system. Additionally or alternatively, optional features may be found based on any one or more of the features described herein with respect to other aspects.

The present disclosure has been described in particular detail with respect to possible embodiments. Those skilled in the art will appreciate that the disclosure may be practiced in other embodiments. The particular naming of the components, capitalization of terms, the attributes, data structures, or any other programming or structural aspect is not mandatory or significant, and the mechanisms that implement the disclosure or its features may have different names, formats, or protocols. The system may be implemented via a combination of hardware and software, as described, or entirely in hardware elements, or entirely in software elements. The particular division of functionality between the various system components described herein is merely exemplary and not mandatory; functions performed by a single system component may instead be performed by multiple components, and functions performed by multiple components may instead be performed by a single component.

In various embodiments, the present disclosure can be implemented as a system or a method for performing the above-described techniques, either singly or in any combination. The combination of any specific features described herein is also provided, even if that combination is not explicitly described. In another embodiment, the present disclosure can be implemented as a computer program product comprising a computer-readable storage medium and computer program code, encoded on the medium, for causing a processor in a computing device or other electronic device to perform the above-described techniques.

As used herein, any reference to “one embodiment” or to “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or “displaying” or “determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The algorithms and displays presented herein are not inherently related to any particular computer, virtualized system, or other apparatus. Various general-purpose systems may also be used with programs, in accordance with the teachings herein, or the systems may prove convenient to construct more specialized apparatus needed to perform the required method steps. The required structure for a variety of these systems will be apparent from the description provided herein. In addition, the present disclosure is not described with reference to any particular programming language. It will be appreciated that a variety of programming languages may be used to implement the teachings of the present disclosure as described herein, and any references above to specific languages are provided for disclosure of enablement and best mode of the present disclosure.

In various embodiments, the present disclosure can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the disclosure include a mobile phone, personal digital assistant, smartphone, kiosk, desktop computer, laptop computer, consumer electronic device, television, set-top box, or the like. An electronic device for implementing the present disclosure may use an operating system such as, for example, iOS available from Apple Inc. of Cupertino, Calif., Android available from Google Inc. of Mountain View, Calif., Microsoft Windows 10 available from Microsoft Corporation of Redmond, Wash., or any other operating system that is adapted for use on the device. In some embodiments, the electronic device for implementing the present disclosure includes functionality for communication over one or more networks, including for example a cellular telephone network, wireless network, and/or computer network such as the Internet.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one as or more than one. The term “plurality,” as used herein, is defined as two or as more than two. The term “another,” as used herein, is defined as at least a second or more.

An ordinary artisan should require no additional explanation in developing the methods and systems described herein but may find some possibly helpful guidance in the preparation of these methods and systems by examining standardized reference works in the relevant art.

The present disclosure is written with both British English and American English. It is understood that equivalent languages and words in meaning can be used interchangeably between British English and American English.

In addition to the above disclosure on the robotic kitchen for use in residential, commercial or industrial applications, the design of the robotic kitchen in the present disclosure can also be modified as a toy for kids, as toy robotic kitchen. In one embodiment, the toy robotic kitchen can be made of plastics with different pieces for assembly by kids, similar to LEGO pieces. In another embodiment, the toy robotic kitchen can be equipped with one or more batteries for which the toy robotic kitchen has some parts that are mechanical pieces to be put together, and some other parts which can be moveable upon activating a power switch by batteries, such as to move the robotic arm and hands. In a further embodiment, the toy robotic kitchen can be an educational toy which the toy robotic kitchen has an interactive function with kids to teach the kids as to how to make food dishes.

While the disclosure has been described with respect to a limited number of embodiments, those skilled in the art, having benefit of the above description, will appreciate that other embodiments may be devised which do not depart from the scope of the present disclosure as described herein. It should be noted that the language used in the specification has been principally selected for readability and instructional purposes, and may not have been selected to delineate or circumscribe the inventive subject matter. The terms used should not be construed to limit the disclosure to the specific embodiments disclosed in the specification and the claims, but the terms should be construed to include all methods and systems that operate under the claims set forth herein below. Accordingly, the disclosure is not limited by the disclosure, but instead its scope is to be determined entirely by the following claims.

What is claimed is:

1. A computer-implemented method for a robotic kitchen, executed by a processor, comprising:
(a) providing a minimanipulation library including a plurality of minimanipulations;
(b) comparing a virtual model of a first robotic kitchen with a physical model of a second robotic kitchen to determine one or more deviations;
(c) computing a mathematical transformation based on the one or more deviations in the virtual model of the first robotic kitchen with the physical model of a second robotic kitchen; and
(d) when executing a minimanipulation from the plurality of minimanipulations, applying the transformation matrix to the robotic kitchen by adjusting the location and orientation data value in the virtual model for compensating the one or more deviations in the virtual model of the first robotic kitchen, thereby the relative locations of the virtual model of the first robotic kitchen has been modified to be the same as the model of the second robotic kitchen.

2. The method of claim 1, wherein the virtual model comprises a virtual three-dimensional model of an etalon robotic kitchen, and wherein the physical model comprises a physical three-dimensional model of second robotic kitchen.

3. The method of claim 2, wherein comparing step comprises comparing the virtual three-dimensional model of the etalon robotic kitchen with the physical three-dimensional model of the second robotic kitchen to determine one or more deviations between one or more virtual locations in one or more virtual markers of the etalon robotic kitchen and the one or more corresponding physical locations in one or more physical markers in the second robotic kitchen.

4. The method of claim 1, wherein the plurality of minimanipulations comprise a plurality of pre-planned joint state trajectories (JST) parameterized minimanipulations

5. The method of claim 4, wherein each pre-planned joint state trajectories parameterized minimanipulation has been pre-tested and assigned a level of performance.

6. The method of claim 1, between the providing step and the comparing step, further comprising sensing the physical model of the second robotic kitchen with one more sensors using a multi-axis gantry to produce a three-dimensional model of the physical dimensions in the second robotic kitchen, the second robotic kitchen having one or more markers associated with the locations of one or more markers in the virtual model of the first robotic kitchen.

7. The method of claim 6, wherein the multi-axis gantry comprises a three-axis gantry actuator system for controlling an x-axis gantry actuator, a y-axis gantry actuator and a z-axis gantry actuator.

8. The method of claim 7, wherein the multi-axis gantry comprises a six-axis robot carriage actuator system for controlling an x-axis robot carriage linear actuator, a y-axis robot carriage linear actuator, a z-axis robot carriage linear actuator, an-axis robot carriage rotational actuator, a y-axis robot carriage rotational actuator, and a z-axis robot carriage rotational actuator.

9. The method of claim 1, wherein the computing step of the mathematical transformation comprises computing a transformation matrix.

10. The method of claim 9, wherein the transformation matrix comprises a unique transformation matrix that includes one or more linear shifts and one or more rotational shifts of a robotic arm along or around the x-axis, y-axis, or z-axis.

11. The method of claim 10, wherein the applying step comprises positioning a robotic arm at a location and an orientation for interacting with an object, wherein the processor executes the mathematical matrix to make one or more adjustments to a relative location and orientation of the robotic arm and the reference point for interacting with an object, a placement or a device.

12. The method of claim 9, wherein computing step of the transformation matrix comprises using one or more force torque sensors for detecting linear forces on a x-axis, a y-axis, a z-axis and rotational forces on the x-axis, the y-axis, the z-axis.

13. The method of claim 9, wherein the transformation matrix is generated uniquely for each pair of the physical model and the virtual model, wherein the robot interacts inside an operational environment for each reference point in the mathematical transformation.

14. The method of claim 13, wherein the applying step comprises positioning a robotic arm at a location and an orientation for interacting with an object, wherein the processor executes the mathematical matrix to make one or more adjustments to a relative location and orientation of the robotic arm and the reference point for interacting with an object, a placement or a device.

15. A robotic calibration method, executed by a processor, comprising:
receiving a virtual three-dimensional model of a first robotic kitchen;
sensing, by one or more sensors, a second robotic kitchen to produce a physical three-dimensional model in a second robotic kitchen;
comparing the virtual three-dimensional model of the first robotic kitchen with the physical three-dimensional model in the second robotic kitchen to determine one or more deviations;
computing a mathematical transformation based on the one or more deviations the virtual three-dimensional model of the first robotic kitchen with the physical three-dimensional model in the second robotic kitchen; and
when executing a minimanipulation by a robot having one or more robotic arms, applying the transformation matrix to the robotic kitchen using a multi-axis gantry by adjusting one or more locations and one or more orientations to the one or more robotic arms, thereby the relative locations of the physical three-dimensional model in the second robotic kitchen have been modified to be the same as the virtual three-dimensional model of the first robotic kitchen.

16. The method of claim 15, wherein comparing step comprises comparing the virtual three-dimensional model of the first robotic kitchen with the physical three-dimensional model of the second robotic kitchen to determine one or more deviations between one or more virtual locations in one or more virtual markers of the first robotic kitchen and the one or more corresponding physical locations in one or more physical markers in the second robotic kitchen.

17. The method of claim 15, wherein the plurality of minimanipulations comprise a plurality of pre-planned joint state trajectories (JST) parameterized minimanipulations; and wherein each pre-planned joint state trajectories parameterized minimanipulation has been pre-tested and assigned a level of performance.

18. The method of claim 15, wherein the computing step of the mathematical transformation comprises computing a transformation matrix; and wherein the transformation matrix comprises a unique transformation matrix that includes one or more linear shifts and one or more rotational shifts of a robotic arm along or around the x-axis, y-axis, or z-axis.

19. The method of claim 19, wherein the transformation matrix is generated uniquely for each pair of the physical model and the virtual model, wherein the robot interacts inside an operational environment for each reference point in the mathematical transformation.

20. A computer-implemented method for calibrating a robotic apparatus, the method comprising:
moving at least one element of the robotic apparatus from a predetermined start configuration until the at least one element of the robotic apparatus is in contact with a predetermined surface of an object;
recording a location value and/or an orientation value of the surface of the object based on the contact with the surface of the object;
comparing the recorded location value and/or the recorded orientation value with an expected location value and/or with an expected orientation value to determine a positional deviation and/or an orientational deviation; and
storing the determined positional and/or orientational deviation in a transformation data set.
